(19) United States
(12) Patent Application Publication
(10) Pub. No.: US 2025/0346612 A1
(43) Pub. Date: Nov. 13, 2025

(54) INTRAMOLECULAR CYCLIZATION FOR GENERAL SYNTHESIS OF BICYCLIC ALKYL BIOISOSTERE BORONATES

(71) Applicant: The Board of Regents of The University of Texas System, Austin, TX (US)

(72) Inventors: Tian QIN, Dallas, TX (US); Yangyang YANG, Dallas, TX (US); Jet TSIEN, Dallas, TX (US)

(73) Assignee: The Board of Regents of The University of Texas System, Austin, TX (US)

(21) Appl. No.: 18/264,413

(22) PCT Filed: Feb. 7, 2022
(86) PCT No.: PCT/US2022/015536

§ 371 Date: Aug. 4, 2023

Related U.S. Application Data
(60) Provisional application No. 63/146,266, filed on Feb. 5, 2021.

(51) Int. Cl. C07F 5/02; C07F 7/08

(52) U.S. Cl. CPC C07F 5/025; C07F 7/0812; C07F 7/083

(57) ABSTRACT

Disclosed herein are methods of synthesizing compounds of the formula (I) wherein the variables are defined herein. Also provided are compounds produced using these methods. In some aspects, the methods provided herein may be used to install aryl bioisosteres.

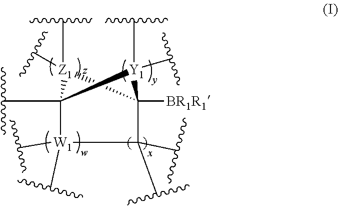

This application is a national phase application under 35 U.S.C. § 371 of International Application No. PCT/US2022/015536, filed Feb. 7, 2022, which claims the benefit of priority from U.S. Provisional Application No. 63/146,266, filed on Feb. 5, 2021, the entire contents of each of which are hereby incorporated by reference.

This invention was made with government support under Grant No. R01GM141088 awarded by the National Institute of Heath. The government has certain rights in the invention. This work was also supported by grant funding from the Welch Foundation under Grant No. I-2010-20190330.

### BACKGROUND

### I. Field

The present disclosure relates generally to the fields of chemistry. More particularly, it concerns methods of synthesis and compounds produced via the methods disclosed herein.

### II. Description of Related Art

Caged bicyclic molecules that exhibit considerable ring strain have long been the subject of intense study due to their unusual geometries, physical properties, and theoretical interest (Levin et al., 2000). Recent developments in medicinal chemistry shine a new light on the potential utility of these C(sp³)-rich hydrocarbons (Lovering et al., 2009). Owing to their unique physical and chemical properties, bicyclic hydrocarbons exhibit the ability to modulate the pharmacokinetic and physiochemical properties of drug candidates (Pellicciari et al., 1996; Mikhailiuk et al., 2006; Stepan et al., 2012; Westphal et al., 2015; Costantino et al., 2001; Nicolaou et al., 2016; Measom et al., 2017; Auberson et al., 2017). Bicyclo[1.1.1]pentanes (BCPs) containing substitutions at bridgehead positions (C1, C3) are now widely recognized as saturated bioisosteres for para-substituted benzenes (Talele, 2020; Bauer et al., 2021). Analogously, related caged scaffolds with differentiated substitutions (FIG. 1A) are expected to be ideal bioisosteres of ortho- or meta- substituted benzenes (Mykhailiuk, 2019; Denisenko et al., 2020). Currently BCPs are synthesized from the highly strained [1.1.1]propellane (6) (the strain energy of the C—C bond=˜59˜65 kcal/mol [Jackson et al., 1984; Feller and Davidson, 1987; Wiberg and Walker, 1982; Wu et al., 2009]), using methodologies pioneered by Wiberg (Wiberg et al., 1982; Wiberg et al., 1986), Michl (Kaszynki and Michl, 1988), Baran (Gianatassio et al., 2016; Lopchuk et al., 2017), and others (Ma et al., 2020; Kanazawa and Uchiyama, 2019; Makarov et al., 2017; Kanazawa et al. 2017; Kondo et al., 2020; Caputo et al., 2018; Nugent et al., 2019; Zhang et al., 2020; Trongsiriwat et al., 2019; Hughes et al., 2019; Shelp et al., 2018; Yu et al., 2020; Kim et al., 2020; Shin et al., 2021; Toriyama et al., 2016; VanHeyst et al., 2020; Garlets et al., 2020; Zarate et al., 2021), wherein 6 is transformed to symmetric and asymmetric BCPs using either single- or two-electron transfer pathways (FIG. 1B). These efforts have primarily focused on accessing C1 and/or C3-substituted BCPs until two recent reports (Ma et al., 2020; Zhao et al., 2020) disclosed strategies for the systematic functionalization of the backbone (C2) of BCPs. In addition to strain-release, Wurtz coupling (Wiberg et al., 1964; Rifi, 1969), Norrish-Yang cyclization (Padwa and Alexander, 1967; Padwa et al., 1969), [2+2] photo-cycloaddition (Srinivasan and Carlough, 1967), ring expansion (Ma et al., 2019; Applequist et al., 1982), and ring contraction (Meinwald et al., 1967; Della et al., 1981; Della and Pigou, 1984) represent other means to access BCPs. However, these methods are often plagued by low yields or limited substrate scope. In light of the aforementioned issues, practical and efficient methodologies to construct multi-substituted (C1/C2/C3) BCPs 8 are highly desirable as they represent elusive bioisosteres of ortho-/meta-substituted benzene rings and would enable access to novel chemical space.

### SUMMARY

The present disclosure provides synthetic methods of synthesizing organic compounds having bicyclic substructures, such as bicyclo[1.1.1]pentane. The present disclosure also provides compounds prepared by said methods.

In one aspect, the present disclosure provides methods of synthesizing a product, wherein the product is an organic compound having a substructure of the formula:

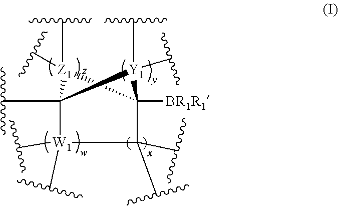

wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, are B-heterocycloalkyl_{(C≤12)} or substituted B-heterocycloalkyl_{(C≤12)};
   or a salt thereof;
   the method comprising:
(a) obtaining a precursor, wherein the precursor is an organic compound having a substructure of the formula:

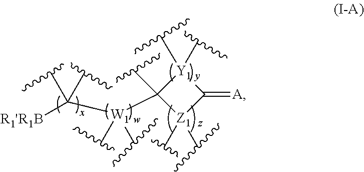

wherein w, x, y, z, W₁, Y₁, Z₁, R₁, and R₁′ are as defined above;
A is O, S, or NRₑ, wherein:
   Rₑ is hydrogen, alkyl_{(C≤12)}, alkoxy_{(C≤12)}, alkylamino_{(C≤12)}, dialkylamino_{(C≤12)}, alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
or a salt thereof; and
(b) contacting the precursor with a reagent, wherein the reagent is an organic compound comprising a hydrazide moiety, to afford a first reaction mixture; and
(c) contacting the first reaction mixture with a base to afford the product.

In some embodiments, the product is further defined as:

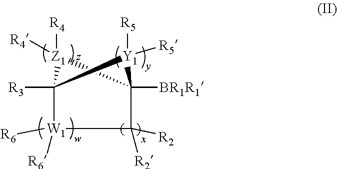

wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤2)} or substituted B-heterocycloalkyl_{(C≤12)};
R₂, R₂′, R₃, R₄, R₄′, R₅, R₅′, R₆, and R₆′ are each independently, in each instance, absent, hydrogen, hydroxy, halo, amino, cyano, nitro, or a monovalent amino protecting group; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group; or
   —BR_{d}R_{d}′, wherein:
      R_{d} and R_{d}′ are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
      or a salt thereof; and
         the substructure of the precursor is further defined as:

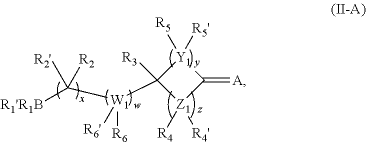

wherein w, x, y, z, W₁, Y₁, Z₁, R₁, R₁′, R₂, R₂′, R₃, R₄, R₄′, R₅, R₅′, R₆, and R₆′ are as defined above;
A is O, S, or NRₑ, wherein:
Rₑ is hydrogen, alkyl_{(C≤12)}, alkoxy_{(C≤12)}, alkylamino_{(C≤12)}, dialkylamino_{(C≤12)}, alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
   A is a protected carbonyl;
   or a salt thereof.

In some embodiments, the product is further defined as:

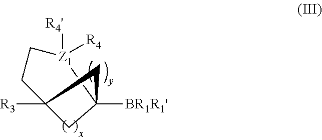

wherein:
x and y are each independently 1, 2, or 3;
Z₁ is C, N, O, or S; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
R₃ is hydrogen, hydroxy, halo, amino, cyano, nitro, or a monovalent amino protecting group; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
   R_{c} and R_{c′} are taken together and is a divalent amino protecting group;
R₄, and R₄′ are each independently absent, hydrogen, hydroxy, halo, amino, cyano, nitro, or a monovalent amino protecting group; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
         or a salt thereof.

In some embodiments, the product is an organic compound having a substructure of the formula:

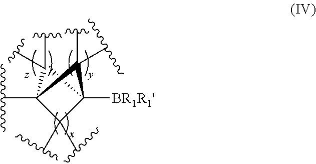

wherein:
x is 1 or 2;
y and z are each independently 1, 2, or 3; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
   or a salt thereof;
   the method comprising:
(a) obtaining a precursor, wherein the precursor is an organic compound having a substructure of the formula:

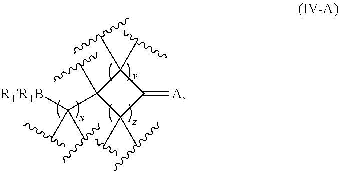

wherein x, y, z, R₁, and R₁′ are as defined above;
A is O, S, or NRₑ, wherein:
   Rₑ is hydrogen, alkyl_{(C≤12)}, alkoxy_{(C≤12)}, alkylamino_{(C≤12)}, dialkylamino_{(C≤12)}, alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
or a salt thereof; and
(b) contacting the precursor with a reagent, wherein the reagent is an organic compound comprising a hydrazide moiety to afford a first reaction mixture; and
(c) contacting the first reaction mixture with a base to afford the product.

In some embodiments, the product is further defined as:

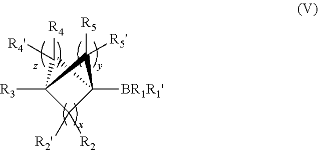

wherein:
x is 1 or 2;
y and z are each independently 1, 2, or 3;
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl(C≤₁₂); and
R₂, R₂′, R₃, R₄, R₄′, R₅, and R₅′ are each independently, in each instance, hydrogen, hydroxy, halo, amino, cyano, or nitro; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
   —BR_{d}R_{d}′, wherein:
      R_{d} and R_{d}′ are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
      R_{d} and R_{d}′, when taken together with the boron atom of the —BR_{d}R_{d}′ group, and is B-heterocycloalkyl_{(C≤2)} or substituted B-heterocycloalkyl_{(C≤12)};
         or a salt thereof; and
         the precursor is further defined as:

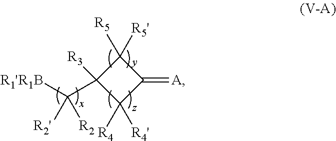

wherein:
x, y, z, R₁, R₁′, R₂, R₂′, R₃, R₄, R₄′, R₅, and R₅′ are as defined above; and
A is O, S, or NRₑ, wherein:
   Rₑ is hydrogen, alkyl_{(C≤12)}, alkoxy_{(C≤12)}, alkylamino_{(C≤12)}, dialkylamino_{(C≤12)}, alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
   or a salt thereof.

In some embodiments, the product is further defined as:

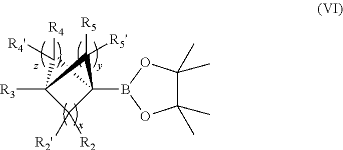

wherein:
x is 1 or 2;
y and z are each independently 1, 2, or 3; and
R₂, R₂′, R₃, R₄, R₄′, R₅, and R₅′ are each independently, in each instance, hydrogen, hydroxy, halo, amino, cyano, or nitro; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c}′ are taken together and is a divalent amino protecting group;
   —BR_{d}R_{d}′, wherein:
      R_{d} and R_{d′} are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
         or a salt thereof.

In some embodiments, the product is further defined as:

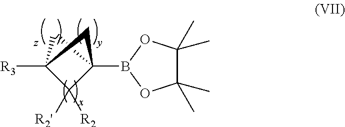

wherein:
x is 1 or 2;
y and z are each independently 1, 2, or 3; and
R₂, R₂′, and R₃ are each independently, in each instance, hydrogen, hydroxy, halo, amino, cyano, or nitro; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
   —BR_{d}R_{d}′, wherein:
      R_{d} and R_{d}′ are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and
      R_{d′} are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
         or a salt thereof.

In some embodiments, Z₁, in each instance, is C or N. In some embodiments, Z₁ is N. In some embodiments, R₄ and R₄′ are, in each instance, both hydrogen. In other embodiments, R₄ is a monovalent amino protecting group and R₄′ is absent. In some embodiments, R₄ is benzyloxycarbonyl. In some embodiments, Y₁, in each instance, is C. In some embodiments, R₅ and R₅′, in each instance, are both hydrogen.

In some embodiments, R₁ and R₁′ are taken together with the boron atom of the —BR₁R₁′ group and is B-heterocycloalkyl_{(C≤12)} or substituted B-heterocycloalkyl_{(C≤12)}. In further embodiments, R₁ and R₁′ are taken together with the boron atom of the —BR₁R₁′ group and is B-heterocycloalkyl_{(C≤12)}, such as 4,4,5,5-tetramethyl-1,3,2-dioxaborolanyl.

In some embodiments, R₄ is hydrogen, alkyl_{(C≤12)}, or substituted alkyl_{(C≤12)}. In some embodiments, R₄ is hydrogen. In some embodiments, R₄ is alkyl_{(C≤12)} or substituted alkyl_{(C≤12)}. In further embodiments, R₄ is alkyl_{(C≤12)}, such as methyl. In some embodiments, R₄′ is hydrogen, alkyl_{(C≤12)}, or substituted alkyl_{(C≤12)}. In some embodiments, R₄′ is hydrogen. In some embodiments, R₄′ is alkyl_{(C≤12)} or substituted alkyl_{(C≤12)}. In further embodiments, R₄′ is alkyl_{(C≤12)}, such as methyl. In some embodiments, R₅ is hydrogen, alkyl_{(C≤12)}, or substituted alkyl_{(C≤12)}. In some embodiments, R₅ is hydrogen. In some embodiments, R₅ is alkyl_{(C≤12)} or substituted alkyl_{(C≤12)}. In further embodiments, R₅ is alkyl_{(C≤12)}, such as methyl. In some embodiments, R₅′ is hydrogen, alkyl_{(C≤12)}, or substituted alkyl_{(C≤12)}. In some embodiments, R₅′ is hydrogen. In some embodiments, R₅′ is alkyl_{(C≤12)} or substituted alkyl_{(C≤12)}. In further embodiments, R₅′ is alkyl_{(C≤12)}, such as methyl.

In some embodiments, w is 0. In some embodiments, x is 1. In other embodiments, x is 2. In some embodiments, y is 1 or 2. In some embodiments, y is 1. In other embodiments, y is 2. In still other embodiments, y is 3. In some embodiments, z is 1 or 2. In some embodiments, z is 1. In other embodiments, z is 2. In still other embodiments, z is 3.

In some embodiments, R₃ is hydrogen; or alkyl_{(C≤12)}, alkenyl_{(C≤12)}, alkynyl_{(C≤12)}, aryl_{(C≤12)}, heteroaryl_{(C≤12)}, or a substituted version of any of these groups; or
—C(O)Rₐ, or —NR_{c}R_{c}′, wherein:
   Rₐ is heterocycloalkyl_{(C≤12)}, substituted heterocycloalkyl_{(C≤12)}, alkoxy_{(C≤12)}, or substituted alkoxy_{(C≤12)}; or
   R_{c} and R_{c′} are each independently hydrogen or a monovalent amino protecting group. In some embodiments, R₃ is hydrogen. In other embodiments, R₃ is alkyl_{(C≤12)} or substituted alkyl_{(C≤12)}. In further embodiments, R₃ is alkyl_{(C≤12)}, such as methyl. In still other embodiments, R₃ is alkenyl_{(C≤12)} or substituted alkenyl_{(C≤12)}. In further embodiments, R₃ is alkenyl_{(C≤12)}, such as ethenyl. In yet other embodiments, R₃ is alkynyl_{(C≤12)} or substituted alkenyl_{(C≤12)}. In further embodiments, R₃ is alkynyl_{(C≤12)}, such as ethynyl. In other embodiments, R₃ is aryl_{(C≤12)} or substituted aryl_{(C≤12)}. In further embodiments, R₃ is aryl_{(C≤12)}, such as phenyl. In still other embodiments, R₃ is substituted aryl_{(C≤12)}, such as 4-chlorophenyl. In yet other embodiments, R₃ is heteroaryl_{(C≤12)} or substituted heteroaryl_{(C≤12)}. In further embodiments, R₃ is heteroaryl_{(C≤12)}, such as thiophen-2-yl or pyridin-3-yl.

In other embodiments, R₃ is —C(O)Rₐ. In some embodiments, Rₐ is heterocycloalkyl_{(C≤12)} or substituted heterocycloalkyl_{(C≤12)}. In further embodiments, Rₐ is heterocycloalkyl_{(C≤12)}, such as morpholinyl. In other embodiments, Rₐ is alkoxy_{(C≤12)} or substituted alkoxy_{(C≤12)}. In further embodiments, Rₐ is alkoxy_{(C≤12)}, such as isopropoxy. In still other embodiments, R₃ is —NR_{c}R_{c}′. In some embodiments, R_{c} is hydrogen. In other embodiments, R_{c} is a monovalent amino protecting group, such as t-butoxycarbonyl. In some embodiments, R_{c}′ is hydrogen. In other embodiments, R_{c}′ is a monovalent amino protecting group, such as t-butoxycarbonyl.

In some embodiments, R₂ is hydrogen; or alkyl_{(C≤12)}, cycloalkyl(cs₁₂), heterocycloalkyl_{(C≤12)}, aryl_{(C≤12)}, aralkyl_{(C≤12)}, -alkanediyl_{(C≤12)}-alkylsilyl_{(C≤12)}, or a substituted version of any of these groups. In some embodiments, R₂ is hydrogen. In other embodiments, R₂ is alkyl_{(C≤12)} or substituted alkyl_{(C≤12)}. In further embodiments, R₂ is alkyl_{(C≤12)}, such as methyl or n-butyl. In still other embodiments, R₂ is cycloalkyl_{(C≤12)} or substituted cycloalkyl_{(C≤12)}. In further embodiments, R₂ is cycloalkyl_{(C≤12)}, such as cyclopropyl, cyclopentyl, or cyclohexyl. In yet other embodiments, R₂ is heterocycloalkyl_{(C≤12)} or substituted heterocycloalkyl_{(C≤12)}. In further embodiments, R₂ is heterocycloalkyl_{(C≤12)}, such as tetrahydro-2H-thiopyran-4-yl or 4,4,5,5-tetramethyl-1,3,2-dioxaborolanyl. In other embodiments, R₂ is aryl_{(C≤12)} or substituted aryl_{(C≤12)}. In further embodiments, R₂ is substituted aryl_{(C≤12)}, such as 4-methoxyphenyl. In still other embodiments, R₂ is aralkyl_{(C≤12)} or substituted aralkyl_{(C≤12)}. In further embodiments, R₂ is aralkyl_{(C≤12)}, such as phenylethyl. In yet other embodiments, R₂ is -alkanediyl_{(C≤12)}-alkylsilyl_{(C≤12)} or substituted -alkanediyl_{(C≤12)}-alkylsilyl_{(C≤12)}. In further embodiments, R₂ is -alkanediyl_{(C≤12)}-alkylsilyl_{(C≤12)}, such as (trimethylsilyl)methyl. In other embodiments, R₂ is —BR_{d}R_{d}′. In some embodiments, R_{d} and R_{d}′ are taken together with the B to form a B-heterocycloalkyl_{(C≤12)} or substituted B-heterocycloalkyl_{(C≤12)}.

In some embodiments, R₂′ is hydrogen, alkyl_{(C≤12)}, or substituted alkyl_{(C≤12)}. In some embodiments, R₂′ is hydrogen. In other embodiments, R₂′ is alkyl_{(C≤12)} or substituted alkyl_{(C≤12)}. In further embodiments, R₂′ is alkyl_{(C≤12)}, such as methyl.

In some embodiments, A is O. In other embodiments, A is a protected carbonyl. In some embodiments, the protected carbonyl is an acetal such as an acetal_{(C≤12)}. IN some embodiments, the protected carbonyl is a dimethyl acetal.

In some embodiments, the product is further defined as:

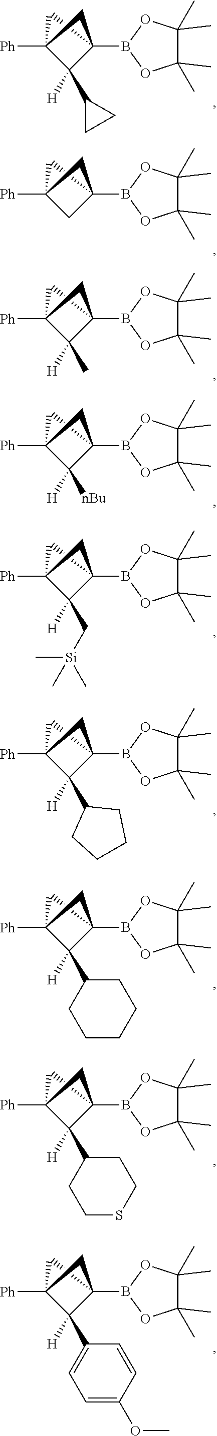

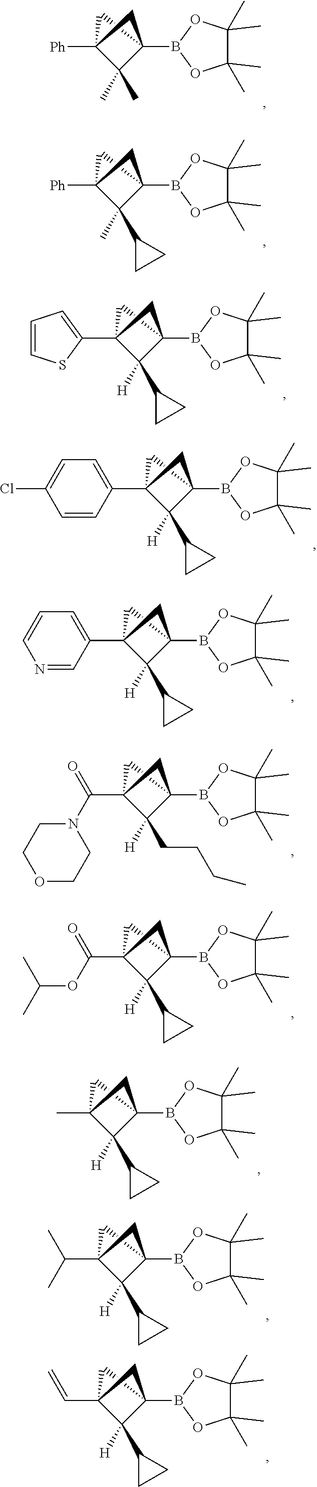

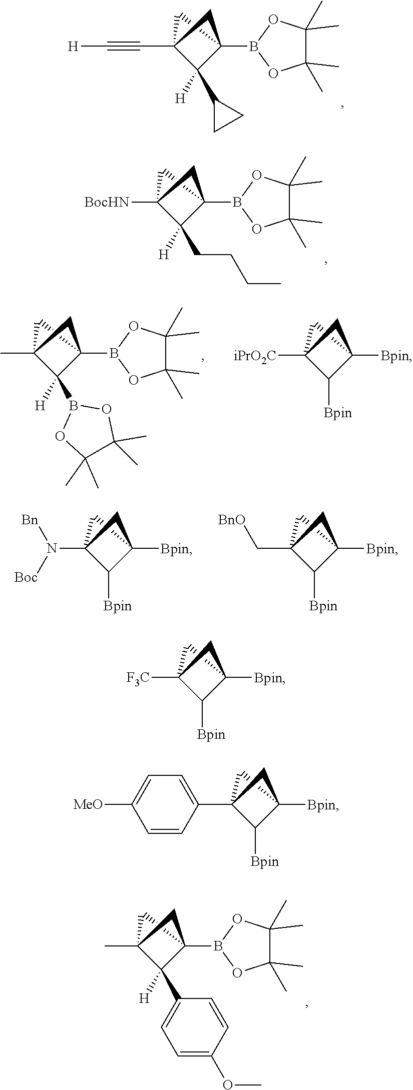

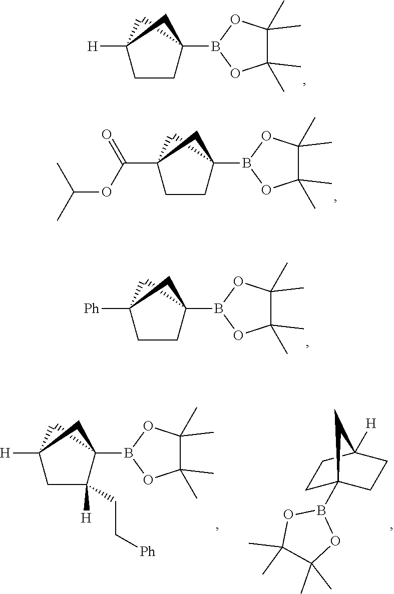

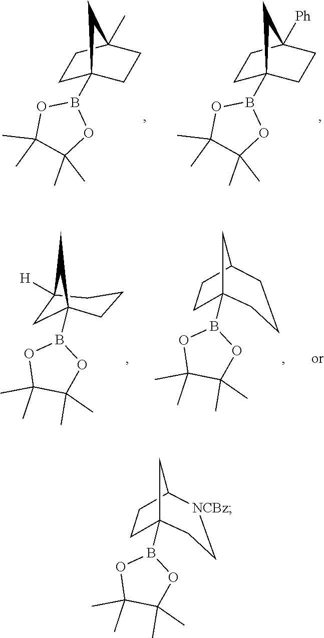

or a salt thereof.

In some embodiments, the reagent is of the formula:

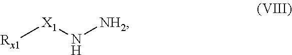

wherein:
X₁ is —C(O)— or —SO₂—; and
Rₓ₁ is alkyl_{(C≤12)}, substituted alkyl_{(C≤12)}, aryl_{(C≤12)}, or substituted aryl_{(C≤12)}.

In some embodiments, X₁—SO₂—. In some embodiments, Rₓ₁ is aryl_{(C≤12)} or substituted aryl_{(C≤12)}. In further embodiments, Rₓ₁ is aryl_{(C≤12)}, such as mesityl. In some embodiments, the reagent is mesitylsulfonyl hydrazide.

In some embodiments, the base is an inorganic base. In some embodiments, the base is a salt. In further embodiments, the base comprises a carbonate anion (CO₃²⁻). In some embodiments, the base comprises an alkali metal cation. In further embodiments, the base comprises a cesium (I) cation (Cs⁺). In some embodiments, the base is Cs₂CO₃. In some embodiments, the method is conducted in a solvent, such as dioxane.

In some embodiments, the method further comprises heating the first reaction mixture to a first temperature. In some embodiments, first temperature is from about 0° C. to about 150° C. In further embodiments, the first temperature is from about 0° C. to about 101° C. In still further embodiments, the first temperature is from about 15° C. to about 25° C., such as about room temperature or about 20° C. In some embodiments, contacting the first reaction mixture with a base further comprises heating to a second temperature. In some embodiments, the second temperature is from about 20° C. to about 150° C. In further embodiments, the second temperature is from about 20° C. to about 101° C., such as about 101° C. In some embodiments, contacting the precursor with the reagent is performed for a first period of time. In further embodiments, the first period of time is from about 1 minute to about 48 hours. In still further embodiments, the first period of time is from about 3 hours to about 12 hours. In some embodiments, contacting the first reaction mixture with the base is performed for a second period of time. In further embodiments, the second period of time is from about 1 minute to about 48 h. In still further embodiments, the second period of time is from about 1 hour to about 12 h, such as about 3 h.

In another aspect, the present disclosure provides compounds of the formula:

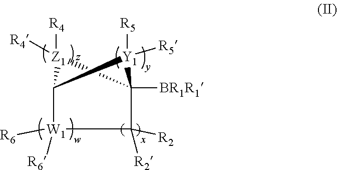

wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl(C≤₁₂);
R₂, R₂′, R₃, R₄, R₄′, R₅, R₅′, R₆, and R₆′ are each independently, in each instance, absent, hydrogen, hydroxy, halo, amino, cyano, nitro, or a monovalent amino protecting group; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
   —BR_{d}R_{d}′, wherein:
      R_{d} and R_{d}′ are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
         or a salt thereof.

In some embodiments, the compound is further defined as:

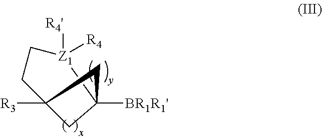

wherein:
x and y are each independently 1, 2, or 3;
Z₁ is C, N, O, or S; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
R₃ is hydrogen, hydroxy, halo, amino, cyano, nitro, or a monovalent amino protecting group; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
R₄, and R₄′ are each independently absent, hydrogen, hydroxy, halo, amino, cyano, nitro, or a monovalent amino protecting group; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
         or a salt thereof.

In some embodiments, the compound is further defined as:

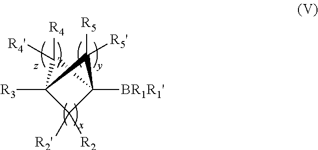

wherein:
x is 1 or 2;
y and z are each independently 1, 2, or 3;
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)}; and
R₂, R₂′, R₃, R₄, R₄′, R₅, and R₅′ are each independently, in each instance, hydrogen, hydroxy, halo, amino, cyano, or nitro; or
   alkyl_{(C≤12)}, alkenyl_{(C≤12)}, alkynyl_{(C≤12)}, cycloalkyl_{(C≤12)}, heterocycloalkyl(cs₁₂), aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
   —BR_{d}R_{d}′, wherein:
      R_{d} and R_{d′} are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d′} are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
         or a salt thereof.

In some embodiments, the compound is further defined as:

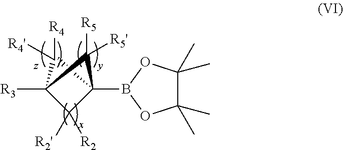

wherein:
x is 1 or 2;
y and z are each independently 1, 2, or 3; and
R₂, R₂′, R₃, R₄, R₄′, R₅, and R₅′ are each independently, in each instance, hydrogen, hydroxy, halo, amino, cyano, or nitro; or
   alkyl_{(C≤12)}, alkenyl_{(C≤12)}, alkynyl_{(C≤12)}, cycloalkyl_{(C≤12)}, heterocycloalkyl(cs₁₂), aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
   —BR_{d}R_{d}′, wherein:
      R_{d} and R_{d}′ are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
         or a salt thereof.

In some embodiments, the compound is further defined as:

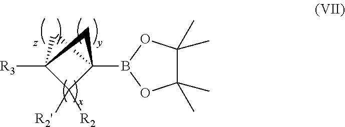

wherein:
x is 1 or 2;
y and z are each independently 1, 2, or 3; and
R₂, R₂′, and R₃ are each independently, in each instance, hydrogen, hydroxy, halo, amino, cyano, or nitro; or
   alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
   —(CH₂)ₐC(O)Rₐ, —(CH₂)ₐOR_{b}, or —(CH₂)ₐNR_{c}R_{c}′, wherein:
      a is 0, 1, 2, 3, or 4;
      Rₐ is hydrogen, hydroxy, halo, or amino; or
         alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
      R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
      R_{c} and R_{c′} are each independently hydrogen or a monovalent amino protecting group; or
      R_{c} and R_{c′} are taken together and is a divalent amino protecting group;
   —BR_{d}R_{d}′, wherein:
      R_{d} and R_{d}′ are each independently are each independently hydrogen, hydroxy, or amino; or
      alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
      R_{d} and R_{d}′, when taken together with the boron atom of the —BR_{d}R_{d}′ group, and is B-heterocycloalkyl_{(C≤12)} or substituted B-heterocycloalkyl_{(C≤12)};
         or a salt thereof.

In some embodiments, Z₁, in each instance, is C or N. In further embodiments, Z₁ is N. In some embodiments, R₄ and R₄′ are, in each instance, both hydrogen. In other embodiments, R₄ is a monovalent amino protecting group and R₄′ is absent. In some embodiments, R₄ is benzyloxycarbonyl. In some embodiments, Y₁, in each instance, is C. In some embodiments, R₅ and R₅′, in each instance, are both hydrogen.

In some embodiments, R₁ and R₁′ are taken together with the boron atom of the —BR₁R₁′ group and is B-heterocycloalkyl_{(C≤12)} or substituted B-heterocycloalkyl_{(C≤12)}. In further embodiments, R₁ and R₁′ are taken together with the boron atom of the —BR₁R₁′ group and is B-heterocycloalkyl_{(C≤12)}, such as 4,4,5,5-tetramethyl-1,3,2-dioxaborolanyl.

In some embodiments, R₄ is hydrogen, alkyl_{(C≤12)}, or substituted alkyl_{(C≤12)}. In some embodiments, R₄ is hydrogen. In other embodiments, R₄ is alkyl_{(C≤12)} or substituted alkyl_{(C≤12)}.

In further embodiments, R₄ is alkyl_{(C≤12)}, such as methyl. In some embodiments, R₄′ is hydrogen, alkyl_{(C≤12)}, or substituted alkyl_{(C≤12)}. In some embodiments, R₄′ is hydrogen. In other embodiments, R₄′ is alkyl_{(C≤12)} or substituted alkyl_{(C≤12)}. In further embodiments, R₄′ is alkyl_{(C≤12)}, such as methyl. In some embodiments, R₅ is hydrogen, alkyl_{(C≤12)}, or substituted alkyl_{(C≤12)}. In some embodiments, R₅ is hydrogen. In other embodiments, R₅ is alkyl_{(C≤12)} or substituted alkyl_{(C≤12)}. In further embodiments, R₅ is alkyl_{(C≤12)}, such as methyl. In some embodiments, R₅′ is hydrogen, alkyl_{(C≤12)}, or substituted alkyl_{(C≤12)}. In some embodiments, R₅′ is hydrogen. In other embodiments, R₅′ is alkyl_{(C≤12)} or substituted alkyl_{(C≤12)}. In further embodiments, R₅′ is alkyl_{(C≤12)}, such as methyl.

In some embodiments, w is 0. In some embodiments, x is 1. In other embodiments, x is 2. In some embodiments, y is 1 or 2. In some embodiments, y is 1. In other embodiments, y is 2. In still other embodiments, y is 3. In some embodiments, z is 1 or 2. In some embodiments, z is 1. In other embodiments, z is 2. In still other embodiments, z is 3.

In some embodiments, R₃ is hydrogen; or

alkyl_{(C≤12)}, alkenyl_{(C≤12)}, alkynyl_{(C≤12)}, aryl_{(C≤12)}, heteroaryl_{(C≤12)}, or a substituted version of any of these groups; or
—C(O)Rₐ, or —NR_{c}R_{c}′, wherein:
Rₐ is heterocycloalkyl_{(C≤12)}, substituted heterocycloalkyl_{(C≤12)}, alkoxy_{(C≤12)}, or substituted alkoxy_{(C≤12)}; or
R_{c} and R_{c′} are each independently hydrogen or a monovalent amino protecting group.

In some embodiments, R₃ is hydrogen. In other embodiments, R₃ is alkyl_{(C≤12)} or substituted alkyl_{(C≤12)}. In further embodiments, R₃ is alkyl_{(C≤12)}, such as methyl. In still other embodiments, R₃ is alkenyl_{(C≤12)} or substituted alkenyl_{(C≤12)}. In further embodiments, R₃ is alkenyl_{(C≤12)}, such as ethenyl. In yet other embodiments, R₃ is alkynyl_{(C≤12)} or substituted alkynyl_{(C≤12)}. In further embodiments, R₃ is alkynyl_{(C≤12)}, such as ethynyl. In other embodiments, R₃ is aryl_{(C≤12)} or substituted aryl_{(C≤12)}. In further embodiments, R₃ is aryl_{(C≤12)}, such as phenyl. In other embodiments, R₃ is substituted aryl_{(C≤12)}, such as 4-chlorophenyl. In still other embodiments, R₃ is heteroaryl_{(C≤12)} or substituted heteroaryl_{(C≤12)}. In further embodiments, R₃ is heteroaryl_{(C≤12)}, such as thiophen-2-yl or pyridin-3-yl.

In yet other embodiments, R₃ is —C(O)Rₐ. In some embodiments, Rₐ is heterocycloalkyl_{(C≤12)} or substituted heterocycloalkyl_{(C≤12)}. In further embodiments, Rₐ is heterocycloalkyl_{(C≤12)}, such as morpholinyl. In other embodiments, Rₐ is alkoxy_{(C≤12)} or substituted alkoxy_{(C≤12)}. In further embodiments, Rₐ is alkoxy_{(C≤12)}, such as isopropoxy. In other embodiments, R₃ is —NR_{c}R_{c}′. In some embodiments, R_{c} is hydrogen. In other embodiments, R_{c} is a monovalent amino protecting group, such as t-butoxycarbonyl. In some embodiments, R_{c}′ is hydrogen. In other embodiments, R_{c}′ is a monovalent amino protecting group, such as t-butoxycarbonyl.

In some embodiments, R₂ is hydrogen; or alkyl_{(C≤12)}, cycloalkyl_{(C≤12)}, heterocycloalkyl_{(C≤12)}, aryl_{(C≤12)}, aralkyl_{(C≤12)}, -alkanediyl_{(C≤12)}-alkylsilyl_{(C≤12)}, or a substituted version of any of these groups. In some embodiments, R₂ is hydrogen. In other embodiments, R₂ is alkyl_{(C≤12)} or substituted alkyl_{(C≤12)}. In further embodiments, R₂ is alkyl_{(C≤12)}, such as methyl or n-butyl. In still other embodiments, R₂ is cycloalkyl_{(C≤12)} or substituted cycloalkyl_{(C≤12)}. In further embodiments, R₂ is cycloalkyl_{(C≤12)}, such as cyclopropyl, cyclopentyl, or cyclohexyl. In yet other embodiments, R₂ is heterocycloalkyl_{(C≤12)} or substituted heterocycloalkyl_{(C≤12)}. In further embodiments, R₂ is heterocycloalkyl_{(C≤12)}, such as tetrahydro-2H-thiopyran-4-yl or 4,4,5,5-tetramethyl-1,3,2-dioxaborolanyl. In other embodiments, R₂ is aryl_{(C≤12)} or substituted aryl_{(C≤12)}. In further embodiments, R₂ is substituted aryl_{(C≤12)}, such as 4-methoxyphenyl. In still other embodiments, R₂ is aralkyl_{(C≤12)} or substituted aralkyl_{(C≤12)}. In further embodiments, R₂ is aralkyl_{(C≤12)}, such as is phenylethyl. In yet other embodiments, R₂ is -alkanediyl(C≤₁₂)-alkylsilyl_{(C≤12)} or substituted -alkanediyl_{(C≤12)}-alkylsilyl_{(C≤12)}. In further embodiments, R₂ is -alkanediyl_{(C≤12)}-alkylsilyl_{(C≤12)}, such as (trimethylsilyl)methyl. In other embodiments, R₂ is —BR_{d}R_{d}′, wherein: R_{d} and R_{d}′ are each independently are each independently hydrogen, hydroxy, or amino; or alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below; R_{d} and R_{d}′, when taken together with the boron atom of the —BR_{d}R_{d}′ group, and is B-heterocycloalkyl_{(C≤12)} or substituted B-heterocycloalkyl_{(C≤12)}. In some embodiments, R_{d} and R_{d}′ are taken together with the boron atom of the —BR_{d}R_{d}′ group and is B-heterocycloalkyl_{(C≤12)} or substituted B-heterocycloalkyl_{(C≤12)}.

In some embodiments, R₂′ is hydrogen, alkyl_{(C≤12)}, or substituted alkyl_{(C≤12)}. In some embodiments, R₂′ is hydrogen. In other embodiments, R₂′ is alkyl_{(C≤12)} or substituted alkyl_{(C≤12)}. In further embodiments, R₂′ is alkyl_{(C≤12)}, such as methyl.

In some embodiments, the compound is further defined as:

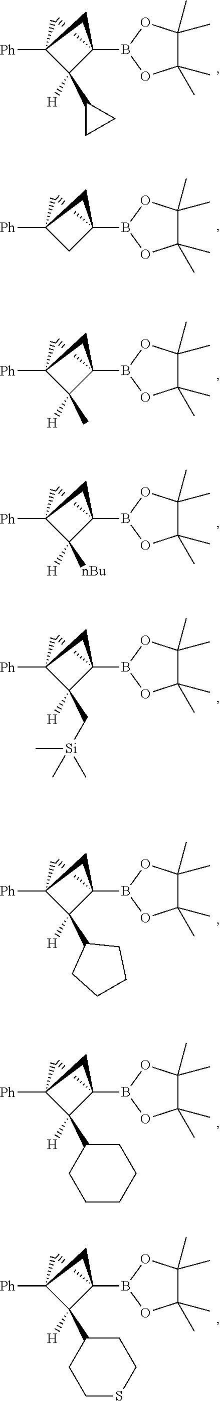

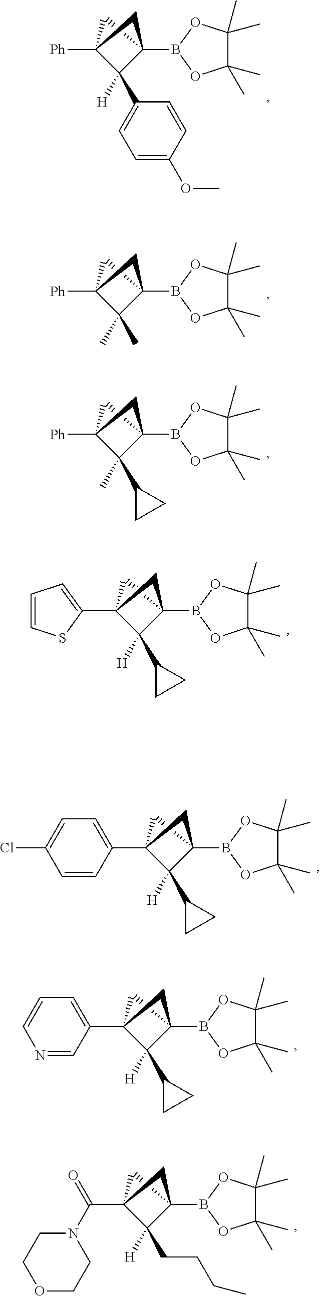

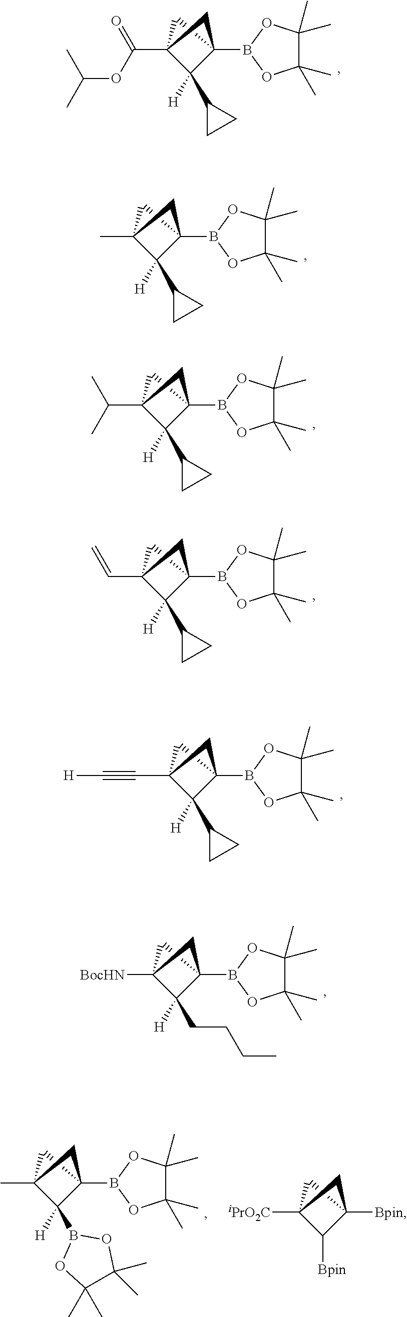

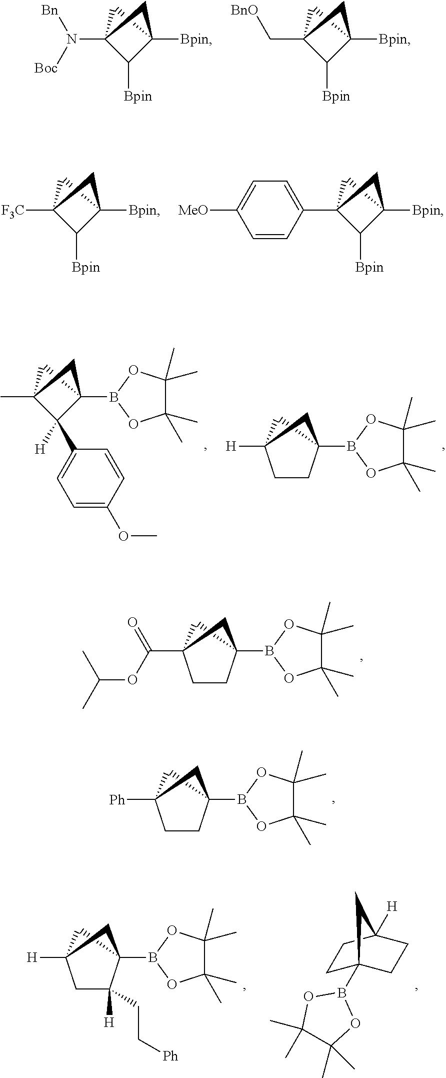

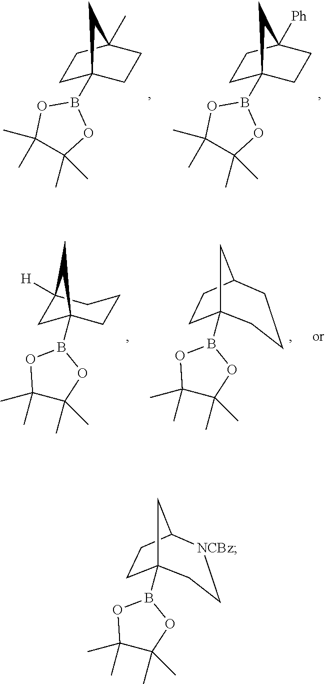

or a salt thereof.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description. Note that simply because a particular compound is ascribed to one particular generic formula doesn't mean that it cannot also belong to another generic formula.

### BRIEF DESCRIPTION OF THE DRAWINGS

For a more complete understanding of the features and advantages of the present disclosure, reference is now made to the detailed description of the disclosure along with the accompanying figures and in which:

FIGS. 1A-1C show bridged hydrocarbons and BCPs syntheses. (FIG. 1A) Substituted hydrocarbons provide novel chemical space as potential bioisosteres. (FIG. 1B) The state-of-art for BCP synthesis using strain releasing strategy. (FIG. 1C) Proposed intramolecular cyclization to access strained multi-substituted BCPs from cyclobutanone.

FIGS. 2A-2C show substrate scope of BCPs via intramolecular cyclization. Starting materials and products are racemic mixtures, unless annotated. (FIG. 2A) Substrate scope; (FIG. 2B) Substitutions on cyclobutanones; (FIG. 2C) Limitation of current reaction. Reaction conditions: ^{a} Cyclobutanone 9 (1.0 equiv.), MesSO₂NHNH₂ (1.2 equiv.) in dioxane (0.1-0.2 M) stirred at rt for 3-12 h, monitored by TLC; then Cs₂CO₃ (3.0 equiv.) was added and stirred at 100° C. for another 3 h; ^{b} 3.7 mmol scale; ^{c} 1) NaOAc, H2O2, 0° C., 1 h; 2) DMAP, 4-bromobenzoyl chloride, DIPEA; ^{d} ee values were measured after conversion to their alcohol derivatives. ^{e} the stereochemistry is unassigned.

FIG. 3 shows derivatization and synthetic application of BCP Bpins.

FIG. 4 shows intramolecular cyclization to access other bridged systems. Starting materials and products are racemic mixtures, un-less annotated. ^{a} Reaction conditions: Cyclic ketone 56 (1.0 equiv.), MesSO₂NHNH₂ (1.2 equiv.) in dioxane (0.1-0.2 M) stirred at rt for 3-12 h, monitored by TLC; then Cs₂CO₃ (3.0 equiv.) was added and stirred at 100° C. for another 3 h. ^{b} ee values were measured after conversion to alcohol derivatives.

FIGS. 5A-5C show the crystal structures of 16 (FIG. 5A), 20 (FIG. 5B), and 26 (FIG. 5C).

FIGS. 6A-6C show an introduction of BCP Bis-functionalization strategy. (a) Bicyclo[1.1.1]pentanes as benzene bioisosteric 3D-surrogates in drug discovery; (b) Structure-activity relationships (SARs) analysis with BCP scaffold; (c) Programmable and orthogonal functionalization of bridge-substituted BCPs.

FIGS. 7A & 7B show the BisBpin-substituted BCPs and representative synthesis route towards BCP 22.

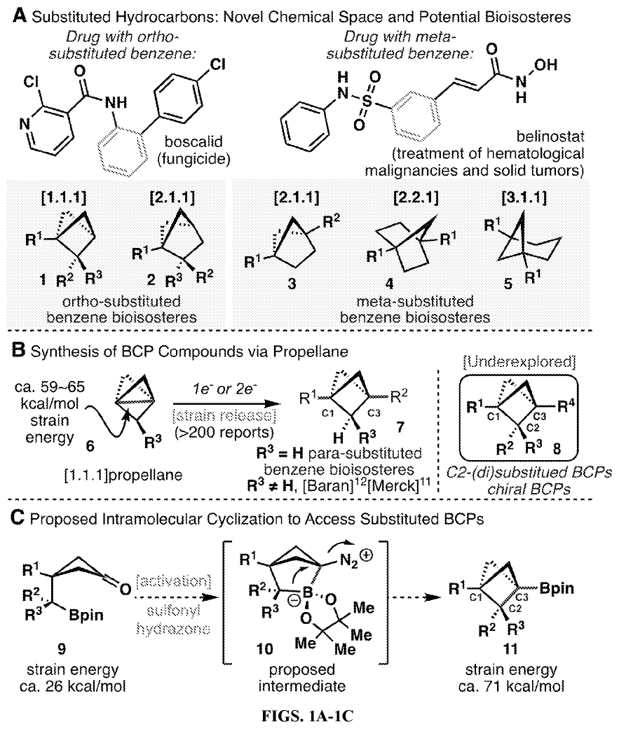

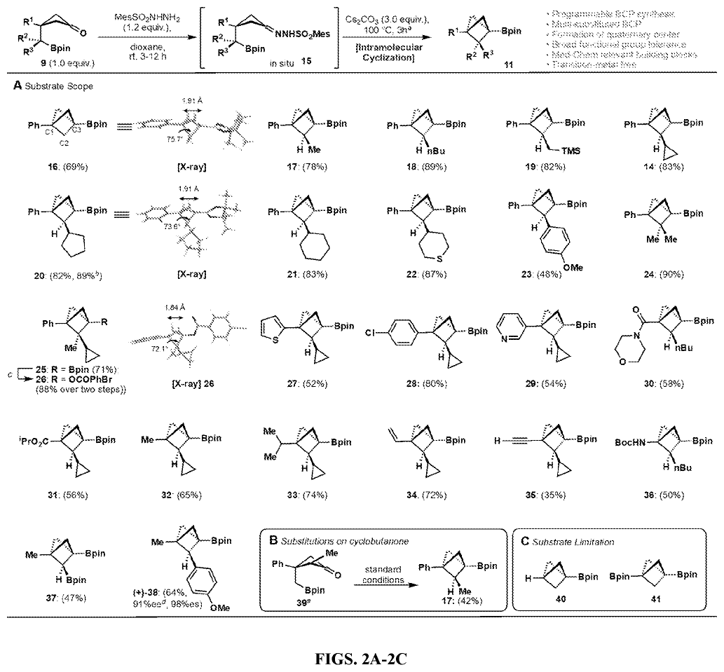

### DESCRIPTION OF ILLUSTRATIVE EMBODIMENTS

In some aspects, the present disclosure provides synthetic methodologies which may be used to prepare a bicyclic structure, which may be used as bioisosteres for various chemical groups, such as aryl groups. The methods described herein may be used in the synthesis of a variety of useful bicyclic structures comprising which may be used as precursors in the preparation of other compounds or as the final step of a longer synthetic scheme. In other embodiments, the methods may result in the formation of a bicyclic structure with a boron-based handle for further use in other synthetic pathways.

### I. Compounds of the Present Disclosure

The compounds of the present disclosure are shown, for example, above, in the summary section, and in the claims below. They may be made using the synthetic methods outlined in the Examples section. These methods can be further modified and optimized using the principles and techniques of organic chemistry as applied by a person skilled in the art. Such principles and techniques are taught, for example, in Smith, March's Advanced Organic Chemistry: Reactions, Mechanisms, and Structure, (2013), which is incorporated by reference herein. In addition, the synthetic methods may be further modified and optimized for preparative, pilot- or large-scale production, either batch or continuous, using the principles and techniques of process chemistry as applied by a person skilled in the art. Such principles and techniques are taught, for example, in Anderson, Practical Process Research & Development—A Guide for Organic Chemists (2012), which is incorporated by reference herein.

TABLE 1
Structure of Bicyclic Compounds Provided Herein

| Compound | |
|---|---|
| ID | Structural Formula |
| 14 | 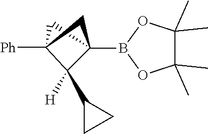 [SMILES: CC1(C)OB([C@]23C[C@](c4ccccc4)(C2)[C@@H]3C2CC2)OC1(C)C] |
| 16 | 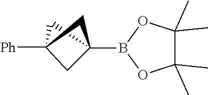 [SMILES: CC1(C)OB([C@]23C[C@](c4ccccc4)(C2)C3)OC1(C)C] |
| 17 | 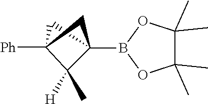 [SMILES: C[C@@H]1[C@]2(B3OC(C)(C)C(C)(C)O3)C[C@@]1(c1ccccc1)C2] |
| 18 | 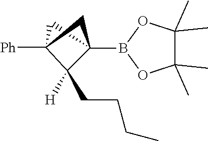 [SMILES: CCCC[C@@H]1[C@]2(B3OC(C)(C)C(C)(C)O3)C[C@@]1(c1ccccc1)C2] |
| 19 | 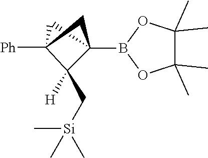 [SMILES: CC1(C)OB([C@]23C[C@](c4ccccc4)(C2)[C@@H]3C[Si](C)(C)C)OC1(C)C] |
| 20 | 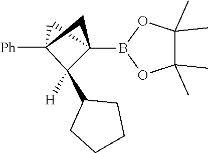 [SMILES: CC1(C)OB([C@]23C[C@](c4ccccc4)(C2)[C@@H]3C2CCCC2)OC1(C)C] |
| 21 | 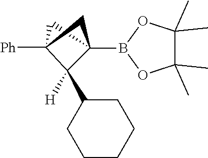 [SMILES: CC1(C)OB([C@]23C[C@](c4ccccc4)(C2)[C@@H]3C2CCCCC2)OC1(C)C] |
| 22 | 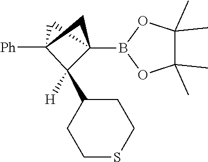 [SMILES: CC1(C)OB([C@]23C[C@](c4ccccc4)(C2)[C@@H]3C2CCSCC2)OC1(C)C] |
| 23 | 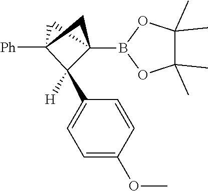 [SMILES: COc1ccc([C@@H]2[C@]3(B4OC(C)(C)C(C)(C)O4)C[C@@]2(c2ccccc2)C3)cc1] |
| 24 | 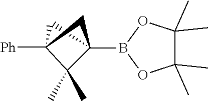 |
| 25 | 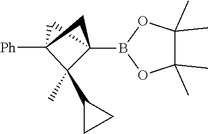 [SMILES: CC1(C)OB([C@]23C[C@](c4ccccc4)(C2)[C@]3(C)C2CC2)OC1(C)C] |
| 26 | 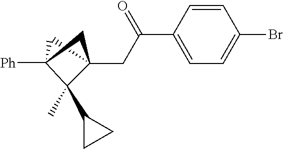 [SMILES: C[C@@]1(C2CC2)[C@]2(CC(=O)c3ccc(Br)cc3)C[C@@]1(c1ccccc1)C2] |
| 27 | 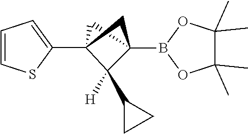 [SMILES: CC1(C)OB([C@]23C[C@](c4cccs4)(C2)[C@@H]3C2CC2)OC1(C)C] |
| 28 | 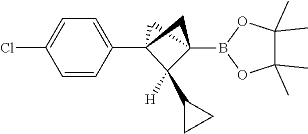 [SMILES: CC1(C)OB([C@]23C[C@](c4ccc(Cl)cc4)(C2)[C@@H]3C2CC2)OC1(C)C] |
| 29 | 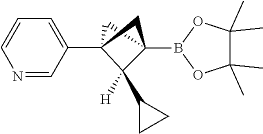 [SMILES: CC1(C)OB([C@]23C[C@](c4cccnc4)(C2)[C@@H]3C2CC2)OC1(C)C] |
| 30 | 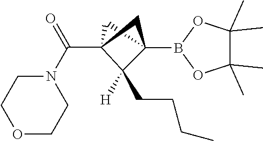 [SMILES: CCCC[C@@H]1[C@]2(B3OC(C)(C)C(C)(C)O3)C[C@@]1(C(=O)N1CCOCC1)C2] |
| 31 | 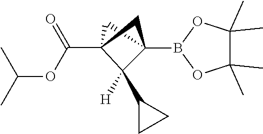 [SMILES: CC(C)OC(=O)[C@]12C[C@](B3OC(C)(C)C(C)(C)O3)(C1)[C@H]2C1CC1] |
| 32 | 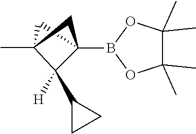 |
| 33 | 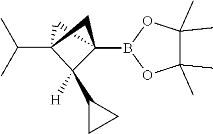 [SMILES: CC(C)[C@]12C[C@](B3OC(C)(C)C(C)(C)O3)(C1)[C@H]2C1CC1] |
| 34 | 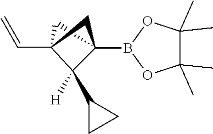 [SMILES: C=C[C@]12C[C@](B3OC(C)(C)C(C)(C)O3)(C1)[C@H]2C1CC1] |
| 35 | 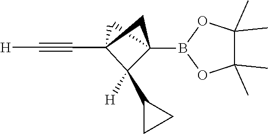 [SMILES: C#C[C@]12C[C@](B3OC(C)(C)C(C)(C)O3)(C1)[C@H]2C1CC1] |
| 36 | 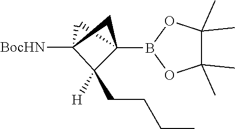 [SMILES: CCCC[C@H]1[C@]2(NC(=O)OC(C)(C)C)C[C@@]1(B1OC(C)(C)C(C)(C)O1)C2] |
| 37 | 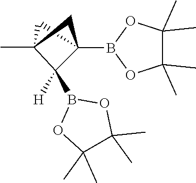 |
| 38 | 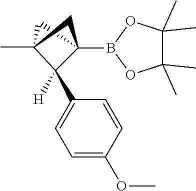 |
| 42 | 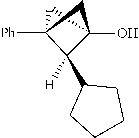 [SMILES: O[C@]12C[C@](c3ccccc3)(C1)[C@@H]2C1CCCC1] |
| 43 | 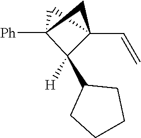 [SMILES: C=C[C@]12C[C@](c3ccccc3)(C1)[C@@H]2C1CCCC1] |
| 44 | 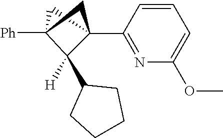 [SMILES: COc1cccc([C@]23C[C@](c4ccccc4)(C2)[C@@H]3C2CCCC2)n1] |
| 45 | 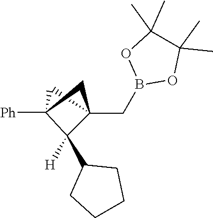 [SMILES: CC1(C)OB(C[C@]23C[C@](c4ccccc4)(C2)[C@@H]3C2CCCC2)OC1(C)C] |
| 46 | 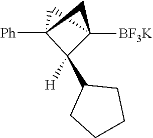 |
| 47 | 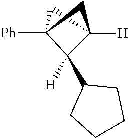 [SMILES: c1ccc([C@]23C[C@H](C2)[C@H]3C2CCCC2)cc1] |
| 48 | 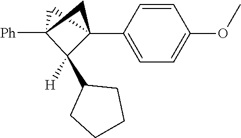 [SMILES: COc1ccc([C@]23C[C@](c4ccccc4)(C2)[C@@H]3C2CCCC2)cc1] |
| 50 | 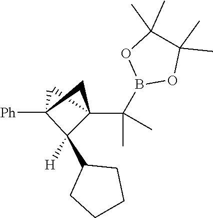 [SMILES: CC1(C)OB(C(C)(C)[C@]23C[C@](c4ccccc4)(C2)[C@@H]3C2CCCC2)OC1(C)C] |
| 54 | 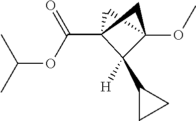 [SMILES: CO[C@]12C[C@](C(=O)OC(C)C)(C1)[C@@H]2C1CC1] |
| 61 | 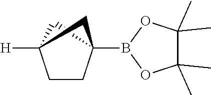 |
| 62 | 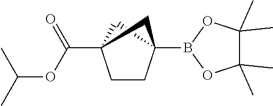 [SMILES: CC(C)OC(=O)[C@]12CC[C@](B3OC(C)(C)C(C)(C)O3)(C1)C2] |
| 63 | 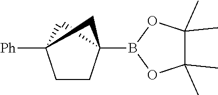 [SMILES: CC1(C)OB([C@]23CC[C@](c4ccccc4)(C2)C3)OC1(C)C] |
| 65 | 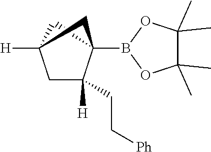 [SMILES: CC1(C)OB([C@]23C[C@H](C[C@H]2CCc2ccccc2)C3)OC1(C)C] |
| 68 | 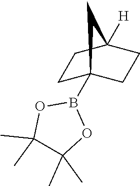 [SMILES: CC1(C)OB([C@]23CC[C@H](CC2)C3)OC1(C)C] |
| 69 | 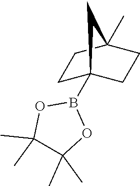 [SMILES: CC1(C)OB([C@]23CC[C@](C)(CC2)C3)OC1(C)C] |
| 71 | 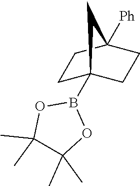 [SMILES: CC1(C)OB([C@]23CC[C@](c4ccccc4)(CC2)C3)OC1(C)C] |
| 73 | 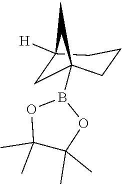 [SMILES: CC1(C)OB([C@]23CCC[C@H](C2)C3)OC1(C)C] |
| 75 | 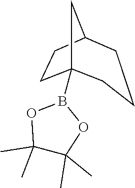 [SMILES: CC1(C)OB(C23CCCC(CC2)C3)OC1(C)C] |
| 77 | 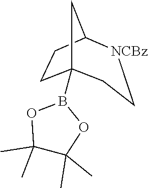 |
| xxCO₂ⁱPr/22 | 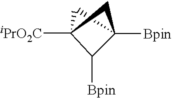 |
| xxNBocBn/23 | 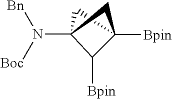 |
| xxCH₂OBn/24 | 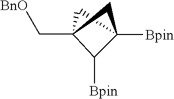 |
| xxMe/15 | 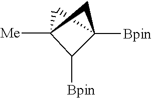 |
| xxCF₃/25 | 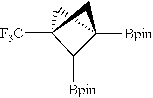 |
| xxPhOMe/26 | 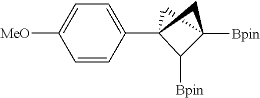 |

Compounds of the present disclosure may contain one or more asymmetrically-substituted carbon, sulfur, or phosphorus atom and may be isolated in optically active or racemic form. Thus, all chiral, diastereomeric, racemic form, epimeric form, and all geometric isomeric forms of a chemical formula are intended, unless the specific stereochemistry or isomeric form is specifically indicated. Compounds may occur as racemates and racemic mixtures, single enantiomers, diastereomeric mixtures and individual diastereomers. In some embodiments, a single diastereomer is obtained. The chiral centers of the compounds of the present disclosure can have the S or the R configuration. In some embodiments, the present compounds may contain two or more atoms which have a defined stereochemical orientation.

Chemical formulas used to represent compounds of the present disclosure will typically only show one of possibly several different tautomers. For example, many types of ketone groups are known to exist in equilibrium with corresponding enol groups. Similarly, many types of imine groups exist in equilibrium with enamine groups. Regardless of which tautomer is depicted for a given compound, and regardless of which one is most prevalent, all tautomers of a given chemical formula are intended.

In addition, atoms making up the compounds of the present disclosure are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C.

In some embodiments, compounds of the present disclosure exist in salt or non-salt form. With regard to the salt form(s), in some embodiments the particular anion or cation forming a part of any salt form of a compound provided herein is not critical, so long as the salt, as a whole, is pharmacologically acceptable. Additional examples of pharmaceutically acceptable salts and their methods of preparation and use are presented in Handbook of Pharmaceutical Salts: Properties, and Use (2002), which is incorporated herein by reference.

It will be appreciated that many organic compounds can form complexes with solvents in which they are reacted or from which they are precipitated or crystallized. These complexes are known as “solvates.” Where the solvent is water, the complex is known as a “hydrate.” It will also be appreciated that many organic compounds can exist in more than one solid form, including crystalline and amorphous forms. All solid forms of the compounds provided herein, including any solvates thereof are within the scope of the present disclosure.

### II. Methods of Synthesis

In some aspects, the present disclosure provides methods of synthesizing a product comprising obtaining a precursor, contacting the precursor with a reagent to afford a first reaction mixture, and contacting the first reaction mixture with a base to afford the product.

In some aspects, the precursor comprises a substructure of the formula:

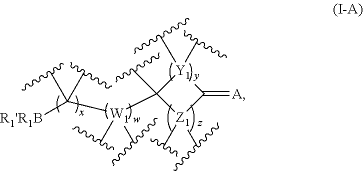

wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
   alkoxy_{(C≤12)}, alkylamino_{(C≤12)}, dialkylamino_{(C≤12)}, acyloxy_{(C≤12)}, amido_{(C≤12)}, or a substituted version of any of these groups; or
   R₁ and R₁′ are taken together as defined below;
R₁ and R₁′, when taken together with the boron atom of the —BR₁R₁′ group, are B-heterocycloalkyl_{(C≤12)} or substituted B-heterocycloalkyl_{(C≤12)};
   or a salt thereof.

The substructure represented by formula (I-A) comprises optional bonds to undefined portions of the precursor. A skilled artisan will recognize that the synthetic methods provided herein may be applied to any organic compound provided that the substructure of formula (I-A) is present. The precursor may further comprise one or more aliphatic or aromatic rings. The precursor may further comprise additional chemical groups, such as alkyl, alkenyl, alkynyl, cycloalkyl, heterocycloalkyl, aryl, heteroaryl, aralkyl, heteroaralkyl, alkoxy, alkylamino, dialkylamino, acyloxy, amido, or any other functional groups, provided that the precursor is an organic compound. An organic compound is understood to be a chemical compound consisting of elements selected from hydrogen, boron, carbon, nitrogen, oxygen, fluorine, silicon, phosphorus, sulfur, chlorine, bromine, and iodine, or salts thereof.

In some embodiments, the reagent comprises a hydrazide moiety. In some embodiments, the reagent is of the formula:

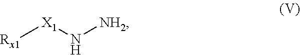

wherein:
X₁ is —C(O)— or —SO₂—; and
Rₓ₁ is alkyl_{(C≤12)}, substituted alkyl_{(C≤12)}, aryl_{(C≤12)}, or substituted aryl_{(C≤12)}.

In some embodiments, the reaction is conducted in an organic solvent, such as a non-polar, aprotic solvent, such as dioxane. In some embodiments, the solvent may comprise a second solvent. In some embodiments, the reaction mixture may further comprise an anhydrous solvent. In other embodiments, the solvent or solvent mixture may further comprise less than 5% water. Furthermore, the methods described herein may further comprise heating the first reaction mixture to a first temperature. In some embodiments, the first temperature is from about 0° C. to about 150° C., from 0° C. to about 101° C., from about 15° C. to about 25° C., or from about 0° C., 10° C., 20° C., 30° C., 40° C., 50° C., 60° C., 70° C., 80° C., 90° C., 100° C., 110° C., 120° C., 130° C., 140° C., to about 150° C., or any range derivable therein. In some embodiments, the first temperature is about room temperature. In some embodiments, the first temperature is about 20° C. In some embodiments, contacting the precursor with the reagent is performed for a first period of time. In some embodiments, the first period of time is from about 1 minute to about 48 hours, or from about 1 minute, 15 minutes, 30 minutes 45 minutes, 1 hour, 2 hours, 3 hours, 4 hours, 5 hours, 6 hours, 12 hours, 18 hours, 24 hours, 36 hours, to about 48 hours, or any range derivable therein. In some embodiments, the first time period is from about 3 hours to about 12 hours.

The methods of the present disclosure further comprise contacting the first reaction mixture with a base to afford the product. In some embodiments, the base is an inorganic base. In some embodiments, the base is a salt. In some embodiments, the base comprises a carbonate anion (CO₃²⁻). In some embodiments, the base comprises an alkali metal cation. In some embodiments, the base comprises a cesium (I) cation (Cs⁺). In some embodiments, the base is Cs₂CO₃. Furthermore, contacting the first reaction mixture with a base may further comprise heating to the first reaction mixture to a second temperature. In some embodiments, the second temperature is from about 20° C. to about 150° C., from 20° C. to about 101° C., or from about 20° C., 30° C., 40° C., 50° C., 60° C., 70° C., 80° C., 90° C., 100° C., 110° C., 120° C., 130° C., 140° C., to about 150° C., or any range derivable therein. In some embodiments, the second temperature is the refluxing temperature of the solvent. In some embodiments, the second temperature is about 101° C. In some embodiments, contacting the first reaction mixture with the base is performed for a second period of time. In some embodiments, the second period of time is from about 1 minute to about 48 hours, from about 1 hour to about 12 hours, or from about 1 minute, 15 minutes, 30 minutes 45 minutes, 1 hour, 2 hours, 3 hours, 4 hours, 5 hours, 6 hours, 12 hours, 18 hours, 24 hours, 36 hours, to about 48 hours, or any range derivable therein. In some embodiments, the second time period is about 3 hours.

### III. Definitions

When used in the context of a chemical group: “hydrogen” means —H; “hydroxy” means —OH; “oxo” means=O; “carbonyl” means —C(═O)—; “carboxy” means —C(═O)OH (also written as —COOH or —CO₂H); “halo” means independently —F, —Cl, —Br or —I; “amino” means —NH₂; “hydroxyamino” means —NHOH; “nitro” means —NO₂; imino means=NH; “cyano” means —CN; “isocyanyl” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof, “mercapto” means —SH; and “thio” means=S; “thiocarbonyl” means —C(═S)—; “sulfonyl” means —S(O)₂—; and “sulfinyl” means —S(O)—.

In the context of chemical formulas, the symbol “-” means a single bond, “=” means a double bond, and “≡” means triple bond. The symbol “ [symbol] ” represents an optional bond, which if present is either single or double. The symbol “ [symbol] ” represents a single bond or a double bond. Thus, the formula

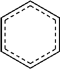

covers, for example,

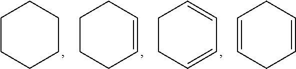

and

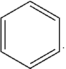

And it is understood that no one such ring atom forms part of more than one double bond. Furthermore, it is noted that the covalent bond symbol “-”, when connecting one or two stereogenic atoms, does not indicate any preferred stereochemistry. Instead, it covers all stereoisomers as well as mixtures thereof. The symbol “ [symbol] ”, when drawn perpendicularly across a bond (e.g.,

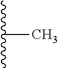

for methyl) indicates a point of attachment of the group. It is noted that the point of attachment is typically only identified in this manner for larger groups in order to assist the reader in unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means a single bond where the geometry around a double bond (e.g., either E or Z) is undefined. Both options, as well as combinations thereof are therefore intended. Any undefined valency on an atom of a structure shown in this application implicitly represents a hydrogen atom bonded to that atom. A bold dot on a carbon atom indicates that the hydrogen attached to that carbon is oriented out of the plane of the paper.

When a variable is depicted as a “floating group” on a ring system, for example, the group “R” in the formula:

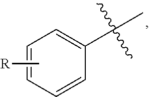

then the variable may replace any hydrogen atom attached to any of the ring atoms, including a depicted, implied, or expressly defined hydrogen, so long as a stable structure is formed. When a variable is depicted as a “floating group” on a fused ring system, as for example the group “R” in the formula:

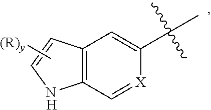

then the variable may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the R enclosed in parentheses, represents a numeric variable. Unless specified otherwise, this variable can be 0, 1, 2, or any integer greater than 2, only limited by the maximum number of replaceable hydrogen atoms of the ring or ring system.

For the chemical groups and compound classes, the number of carbon atoms in the group or class is as indicated as follows: “Cn” or “C=n” defines the exact number (n) of carbon atoms in the group/class. “C≤n” defines the maximum number (n) of carbon atoms that can be in the group/class, with the minimum number as small as possible for the group/class in question. For example, it is understood that the minimum number of carbon atoms in the groups “alkyl_{(C≤8)}”, “alkanediyl_{(C≤8)}”, “heteroaryl_{(C≤8)}”, and “acyl_{(C≤8)}” is one, the minimum number of carbon atoms in the groups “alkenyl_{(C≤8)}”, “alkynyl_{(C≤8)}”, and “heterocycloalkyl_{(C≤8)}” is two, the minimum number of carbon atoms in the group “cycloalkyl_{(C≤8)}” is three, and the minimum number of carbon atoms in the groups “aryl_{(C≤8)}” and “arenediyl_{(C≤8)}” is six. “Cn-n′” defines both the minimum (n) and maximum number (n′) of carbon atoms in the group. Thus, “alkyl_{(C2-10)}” designates those alkyl groups having from 2 to 10 carbon atoms. These carbon number indicators may precede or follow the chemical groups or class it modifies and it may or may not be enclosed in parenthesis, without signifying any change in meaning. Thus, the terms “C₁₋₄-alkyl”, “C₁₋₄-alkyl”, “alkyl_{(C1-4)}”, and “alkyl_{(C≤4)}” are all synonymous. Except as noted below, every carbon atom is counted to determine whether the group or compound falls with the specified number of carbon atoms. For example, the group dihexylamino is an example of a dialkylamino_{(C12)} group; however, it is not an example of a dialkylamino_{(C6)} group. Likewise, phenylethyl is an example of an aralkyl_{(C=8)} group. When any of the chemical groups or compound classes defined herein is modified by the term “substituted”, any carbon atom in the moiety replacing the hydrogen atom is not counted. Thus methoxyhexyl, which has a total of seven carbon atoms, is an example of a substituted alkyl_{(C1-6)}. Unless specified otherwise, any chemical group or compound class listed in a claim set without a carbon atom limit has a carbon atom limit of less than or equal to twelve.

The term “saturated” when used to modify a compound or chemical group means the compound or chemical group has no carbon-carbon double and no carbon-carbon triple bonds, except as noted below. When the term is used to modify an atom, it means that the atom is not part of any double or triple bond. In the case of substituted versions of saturated groups, one or more carbon oxygen double bond or a carbon nitrogen double bond may be present. And when such a bond is present, then carbon-carbon double bonds that may occur as part of keto-enol tautomerism or imine/enamine tautomerism are not precluded. When the term “saturated” is used to modify a solution of a substance, it means that no more of that substance can dissolve in that solution.

The term “aliphatic” signifies that the compound or chemical group so modified is an acyclic or cyclic, but non-aromatic compound or group. In aliphatic compounds/groups, the carbon atoms can be joined together in straight chains, branched chains, or non-aromatic rings (alicyclic). Aliphatic compounds/groups can be saturated, that is joined by single carbon-carbon bonds (alkanes/alkyl), or unsaturated, with one or more carbon-carbon double bonds (alkenes/alkenyl) or with one or more carbon-carbon triple bonds (alkynes/alkynyl).

The term “aromatic” signifies that the compound or chemical group so modified has a planar unsaturated ring of atoms with 4n+2 electrons in a fully conjugated cyclic 11 system. An aromatic compound or chemical group may be depicted as a single resonance structure; however, depiction of one resonance structure is taken to also refer to any other resonance structure. For example:

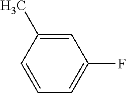

is also taken to refer to

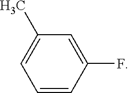

Aromatic compounds may also be depicted using a circle to represent the delocalized nature of the electrons in the fully conjugated cyclic π system, two non-limiting examples of which are shown below:

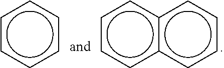

The term “alkyl” refers to a monovalent saturated aliphatic group with a carbon atom as the point of attachment, a linear or branched acyclic structure, and no atoms other than carbon and hydrogen. The groups —CH₃ (Me), —CH₂CH₃ (Et), —CH₂CH₂CH₃ (n-Pr or propyl), —CH(CH₃)₂ (i-Pr, ⁱPr or isopropyl), —CH₂CH₂CH₂CH₃ (n-Bu), —CH(CH₃)CH₂CH₃ (sec-butyl), —CH₂CH(CH₃)₂ (isobutyl), —C(CH₃)₃ (tert-butyl, t-butyl, t-Bu or ^{t}Bu), and —CH₂C(CH₃)₃ (neo-pentyl) are non-limiting examples of alkyl groups. The term “alkanediyl” refers to a divalent saturated aliphatic group, with one or two saturated carbon atom(s) as the point(s) of attachment, a linear or branched acyclic structure, no carbon-carbon double or triple bonds, and no atoms other than carbon and hydrogen. The groups —CH₂— (methylene), —CH₂CH₂—, —CH₂C(CH₃)₂CH₂—, and —CH₂CH₂CH₂— are non-limiting examples of alkanediyl groups. The term “alkylidene” refers to the divalent group ═CRR′ in which R and R′ are independently hydrogen or alkyl. Non-limiting examples of alkylidene groups include: ═CH₂, ═CH(CH₂CH₃), and ═C(CH₃)₂. An “alkane” refers to the class of compounds having the formula H-R, wherein R is alkyl as this term is defined above.

The term “cycloalkyl” refers to a monovalent saturated aliphatic group with a carbon atom as the point of attachment, said carbon atom forming part of one or more non-aromatic ring structures, no carbon-carbon double or triple bonds, and no atoms other than carbon and hydrogen. Non-limiting examples include: —CH(CH₂)₂ (cyclopropyl), cyclobutyl, cyclopentyl, or cyclohexyl (Cy). As used herein, the term does not preclude the presence of one or more alkyl groups (carbon number limitation permitting) attached to a carbon atom of the non-aromatic ring structure. The term “cycloalkanediyl” refers to a divalent saturated aliphatic group with two carbon atoms as points of attachment, no carbon-carbon double or triple bonds, and no atoms other than carbon and hydrogen. The group

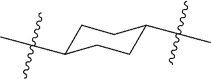 [SMILES: *C1CCC(*)CC1]

is a non-limiting example of cycloalkanediyl group. A “cycloalkane” refers to the class of compounds having the formula H-R, wherein R is cycloalkyl as this term is defined above.

The term “alkenyl” refers to a monovalent unsaturated aliphatic group with a carbon atom as the point of attachment, a linear or branched, acyclic structure, at least one nonaromatic carbon-carbon double bond, no carbon-carbon triple bonds, and no atoms other than carbon and hydrogen. Non-limiting examples include: —CH═CH₂ (vinyl), —CH═CHCH₃, —CH═CHCH₂CH₃, —CH₂CH═CH₂ (allyl), —CH₂CH═CHCH₃, and —CH═CHCH═CH₂. The term “alkenediyl” refers to a divalent unsaturated aliphatic group, with two carbon atoms as points of attachment, a linear or branched acyclic structure, at least one nonaromatic carbon-carbon double bond, no carbon-carbon triple bonds, and no atoms other than carbon and hydrogen. The groups —CH═CH—, —CH═C(CH₃)CH₂—, —CH═CHCH₂—, and —CH₂CH═CHCH₂— are non-limiting examples of alkenediyl groups. It is noted that while the alkenediyl group is aliphatic, once connected at both ends, this group is not precluded from forming part of an aromatic structure. The terms “alkene” and “olefin” are synonymous and refer to the class of compounds having the formula H-R, wherein R is alkenyl as this term is defined above. Similarly, the terms “terminal alkene” and “α-olefin” are synonymous and refer to an alkene having just one carbon-carbon double bond, wherein that bond is part of a vinyl group at an end of the molecule.

The term “alkynyl” refers to a monovalent unsaturated aliphatic group with a carbon atom as the point of attachment, a linear or branched acyclic structure, at least one carbon-carbon triple bond, and no atoms other than carbon and hydrogen. As used herein, the term alkynyl does not preclude the presence of one or more non-aromatic carbon-carbon double bonds. The groups —C≡CH, —C≡CCH₃, and —CH₂C—CCH₃ are non-limiting examples of alkynyl groups. An “alkyne” refers to the class of compounds having the formula H-R, wherein R is alkynyl.

The term “aryl” refers to a monovalent unsaturated aromatic group with an aromatic carbon atom as the point of attachment, said carbon atom forming part of a one or more aromatic ring structures, each with six ring atoms that are all carbon, and wherein the group consists of no atoms other than carbon and hydrogen. If more than one ring is present, the rings may be fused or unfused. Unfused rings are connected with a covalent bond. As used herein, the term aryl does not preclude the presence of one or more alkyl groups (carbon number limitation permitting) attached to the first aromatic ring or any additional aromatic ring present.

Non-limiting examples of aryl groups include phenyl (Ph), methylphenyl, (dimethyl)phenyl, —C₆H₄CH₂CH₃ (ethylphenyl), naphthyl, and a monovalent group derived from biphenyl (e.g., 4-phenylphenyl). The term “arenediyl” refers to a divalent aromatic group with two aromatic carbon atoms as points of attachment, said carbon atoms forming part of one or more six-membered aromatic ring structures, each with six ring atoms that are all carbon, and wherein the divalent group consists of no atoms other than carbon and hydrogen. As used herein, the term arenediyl does not preclude the presence of one or more alkyl groups (carbon number limitation permitting) attached to the first aromatic ring or any additional aromatic ring present. If more than one ring is present, the rings may be fused or unfused. Unfused rings are connected with a covalent bond. Non-limiting examples of arenediyl groups include:

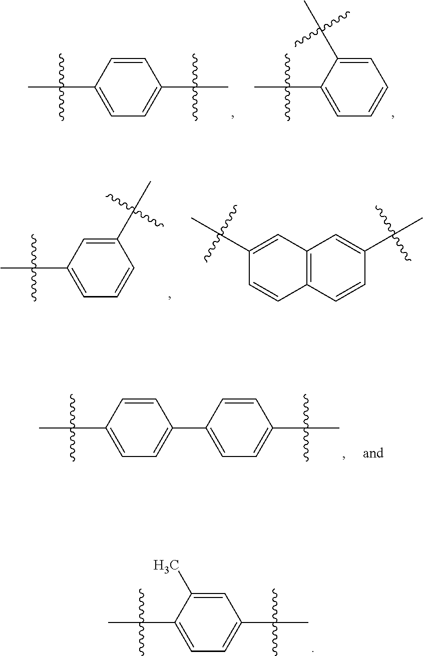

An “arene” refers to the class of compounds having the formula H-R, wherein R is aryl as that term is defined above. Benzene and toluene are non-limiting examples of arenes.

The term “aralkyl” refers to the monovalent group -alkanediyl-aryl, in which the terms alkanediyl and aryl are each used in a manner consistent with the definitions provided above. Non-limiting examples are: phenylmethyl (benzyl, Bn) and 2-phenyl-ethyl.

The term “heteroaryl” refers to a monovalent aromatic group with an aromatic carbon atom or nitrogen atom as the point of attachment, said carbon atom or nitrogen atom forming part of one or more aromatic ring structures, each with three to eight ring atoms, wherein at least one of the ring atoms of the aromatic ring structure(s) is nitrogen, oxygen or sulfur, and wherein the heteroaryl group consists of no atoms other than carbon, hydrogen, aromatic nitrogen, aromatic oxygen and aromatic sulfur. If more than one ring is present, the rings are fused; however, the term heteroaryl does not preclude the presence of one or more alkyl or aryl groups (carbon number limitation permitting) attached to one or more ring atoms. Non-limiting examples of heteroaryl groups include benzoxazolyl, benzimidazolyl, furanyl, imidazolyl (Im), indolyl, indazolyl, isoxazolyl, methylpyridinyl, oxazolyl, oxadiazolyl, phenylpyridinyl, pyridinyl (pyridyl), pyrrolyl, pyrimidinyl, pyrazinyl, quinolyl, quinazolyl, quinoxalinyl, triazinyl, tetrazolyl, thiazolyl, thienyl, and triazolyl. The term “N-heteroaryl” refers to a heteroaryl group with a nitrogen atom as the point of attachment. A “heteroarene” refers to the class of compounds having the formula H-R, wherein R is heteroaryl. Pyridine and quinoline are non-limiting examples of heteroarenes.

The term “heteroaralkyl” refers to the monovalent group -alkanediyl-heteroaryl, in which the terms alkanediyl and heteroaryl are each used in a manner consistent with the definitions provided above. Non-limiting examples are: pyridinylmethyl and 2-quinolinyl-ethyl.

The term “heterocycloalkyl” refers to a monovalent non-aromatic group with a carbon, nitrogen, or boron atom as the point of attachment, said carbon, nitrogen, or boron atom forming part of one or more non-aromatic ring structures, each with three to eight ring atoms, wherein at least one of the ring atoms of the non-aromatic ring structure(s) is nitrogen, oxygen, sulfur, or boron and wherein the heterocycloalkyl group consists of no atoms other than carbon, hydrogen, nitrogen, oxygen, sulfur, and boron. If more than one ring is present, the rings are fused. As used herein, the term does not preclude the presence of one or more alkyl groups (carbon number limitation permitting) attached to one or more ring atoms. Also, the term does not preclude the presence of one or more double bonds in the ring or ring system, provided that the resulting group remains non-aromatic. Non-limiting examples of heterocycloalkyl groups include aziridinyl, azetidinyl, pyrrolidinyl, piperidinyl, piperazinyl, morpholinyl, thiomorpholinyl, tetrahydrofuranyl, tetrahydrothiofuranyl, tetrahydropyranyl, pyranyl, oxiranyl, oxetanyl, 1,3,2-dioxaborolanyl, and 4,4,5,5-tetramethyl-1,3,2-dioxaborolanyl. The term “N-heterocycloalkyl” refers to a heterocycloalkyl group with a nitrogen atom as the point of attachment. N-pyrrolidinyl is an example of such a group. The term “B-heterocycloalkyl” refers to a heterocycloalkyl group with a boron atom as the point of attachment. 1,3,2-dioxaborolanyl and 4,4,5,5-tetramethyl-1,3,2-dioxaborolanyl are examples of such a group.

The term “acyl” refers to the group —C(O)R, in which R is a hydrogen, alkyl, cycloalkyl, or aryl as those terms are defined above. The groups, —CHO, —C(O)CH₃ (acetyl, Ac), —C(O)CH₂CH₃, —C(O)CH(CH₃)₂, —C(O)CH(CH₂)₂, —C(O)C₆H₅, and —C(O)C₆H₄CH₃ are non-limiting examples of acyl groups. A “thioacyl” is defined in an analogous manner, except that the oxygen atom of the group —C(O)R has been replaced with a sulfur atom, —C(S)R. The term “aldehyde” corresponds to an alkyl group, as defined above, attached to a —CHO group.

The term “alkoxy” refers to the group —OR, in which R is an alkyl, as that term is defined above. Non-limiting examples include: —OCH₃ (methoxy), —OCH₂CH₃ (ethoxy), —OCH₂CH₂CH₃, —OCH(CH₃)₂ (isopropoxy), or —OC(CH₃)₃ (tert-butoxy). The terms “cycloalkoxy”, “alkenyloxy”, “alkynyloxy”, “aryloxy”, “aralkoxy”, “heteroaryloxy”, “heterocycloalkoxy”, and “acyloxy”, when used without the “substituted” modifier, refers to groups, defined as —OR, in which R is cycloalkyl, alkenyl, alkynyl, aryl, aralkyl, heteroaryl, heterocycloalkyl, and acyl, respectively. The term “alkylthio” and “acylthio” refers to the group —SR, in which R is an alkyl and acyl, respectively. The term “alcohol” corresponds to an alkane, as defined above, wherein at least one of the hydrogen atoms has been replaced with a hydroxy group. The term “ether” corresponds to an alkane, as defined above, wherein at least one of the hydrogen atoms has been replaced with an alkoxy group.

The term “alkylamino” refers to the group —NHR, in which R is an alkyl, as that term is defined above. Non-limiting examples include: —NHCH₃ and —NHCH₂CH₃. The term “dialkylamino” refers to the group —NRR′, in which R and R′ can be the same or different alkyl groups. Non-limiting examples of dialkylamino groups include: —N(CH₃)₂ and —N(CH₃)(CH₂CH₃). The term “amido” (acylamino), when used without the “substituted” modifier, refers to the group —NHR, in which R is acyl, as that term is defined above. A non-limiting example of an amido group is —NHC(O)CH₃.

The term “alkylsilyl” refers to the group —Si(R)₃, in which R, R′, and R″ are alkyl, as that term is defined above, and R, R′, and R″ can be the same or different alkyl groups. Non-limiting examples include: —Si(CH₃)₃ and —Si(CH₃)₂C(CH₃)₃.

An “amine protecting group” or “amino protecting group” is well understood in the art. An amine protecting group is a group which modulates the reactivity of the amine group during a reaction which modifies some other portion of the molecule. Amine protecting groups can be found at least in Greene and Wuts, 1999, which is incorporated herein by reference. Some non-limiting examples of amino protecting groups include formyl, acetyl, propionyl, pivaloyl, t-butylacetyl, 2-chloroacetyl, 2-bromoacetyl, trifluoroacetyl, trichloroacetyl, o-nitrophenoxyacetyl, α-chlorobutyryl, benzoyl, 4-chlorobenzoyl, 4-bromobenzoyl, 4-nitrobenzoyl, and the like; sulfonyl groups such as benzenesulfonyl, p-toluenesulfonyl and the like; alkoxy- or aryloxycarbonyl groups (which form urethanes with the protected amine) such as benzyloxycarbonyl (Cbz), p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxycarbonyl, t-butyloxycarbonyl (Boc), diisopropylmethoxycarbonyl, isopropyloxycarbonyl, ethoxycarbonyl, methoxycarbonyl, allyloxycarbonyl (Alloc), 2,2,2-trichloroethoxycarbonyl, 2-trimethylsilylethyloxycarbonyl (Teoc), phenoxycarbonyl, 4-nitrophenoxycarbonyl, fluorenyl-9-methoxycarbonyl (Fmoc), cyclopentyloxycarbonyl, adamantyloxycarbonyl, cyclohexyloxycarbonyl, phenylthiocarbonyl and the like; alkylaminocarbonyl groups (which form ureas with the protect amine) such as ethylaminocarbonyl and the like; aralkyl groups such as benzyl, triphenylmethyl, benzyloxymethyl and the like; and silyl groups such as trimethylsilyl and the like. Additionally, the “amine protecting group” can be a divalent protecting group such that both hydrogen atoms on a primary amine are replaced with a single protecting group. In such a situation the amine protecting group can be phthalimide (phth) or a substituted derivative thereof wherein the term “substituted” is as defined above. In some embodiments, the halogenated phthalimide derivative may be tetrachlorophthalimide (TCphth). When used herein, a “protected amino group”, is a group of the formula PG_{MA}NH— or PG_{DA}N- wherein PG_{MA} is a monovalent amine protecting group, which may also be described as a “monovalently protected amino group” and PG_{DA} is a divalent amine protecting group as described above, which may also be described as a “divalently protected amino group”.

As used herein, a “chiral auxiliary” refers to a removable chiral group that is capable of influencing the stereoselectivity of a reaction. Persons of skill in the art are familiar with such compounds, and many are commercially available.

When a chemical group is used with the “substituted” modifier, one or more hydrogen atom has been replaced, independently at each instance, by —OH, —F, —Cl, —Br, —I, —NH₂, —NO₂, —CO₂H, —CO₂CH₃, —CO₂CH₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. For example, the following groups are non-limiting examples of substituted alkyl groups: —CH₂OH, —CH₂Cl, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂Cl. The term “haloalkyl” is a subset of substituted alkyl, in which the hydrogen atom replacement is limited to halo (i.e. —F, —Cl, —Br, or —I) such that no other atoms aside from carbon, hydrogen and halogen are present. The group, —CH₂Cl is a non-limiting example of a haloalkyl. The term “fluoroalkyl” is a subset of substituted alkyl, in which the hydrogen atom replacement is limited to fluoro such that no other atoms aside from carbon, hydrogen and fluorine are present. The groups —CH₂F, —CF₃, and —CH₂CF₃ are non-limiting examples of fluoroalkyl groups. Non-limiting examples of substituted aralkyls are: (3-chlorophenyl)-methyl, and 2-chloro-2-phenyl-eth-1-yl. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups. The groups —NHC(O)OCH₃ and —NHC(O)NHCH₃ are non-limiting examples of substituted amido groups.

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the inherent variation of error for the device, the method being employed to determine the value, or the variation that exists among the study subjects or patients. When used in the context of X-ray powder diffraction, the term “about” is used to indicate a value of ±0.2 °2θ from the reported value, preferably a value of ±0.1 °2θ from the reported value. When used in the context of differential scanning calorimetry or glass transition temperatures, the term “about” is used to indicate a value of ±10° C. relative to the maximum of the peak, preferably a value of ±2° C. relative to the maximum of the peak. When used in other contexts, the term “about” is used to indicate a value of ±10% of the reported value, preferably a value of ±5% of the reported value. It is to be understood that, whenever the term “about” is used, a specific reference to the exact numerical value indicated is also included.”

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The term “effective,” as that term is used in the specification and/or claims, means adequate to accomplish a desired, expected, or intended result. The above definitions supersede any conflicting definition in any reference that is incorporated by reference herein. The fact that certain terms are defined, however, should not be considered as indicative that any term that is undefined is indefinite. Rather, all terms used are believed to describe the disclosure in terms such that one of ordinary skill can appreciate the scope and practice the present disclosure.

The term “hydrate” when used as a modifier to a compound means that the compound has less than one (e.g., hemihydrate), one (e.g., monohydrate), or more than one (e.g., dihydrate) water molecules associated with each compound molecule, such as in solid forms of the compound.

An “isomer” of a first compound is a separate compound in which each molecule contains the same constituent atoms as the first compound, but where the configuration of those atoms in three dimensions differs.

“Pharmaceutically acceptable salts” means salts of compounds disclosed herein which are pharmaceutically acceptable, as defined above, and which possess the desired pharmacological activity. Such salts include acid addition salts formed with inorganic acids such as hydrochloric acid, hydrobromic acid, sulfuric acid, nitric acid, phosphoric acid, and the like; or with organic acids such as 1,2-ethanedisulfonic acid, 2-hydroxyethanesulfonic acid, 2-naphthalenesulfonic acid, 3-phenylpropionic acid, 4,4′-methylenebis(3-hydroxy-2-ene-1-carboxylic acid), 4-methylbicyclo[2.2.2]oct-2-ene-1-carboxylic acid, acetic acid, aliphatic mono- and dicarboxylic acids, aliphatic sulfuric acids, aromatic sulfuric acids, benzenesulfonic acid, benzoic acid, camphorsulfonic acid, carbonic acid, cinnamic acid, citric acid, cyclopentanepropionic acid, ethanesulfonic acid, fumaric acid, glucoheptonic acid, gluconic acid, glutamic acid, glycolic acid, heptanoic acid, hexanoic acid, hydroxynaphthoic acid, lactic acid, laurylsulfuric acid, maleic acid, malic acid, malonic acid, mandelic acid, methanesulfonic acid, muconic acid, o-(4-hydroxybenzoyl)benzoic acid, oxalic acid, p-chlorobenzenesulfonic acid, phenyl-substituted alkanoic acids, propionic acid, p-toluenesulfonic acid, pyruvic acid, salicylic acid, stearic acid, succinic acid, tartaric acid, tertiarybutylacetic acid, trimethylacetic acid, and the like. Pharmaceutically acceptable salts also include base addition salts which may be formed when acidic protons present are capable of reacting with inorganic or organic bases. Acceptable inorganic bases include sodium hydroxide, sodium carbonate, potassium hydroxide, aluminum hydroxide and calcium hydroxide. Acceptable organic bases include ethanolamine, diethanolamine, triethanolamine, tromethamine, N-methylglucamine and the like. It should be recognized that the particular anion or cation forming a part of any salt of this disclosure is not critical, so long as the salt, as a whole, is pharmacologically acceptable. Additional examples of pharmaceutically acceptable salts and their methods of preparation and use are presented in Handbook of Pharmaceutical Salts: Properties, and Use (P. H. Stahl & C. G. Wermuth eds., Verlag Helvetica Chimica Acta, 2002).

A “stereoisomer” or “optical isomer” is an isomer of a given compound in which the same atoms are bonded to the same other atoms, but where the configuration of those atoms in three dimensions differs. “Enantiomers” are stereoisomers of a given compound that are mirror images of each other, like left and right hands. “Diastereomers” are stereoisomers of a given compound that are not enantiomers. Chiral molecules contain a chiral center, also referred to as a stereocenter or stereogenic center, which is any point, though not necessarily an atom, in a molecule bearing groups such that an interchanging of any two groups leads to a stereoisomer. In organic compounds, the chiral center is typically a carbon, phosphorus or sulfur atom, though it is also possible for other atoms to be stereocenters in organic and inorganic compounds. A molecule can have multiple stereocenters, giving it many stereoisomers. In compounds whose stereoisomerism is due to tetrahedral stereogenic centers (e.g., tetrahedral carbon), the total number of hypothetically possible stereoisomers will not exceed 2ⁿ, where n is the number of tetrahedral stereocenters. Molecules with symmetry frequently have fewer than the maximum possible number of stereoisomers. A 50:50 mixture of enantiomers is referred to as a racemic mixture. Alternatively, a mixture of enantiomers can be enantiomerically enriched so that one enantiomer is present in an amount greater than 50%. Typically, enantiomers and/or diastereomers can be resolved or separated using techniques known in the art. It is contemplated that that for any stereocenter or axis of chirality for which stereochemistry has not been defined, that stereocenter or axis of chirality can be present in its R form, S form, or as a mixture of the R and S forms, including racemic and non-racemic mixtures. As used herein, the phrase “substantially free from other stereoisomers” means that the composition contains ≤15%, more preferably ≤10%, even more preferably ≤5%, or most preferably ≤1% of another stereoisomer(s).

The above definitions supersede any conflicting definition in any reference that is incorporated by reference herein. The fact that certain terms are defined, however, should not be considered as indicative that any term that is undefined is indefinite. Rather, all terms used are believed to describe the disclosure in terms such that one of ordinary skill can appreciate the scope and practice the present disclosure.

### IV. Examples

The following examples are included to demonstrate preferred embodiments of the disclosure. It should be appreciated by those of skill in the art that the techniques disclosed in the examples which follow represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1: Synthetic Routes, Methodology, and Characterization

### A. General Information

Materials. Tetrahydrofuran (THF), diethyl ether (Et₂O), toluene and dichloromethane (CH₂Cl₂) were obtained by passing the previously degassed solvents through an activated alumina column. Dioxane and reagents were purchased at the highest commercial quality and used without further purification. Pinacol was purchased from TCI and used without further purification. Cesium carbonate (Cs₂CO₃) was purchased from Combi-Blocks. Boronic acid, boronic acid pinacol ester and ketones were purchased from Sigma-Aldrich, Synthonix and Combi-Blocks, which were used without further purification. Yields refer to chromatographically and spectroscopically (¹H NMR, GC) homogeneous material. Reactions were monitored by GC-MS (Rtx-5MS, 30 m, 0.25 mm ID, 0.25 μm), GC-FID (SH-Rxi-5Sil MS, 30 m, 0.25 mm ID, 0.25 μm), LC/MS, and thin layer chromatography (TLC). TLC was performed using 0.25 mm E. Merck silica plates (60F-254), using short-wave UV light as the visualizing agent, and phosphomolybdic acid and CAM (H₂SO₄, ammonium molybdate and ceric ammonium sulfate), or KMnO₄ and heat as developing agents. NMR spectra were recorded on Bruker Ascend-600 spectrometers, Varian Inova-400 spectrometers and Bruker Ascend-400 spectrometers instruments and are calibrated using residual undeuterated solvent (CHCl₃ at 7.26 ppm ¹H NMR, 77.16 ppm ¹³C NMR; acetone at 2.05 ppm ¹H NMR, 29.84, 206.26 ppm ¹³C NMR; DMSO at 2.50 ppm ¹H NMR, 39.52 ppm ¹³C NMR; methanol at 3.31 ppm ¹H NMR, 49.00 ppm ¹³C NMR). The following abbreviations were used to explain multiplicities: s=singlet, d=doublet, t=triplet, q=quartet, m=multiplet, br=broad. ¹³C signals adjacent to boron are generally not observed due to quadrupolar relaxation. Column chromatography was performed using E. Merck silica (60, particle size 0.043-0.063 mm), and preparative TLC was performed on Merck silica plates (60F-254). Melting points were recorded on a Fisher Scientific™ melting point apparatus (12-144) and are uncorrected. Optical rotation data was recorded on a JAS DIP-360 digital polarimeter. Chiral HPLC analyses were performed on an Agilent 1200 Series system.

### B. General Procedures

General Procedure A for Preparation of BCP Precursors (Yang et al., 2012; Stymiest et al., 2007; Li et al., 2014; Li et al., 2012; Bonet et al., 2011; Kisan et al., 2017; Yamamoto et al., 2004)

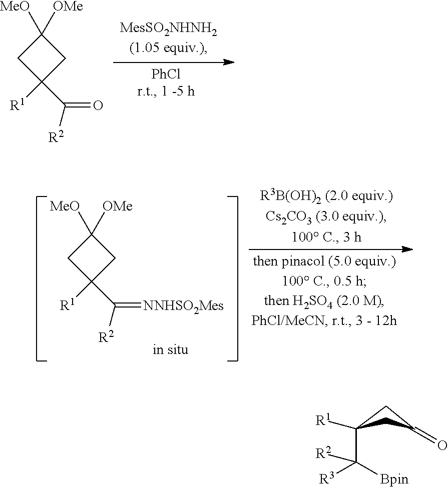

A screw-capped culture tube was charged with carbonyl compounds (1.0 equiv.), 2-mesitylenesulfonyl hydrazide (1.05 equiv.) and chlorobenzene (0.2 M). The mixture was then stirred at room temperature until the completion of the reaction showed by TLC analysis (usually 1-5 h). Cesium carbonate (3.0 equiv.) and boronic acid (3.0 equiv.) were added, and the tube was evacuated and backfilled with argon for three times. The system was then stirred at 100° C. under argon atmosphere for 1-3 hours. After cooling the system to room temperature, pinacol (5.0 equiv.) was added, and the mixture was stirred at 100° C. for another 1 hour. The suspended solution was then filtered over Celite and washed with acetonitrile. 2M H₂SO₄ was added to the reaction and the system was stirred at room temperature until the completion of the reaction showed by TLC analysis (usually 3-12 h). The mixture was extracted with ethyl acetate and the combined organic layers were washed with brine and dried over Na₂SO₄. The solvent was removed under reduced pressure, and the resulting crude material was purified by column chromatography on silica gel to afford the boronated products.

### General Procedure B for Cyclization to Afford BCP Derivatives

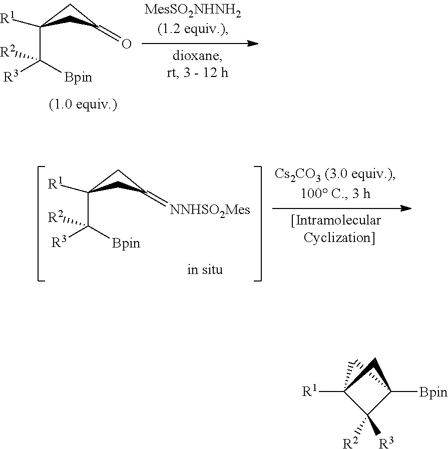

A screw-capped culture tube was charged with ketone (1.0 equiv.), 2-mesitylenesulfonyl hydrazide (1.2 equiv.) and dried dioxane (0.1 M). The mixture was then stirred at r.t. until the completion of the reaction showed by TLC analysis (usually 3-12 h). Cesium carbonate (3.0 equiv.) was added, and the headspace of the tube was purged with a gentle stream of argon for approximately 10 seconds. The system was stirred at 100° C. under argon atmosphere for 3 hours. The suspended solution was then filtered over Celite and washed with diethyl ether. The solvent was removed under high vacuum, and the crude residue was purified by chromatography on silica gel.

### C. Additional Reaction Optimizations

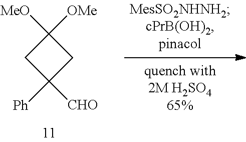 [SMILES: COC1(OC)CC(C=O)(c2ccccc2)C1]

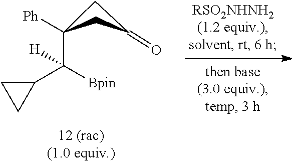

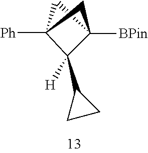

| Entry | R | Base | Solvent | Temp /° C. | Yield/% |
|---|---|---|---|---|---|
| 1 | Mes | Cs₂CO₃ | dioxane | 100 | 88 |
| 2 | Tolyl | Cs₂CO₃ | dioxane | 100 | 63 |
| 3 | Trisyl | Cs₂CO₃ | dioxane | 100 | 67 |
| 4 | Tolyl | Cs₂CO₃ | dioxane | 100 | 71 |
| 5 | p-CF₃Ph | Cs₂CO₃ | dioxane | 100 | 70 |
| 6 | p-MeOPh | Cs₂CO₃ | dioxane | 100 | ^{—a} |
| 7 | Mes | K₂CO₃ | dioxane | 100 | 26 |
| 8 | Mes | Na₂CO₃ | dioxane | 100 | 16 |
| 9 | Mes | MeONa | dioxane | 100 | 26 |
| 10 | Mes | KO^{t}Bu | dioxane | 100 | 18 |
| 11 | Mes | Cs₂CO₃ | PhCl | 100 | 78 |
| 12 | Mes | Cs₂CO₃ | toluene | 100 | 80 |
| 13 | Mes | Cs₂CO₃ | Benzene | 100 | 78 |
| 14 | Mes | Cs₂CO₃ | DMF | 100 | 52 |
| 15 | Mes | Cs₂CO₃ | dioxane | 80 | 78 |
| 16 | Mes | Cs₂CO₃ | dioxane | 90 | 84 |
| 17 | Mes | Cs₂CO₃ | dioxane | 110 | 75 |
| 18 | Mes | Cs₂CO₃ | dioxane | 100 | 77^{b} |

^{a}Ketone cannot be transformed to hydrazone in situ totally;
^{b}The reaction was exposed to air.

### D. Experimental Procedures and Characterization Data of Starting Materials

### 1. Compound SI-1

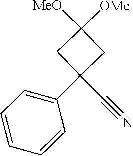 [SMILES: COC1(OC)CC(C#N)(c2ccccc2)C1]

3,3-dimethoxy-1-phenylcyclobutane-1-carbonitrile (SI-1). SI-1 was prepared according to the previously reported procedure (WO 2004/082682). A solution of 60% NaH (1.0 mol, 40 g, 5.0 equiv.) suspended in DMF (400 mL) was cooled to 0° C. before benzyl acetonitrile (0.4 mol, 46 mL, 2.0 equiv.) was added slowly. The solution was stirred at 0° C. for another 10 minutes. 1,3-Dibromo-2,2-dimethoxypropane (0.2 mol, 52.4 g, 1.0 equiv.) was added and the reaction mixture was stirred at 60° C. for 18 hours before cooled to room temperature. Then the reaction mixture was poured into water in ice-bath and extracted with ether. The combined organic layer was concentrated in vacuo. The crude product was purified by flash chromatography (hexanes:ethyl acetate, 4:1) on silica gel and crystallization (hexanes/ethyl acetate) to afford 20 g (46%) of the title compound SI-1. Spectroscopic data matches that reported in the literature (WO 2004/082682).

### 2. Compound SI-2

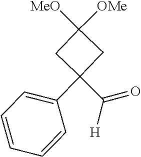 [SMILES: COC1(OC)CC(C=O)(c2ccccc2)C1]

3,3-dimethoxy-1-phenylcyclobutane-1-carbaldehyde (SI-2). To a solution of compound SI-1 (6.5 g, 30 mmol, 1.0 equiv.) in methylene chloride (120 mL) was added DIBAL-H (39 mL, 1.0 M, 1.3 equiv.) at 0° C. The mixture was stirred at 0° C. for 3 hours. The cool mixture was added under vigorous stirring to saturated Rochelle salt solution at 0° C. and stirred overnight. The organic phase was separated, washed with brine, dried over Na₂SO₄ and evaporated. The crude product was purified through flash chromatography (hexanes:ethyl acetate, 4:1) on silica gel to afford 4.5 g (68%) of the title compound SI-2. Physical State: colorless oil. ¹H NMR (600 MHz, CDCl₃): δ 9.54 (s, ¹H), 7.37 (t, J=7.7 Hz, 2H), 7.28 (t, J=7.4 Hz, ¹H), 7.19-7.16 (m, 2H), 3.18 (s, 3H), 3.15 (s, 3H), 3.03 (d, J=13.2 Hz, 2H), 2.50 (d, J=13.3 Hz, 2H) ppm. 13C NMR (151 MHz, CDCl₃): δ 198.21, 139.44, 129.03, 127.41, 127.07, 98.63, 48.97, 48.77, 48.70, 39.02 ppm. MS (GCMS, EI): m/z=220 (2%), 191 (100%), 177 (18%), 160 (20%), 129 (30%), 115 (36%). TLC: R_{f}=0.31 (5:1 hexanes:ethyl acetate).

### 3. Compound SI-3

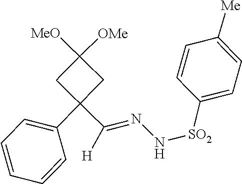 [SMILES: COC1(OC)CC(/C=N/NS(=O)(=O)c2ccc(C)cc2)(c2ccccc2)C1]

N′-(1-(3,3-dimethoxy-1-phenylcyclobutyl)ethylidene)-4-methylbenzenesulfonohydrazide (SI-3). To a solution of SI-2 (2.17 g, 10 mmol, 1.0 equiv.) in MeOH (10 mL, 1.0 M) at room temperature, p-toluenesulfonyl hydrazide (2.05 g, 11 mmol, 1.1 equiv.) was added. The solution was stirred at room temperature for 5 hours over which time white solid crashes out, and TLC showed the complete consumption of both starting materials. The solid was filtered, washed with cold MeOH and dried to give 3.6 g (93%) of the desired product SI-3. Physical State: white solid. m.p.: 130-132° C. ¹H NMR (600 MHz, CDCl₃): δ 7.75 (d, J=8.3 Hz, 2H), 7.70-7.65 (m, ¹H), 7.33-7.26 (m, 4H), 7.24-7.19 (m, ¹H), 7.07 (d, J=7.0 Hz, 2H), 3.10 (s, 3H), 3.02 (s, 3H), 2.88 (d, J=13.2 Hz, 2H), 2.52 (d, J=13.2 Hz, 2H), 2.45 (s, 3H). ppm. 13C NMR (151 MHz, CDCl₃): δ 155.22, 144.08, 143.78, 135.33, 129.63, 128.64, 128.14, 126.71, 126.57, 98.73, 48.55, 48.44, 41.34, 40.51, 21.73 ppm. LC-MS (ESI, m/z): calcd for [M+Na]⁺411.1; found: 411.2. TLC: R_{f}=0.46 (2:1 hexanes:acetone).

### 4. Compound SI-4

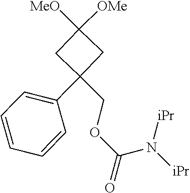 [SMILES: COC1(OC)CC(COC(=O)N(C(C)C)C(C)C)(c2ccccc2)C1]

(3,3-dimethoxy-1-phenylcyclobutyl)methyl diisopropylcarbamate (SI-4). To a solution of SI-2 (2.17 g, 10 mmol, 1.0 equiv.) in THE (100 mL) was added LiAlH₄ (570 mg, 15 mmol, 1.5 equiv.) at 0° C. and the reaction mixture was stirred at 0° C. for 3 hours. Then H₂O (0.57 mL) was slowly added, followed by 20% w.t. NaOH (0.57 mL) and H₂O (1.7 mL), and the mixture was stirred at 0° C. for 30 min. Then excess Na₂SO₄ was added and the suspended solution was stirred at room temperature for 1 hour. The mixture was filtered through Celite and the solvent was removed under high vacuum. The crude alcohol was used without further purification.

Sodium hydride (504 mg, 12.6 mmol, 60%, 1.26 equiv.) was added to a round bottomed flask (50 mL) with a stir bar and backfilled with argon three times. THE (15 mL) and DMF (4 mL) were added via syringe and the suspension cooled to 0° C. before slowly adding crude alcohol. The reaction mixture was allowed to warm to ambient temperature and stirred at this temperature for 1 h. After recooling the mixture to 0° C., N,N-diisopropyl carbamoyl chloride (2.06 g, 12.6 mmol, 1.26 equiv.) was added dropwise via syringe as a solution in THE (10 mL). A condenser was attached to the flask and the reaction mixture then heated to 50° C. and stirred at this temperature overnight. The reaction was then cooled to room temperature, before adding NH₄Cl (sat. aq. 10 mL) and separating the two phases. The aqueous phase was extracted with Et₂O and the combined organic extracts washed with brine, dried over MgSO₄ and concentrated in vacuo. The title compound was isolated as a light-yellow oil (2.2 g, 63%) by flash column chromatography (hexanes:ethyl acetate, 5:1) on silica gel. Physical State: colorless oil. ¹H NMR (600 MHz, CDCl₃): δ 7.31-7.26 (m, 2H), 7.23-7.19 (m, 2H), 7.20-7.14 (m, ¹H), 4.26 (s, 2H), 3.91 (br, ¹H), 3.71 (br., ¹H), 3.19 (s, 3H), 3.10 (s, 3H), 2.60-2.53 (m, 2H), 2.51-2.45 (m, 2H), 1.07 (br, 12H) ppm. ¹³C NMR (151 MHz, CDCl₃): δ 155.49, 146.41, 128.06, 126.67, 126.09, 99.05, 72.44, 48.46, 48.31, 46.08 (br.), 45.44 (br.), 40.60, 36.91, 21.16 (br.), 20.58 (br.) ppm. LC-MS (ESI, m/z): calcd for [M+Na]⁺ 372.2; found: 372.3. TLC: R_{f}=0.19 (5:1 hexanes:ethyl acetate).

### 5. Compound SI-5

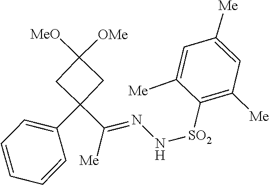 [SMILES: COC1(OC)CC(/C(C)=N/NS(=O)(=O)c2c(C)cc(C)cc2C)(c2ccccc2)C1]

1-(1-(3,3-dimethoxy-1-phenylcyclobutyl)ethylidene)-2-mesitylhydrazine (SI-5). To a solution of SI-2 (2.17 g, 10.0 mmol, 1.0 equiv.) in diethyl ether (20 mL) in a sealed tube was added MeMgBr (13.3 mL, 40 mmol, 3M in diethyl ether, 4.0 equiv.) at 0° C., and the resultant mixture was stirred at 80° C. for 24 h later. After cooling to 0° C., the reaction mixture was quenched by addition of a saturated aqueous solution of NH₄Cl carefully. The mixture was extracted with diethyl ether, and the combined extracts were washed with brine and dried over Na₂SO₄. The solvent was concentrated, and the residue was redissolved in methanol (10 mL). To the mixture was added mesitylsulfonyl hydrazide (2.14 g, 10.0 mmol, 1.0 equiv.) and stirred at room temperature for 1 hour. The suspension was filtered and washed by cold MeOH to afford the desired compound as a white solid (2.2 g, 51% yield). Physical State: white solid. m.p.: 109-111° C. ¹H NMR (600 MHz, CDCl₃): δ 7.31 (br., ¹H), 7.21-7.13 (m, 3H), 6.99 (s, 2H), 6.97-6.95 (m, 2H), 3.05 (s, 3H), 2.83 (d, J=13.1 Hz, 2H), 2.81 (s, 3H), 2.70 (s, 6H), 2.41 (d, J=13.0 Hz, 2H), 2.33 (s, 3H), 1.55 (s, 3H) ppm. ¹³C NMR (151 MHz, CDCl₃): δ 157.02, 143.99, 142.88, 140.44, 132.63, 131.89, 128.46, 126.57, 126.45, 98.69, 48.53, 48.13, 45.14, 40.69, 23.40, 21.12, 12.23 ppm. LC-MS (ESI, m/z): calcd for [M+Na]⁺ 453.2; found: 453.2. TLC: R_{f}=0.59 (2:1 hexanes:acetone).

### 6. Compound SI-6

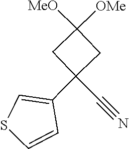 [SMILES: COC1(OC)CC(C#N)(c2ccsc2)C1]

3,3-dimethoxy-1-(thiophen-3-yl)-cyclobutane-1-carbonitrile (SI-6). A solution of 60% NaH (80 mmol, 3.2 g, 2.0 equiv.) suspended in DMF (50 mL) was cooled to 0° C. before 3-thiopheneacetonitrile (40 mmol, 4.92 g, 1.0 equiv.) was added slowly. The solution was stirred at 0° C. for another 10 minutes after hydrogen was released. Then 1,3-dibromo-2,2-dimethoxypropane (40 mmol, 13.0 g, 1.0 equiv.) was added and the reaction mixture was stirred at 60° C. for 18 hours before cooled to room temperature, poured into water, and extracted with ether. The combined organic layer was concentrated in vacuo. The crude product was purified by flash chromatography (hexanes:ethyl acetate, 4:1) on silica gel to afford 2.5 g (28%) of the title compound SI-6. Physical State: white solid. m.p.: 86-88° C. ¹H NMR (600 MHz, CDCl₃): δ 7.36 (dd, J=5.0, 3.0 Hz, ¹H), 7.33 (dd, J=3.0, 1.4 Hz, ¹H), 7.17 (dd, J=5.1, 1.5 Hz, ¹H), 3.25 (s, 3H), 3.18 (s, 3H), 3.06 (d, J=13.7 Hz, 2H), 2.68 (d, J=13.7 Hz, 2H) ppm. ¹³C NMR (151 MHz, CDCl₃): δ 140.58, 127.61, 125.50, 123.50, 121.85, 98.16, 49.01, 48.75, 46.25, 27.94 ppm. MS (GCMS, EI): m/z=223 (1%), 192 (12%), 160 (100%), 135 (24%), 109 (26%). TLC: R_{f}=0.35 (5:1 hexanes:ethyl acetate).

### 7. Compound SI-7

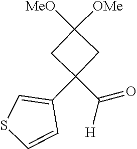 [SMILES: COC1(OC)CC(C=O)(c2ccsc2)C1]

3,3-dimethoxy-1-(thiophen-3-yl)cyclobutane-1-carbaldehyde (SI-7). To a solution of compound SI-6 (2.0 g, 9 mmol, 1.0 equiv.) in methylene chloride (50 mL) was added DIBAL-H (10.8 mL, 1.0 M, 1.2 equiv.) at 0° C. The mixture was stirred at 0° C. for 3 hours. The cool mixture was added under vigorous stirring to excess saturated Rochelle salt solution at 0° C. and stirred overnight. The organic phase was separated, washed with brine, dried over Na₂SO₄ and evaporated. The crude product was purified through flash chromatography (hexanes:ethyl acetate, 4:1) on silica gel to afford 1.37 g (67%) of the title compound SI-7. Physical State: colorless oil. ¹H NMR (400 MHz, CDCl₃): δ 9.48 (s, ¹H), 7.25 (dd, J=5.0, 2.9 Hz, ¹H), 6.97 (dd, J=2.9, 1.3 Hz, ¹H), 6.83 (dd, J=5.0, 1.4 Hz, ¹H), 3.06 (s, 3H), 3.06 (s, 3H), 2.85 (d, J=13.3 Hz, 2H), 2.36 (d, J=13.3 Hz, 2H) ppm. ¹³C NMR (101 MHz, CDCl₃): δ 197.99, 140.53, 127.10, 126.45, 121.96, 98.74, 48.79, 48.67, 45.72, 39.48 ppm. MS (GCMS, EI): m/z=226 (16%), 197 (100%), 195 (26%), 183 (20%), 135 (26%), 109 (50%). TLC: R_{f}=0.31 (5:1 hexanes:ethyl acetate).

### 8. Compound SI-8

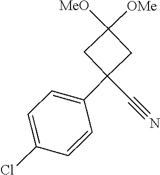 [SMILES: COC1(OC)CC(C#N)(c2ccc(Cl)cc2)C1]

1-(4-chlorophenyl)-3,3-dimethoxycyclobutane-1-carbonitrile (SI-8). A solution of 60% NaH (40 mmol, 1.6 g, 2.0 equiv.) suspended in DMF (25 mL) was cooled to 0° C. before 4-chlorophenyl acetonitrile (20 mmol, 3.03 g, 1.0 equiv.) was added slowly. The solution was stirred at 0° C. for another 10 minutes after hydrogen was released. Then 1,3-dibromo-2,2-dimethoxypropane (25 mmol, 6.55 g, 1.25 equiv.) was added and the reaction mixture was stirred at 60° C. for 18 hours before cooled to room temperature, poured into water, and extracted with ether. The combined organic layer was concentrated in vacuo. The crude product was purified by flash chromatography (hexanes:ethyl acetate, 4:1) on silica gel to afford 1.76 g (35%) of the title compound SI-8. Physical State: brown solid. m.p.: 41-43° C. ¹H NMR (600 MHz, CDCl₃): δ 7.42 (d, J=8.8 Hz, 2H), 7.37 (d, J=8.6 Hz, 2H), 3.27 (s, 3H), 3.17 (s, 3H), 3.10 (d, J=13.7 Hz, 2H), 2.68 (d, J=13.7 Hz, 2H) ppm. ¹³C NMR (151 MHz, CDCl₃): δ 138.07, 134.17, 129.27, 127.41, 123.31, 97.95, 49.09, 48.76, 45.92, 30.76 ppm. MS (GCMS, EI): m/z=251 (2%), 220 (48%), 188 (100%), 163 (30%), 128 (76%). TLC: R_{f}=0.35 (5:1 hexanes:ethyl acetate).

### 9. Compound SI-9

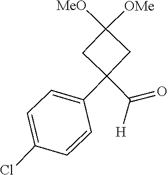 [SMILES: COC1(OC)CC(C=O)(c2ccc(Cl)cc2)C1]

1-(4-chlorophenyl)-3,3-dimethoxycyclobutane-1-carbaldehyde (SI-9). To a solution of compound SI-8 (1.56 g, 6 mmol, 1.0 equiv.) in methylene chloride (30 mL) was added DIBAL-H (7.2 mL, 1.0 M, 1.2 equiv.) at 0° C. The mixture was stirred at 0° C. for 3 hours. The cool mixture was added under vigorous stirring to excess saturated Rochelle salt solution at 0° C. and stirred overnight. The organic phase was separated, washed with brine, dried over Na₂SO₄ and evaporated. The crude product was purified through flash chromatography (hexanes:ethyl acetate, 4:1) on silica gel to afford 750 mg (48%) of the title compound SI-9. Physical State: colorless oil. ¹H NMR (600 MHz, CDCl₃): δ 9.51 (s, ¹H), 7.33 (d, J=8.5 Hz, 2H), 7.09 (d, J=8.5 Hz, 2H), 3.16 (s, 3H), 3.13 (s, 3H), 3.00 (d, J=13.2 Hz, 2H), 2.45 (d, J=13.3 Hz, 2H) ppm. ¹³C NMR (151 MHz, CDCl₃): δ 197.86, 137.98, 133.44, 129.15, 128.47, 98.40, 48.74, 48.68, 48.50, 39.14 ppm. MS (GCMS, EI): m/z=254 (2%), 225 (100%), 211 (16%), 137 (30%), 115 (40%). TLC: R_{f}=0.32 (5:1 hexanes:ethyl acetate).

### 10. Compound SI-10

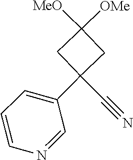 [SMILES: COC1(OC)CC(C#N)(c2cccnc2)C1]

3,3-dimethoxy-1-(pyridin-3-yl)cyclobutane-1-carbonitrile (SI-10). A solution of 60% NaH (80 mmol, 3.2 g, 2.0 equiv.) suspended in DMF (25 mL) was cooled to 0° C. before 3-pyridyl acetonitrile (40 mmol, 4.72 g, 1.0 equiv.) was added slowly. The solution was stirred at 0° C. for another 10 minutes after hydrogen was released. Then 1,3-dibromo-2,2-dimethoxypropane (50 mmol, 13.0 g, 1.25 equiv.) was added and the reaction mixture was stirred at 60° C. for 18 hours before cooled to room temperature, poured into water, and extracted with ether. The combined organic layer was concentrated in vacuo. The crude product was purified by flash chromatography (hexanes:ethyl acetate, 1:1) on silica gel and recrystallization (hexanes/ethyl acetate) to afford 3.1 g (36%) of the title compound SI-10. Physical State: brown solid. m.p.: 62-64° C. ¹H NMR (600 MHz, CDCl₃): δ 8.78 (d, J=2.6 Hz, ¹H), 8.59 (dd, J=4.8, 1.6 Hz, ¹H), 7.81 (ddd, J=8.1, 2.6, 1.7 Hz, ¹H), 7.34 (dd, J=8.0, 4.7 Hz, ¹H), 3.28 (s, 3H), 3.18 (s, 3H), 3.15 (d, J=13.6 Hz, 2H), 2.75 (d, J=13.7 Hz, 2H) ppm. ¹³C NMR (151 MHz, CDCl₃): δ 149.53, 147.65, 135.27, 133.71, 123.68, 122.74, 98.03, 49.13, 48.81, 45.83, 29.41 ppm. LC-MS (ESI, m/z): calcd for [M+H]⁺ 219.1; found: 219.2. TLC: R_{f}=0.25 (2:1 hexanes:acetone).

### 11. Compound SI-11

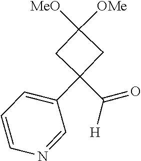 [SMILES: COC1(OC)CC(C=O)(c2cccnc2)C1]

3,3-dimethoxy-1-(pyridin-3-yl)cyclobutane-1-carbaldehyde (SI-11). To a solution of compound SI-10 (1.63 g, 7.5 mmol, 1.0 equiv.) in methylene chloride (30 mL) was added DIBAL-H (10 mL, 1.0 M, 1.33 equiv.) at 0° C. The mixture was stirred at 0° C. for 3 hours. The cool mixture was added under vigorous stirring to excess saturated Rochelle salt solution at 0° C. and stirred overnight. The organic phase was separated, washed with brine, dried over Na₂SO₄ and evaporated. The crude product was purified through flash chromatography (hexanes:ethyl acetate, 1:1) on silica gel to afford 369 mg (22%) of the title compound SI-11. Physical State: colorless oil. ¹H NMR (600 MHz, CDCl₃): δ 9.60 (d, J=1.0 Hz, ¹H), 8.54 (d, J=4.6 Hz, ¹H), 8.47 (d, J=2.4 Hz, ¹H), 7.49 (dt, J=7.9, 1.3 Hz, ¹H), 7.33-7.27 (m, ¹H), 3.18 (s, 3H), 3.15 (s, 3H), 3.05 (d, J=12.7 Hz, 2H), 2.54 (d, J=13.2 Hz, 2H) ppm. ¹³C NMR (151 MHz, CDCl₃): δ 197.98, 148.78, 148.70, 135.24, 134.79, 123.73, 98.65, 48.82, 48.77, 47.14, 39.22 ppm. MS (GCMS, EI): m/z=192 (100%) [M-CHO], 178 (14%), 161 (18%), 117 (38%). TLC: R_{f}=0.22 (2:1 hexanes:acetone).

### 12. Compound 52

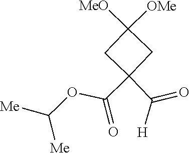 [SMILES: COC1(OC)CC(C=O)(C(=O)OC(C)C)C1]

isopropyl 1-formyl-3,3-dimethoxycyclobutane-1-carboxylate (52). To a solution of diisopropyl 3,3-dimethoxycyclobutane-1,1-dicarboxylate (8.7 g, 30 mmol, 1.0 equiv.) in methylene chloride (120 mL) was added DIBAL-H (60 mL, 1.0 M, 2.0 equiv.) at −78° C. The mixture was stirred at −78° C. for 5 hours. The cool mixture was quenched by methanol and then added under vigorous stirring to excess saturated Rochelle salt solution after it was warmed up to room temperature and stirred overnight. The organic phase was separated, washed with brine, dried over Na₂SO₄ and evaporated. The crude product was purified through flash chromatography (hexanes:ethyl acetate, 4:1) on silica gel to afford 5.4 g (78%) of the title compound 52. Physical State: colorless oil. ¹H NMR (600 MHz, CDCl₃): δ 9.69 (s, ¹H), 5.09 (hept, J=6.3 Hz, ¹H), 3.16 (s, 3H), 3.13 (s, 3H), 2.65 (d, J=12.1 Hz, 2H), 2.61 (d, J=11.8 Hz, 2H), 1.25 (d, J=6.3 Hz, 6H) ppm. ¹³C NMR (151 MHz, CDCl₃): δ 196.06, 170.25, 98.28, 69.74, 49.73, 48.79, 48.72, 37.30, 21.80 ppm. MS (GCMS, EI): m/z=201 (90%) [M-CHO], 159 (82%), 127 (100%). TLC: R_{f}=0.31 (5:1 hexanes:ethyl acetate).

### 13. Compound SI-13

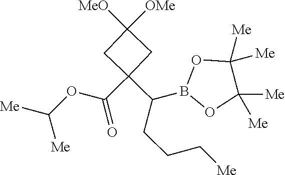 [SMILES: CCCCC(B1OC(C)(C)C(C)(C)O1)C1(C(=O)OC(C)C)CC(OC)(OC)C1]

isopropyl 3,3-dimethoxy-1-(1-(4,4,5,5-tetramethyl-1,3,2-dioxaborolan-2-yl)pentyl)cyclobutane-1-carboxylate (SI-13). Following General Procedure A on 16 mmol scale with SI-12 and butylboronic acid until H₂SO₄ was added. Then the reaction mixture was filtered through Celite and solvent was removed under high vacuum. Purification by chromatography (hexanes:ethyl acetate, 10:1) on silica gel afforded 2.07 g (33%) of the title compound SI-13. Physical State: colorless oil. ¹H NMR (600 MHz, CDCl₃): δ 5.01 (hept, J=6.3 Hz, ¹H), 3.12 (s, 3H), 3.11 (s, 3H), 2.66 (dd, J=12.6, 4.1 Hz, ¹H), 2.54 (dd, J=12.7, 4.1 Hz, ¹H), 2.39 (d, J=12.8 Hz, ¹H), 2.08 (d, J=12.6 Hz, ¹H), 1.40-1.10 (m, 25H), 0.85 (t, J=7.0 Hz, 3H) ppm. ¹³C NMR (151 MHz, CDCl₃): δ 175.91, 99.41, 83.26, 67.93, 48.59, 48.48, 41.80, 41.58, 40.26, 32.12, 26.96, 25.43, 24.55, 22.91, 21.94, 21.90, 14.21 ppm. ¹¹B NMR (128 MHz, CDCl₃): δ 34.05 ppm. LC-MS (ESI, m/z): calcd for [M+Na]+421.3; found: 421.3. TLC: R_{f}=0.71 (5:1 hexanes:ethyl acetate).

### 14. Compound SI-14

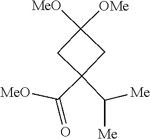 [SMILES: COC(=O)C1(C(C)C)CC(OC)(OC)C1]

methyl 1-isopropyl-3,3-dimethoxycyclobutane-1-carboxylate (SI-14). To a flamed-dried flask under nitrogen, diisopropylamine (1.06 mL, 7.5 mmol, 1.5 equiv.) was added to THE (30 mL) at −78° C. followed by nBuLi (3.3 mL, 2.3 M in hexane, 7.5 mmol) and 3,3-dimethoxycyclobutane-1-carboxylate methyl ester (870 mg, 5 mmol, 1.0 equiv.). The mixture was stirred for 30 minutes before 2-iodopropane (848 mg, 15 mmol, 3.0 equiv.) was added. The reaction was stirred at −78° C. for 1 hour and allowed to warm up to room temperature. The solution was quenched with saturated NH₄Cl solution and extracted with diethyl ether three times. Combined organic layer was washed with water and brine, dried over anhydrous MgSO₄, and concentrated in vacuo. The crude product was purified by chromatography (hexanes:ethyl acetate, 5:1) on silica gel afforded 840 mg (78%) of the title compound SI-14. Physical State: colorless oil. ¹H NMR (600 MHz, CDCl₃): δ 3.69 (s, 3H), 3.13 (s, 3H), 3.11 (s, 3H), 2.60 (d, J=13.5 Hz, 2H), 2.09 (d, J=13.5 Hz, 2H), 1.93 (hept, J=6.9 Hz, ¹H), 0.89 (d, J=6.9 Hz, 6H) ppm. ¹³C NMR (151 MHz, CDCl₃): δ 176.11, 98.62, 51.81, 48.64, 48.57, 44.23, 39.95, 36.15, 17.78 ppm. LC-MS (ESI, m/z): calcd for [M+Na]⁺ 239.1; found: 239.2. TLC: R_{f}=0.40 (5:1 hexanes:ethyl acetate).

### 15. Compound SI-15

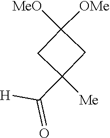 [SMILES: COC1(OC)CC(C)(C=O)C1]

3,3-dimethoxy-1-methylcyclobutane-1-carbaldehyde (SI-15). To a solution of methyl 3,3-dimethoxy-1-methyl-cyclobutanecarboxylate (470 mg, 2.5 mmol, 1.0 equiv.) in diethyl ether (7 mL) was added LiAlH₄ (143 mg, 3.8 mmol, 1.5 equiv.) at 0° C. The mixture was allowed to warm up to room temperature. Then H₂O (0.2 mL) was slowly added at 0° C., followed by 20% w.t. NaOH (0.2 mL) and H₂O (0.6 mL), and the mixture was stirred at 0° C. for 30 min. Then excess Na₂SO₄ was added and the suspended solution was stirred at room temperature for another 1 hour. The mixture was filtered through Celite and the solvent was removed under high vacuum. The crude alcohol was used without further purification.

To a solution of the crude alcohol in methylene chloride was added Dess-Martin periodinane (1.06 g, 2.5 mmol, 1.0 equiv.) at 0° C. and the reaction mixture was allowed to stir at room temperature for 2 hours. Then the reaction was quenched by saturated NaHCO₃ solution and extracted with methylene chloride. The organic phase was separated, washed with brine, dried over Na₂SO₄ and evaporated. The crude product was purified through flash chromatography (hexanes:ethyl acetate, 4:1) on silica gel to afford 199.3 mg (50%) of the title compound SI-15. Physical State: colorless oil. ¹H NMR (600 MHz, CDCl₃): δ 9.62 (s, ¹H), 3.17 (s, 3H), 3.13 (s, 3H), 2.50 (d, J=13.5 Hz, 2H), 1.99 (d, J=13.5 Hz, 2H), 1.32 (s, 3H) ppm. ¹³C NMR (151 MHz, CDCl₃): δ 203.38, 98.55, 48.51, 48.50, 39.37, 39.04, 20.62 ppm. LC-MS (ESI, m/z): calcd for [M+H]⁺ 159.1; found: 159.2. TLC: R_{f}=0.36 (5:1 hexanes:ethyl acetate).

### 16. Compound SI-16

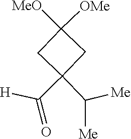 [SMILES: COC1(OC)CC(C=O)(C(C)C)C1]

1-isopropyl-3,3-dimethoxycyclobutane-1-carbaldehyde (SI-16). To a solution of SI-14 (840 mg, 3.9 mmol, 1.0 equiv.) in diethyl ether (10 mL) was added LiAlH₄ (222 mg, 5.7 mmol, 1.5 equiv.) at 0° C. The mixture was allowed to warm up to room temperature. Then H₂O (0.3 mL) was slowly added at 0° C., followed by 20% w.t. NaOH (0.3 mL) and H₂O (0.9 mL), and the mixture was stirred at 0° C. for 30 min. Then excess Na₂SO₄ was added and the suspended solution was stirred at room temperature for 1 hour. The mixture was filtered through Celite and the solvent was removed under high vacuum. The crude alcohol was used without further purification.

To a solution of the crude alcohol in methylene chloride was added Dess-Martin periodinane (1.65 g, 3.9 mmol, 1.0 equiv.) at 0° C. and the reaction mixture was allowed to stir at room temperature for 2 hours. Then the reaction was quenched by saturated NaHCO₃ solution and extracted with methylene chloride. The organic phase was separated, washed with brine, dried over Na₂SO₄ and evaporated. The crude product was purified through flash chromatography (hexanes:ethyl acetate, 4:1) on silica gel to afford 116.0 mg (16%) of the title compound SI-16. Physical State: colorless oil. ¹H NMR (600 MHz, CDCl₃): δ 9.69 (s, ¹H), 3.14 (s, 3H), 3.09 (s, 3H), 2.48 (d, J=13.6 Hz, 2H), 2.14-1.86 (m, 3H), 0.94 (d, J=7.0 Hz, 6H) ppm. ¹³C NMR (151 MHz, CDCl₃): δ 203.83, 98.28, 48.61, 48.49, 47.54, 36.27, 34.26, 17.44 ppm. LC-MS (ESI, m/z): calcd for [M+H]⁺ 187.1; found: 187.2. TLC: R_{f}=0.22 (5:1 hexanes:ethyl acetate).

### 17. Compound SI-17

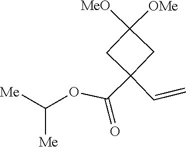 [SMILES: C=CC1(C(=O)OC(C)C)CC(OC)(OC)C1]

isopropyl 3,3-dimethoxy-1-vinylcyclobutane-1-carboxylateylate (SI-17). In a flamed dried flask was charged with methyltriphenylphosphonium bromide (1.07 g, 3.0 mmol, 1.5 equiv.) and KO^{t}Bu (336 mg, 3.0 mmol, 1.5 equiv.). Then diethyl ether (10 mL) was added and the mixture was allowed to stir at room temperature for 1 hour. Next, compound 52 (460 mg, 2.0 mmol, 1.0 equiv.) was added and the reaction mixture was stirred at room temperature overnight. Saturated NH₄Cl was added to quench the reaction and the mixture was extracted with diethyl ether. The organic phase was separated, washed with brine, dried over Na₂SO₄ and evaporated. The crude product was purified through flash chromatography (hexanes:ethyl acetate, 4:1) on silica gel to afford 245.0 mg (54%) of the title compound SI-17. Physical State: colorless oil. ¹H NMR (600 MHz, CDCl₃): δ 5.95 (dd, J=17.2, 10.5 Hz, ¹H), 5.06-5.00 (m, 2H), 4.93 (hept, J=6.3 Hz, ¹H), 3.04 (s, 3H), 3.04 (s, 3H), 2.64 (d, J=13.2 Hz, 2H), 2.17 (d, J=13.2 Hz, 2H), 1.14 (d, J=6.3 Hz, 6H) ppm. ¹³C NMR (151 MHz, CDCl₃): δ 174.19, 139.63, 114.67, 98.92, 68.44, 48.74, 48.67, 42.53, 41.20, 21.78 ppm. MS (GCMS, EI): m/z=213 (1%) [M-Me], 197(10%), 185 (100%), 169 (16%), 137 (28%). TLC: R_{f}=0.43 (5:1 hexanes:ethyl acetate).

### 18. Compound SI-18

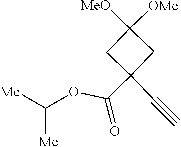 [SMILES: C#CC1(C(=O)OC(C)C)CC(OC)(OC)C1]

isopropyl 1-ethynyl-3,3-dimethoxycyclobutane-1-carboxylate (SI-18). In a flamed dried flask was charged with dimethyl 2-oxopropylphosphonate (0.83 mL, 6 mmol, 1.2 equiv.), tosyl azide (1.38 g, 6.5 mmol, 1.3 equiv.), and potassium carbonate (2.48 g, 18 mmol, 3.6 equiv.). Then acetonitrile (50 mL) was added, and the reaction mixture was allowed to stir at room temperature for 5 hours. Next, the mixture was filtered through Celite and solvent was removed under high vacuum. The crude Bestmann-Ohira reagent was used without further purification.

Then to a solution of the crude Bestmann-Ohira reagent in methanol (10 mL) was added compound 52 (1.15 g, 5.0 mmol, 1.0 equiv.) and the reaction mixture was stirred at room temperature overnight. Saturated NH₄Cl was added to quench the reaction and the mixture was extracted with ethyl acetate. The organic phase was separated, washed with brine, dried over Na₂SO₄ and evaporated. The crude product was purified through flash chromatography (hexanes:ethyl acetate, 10:1) on silica gel to afford 470 mg (42%) of the title compound SI-18. Physical State: colorless oil. ¹H NMR (600 MHz, CDCl₃): δ 5.06 (hept, J=6.3 Hz, ¹H), 3.18 (s, 3H), 3.13 (s, 3H), 2.84 (d, J=13.0 Hz, 2H), 2.54 (d, J=12.9 Hz, 2H), 2.32 (s, ¹H), 1.28 (d, J=6.2 Hz, 6H) ppm. ¹³C NMR (151 MHz, CDCl₃): δ 171.13, 98.75, 84.72, 70.49, 69.59, 48.88, 48.65, 43.68, 32.65, 21.63 ppm. MS (GCMS, EI): m/z=183 (12%) [M-iPr], 167 (100%), 135 (48%), 107 (44%). TLC: R_{f}=0.43 (5:1 hexanes:ethyl acetate).

### 19. Compound SI-19

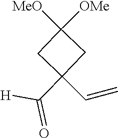

3,3-dimethoxy-1-vinylcyclobutane-1-carbaldehyde (SI-19). To a solution of SI-17 (456 mg, 2 mmol, 1.0 equiv.) in methylene chloride (10 mL) was added DIBAL-H (4 mL, 1.0 M, 2.0 equiv.) at −78° C. The mixture was stirred at −78° C. for 5 hours. The cool mixture was quenched by methanol and then added under vigorous stirring to excess saturated Rochelle salt solution after it was warmed up to room temperature and stirred overnight. The organic phase was separated, washed with brine, dried over Na₂SO₄ and evaporated. The crude alcohol was used without further purification.

To a solution of the crude alcohol in methylene chloride (20 mL) was added was added Dess-Martin periodinane (850 mg, 2.0 mmol, 1.0 equiv.) at 0° C. and the reaction mixture was allowed to stir at room temperature for 2 hours. Saturated NaHCO₃ solution was added to quench the reaction and the mixture was extracted with methylene chloride. The organic phase was separated, washed with brine, dried over Na₂SO₄ and evaporated. The crude product was purified through flash chromatography (hexanes:ethyl acetate, 4:1) on silica gel to afford 256.0 mg (74%) of the title compound SI-19. Physical State: colorless oil. ¹H NMR (600 MHz, CDCl₃): δ 9.52 (d, J=1.7 Hz, ¹H), 5.95 (ddd, J=17.3, 10.5, 1.4 Hz, ¹H), 5.30 (d, J=10.5 Hz, ¹H), 5.14 (d, J=17.4 Hz, ¹H), 3.15 (s, 3H), 3.12 (s, 3H), 2.65 (d, J=13.3 Hz, 2H), 2.22 (d, J=13.3 Hz, 2H) ppm. ¹³C NMR (151 MHz, CDCl₃): δ 199.55, 136.78, 117.17, 98.58, 48.68, 48.61, 46.76, 38.20 ppm. MS (GCMS, EI): m/z=170 (0.5%), 169 (1%), 155 (14%), 141 (100%), 109 (52%). TLC: R_{f}=0.40 (5:1 hexanes:ethyl acetate).

### 20. Compound SI-20

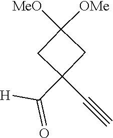

1-ethynyl-3,3-dimethoxycyclobutane-1-carbaldehyde (SI-20). To a solution of SI-18 (454 mg, 2 mmol, 1.0 equiv.) in methylene chloride (10 mL) was added DIBAL-H (4 mL, 1.0 M, 2.0 equiv.) at −78° C. The mixture was stirred at −78° C. for 5 hours. The cool mixture was quenched by methanol and then added under vigorous stirring to excess saturated Rochelle salt solution after it was warmed up to room temperature and stirred overnight. The organic phase was separated, washed with brine, dried over Na₂SO₄ and evaporated. The crude alcohol was used without further purification.

To a solution of the crude alcohol in methylene chloride (20 mL) was added was added Dess-Martin periodinane (850 mg, 2.0 mmol, 1.0 equiv.) at 0° C. and the reaction mixture was allowed to stir at room temperature for 2 hours. Saturated NaHCO₃ solution was added to quench the reaction and the mixture was extracted with methylene chloride. The organic phase was separated, washed with brine, dried over Na₂SO₄ and evaporated. The crude product was purified through flash chromatography (hexanes:ethyl acetate, 4:1) on silica gel to afford 214.0 mg (64%) of the title compound SI-20. Physical State: colorless oil. ¹H NMR (600 MHz, CDCl₃): δ 9.55 (s, ¹H), 3.16 (s, 3H), 3.09 (s, 3H), 2.70 (d, J=13.2 Hz, 2H), 2.46-2.38 (m, 3H) ppm. ¹³C NMR (151 MHz, CDCl₃): δ 195.42, 98.20, 82.73, 73.76, 48.73, 48.54, 40.47, 37.23 ppm. MS (GCMS, EI): m/z=168 (0.2%), 153 (2%), 139 (100%), 108 (12%). TLC: R_{f}=0.29 (5:1 hexanes:ethyl acetate).

### 21. Compound SI-21

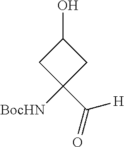 [SMILES: CC(C)(C)OC(=O)NC1(C=O)CC(O)C1]

tert-butyl (1-formyl-3-hydroxycyclobutyl)carbamate (SI-21). To a solution of ethyl 1-([(tert-butoxy)carbonyl]amino)-3-oxocyclobutane-1-carboxylate (514 mg, 2 mmol, 1.0 equiv.) in methylene chloride (8 mL) was added DIBAL-H (4 mL, 1.0 M, 2.0 equiv.) at −78° C. The mixture was stirred at −78° C. for 5 hours. The cool mixture was quenched by methanol and then added under vigorous stirring to excess saturated Rochelle salt solution after it was warmed up to room temperature and stirred overnight. The organic phase was separated, washed with brine, dried over Na₂SO₄ and evaporated. The crude product was purified through flash chromatography (hexanes:ethyl acetate, 4:1) on silica gel to afford 274.0 mg (64%) of the title compound SI-21. Note: a mixture containing trans and cis isomers is reported. Physical State: colorless oil. ¹H NMR (600 MHz, CDCl₃): δ 9.64 (s, 0.5H), 9.46 (s, 0.5H), 5.68-4.38 (m, 2H, NH and OH), 4.27-4.16 (m, ¹H), 3.03-2.88 (m, ¹H), 2.65-2.35 (m, 3H), 1.61-1.29 (m, 9H) ppm. LC-MS (ESI, m/z): calcd for [M+Na]⁺238.2; found: 238.2. TLC: R_{f}=0.19 (2:1 hexanes:acetone).

### 22. Compound SI-22

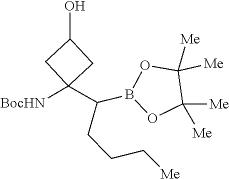 [SMILES: CCCCC(B1OC(C)(C)C(C)(C)O1)C1(NC(=O)OC(C)(C)C)CC(O)C1]

tert-butyl-(3-hydroxy-1-(1-(4,4,5,5-tetramethyl-1,3,2-dioxaborolan-2-yl)pentyl)cyclobutyl)car-bamate (SI-22). Following General Procedure A on 0.5 mmol scale with SI-21 and butylboronic acid until H₂SO₄ was added. Then the reaction mixture was filtered through Celite and washed with diethyl ether. The solvent was removed under high vacuum. The crude product was purified through flash chromatography (hexanes:ethyl acetate 4:1) on silica gel to afford 70.0 mg (37%) of the title compound SI-22. Physical State: colorless oil. ¹H NMR (600 MHz, CDCl₃): δ 5.25 (s, ¹H), 4.53 (br., ¹H), 4.10 (br., ¹H), 3.99-3.90 (m, ¹H), 2.63-2.49 (m, 3H), 2.42 (d, J=12.5 Hz, ¹H), 1.41 (s, 9H), 1.39-1.23 (m, 6H), 1.22 (s, 6H), 1.21 (s, 6H), 1.06-1.01 (m, ¹H), 0.86 (t, J=7.2 Hz, 3H) ppm. ¹³C NMR (151 MHz, CDCl₃): δ 155.82, 83.69, 61.19, 44.78, 43.93, 32.14, 28.55, 28.33, 25.92, 24.87, 24.73, 22.92, 14.12 ppm. ¹¹B NMR (128 MHz, CDCl₃): δ 33.98 ppm. LC-MS (ESI, m/z): calcd for [M+Na]+406.3; found: 406.3. TLC: R_{f}=0.63 (1:1 hexanes:ethyl acetate).

### 23. Compound SI-23

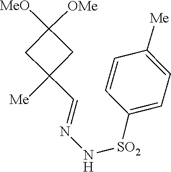 [SMILES: COC1(OC)CC(C)(/C=N/NS(=O)(=O)c2ccc(C)cc2)C1]

N′-((3,3-dimethoxy-1-methylcyclobutyl)methylene)-4-methylbenzenesulfonohydrazide (SI-23). To a solution of SI-15 (2.17 g, 5.0 mmol, 1.0 equiv.) in methanol (10 mL) was added p-toluenesulfonyl hydrazide (1.02 g, 5.5 mmol, 1.1 equiv.), and the resultant mixture was stirred at room temperature for 2 hours. The solvent was concentrated and the residue was purified by chromatography (hexanes:ethyl acetate, 2:1) on silica gel to afford 1.52 g (93%) of the tosyl hydrazone product SI-23. Physical State: White solid. m.p.: 85-87° C. ¹H NMR (600 MHz, CDCl₃): δ 7.81 (d, J=8.4 Hz, 2H), 7.42 (s, ¹H), 7.31 (d, J=8.1 Hz, 2H), 7.25 (s, ¹H), 3.12 (s, 3H), 3.04 (s, 3H), 2.43 (s, 3H), 2.28 (d, J=13.1 Hz, 2H), 1.99 (d, J=13.3 Hz, 2H), 1.28 (s, 3H) ppm. ¹³C NMR (151 MHz, CDCl₃): δ 157.68, 144.25, 135.30, 129.65, 128.16, 98.70, 48.46, 48.37, 41.94, 32.11, 24.46, 21.76 ppm. LC-MS (ESI, m/z): calcd for [M+Na]+349.1; found: 349.2 TLC: R_{f}=0.20 (2:1 hexanes:ethyl acetate).

### 24. Compound SI-24

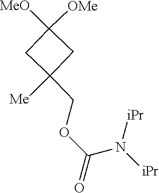 [SMILES: COC1(OC)CC(C)(COC(=O)N(C(C)C)C(C)C)C1]

(3,3-dimethoxy-1-methylcyclobutyl)methyl diisopropylcarbamate (SI-24). To a solution of SI-15 (1.26 g, 8 mmol, 1.0 equiv.) in THF (100 mL) was added LiAlH₄ (456 mg, 12 mmol, 1.5 equiv.) at 0° C. and the reaction mixture was stirred at 0° C. for 3 hours. Then H₂O (0.6 mL) was slowly added, followed by 20% w.t. NaOH (0.6 mL) and H₂O (1.2 mL), and the mixture was stirred at 0° C. for 30 min. Then excess Na₂SO₄ was added and the suspended solution was stirred at room temperature for 1 hour. The mixture was filtered through Celite and the solvent was removed under high vacuum. The crude alcohol was used without further purification.

Sodium hydride (420 mg, 10.5 mmol, 60% dispersion in oil) was added to a round bottomed flask (50 mL) with a stir bar and backfilled with nitrogen three times. THF (15 mL) and DMF (4 mL) were added via syringe and the suspension cooled to 0° C. before slowly adding crude alcohol. The reaction mixture was allowed to warm to ambient temperature and stirred at this temperature for 1 h. After cooling the reaction to 0° C., N,N-diisopropyl carbamoyl chloride (1.4 g, 8.4 mmol) was added dropwisely via syringe as a solution in THF (10 mL). A condenser was attached to the flask and the reaction mixture then heated to 50° C. and stirred at this temperature overnight. The reaction was then cooled to room temperature, before adding NH₄Cl (sat. aq. 10 mL) and separating the two phases. The aqueous phase was extracted with diethyl ether (3×15 mL) and the combined organic extracts washed with brine (3×25 mL), dried with MgSO₄ and concentrated in vacuo. The crude residue was purified by flash column chromatography (hexanes:ethyl acetate, 5:1) on silica gel to afford 1.67 g (73%) of the product SI-24. Physical State: colorless oil. ¹H NMR (600 MHz, CDCl₃): δ 4.12 (br, ¹H), 3.99 (s, 2H), 3.71 (s, ¹H), 3.14-3.13 (m, 3H), 3.11-3.10 (m, 3H), 2.12 (dd, J=13.0, 2.2 Hz, 2H), 1.88 (dd, J=13.1, 2.1 Hz, 2H), 1.25-1.16 (m, 15H) ppm. ¹³C NMR (151 MHz, CDCl₃): δ 156.17, 98.98, 72.21, 48.31, 48.30, 46.62 (br.), 45.05 (br.), 40.51, 28.93, 25.19, 21.66 (br.), 20.70 (br.) ppm. LC-MS (ESI, m/z): calcd for [M+Na]+310.2; found: 310.3. TLC: R_{f}=0.34 (5:1 hexanes:ethyl acetate).

### 25. Compound SI-25

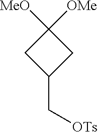 [SMILES: COC1(OC)CC(COS(=O)(=O)c2ccc(C)cc2)C1]

(3,3-dimethoxycyclobutyl)methyl 4-methylbenzenesulfonate (SI-25). To a solution of 3,3-dimethoxycyclobutane-1-carboxylate methyl ester (2.6 g, 15 mmol, 1.0 equiv.) in THE (150 mL) was added LiAlH₄ (760 mg, 20 mmol, 1.3 equiv.) at 0° C. and the reaction mixture was stirred at 0° C. for 3 hours. Then H₂O (0.76 mL) was slowly added, followed by 20% w.t. NaOH (0.76 mL) and H₂O (2.2 mL), and the mixture was stirred at 0° C. for 30 min. Then excess Na₂SO₄ was added and the suspended solution was stirred at room temperature for 1 hour. The mixture was filtered through Celite and the solvent was removed under high vacuum. The crude alcohol was used without further purification.

p-Toluenesulfonyl chloride (3.2 g, 16.5 mmol, 1.1 equiv.) was added over a period of 30 min to a stirred solution of pyridine (10 mL) and crude alcohol maintained at 0° C. The reaction mixture was allowed to stir an additional 3 hours and then quenched with H₂O (10 mL) and extracted with methylene dichloride, and the combined organic layers were washed with 3 M HCl followed by 10% NaHCO₃. The organic layer was dried over Na₂SO₄ and concentrated under vacuum and the crude product was purified by chromatography (hexanes:ethyl acetate, 3:1) on silica gel to afford 1.67 g (72%) of the product SI-25. Physical State: colorless oil. ¹H NMR (600 MHz, CDCl₃): δ 7.78 (dd, J=8.3, 3.1 Hz, 2H), 7.37-7.32 (m, 2H), 4.02 (d, J=7.2 Hz, 2H), 3.10 (s, 3H), 3.05 (s, 3H), 2.44 (s, 3H), 2.41-2.31 (m, ¹H), 2.27-2.20 (m, 2H), 1.83-1.74 (m, 2H) ppm. ¹³C NMR (151 MHz, CDCl₃): δ 144.89, 133.20, 129.98, 128.03, 100.32, 73.82, 48.64, 48.35, 34.31, 24.12, 21.78 ppm. LC-MS (ESI, m/z): calcd for [M+Na]+323.1; found: 323.2. TLC: R_{f}=0.53 (2:1 hexanes:ethyl acetate).

### 26. Compound SI-26

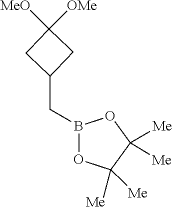 [SMILES: COC1(OC)CC(CB2OC(C)(C)C(C)(C)O2)C1]

2-((3,3-dimethoxycyclobutyl)methyl)-4,4,5,5-tetramethyl-1,3,2-dioxaborolane (SI-26)³. A dry round-bottom flask charged with CuI (38 mg, 0.2 mmol), LiO^{t}Bu (320 mg, 4.0 mmol), NBu₄I (738.0, 2.0 mmol), and bis(pinacolato)diboron (762 mg, 3.0 mmol) was evacuated and filled with argon for three cycles. Acetonitrile (4 mL) was added by syringe, followed by SI-25 (600 mg, 2.0 mmol). The resulting reaction mixture was stirred vigorously at 60° C. for 18 h. The mixture was diluted with diethyl ether, filtered through a pad of silica gel with copious washings with diethyl ether. The solution was concentrated, and the residue was purified by column chromatography (hexanes:ethyl acetate, 10:1) on silica gel to afford 364 mg (71%) of the product SI-26. Physical State: colorless oil. ¹H NMR (600 MHz, CDCl₃): δ 3.13 (s, 3H), 3.11 (s, 3H), 2.40-2.33 (m, 2H), 2.20 (hept, J=7.9 Hz, ¹H), 1.74-1.64 (m, 2H), 1.22 (s, 12H), 0.99 (d, J=7.8 Hz, 2H) ppm. ¹³C NMR (151 MHz, CDCl₃): δ 100.75, 83.08, 48.66, 48.39, 39.74, 24.93, 21.61 ppm. ¹¹B NMR (128 MHz, CDCl₃): δ 33.33 ppm. MS (GCMS, EI): m/z=256 (0.5%), 225 (42%), 170 (66%), 143 (100%), 125 (80%). TLC: R_{f}=0.50 (5:1 hexanes:ethyl acetate).

### 27. Compound SI-27

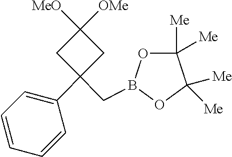 [SMILES: COC1(OC)CC(CB2OC(C)(C)C(C)(C)O2)(c2ccccc2)C1]

2-((3,3-dimethoxy-1-phenylcyclobutyl)methyl)-4,4,5,5-tetramethyl-1,3,2-dioxaborolane (SI-27) (Li et al., 2012). A dry round-bottom flask charged with SI-3 (776 mg, 2.0 mmol, 1.0 equiv.), 60% NaH (96 mg, 2.4 mmol, 1.2 equiv.) was degassed and filled with argon for three times. Toluene (15 mL) was added, and the reaction mixture was stirred at room temperature for 1 h. A solution of HBpin (768 mg, 6.0 mmol, 3.0 equiv.) in toluene (4 mL) was added via syringe. Then the tube was sealed and heated at 100° C. for 12 h. After cooling to room temperature, the suspension was filtered by Celite, concentrated, and the residue was purified by chromatography (hexanes:ethyl acetate, 10:1) on silica gel to afford 339 mg (51%) of the boronated product SI-27. Physical State: colorless oil. ¹H NMR (600 MHz, CDCl₃): δ 7.31-7.24 (m, 5H), 3.25 (s, 3H), 3.12 (s, 3H), 2.62-2.51 (m, 4H), 1.16 (s, 2H), 1.11 (s, 12H) ppm. ¹³C NMR (151 MHz, CDCl₃): δ 150.83, 127.95, 126.12, 125.41, 99.57, 82.86, 48.52, 48.39, 45.10, 35.00, 24.94 ppm. ¹¹B NMR (128 MHz, CDCl₃): δ 32.76 ppm. MS (GCMS, EI): m/z=332 (8%), 300 (8%), 244 (50%), 143 (100%), 128 (60%). TLC: R_{f}=0.50 (5:1 hexanes ethyl acetate).

The following compounds were prepared through previous literatures: SI-28 (Clausen et al., 2019), 29 (de Miguel et al., 2012), 30 (de Miguel et al., 2012), 31 (Wu et al., 2013), 32 (Lambert et al., 1986), 33 (Wolleb et al., 2018), 34 (Comins et al., 2001), 35 (Yang et al., 2021), & Compound 49.

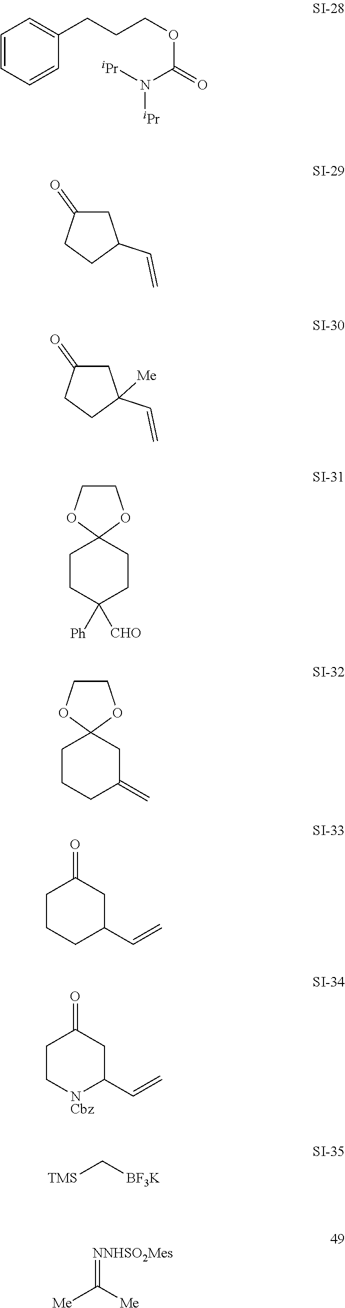

### E. Experimental Procedures and Characterization Data of Precursors of Substrates

### 28. Compound K-1

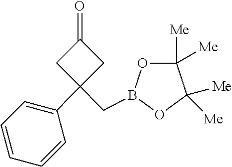 [SMILES: CC1(C)OB(CC2(c3ccccc3)CC(=O)C2)OC1(C)C]

3-phenyl-3-((4,4,5,5-tetramethyl-1,3,2-dioxaborolan-2-yl)methyl)cyclobutan-1-one (K-1). A dry round-bottom flask charged with SI-3 (776 mg, 2.0 mmol), 60% NaH (96 mg, 2.4 mmol) was degassed and filled with argon for three times. Toluene (15 mL) was added and the mixture was stirred at room temperature for 1 hour. A solution of HBpin (768 mg, 6.0 mmol) in toluene (4 mL) was added via syringe. Then the tube was sealed and heated at 100° C. for 12 h. After cooling to room temperature, the suspension was filtered over Celite, washed with acetonitrile (5 mL). To the filtrate solution was added 2 M H₂SO₄ (4 mL), and the mixture was stirred at room temperature for 3 hours. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 10:1) on silica gel to give the boronic esters K-1 as a colorless oil (257 mg, 45% yield). Physical State: colorless oil. ¹H NMR (400 MHz, CDCl₃): δ 7.38-7.15 (m, 5H), 3.51-3.43 (m, 2H), 3.36-3.27 (m, 2H), 1.49 (s, 2H), 1.13 (s, 12H) ppm. ¹³C NMR (101 MHz, CDCl₃): δ 208.06, 148.76, 128.38, 126.33, 126.22, 83.40, 59.87, 35.47, 24.91 ppm. ¹¹B NMR (128 MHz, CDCl₃): δ 32.46 ppm. MS (GCMS, EI): m/z=286 (2.5%), 285 (7%), 244 (100%), 171 (75%), 143 (99%), 117 (68%). TLC: R_{f}=0.44 (5:1 hexanes:ethyl acetate).

### 29. Compound K-2

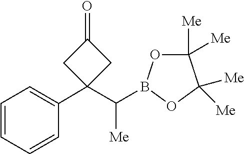 [SMILES: CC(B1OC(C)(C)C(C)(C)O1)C1(c2ccccc2)CC(=O)C1]

3-phenyl-3-(1-(4,4,5,5-tetramethyl-1,3,2-dioxaborolan-2-yl)ethyl)cyclobutan-1-one (K-2). Following General Procedure A on 2 mmol scale with SI-2 and methylboronic acid. Purification by chromatography (hexanes:methylene chloride, 2:1) on silica gel afforded 150.0 mg (25%) of the title compound K-2. Physical State: colorless oil. ¹H NMR (600 MHz, CDCl₃): δ 7.26-7.19 (m, 4H), 7.17-7.11 (m, ¹H), 3.51-3.42 (m, ¹H), 3.35-3.24 (m, 3H), 1.46 (q, J=7.4 Hz, 1H), 1.12 (d, J=14.9 Hz, 12H), 0.80 (d, J=7.4 Hz, 3H) ppm. ¹³C NMR (151 MHz, CDCl₃): δ 208.26, 146.88, 127.96, 127.53, 126.16, 83.47, 58.54, 56.81, 39.74, 24.93, 24.90, 12.22 ppm. ¹¹B NMR (128 MHz, CDCl₃): δ 33.55 ppm. MS (GCMS, EI): m/z=300 (2.5%), 258 (38%), 158 (100%), 115 (54%). TLC: R_{f}=0.51 (5:1 hexanes:ethyl acetate).

### 30. Compound K-3

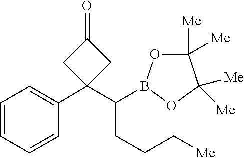 [SMILES: CCCCC(B1OC(C)(C)C(C)(C)O1)C1(c2ccccc2)CC(=O)C1]

3-phenyl-3-(1-(4,4,5,5-tetramethyl-1,3,2-dioxaborolan-2-yl)pentyl)cyclobutan-1-one (K-3). Following General Procedure A on 1 mmol scale with SI-2 and butylboronic acid. Purification by chromatography (hexanes:methylene chloride, 2:1) on silica gel afforded 154.8 mg (45%) of the title compound K-3. Physical State: colorless oil. ¹H NMR (600 MHz, CDCl₃): δ 7.28-7.10 (m, 5H), 3.54-3.40 (m, ¹H), 3.35-3.24 (m, 3H), 1.45-1.33 (m, ¹H), 1.30-0.96 (m, 6H), 1.13 (s, 12H), 0.72 (t, J=6.7 Hz, 3H) ppm. ¹³C NMR (151 MHz, CDCl₃): δ 208.02, 147.38, 127.97, 127.25, 126.09, 83.50, 59.00, 56.22, 39.40, 31.74, 27.73, 25.19, 24.87, 22.84, 14.04 ppm. ¹¹B NMR (128 MHz, CDCl₃): δ 33.15 ppm. MS (GCMS, EI): m/z=342 (1.5%), 341 (2%), 300 (8%), 244 (100%), 227 (18%), 187 (50%). TLC: R_{f}=0.56 (5:1 hexanes:ethyl acetate).

### 31. Compound K-4

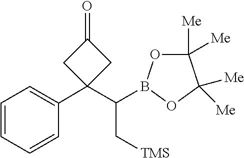 [SMILES: CC1(C)OB(C(C[Si](C)(C)C)C2(c3ccccc3)CC(=O)C2)OC1(C)C]

3-phenyl-3-(1-(4,4,5,5-tetramethyl-1,3,2-dioxaborolan-2-yl)-2-(trimethylsilyl)ethyl)cyclobutan-1-one (K-4). Preparation of TMSCH₂B(OH)₂: A screw-capped culture tube was charged with SI-35 (386 mg, 2.0 mmol, 3.3 equiv.) and degassed water (10 mL), followed by addition of silica gel (1.5 g) under argon atmosphere. The mixture was stirred at room temperature for 1 hour. Ethyl acetate was added and the suspended solution was filtered by Celite. The organic phase was separated, and the water phase was extracted with ethyl acetate. The combined organic solvent was washed with brine and dried by anhydrous MgSO₄. The solvent was removed under vacuum and the crude residue was used in the subsequent step without further purification.

Following General Procedure A on 0.6 mmol scale with SI-2 and crude boronic acid. Purification by chromatography (hexanes:methylene chloride, 2:1) on silica gel afforded 55.0 mg (25%) of the title compound K-4. Physical State: colorless crystal. m.p.: 85-87° C. ¹H NMR (600 MHz, CDCl₃): δ 7.45-7.37 (m, 4H), 7.35-7.30 (m, ¹H), 3.68-3.60 (m, ¹H), 3.52-3.41 (m, 3H), 1.61 (dd, J=11.9, 1.5 Hz, ¹H), 1.33 (s, 6H), 1.31 (s, 6H), 0.78 (dd, J=14.4, 11.9 Hz, ¹H), 0.54 (dd, J=14.4, 1.4 Hz, ¹H), 0.00 (s, 9H) ppm. ¹³C NMR (151 MHz, CDCl₃): δ 208.42, 146.96, 127.96, 127.60, 126.21, 83.63, 58.50, 56.41, 41.07, 25.48, 25.32, 13.99, -1.26 ppm. ¹¹B NMR (128 MHz, CDCl₃): δ 33.02 ppm. MS (GCMS, EI): m/z=372 (0.5%), 330 (18%), 218 (62%), 173 (48%), 127 (100%). TLC: R_{f}=0.61 (5:1 hexanes:ethyl acetate).

### 32. Compound 13

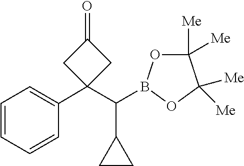 [SMILES: CC1(C)OB(C(C2CC2)C2(c3ccccc3)CC(=O)C2)OC1(C)C]

3-(cyclopropyl(4,4,5,5-tetramethyl-1,3,2-dioxaborolan-2-yl)methyl)-3-phenylcyclobutan-1-one (13). Following General Procedure A on 1 mmol scale with SI-2 and cyclopropylboronic acid. Purification by chromatography (hexanes:methylene chloride, 2:1) on silica gel afforded 196.0 mg (65%) of the title compound 13. Physical State: colorless crystal. m.p.: 38-40° C. ¹H NMR (400 MHz, CDCl₃): δ 7.51-7.44 (m, 4H), 7.42-7.35 (m, ¹H), 3.92-3.84 (m, ¹H), 3.72-3.64 (m, 1H), 3.62-3.50 (m, 2H), 1.37 (s, 6H), 1.34 (s, 6H), 1.08 (d, J=10.0 Hz, ¹H), 0.88-0.78 (m, ¹H), 0.63-0.52 (m, 2H), 0.25-0.17 (m, ¹H), 0.03-−0.04 (m, ¹H) ppm. 13C NMR (101 MHz, CDCl₃): δ 207.82, 148.26, 127.98, 127.15, 126.06, 83.38, 57.48, 56.42, 39.68, 24.80, 24.77, 9.32, 7.24, 2.46 ppm. ¹¹B NMR (128 MHz, CDCl₃): δ 32.71 ppm. MS (GCMS, EI): m/z=326 (1%), 284 (10%), 256 (18%), 199 (48%), 143 (100%), 128 (70%). TLC: R_{f}=0.51 (5:1 hexanes:ethyl acetate).

### 33. Compound K-6

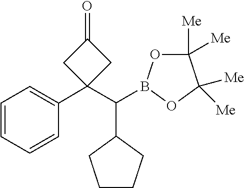 [SMILES: CC1(C)OB(C(C2CCCC2)C2(c3ccccc3)CC(=O)C2)OC1(C)C]

3-(cyclopentyl(4,4,5,5-tetramethyl-1,3,2-dioxaborolan-2-yl)methyl)-3-phenylcyclobutan-1-one (K-6). Following General Procedure A on 10 mmol scale with SI-2 and cyclopentylboronic acid. Purification by chromatography (hexanes:methylene chloride, 2:1) on silica gel afforded 1.46 g (41%) of the title compound K-6. Physical State: colorless crystal. m.p.: 61-63° C. ¹H NMR (600 MHz, CDCl₃): δ 7.33-7.30 (m, 4H), 7.24-7.19 (m, ¹H), 3.68-3.61 (m, ¹H), 3.42-3.35 (m, 3H), 1.77 (d, J=5.6 Hz, ¹H), 1.67-1.45 (m, 5H), 1.42-1.28 (m, 2H), 1.26-1.16 (m, ¹H), 1.24 (s, 6H), 1.23 (s, 6H), 1.09-1.01 (m, ¹H) ppm. ¹³C NMR (151 MHz, CDCl₃): δ 208.47, 147.93, 128.11, 127.40, 126.16, 83.61, 60.58, 56.37, 39.93, 39.60, 34.09, 31.16, 25.31, 25.28, 25.05, 24.84 ppm. ¹¹B NMR (128 MHz, CDCl₃): δ 32.63 ppm. LC-MS (ESI, m/z): calcd for [M+H]⁺ 355.2; found: 355.3. TLC: R_{f}=0.54 (5:1 hexanes ethyl acetate).

### 34. Compound K-7

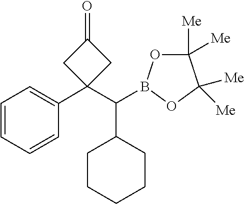 [SMILES: CC1(C)OB(C(C2CCCCC2)C2(c3ccccc3)CC(=O)C2)OC1(C)C]

3-(cyclohexyl(4,4,5,5-tetramethyl-1,3,2-dioxaborolan-2-yl)methyl)-3-phenylcyclobutan-1-one (K-7). Following General Procedure A on 0.5 mmol scale with SI-2 and cyclohexylborornic acid. Purification by chromatography (hexanes:methylene chloride, 2:1) on silica gel afforded 84.5 mg (46%) of the title compound K-7. Physical State: white solid. m.p.: 75-77° C. ¹H NMR (600 MHz, CDCl₃): δ 7.35-7.29 (m, 4H), 7.24-7.19 (m, ¹H), 3.70 (ddd, J=18.0, 4.3, 2.0 Hz, ¹H), 3.46-3.40 (m, ¹H), 3.38-3.28 (m, 2H), 1.62-1.52 (m, 5H), 1.37-1.31 (m, ¹H), 1.26 (s, 12H), 1.12-0.92 (m, 6H) ppm. ¹³C NMR (151 MHz, CDCl₃): δ 208.80, 147.95, 128.18, 127.23, 126.07, 83.66, 61.78, 56.03, 39.03, 38.38, 34.84, 30.80, 26.99, 26.62, 26.50, 25.18, 25.10 ppm. ¹¹B NMR (128 MHz, CDCl₃): δ 33.21 ppm. LC-MS (ESI, m/z): calcd for [M+H]⁺ 369.3; found: 369.3. TLC: R_{f}=0.54 (5:1 hexanes:ethyl acetate).

### 35. Compound K-8

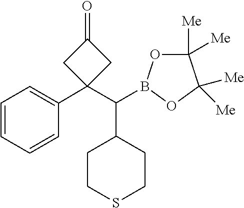 [SMILES: CC1(C)OB(C(C2CCSCC2)C2(c3ccccc3)CC(=O)C2)OC1(C)C]

3-phenyl-3-((tetrahydro-2H-thiopyran-4-yl)(4,4,5,5-tetramethyl-1,3,2-dioxaborolan-2-yl)-methyl)cyclobutan-1-one (K-8). Following General Procedure A on 0.5 mmol scale with SI-2 and tetrahydrothiopyran-4-ylboronic acid. Purification by chromatography (hexanes:methylene chloride, 2:1) on silica gel afforded 54.2 mg (28%) of the title compound K-8. Physical State: colorless oil. ¹H NMR (600 MHz, CDCl₃): δ 7.36-7.32 (m, 2H), 7.32-7.29 (m, 2H), 7.25-7.22 (m, ¹H), 3.68 (ddd, J=17.9, 4.5, 2.2 Hz, ¹H), 3.45 (ddd, J=17.6, 4.1, 2.5 Hz, ¹H), 3.40-3.28 (m, 2H), 2.51-2.33 (m, 4H), 1.81 (d, J=13.1, 3.5 Hz, ¹H), 1.62-1.48 (m, 4H), 1.28 (s, 6H), 1.27 (s, 6H), 1.11-1.04 (m, ¹H) ppm. ¹³C NMR (151 MHz, CDCl₃): δ 208.13, 147.43, 128.38, 127.12, 126.35, 83.94, 61.98, 56.01, 38.89, 38.33, 35.56, 31.71, 29.38, 29.08, 25.14 ppm. ¹¹B NMR (128 MHz, CDCl₃): δ 32.85 ppm. LC-MS (ESI, m/z): calcd for [M+H]⁺ 387.2; found: 387.2. TLC: R_{f}=0.41 (5:1 hexanes:ethyl acetate).

### 36. Compound K-9

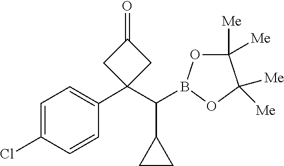 [SMILES: CC1(C)OB(C(C2CC2)C2(c3ccc(Cl)cc3)CC(=O)C2)OC1(C)C]

3-(4-chlorophenyl)-3-(cyclopropyl(4,4,5,5-tetramethyl-1,3,2-dioxaborolan-2-yl)methyl)cyclo-butan-1-one (K-9). Following General Procedure A on 0.5 mmol scale with SI-9 and cyclopropylboronic acid. Purification by chromatography (hexanes:methylene chloride, 2:1) on silica gel afforded 87.2 mg (48%) of the title compound K-9. Physical State: colorless oil. ¹H NMR (600 MHz, CDCl₃): δ 7.25 (d, J=8.6 Hz, 2H), 7.20 (d, J=8.6 Hz, 2H), 3.66 (ddd, J=17.4, 5.8, 2.6 Hz, ¹H), 3.46 (ddd, J=17.2, 5.8, 2.8 Hz, ¹H), 3.37-3.24 (m, 2H), 1.16 (s, 6H), 1.15 (s, 6H), 0.83 (d, J=10.0 Hz, ¹H), 0.66-0.53 (m, ¹H), 0.41-0.34 (m, 2H), 0.03-−0.03 (m, ¹H), -0.17-−0.24 (m, ¹H) ppm. ¹³C NMR (151 MHz, CDCl₃): δ 207.17, 146.82, 132.02, 128.78, 128.12, 83.58, 57.82, 56.53, 39.49, 24.87, 24.84, 9.37, 7.32, 2.55 ppm. ¹¹B NMR (128 MHz, CDCl₃): δ 32.85 ppm. MS (GCMS, EI): m/z=360 (0.5%), 331 (4%), 318 (8%), 233 (38%), 177 (100%), 155 (30%). TLC: R_{f}=0.55 (5:1 hexanes:ethyl acetate).

### 37. Compound K-10

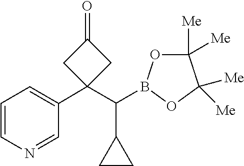 [SMILES: CC1(C)OB(C(C2CC2)C2(c3cccnc3)CC(=O)C2)OC1(C)C]

3-(cyclopropyl(4,4,5,5-tetramethyl-1,3,2-dioxaborolan-2-yl)methyl)-3-(pyridin-3-yl)cyclobutan-1-one (K-10). Following General Procedure A on 0.5 mmol scale with SI-11 and cyclopropylboronic acid. Purification by chromatography (hexanes:methylene chloride, 2:1) on silica gel afforded 54.0 mg (33%) of the title compound K-10. Physical State: yellow oil. ¹H NMR (600 MHz, CDCl₃): δ 8.60 (s, ¹H), 8.48 (d, J=4.7 Hz, ¹H), 7.66 (dt, J=8.0, 2.0 Hz, ¹H), 7.29 (dd, J=8.0, 4.8 Hz, ¹H), 3.75-3.66 (m, ¹H), 3.55-3.48 (m, ¹H), 3.42-3.34 (m, 2H), 1.18 (s, 6H), 1.17 (s, 6H), 0.87 (d, J=9.9 Hz, ¹H), 0.66-0.55 (m, ¹H), 0.44-0.34 (m, 2H), 0.07-−0.04 (m, ¹H), -0.20-−0.28 (m, ¹H) ppm. ¹³C NMR (151 MHz, CDCl₃): δ 206.11, 148.31, 146.76, 143.69, 135.67, 123.09, 83.75, 57.96, 56.50, 38.21, 24.85, 24.79, 9.33, 7.25, 2.63 ppm. ¹¹B NMR (128 MHz, CDCl₃): δ 32.26 ppm. MS (GCMS, EI): m/z=327 (2%), 312 (8%), 285 (14%), 256 (48%), 144 (100%), 130 (58%). TLC: R_{f}=0.50 (1:1 hexanes acetone).

### 38. Compound K-11

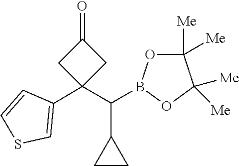 [SMILES: CC1(C)OB(C(C2CC2)C2(c3ccsc3)CC(=O)C2)OC1(C)C]

3-(cyclopropyl(4,4,5,5-tetramethyl-1,3,2-dioxaborolan-2-yl)methyl)-3-(thiophen-3-yl)cyclo-butan-1-one (K-11). Following General Procedure A on 2.0 mmol scale with SI-7 and cyclopropylboronic acid. Purification by chromatography (hexanes:methylene chloride, 2:1) on silica gel afforded 341.3 mg (50%) of the title compound K-11. Physical State: red oil. ¹H NMR (600 MHz, CDCl₃): δ 7.27-7.24 (m, ¹H), 7.03 (dd, J=3.0, 1.4 Hz, ¹H), 7.00 (dd, J=5.0, 1.4 Hz, ¹H), 3.70 (ddd, J=17.5, 5.1, 2.5 Hz, ¹H), 3.51-3.44 (m, ¹H), 3.33 (ddd, J=17.6, 4.6, 2.5 Hz, ¹H), 3.30-3.22 (m, ¹H), 1.17 (s, 6H), 1.17 (s, 6H), 1.00 (d, J=9.8 Hz, ¹H), 0.74-0.64 (m, ¹H), 0.50-0.35 (m, 2H), 0.12-0.05 (m, ¹H), −0.03-−0.12 (m, ¹H) ppm. ¹³C NMR (151 MHz, CDCl₃): δ 208.16, 149.40, 127.40, 125.87, 120.65, 83.46, 57.99, 57.24, 36.66, 24.88, 24.81, 9.32, 6.91, 2.52 ppm. ¹¹B NMR (128 MHz, CDCl₃): δ 32.84 ppm. LC-MS (ESI, m/z): calcd for [M+H]+ 333.2; found: 333.3. TLC: R_{f}=0.48 (5:1 hexanes:ethyl acetate).

### 39. Compound K-12

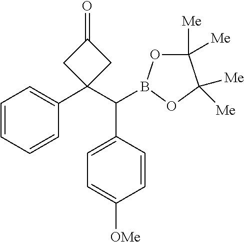 [SMILES: COc1ccc(C(B2OC(C)(C)C(C)(C)O2)C2(c3ccccc3)CC(=O)C2)cc1]

3-((4-methoxyphenyl)(4,4,5,5-tetramethyl-1,3,2-dioxaborolan-2-yl)methyl)-3-phenylcyclo-butan-1-one (K-12) (Stymiest et al., 2007). To a solution of SI-4 (350.0 mg, 1.0 mmol) and TMEDA (232.4 mg, 2.0 mmol) in Et₂O (5 mL) at −78° C. was added sBuLi (1.4 M in cyclohexane, 0.86 mL, 1.2 mmol) dropwise. The resulting mixture was stirred for 5 hours at -78° C. before 4-methoxyphenylboronic acid, pinacol ester (281.0 mg, 1.2 mmol, 1 M solution in diethyl ether) was added. The reaction mixture was further stirred at −78° C. for 1 hour. A solution of MgBr₂ in diethyl ether was added to the reaction mixture at this point and stirred for another 20 min. The reaction mixture was refluxed for 16 hours, then was allowed to cool down to room temperature and was carefully quenched with water. Diethyl ether was added, the organic layer was separated, and the aqueous phase was extracted with diethyl ether. The combined organic layer was concentrated, and the residue was dissolved in THE (5 mL). To the mixture was added 2M H₂SO₄ (2.0 mL). The suspension was stirred at room temperature for 2 h. Diethyl ether was added, the organic layer was separated, and the aqueous phase was extracted with diethyl ether. The combined organic layers were washed with water and brine, dried by anhydrous MgSO₄, concentrated and purified by column chromatography (hexanes:ethyl acetate, 10:1) on silica gel to obtain 137.0 mg (35%) the product SI-12.

Note: Preparation of MgBr₂ solution in diethyl ether: To a suspension of magnesium (28.8 mg, 1.2 mmol, 1.0 equiv.) in diethyl ether (2 mL) was added 1,2-dibromoethane (0.1 mL, 1.2 mmol, 1.0 equiv.) at room temperature and the mixture was allowed to stir at room temperature until magnesium disappeared.). Physical State: colorless oil. ¹H NMR (600 MHz, CDCl₃): δ 7.27-7.23 (m, 2H), 7.20-7.16 (m, ¹H), 7.13-7.09 (m, 2H), 6.88 (d, J=8.7 Hz, 2H), 6.72 (d, J=8.7 Hz, 2H), 3.76 (s, 3H), 3.63 (ddd, J=17.4, 5.3, 2.3 Hz, ¹H), 3.48 (ddd, J=17.6, 5.2, 2.3 Hz, ¹H), 3.39 (ddd, J=17.6, 4.0, 2.3 Hz, ¹H), 3.25 (ddd, J=17.5, 3.9, 2.3 Hz, ¹H), 2.78 (s, ¹H), 1.17 (s, 6H), 1.17 (s, 6H) ppm. ¹³C NMR (151 MHz, CDCl₃): δ 207.29, 158.25, 147.26, 131.89, 130.57, 127.82, 127.78, 126.18, 113.50, 83.77, 57.13, 56.64, 55.18, 40.27, 24.83, 24.71 ppm. ¹¹B NMR (128 MHz, CDCl₃): δ 32.91 ppm. LC-MS (ESI, m/z): calcd for [M+H]+ 393.2; found: 393.3. TLC: R_{f}=0.33 (5:1 hexanes:ethyl acetate).

### 40. Compound K-13

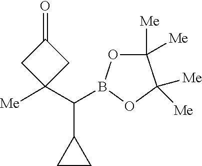 [SMILES: CC1(C(B2OC(C)(C)C(C)(C)O2)C2CC2)CC(=O)C1]

3-(cyclopropyl(4,4,5,5-tetramethyl-1,3,2-dioxaborolan-2-yl)methyl)-3-methylcyclobutan-1-one (K-13). Following General Procedure A on 0.5 mmol scale with SI-15 and cyclopropylboronic acid. Purification by chromatography (hexanes:methylene chloride, 2:1) on silica gel afforded 85.1 mg (64%) of the title compound K-13. Physical State: colorless oil. 5 ¹H NMR (600 MHz, CDCl₃): δ 3.24 (ddd, J=17.3, 3.9, 2.7 Hz, ¹H), 3.08-3.01 (m, ¹H), 2.69 (ddd, J=17.4, 5.7, 2.6 Hz, ¹H), 2.63 (ddd, J=17.2, 5.8, 2.7 Hz, ¹H), 1.39 (s, 3H), 1.23 (s, 6H), 1.23 (s, 6H), 0.77-0.70 (m, ¹H), 0.67 (d, J=9.7 Hz, ¹H), 0.58-0.51 (m, ¹H), 0.49-0.41 (m, ¹H), 0.19-0.07 (m, ¹H), 0.12-0.07 (m, ¹H) ppm. ¹³C NMR (151 MHz, CDCl₃): δ 209.86, 83.35, 58.51, 57.76, 31.36, 26.93, 24.93, 24.79, 9.37, 6.57, 2.58 ppm. ¹¹B NMR (128 MHz, CDCl₃): δ 32.99 ppm. MS (GCMS, EI): m/z=264 (1%), 249 (10%), 222 (59%), 165 (70%), 121 (96%), 108 (100%). TLC: R_{f}=0.48 (5:1 hexanes:ethyl acetate).

### 41. Compound K-14

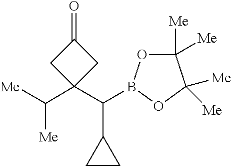 [SMILES: CC(C)C1(C(B2OC(C)(C)C(C)(C)O2)C2CC2)CC(=O)C1]

3-(cyclopropyl(4,4,5,5-tetramethyl-1,3,2-dioxaborolan-2-yl)methyl)-3-isopropylcyclobutan-1-one (K-14). Following General Procedure A on 0.5 mmol scale with SI-16 and cyclopropylboronic acid. Purification by chromatography (hexanes:methylene chloride, 2:1) on silica gel afforded 97.0 mg (66%) of the title compound K-14. Physical State: colorless oil. ¹H NMR (600 MHz, CDCl₃): δ 3.39 (d, J=1.9 Hz, ¹H), 3.07 (ddd, J=18.0, 4.5, 2.7 Hz, ¹H), 2.76 (ddd, J=18.0, 5.4, 2.7 Hz, ¹H), 2.69 (ddd, J=17.6, 5.4, 2.7 Hz, ¹H), 1.94 (hept, J=6.8 Hz, ¹H), 1.20 (s, 6H), 1.19 (s, 6H), 0.89 (d, J=3.9 Hz, 3H), 0.88 (d, J=3.8 Hz, 3H), 0.68 (d, J=10.2 Hz, ¹H), 0.64-0.54 (m, 2H), 0 ppm. ¹³C NMR (151 MHz, CDCl₃): δ 210.45, 83.14, 53.13, 52.18, 38.39, 35.45, 24.89, 24.72, 18.23, 17.96, 9.19, 8.30, 2.89 ppm. ¹¹B NMR (128 MHz, CDCl₃): δ 33.07 ppm. MS (GCMS, EI): m/z=292 (2%), 277 (8%), 249 (38%), 207 (48%), 150 (90%), 122 (100%). TLC: R_{f}=0.55 (5:1 hexanes:ethyl acetate).

### 42. Compound K-15

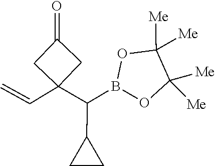 [SMILES: C=CC1(C(B2OC(C)(C)C(C)(C)O2)C2CC2)CC(=O)C1]

3-(cyclopropyl(4,4,5,5-tetramethyl-1,3,2-dioxaborolan-2-yl)methyl)-3-vinylcyclobutan-1-one (K-15). Following General Procedure A on 1 mmol scale with SI-19 and cyclopropylboronic acid. Purification by chromatography (hexanes:methylene chloride, 2:1) on silica gel afforded 98.0 mg (35%) of the title compound K-15. Physical State: colorless oil. ¹H NMR (600 MHz, CDCl₃): δ 6.18 (dd, J=17.2, 10.5 Hz, ¹H), 5.12-4.99 (m, 2H), 3.24 (ddd, J=17.3, 4.6, 2.3 Hz, ¹H), 3.10 (ddd, J=17.6, 4.5, 2.3 Hz, ¹H), 3.02 (ddd, J=17.6, 4.7, 2.3 Hz, ¹H), 2.89 (ddd, J=17.5, 4.7, 2.3 Hz, ¹H), 1.19 (s, 6H), 1.19 (s, 6H), 0.74-0.65 (m, 2H), 0.53-0.48 (m, ¹H), 0.43-0.36 (m, ¹H), 0.14-0.04 (m, 2H) ppm. ¹³C NMR (151 MHz, CDCl₃): δ 208.01, 143.86, 112.87, 83.36, 55.85, 55.07, 37.48, 24.86, 24.74, 9.04, 6.85, 2.42 ppm. ¹¹B NMR (128 MHz, CDCl₃): δ 32.81 ppm. MS (GCMS, EI): m/z=276 (8%), 247 (10%), 206 (10%), 177 (18%), 149 (100%), 133 (40%). TLC: R_{f}=0.52 (5:1 hexanes:ethyl acetate).

### 43. Compound K-16

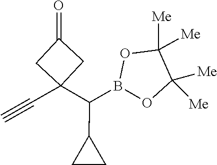 [SMILES: C#CC1(C(B2OC(C)(C)C(C)(C)O2)C2CC2)CC(=O)C1]

3-(cyclopropyl(4,4,5,5-tetramethyl-1,3,2-dioxaborolan-2-yl)methyl)-3-ethynylcyclobutan-1-one (K-16). Following General Procedure A on 1 mmol scale with SI-20 and cyclopropylboronic acid. Purification by chromatography (hexanes:methylene chloride, 2:1) on silica gel afforded 82.2 mg (30%) of the title compound K-16. Physical State: colorless oil. ¹H NMR (600 MHz, CDCl₃): δ 3.49-3.43 (m, ¹H), 3.37-3.24 (m, 3H), 2.25 (s, ¹H), 1.23 (s, 6H), 1.23 (s, 6H), 0.94-0.86 (m, ¹H), 0.83 (d, J=9.8 Hz, ¹H), 0.63-0.55 (m, ¹H), 0.51-0.45 (m, ¹H), 0.27-0.21 (m, ¹H), 0.15-0.08 (m, ¹H) ppm. ¹³C NMR (151 MHz, CDCl₃): δ 206.44, 89.60, 83.65, 69.81, 59.75, 59.41, 29.07, 24.82, 24.77, 9.48, 6.58, 2.40 ppm. ¹¹B NMR (128 MHz, CDCl₃): δ 32.60 ppm. MS (GCMS, EI): m/z=274 (0.5%), 246 (6%), 217 (18%), 174 (32%), 118 (88%), 105 (100%). TLC: R_{f}=0.52 (5:1 hexanes:ethyl acetate).

### 44. Compound 53

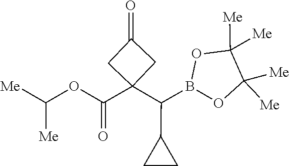 [SMILES: CC(C)OC(=O)C1(C(B2OC(C)(C)C(C)(C)O2)C2CC2)CC(=O)C1]

isopropyl-1-(cyclopropyl(4,4,5,5-tetramethyl-1,3,2-dioxaborolan-2-yl)methyl)-3-oxocyclo-but-ane-1-carboxylate (53). Following General Procedure A on 3 mmol scale with 52 and cyclopropylboronic acid. Purification by chromatography (hexanes:methylene chloride, 2:1) on silica gel afforded 385.4 mg (38%) of the title compound 53. Physical State: colorless oil. ¹H NMR (600 MHz, CDCl₃): δ 5.02 (hept, J=6.3 Hz, ¹H), 3.44-3.40 (m, 2H), 3.35-3.29 (m, ¹H), 3.26-3.20 (m, ¹H), 1.24 (d, J=4.7 Hz, 3H), 1.23 (d, J=5.4 Hz, 3H), 1.21 (s, 6H), 1.20 (s, 6H), 1.02 (d, J=10.0 Hz, ¹H), 0.73-0.64 (m, ¹H), 0.53-0.44 (m, 2H), 0.20-0.11 (m, 2H) ppm. ¹³C NMR (151 MHz, CDCl₃): δ 206.26, 175.65, 83.45, 68.84, 55.78, 54.61, 40.62, 24.87, 24.72, 21.78, 8.86, 6.63, 2.78 ppm. ¹¹B NMR (128 MHz, CDCl₃): δ 32.71 ppm. MS (GCMS, EI): m/z=336 (0.5%), 321 (4%), 278 (16%), 194 (54%), 166 (100%), 122 (68%). TLC: R_{f}=0.35 (5:1 hexanes:ethyl acetate).

### 45. Compound K-18

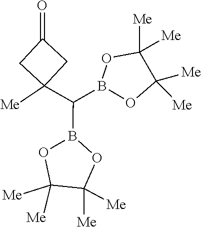

3-(bis(4,4,5,5-tetramethyl-1,3,2-dioxaborolan-2-yl)methyl)-3-methylcyclobutan-1-one (K-18) (Li et al., 2014). A dry round-bottom flask charged with SI-23 (326.0 mg, 1 mmol), 60% NaH (1.2 mmol, 48 mg) was degassed and filled with argon for three times. Toluene (8 mL) was added, and the mixture was stirred at room temperature for 1 h. A solution of B₂pin₂ (1.2 mmol, 305 mg) in toluene (2 mL) was added via syringe. Then the tube was sealed and heated at 90° C. for 12 h. After cooling to room temperature, the suspension was filtered by Celite, and washed by acetonitrile (10 mL). The filtrate was transferred to a round-bottom flask, and 2M H₂SO₄ (5 mL) was added. The mixture was stirred at room temperature for 3 hours, then diethyl ether was added. The solution was separated, and the aqueous layer was extracted with diethyl ether. The combined organic solution was washed with saturated brine and dried over anhydrous Na₂SO₄. The mixture was filtered and concentrated, and the residue was purified by chromatography (hexanes:ethyl acetate, 20:1) on silica gel to afford 175 mg (50%) of the gem-diborated product K-18. Physical State: white solid. m.p.: 48-50° C. ¹H NMR (600 MHz, CDCl₃): δ 3.21-3.13 (m, 2H), 2.75-2.68 (m, 2H), 1.38 (s, 3H), 1.22 (s, 12H), 1.21 (s, 12H) ppm. ¹³C NMR (151 MHz, CDCl₃): δ 211.24, 83.28, 60.04, 30.32, 28.39, 25.02, 24.58 ppm. ¹¹B NMR (128 MHz, CDCl₃): δ 33.22 ppm. MS (GCMS, EI): m/z=350 (0.5%), 292 (4%), 251 (100%), 235 (38%), 165 (38%). TLC: R_{f}=0.36 (5:1 hexanes:ethyl acetate).

### 46. Compound K-19

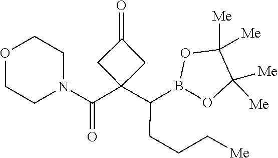 [SMILES: CCCCC(B1OC(C)(C)C(C)(C)O1)C1(C(=O)N2CCOCC2)CC(=O)C1]

3-(bis(4,4,5,5-tetramethyl-1,3,2-dioxaborolan-2-yl)methyl)-3-methylcyclobutan-1-one (K-19). To a solution of SI-14 (156 mg, 0.5 mmol, 1.0 equiv.) in EtOH (2.5 mL) was added 3 M NaOH (1 mL) and the mixture was allowed to stir overnight. Then 1 M HCl (10 mL) was added to neutralize extra base and the reaction mixture was extracted with ethyl acetate three times. Combined organic layer was dried over anhydrous Na₂SO₄ and concentrated in vacuo. The crude carboxylic acid was used without further purification.

To a solution of crude acid in DMF (1 mL) was added HBTU (228 mg, 0.6 mmol, 1.2 equiv.), DIPEA (0.26 mL, 1.5 mmol, 3.0 equiv.) and morpholine (52 mL, 0.6 mmol, 1.2 equiv.) and the mixture was allowed to stir for 3 hours. Then brine was added to quench the reaction and the mixture was extracted with ethyl acetate 3 times. The combined organic layer was washed with brine, dried over anhydrous Na₂SO₄ and concentrated in vacuo. The crude amide was used without further purification.

To a solution of crude amide in acetonitrile (1 mL) was added 2 M H₂SO₄ (2 mL) and the mixture was stirred at room temperature for 5 hours, then diethyl ether was added. The solution was separated, and the aqueous layer was extracted with diethyl ether three times. The combined organic solution was washed with saturated brine and dried over anhydrous Na₂SO₄. The mixture was filtered and concentrated, and the residue was purified by chromatography (hexanes:acetone, 5:1) on silica gel to afford 53 mg (28%) of amide product K-19. Physical State: colorless oil. ¹H NMR (600 MHz, CDCl₃): δ 3.79-3.31 (m, 9H), 3.28-3.21 (m, 2H), 3.13 (ddd, J=18.0, 5.5, 2.6 Hz, ¹H), 1.56-1.41 (m, 2H), 1.35-1.24 (m, 5H), 1.21 (s, 6H), 1.21 (s, 6H), 0.85 (t, J=6.8 Hz, 3H) ppm. ¹³C NMR (151 MHz, CDCl₃): δ 206.55, 173.16, 84.05, 55.23, 54.58, 39.82, 31.59, 27.30, 24.85, 24.83, 22.72, 13.98 ppm. Note: NCH2 and OCH2 were not observed due to rotate isomerization. ¹¹B NMR (128 MHz, CDCl₃): δ 33.15 ppm. MS (GCMS, EI): m/z=379 (1%), 364 (4%), 308 (16%), 236 (28%), 182 (100%), 154 (40%). TLC: R_{f}=0.46 (2:1 hexanes:acetone).

### 47. Compound K-20

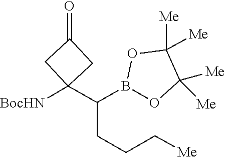 [SMILES: CCCCC(B1OC(C)(C)C(C)(C)O1)C1(NC(=O)OC(C)(C)C)CC(=O)C1]

tert-butyl-(3-oxo-1-(1-(4,4,5,5-tetramethyl-1,3,2-dioxaborolan-2-yl)pentyl)cyclobutyl)carbamate (K-20). To a solution of SI-22 (60 mg, 0.15 mmol, 1.0 equiv.) in methylene chloride (1.0 mL) was added Dess-Martin periodinane (127.2 mg, 0.3 mmol, 2.0 equiv.) at 0° C. and the reaction mixture was allowed to stir overnight. Then saturated NaHCO₃ was added to quench the reaction and the mixture was extracted with methylene dichloride 3 times. The combined organic layer was washed with brine, dried over anhydrous Na₂SO₄ and concentrated in vacuo. The residue was purified by chromatography (hexanes:ethyl acetate, 2:1) on silica gel to afford 57.5 mg (99%) of product K-20. Physical State: colorless oil. ¹H NMR (600 MHz, CDCl₃): δ 5.18 (s, ¹H), 3.59 (d, J=17.8 Hz, ¹H), 3.38 (d, J=17.8 Hz, ¹H), 3.18-3.08 (m, ¹H), 3.07-3.00 (m, ¹H), 1.53-1.48 (m, 2H), 1.42 (s, 9H), 1.40-1.25 (m, 5H), 1.23 (s, 6H), 1.22 (s, 6H), 0.87 (t, J=6.9 Hz, 3H) ppm. ¹³C NMR (151 MHz, CDCl₃): δ 206.77, 154.95, 83.85, 57.23, 56.84, 49.97, 31.85, 28.52, 26.99, 24.86, 24.83, 22.93, 14.10 ppm. Note: NHC was not observed. ¹¹B NMR (128 MHz, CDCl₃): δ 33.75 ppm. LC-MS (ESI, m/z): calcd for [M+Na]+404.3; found: 404.3. TLC: R_{f}=0.27 (5:1 hexanes:acetone).

### 48. Compound K-21

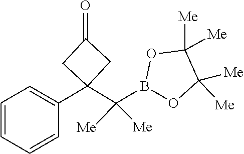 [SMILES: CC1(C)OB(C(C)(C)C2(c3ccccc3)CC(=O)C2)OC1(C)C]

3-phenyl-3-(2-(4,4,5,5-tetramethyl-1,3,2-dioxaborolan-2-yl)propan-2-yl)cyclobutan-1-one (K-21). Following General Procedure A on 0.5 mmol scale with SI-5 and methylboronic acid starting from the coupling between sulfonyl hydrazone and boronic acid. Purification by chromatography (hexanes:methylene chloride, 2:1) on silica gel afforded 22 mg (14%) of the title compound K-21. Physical State: colorless crystal. m.p.: 62-64° C. ¹H NMR (600 MHz, CDCl₃): δ 7.32-7.29 (m, 2H), 7.26-7.20 (m, 3H), 3.64-3.57 (m, 2H), 3.33-3.26 (m, 2H), 1.21 (s, 12H), 0.87 (s, 6H) ppm. ¹³C NMR (151 MHz, CDCl₃): δ 208.73, 145.39, 129.19, 127.36, 126.10, 83.63, 56.65, 42.97, 24.82, 21.32 ppm. ¹¹B NMR (128 MHz, CDCl₃): δ 34.06 ppm. MS (GCMS, EI): m/z=314 (4%), 299 (8%), 272 (78%), 172 (100%), 145 (50%), 117 (84%). TLC: R_{f}=0.54 (5:1 hexanes:ethyl acetate).

### 49. Compound K-22

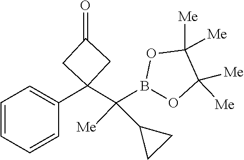 [SMILES: CC1(C)OB(C(C)(C2CC2)C2(c3ccccc3)CC(=O)C2)OC1(C)C]

3-(1-cyclopropyl-1-(4,4,5,5-tetramethyl-1,3,2-dioxaborolan-2-yl)ethyl)-3-phenylcyclobutan-1-one (K-22). Following General Procedure A on 1.5 mmol scale with SI-5 and cyclopropylboronic acid starting from the coupling between sulfonyl hydrazone and boronic acid. Purification by chromatography (hexanes:methylene chloride, 2:1) on silica gel afforded 229.6 mg (45%) of the title compound K-22. Physical State: yellow solid. m.p.: 52-54° C. ¹H NMR (600 MHz, CDCl₃): δ 7.32-7.26 (m, 4H), 7.22-7.18 (m, ¹H), 3.87 (ddd, J=17.7, 5.9, 2.5 Hz, ¹H), 3.65 (ddd, J=18.0, 6.0, 2.7 Hz, ¹H), 3.36 (ddd, J=17.9, 3.7, 2.5 Hz, ¹H), 3.26 (ddd, J=17.6, 3.7, 2.6 Hz, ¹H), 1.22 (s, 6H), 1.17 (s, 6H), 0.79 (tt, J=8.2, 6.2 Hz, ¹H), 0.63 (s, 3H), 0.43-0.32 (m, 2H), 0.29-0.19 (m, ¹H), 0.08 (tt, J=7.3, 5.0 Hz, ¹H) ppm. ¹³C^{NMR} (151 MHz, CDCl₃): δ 208.71, 146.44, 129.13, 127.28, 126.03, 83.59, 57.42, 55.80, 44.02, 25.13, 24.77, 15.70, 14.91, 1.84, 1.31 ppm. ¹¹B NMR (128 MHz, CDCl₃): δ 30.24 ppm. MS (GCMS, EI): m/z=340 (1%), 297 (4%), 212 (10%), 195 (86%), 142 (42%), 101 (100%). TLC: R_{f}=0.54 (5:1 hexanes:ethyl acetate).

### 50. Compound K-23

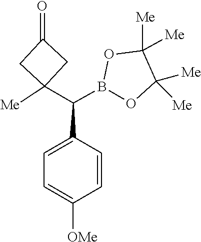 [SMILES: COc1ccc([C@H](B2OC(C)(C)C(C)(C)O2)C2(C)CC(=O)C2)cc1]

(R)-3-((4-methoxyphenyl)(4,4,5,5-tetramethyl-1,3,2-dioxaborolan-2-yl)methyl)-3-methylcyclo-butan-1-one (K-23) (Stymiest et al., 2007). To a solution of SI-24 (574.0 mg, 2.0 mmol) and (−)-sparteine (608 mg, 2.6 mmol) in diethyl ether (10 mL) at −78° C. was added sBuLi (1.4 M in cyclohexane, 1.9 mL, 2.6 mmol) dropwise. The resulting mixture was stirred for 5 hours at −78° C. before 4-methoxyphenylboronic acid, pinacol ester (608.0 mg, 2.6 mmol, 1 M solution in diethyl ether) was added. The reaction mixture was further stirred at −78° C. for 1 h. A solution of MgBr₂ in diethyl ether was added to the reaction mixture at −78° C. and stirred for another 20 min. The reaction mixture was allowed to warm to room temperature and then refluxed for 16 h. The mixture was allowed to cool down to room temperature and was carefully quenched with water. diethyl ether was added, the layers were separated, and the aqueous phase was extracted with diethyl ether. The combined organic layers were concentrated, and the residue was dissolved in THE (10 mL). To the mixture was added 2M H₂SO₄ (4.0 mL). The suspension was stirred at room temperature for 2 h. Diethyl ether was added, the organic layer was separated, and the aqueous phase was extracted with diethyl ether. The combined organic layers were washed with water and brine, dried (MgSO₄), concentrated and purified by column chromatography (hexanes:ethyl acetate, 10:1) on silica gel to obtain 409 mg (62%) of the product K-23. Note: Preparation of MgBr₂ solution in diethyl ether: To a suspension of magnesium (28.8 mg, 1.2 mmol, 1.0 equiv.) in diethyl ether (2 mL) was added 1,2-dibromoethane (0.1 mL, 1.2 mmol, 1.0 equiv.) at room temperature and the mixture was allowed to stir at room temperature until magnesium disappeared). Physical State: colorless oil. ¹H NMR (600 MHz, CDCl₃): δ 7.18-7.14 (m, 2H), 6.86-6.81 (m, 2H), 3.79 (s, 3H), 3.16 (dt, J=16.9, 3.2 Hz, ¹H), 3.06 (dt, J=17.2, 3.2 Hz, ¹H), 2.64-2.53 (m, 2H), 2.53 (s, ¹H), 1.29 (s, 3H), 1.25 (s, 6H), 1.21 (s, 6H) ppm. ¹³C NMR (151 MHz, CDCl₃): δ 209.14, 158.21, 131.90, 131.33, 113.85, 83.69, 57.94, 57.46, 55.31, 31.60, 26.81, 24.91, 24.79 ppm. ¹¹B NMR (128 MHz, CDCl₃): δ 32.75 ppm. MS (GCMS, EI): m/z=330 (26%), 288(100%), 247 (74%), 188 (44%), 147 (50%). [α]_{D}²⁰=−4.80 (c=1.0, CHCl₃). TLC: R_{f}=0.30 (5:1 hexanes:ethyl acetate). Chiral HPLC: The product was oxidized, and the corresponding alcohol K-23-ol was used for HPLC analysis.

To a solution of K-23 (66 mg, 0.2 mmol) and NaOAc (32.8 mg, 0.4 mmol) in THE (1.0 mL) at 0° C. was added H₂O₂ (35 wt. % in water, 0.2 mL) dropwise. The resulting mixture was stirred at 0° C. for 1.5 h. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 3:1) on silica gel to obtain 19 mg (43%) of the alcohol K-23-ol. Physical State: colorless oil. ¹H NMR (600 MHz, CDCl₃): δ 7.25 (d, J=8.7 Hz, 2H), 6.87 (d, J=8.6 Hz, 2H), 4.71 (s, ¹H), 3.79 (s, 3H), 3.36 (dddd, J=34.7, 16.8, 3.9, 2.7 Hz, 2H), 2.51 (dddd, J=31.7, 16.8, 5.8, 2.6 Hz, 2H), 2.35 (s, ¹H), 1.16 (s, 3H) ppm. ¹³C NMR (151 MHz, CDCl₃): δ 207.95, 159.43, 133.85, 128.00, 113.77, 78.21, 55.37, 55.30, 53.53, 34.28, 23.20 ppm. MS (GCMS, EI): m/z=220 (6%), 161 (28%), 137 (100%), 109 (24%). TLC: R_{f}=0.53 (1:1 hexanes:ethyl acetate). [α]_{D}²⁰=+30.9 (c=1.14, CHCl₃). Chiral HPLC: Chiralcel-OD-H column (25 cm) with guard, 15.0% isopropanol in hexane, 0.8 mL/min, ambient temperature, 220 nm: t_{R}=14.27 min (minor, (R)), t_{R}=16.60 min (major, (S)), 96:3 e.r.

### 51. Compound 39

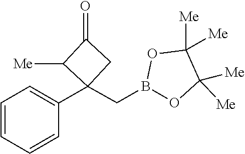 [SMILES: CC1C(=O)CC1(CB1OC(C)(C)C(C)(C)O1)c1ccccc1]

2-methyl-3-phenyl-3-(1-(4,4,5,5-tetramethyl-1,3,2-dioxaborolan-2-yl)ethyl)cyclobutan-1-one (39). To a solution of K-1 (28.6 mg, 0.1 mmol) in THE (1.0 mL) was added LDA (0.15 mL, 1 M in THF) at −78° C. and the mixture was allowed to stir at the same temperature for 1 hour. Then methyl iodide (19 mL, 0.3 mmol, 3.0 equiv.) was added at −78° C. and the reaction was allowed to warm up to room temperature and stir overnight. Saturated NH₄Cl solution (1 mL) was added to quench the reaction and the mixture was extracted with ethyl acetate three times. The combined organic layers were washed with brine, dried over anhydrous MgSO₄, concentrated and purified by column chromatography (hexanes:ethyl acetate, 10:1) on silica gel to obtain 7.5 mg (25%) of the product 39. Note: The product is a single diastereomer, without assign stereochemistry. Physical State: colorless oil. ¹H NMR (600 MHz, CDCl₃): δ 7.35-7.28 (m, 4H), 7.23-7.18 (m, ¹H), 3.54-3.47 (m, 2H), 3.26-3.20 (m, ¹H), 1.36 (d, J=15.2, 1.6 Hz, ¹H), 1.28 (d, J=7.1 Hz, 3H), 1.10 (d, J=14.5 Hz, ¹H), 1.09 (s, 6H), 1.06 (s, 6H) ppm. ¹³C NMR (151 MHz, CDCl₃): δ 210.25, 149.44, 128.31, 126.33, 126.05, 83.26, 64.62, 56.38, 38.78, 24.90, 24.83, 9.26 ppm. ¹¹B NMR (128 MHz, CDCl₃): δ 32.84 ppm. MS (GCMS, EI): m/z=299 (12%), 258 (14%), 217 (28%), 156 (100%), 145 (46%). TLC: R_{f}=0.46 (5:1 hexanes:ethyl acetate).

### 52. Compound K-25

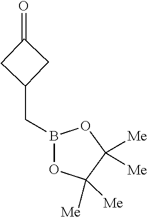 [SMILES: CC1(C)OB(CC2CC(=O)C2)OC1(C)C]

3-((4,4,5,5-tetramethyl-1,3,2-dioxaborolan-2-yl)methyl)cyclobutan-1-one (K-25). To a solution of SI-26 (256 mg, 1.0 mmol, 1.0 equiv.) in acetonitrile (4.0 mL) was added 2M H₂SO₄ (2.0 mL) and the mixture was stirred at room temperature for 3 hours. Then diethyl ether (5 mL) was added, and layers were separated. Aqueous layer was extracted, and the combined organic layers were washed with brine, dried over Na₂SO₄, and purified by column chromatography (hexanes:ethyl acetate, 5:1) on silica gel to obtain 190 mg (90%) of the product K-25. Physical State: colorless oil. ¹H NMR (600 MHz, CDCl₃): δ 3.16 (dd, J=20.4, 8.7 Hz, 2H), 2.69 (dd, J=20.5, 6.2 Hz, 2H), 2.61-2.54 (m, ¹H), 1.21 (s, 12H), 1.15 (d, J=7.4 Hz, 2H) ppm. ¹³C NMR (151 MHz, CDCl₃): δ 209.32, 83.37, 54.63, 24.89, 20.13 ppm. ¹¹B NMR (128 MHz, CDCl₃): δ 33.30 ppm. MS (GCMS, EI): m/z=210 (14%), 295 (38%), 153 (100%), 110 (60%). TLC: R_{f}=0.34 (5:1 hexanes:ethyl acetate).

### 53. Compound K-26

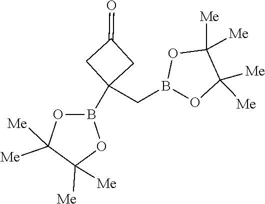 [SMILES: CC1(C)OB(CC2(B3OC(C)(C)C(C)(C)O3)CC(=O)C2)OC1(C)C]

3-(4,4,5,5-tetramethyl-1,3,2-dioxaborolan-2-yl)-3-((4,4,5,5-tetramethyl-1,3,2-dioxaborolan-2-yl)methyl)cyclobutan-1-one (K-26)¹³. To a flame-dried round-bottom flask was added B₂cat₂ (784 mg, 1.1 equiv.), after which the flask was evacuated and back-filled with argon three times. Anhydrous 2-MeTHF (10 mL), t-butylamine (22 mg, 10 mol %) and the 2-methylene-5,8-dioxaspiro[3.4]octane (378 mg, 1.0 equiv.) were added sequentially via syringe. The resulting solution was heated to 70° C. for 16 h and subsequently allowed to cool to ambient temperature. After this, a solution of pinacol (2.12 g, 6.0 equiv.) in triethylamine (5 mL) was added to the reaction mixture and the resulting solution was vigorously stirred at ambient temperature for 3 hours. After this time, the reaction mixture was directly concentrated under reduced pressure and the resulting crude material was resolved in acetonitrile (10 mL). 2M H₂SO₄ (5 mL) was added, and the mixture was stirred at room temperature for 3 hours. Diethyl ether was added, the layers were separated, and the aqueous phase was extracted by ether. The combined organic layers were washed with brine, dried with Na₂SO₄, concentrated and purified by flash column chromatography (hexanes:diethyl ether 10:1) on silica gel to afford 514 mg (51%) of the diborated products. Physical State: colorless oil. ¹H NMR (600 MHz, CDCl₃): δ 3.24 (d, J=20.3 Hz, 2H), 2.68 (d, J=20.4 Hz, 2H), 1.25 (s, 2H), 1.24 (s, 12H), 1.21 (s, 12H) ppm. ¹³C NMR (151 MHz, CDCl₃): δ 209.48, 83.83, 83.30, 57.28, 24.94, 24.78 ppm. ¹¹B NMR (128 MHz, CDCl₃): δ 33.57 ppm. LC-MS (ESI, m/z): calcd for [M+H]+ 337.3; found: 337.3. TLC: R_{f}=0.36 (5:1 hexanes:ethyl acetate).

### 54. Compound 58

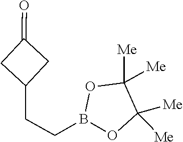 [SMILES: CC1(C)OB(CCC2CC(=O)C2)OC1(C)C]

3-(2-(4,4,5,5-tetramethyl-1,3,2-dioxaborolan-2-yl)ethyl)cyclobutan-1-one (58). A dry round-bottom flask charged with BrCH₂Cl (130 mg, 1.0 mmol) and SI-26 (128 mg, 0.50 mmol) was evacuated and filled with argon for three cycles. THE (1.5 mL) was added and the mixture was cooled to −78° C. n-BuLi (1.6 M in hexanes, 0.63 mL, 1.0 mmol) was added dropwise to the mixture via syringe and the resulting solution was stirred at −78° C. for 0.5 hour. The cooling bath was removed and the mixture was stirred at room temperature for 12 hours. To the mixture was added 2M H₂SO₄ (2.0 mL). The suspension was stirred at room temperature for 2 hours. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 10:1) on silica gel to give the 87 mg (78%) of boronic esters 58. Physical State: colorless oil. ¹H NMR (600 MHz, CDCl₃): δ 3.14-3.04 (m, 2H), 2.70-2.61 (m, 2H), 2.36-2.26 (m, ¹H), 1.69 (q, J=7.7 Hz, 2H), 1.24 (s, 12H), 0.80 (t, J=8.0 Hz, 2H) ppm. ¹³C NMR (151 MHz, CDCl₃): δ 208.99, 83.28, 52.34, 30.75, 26.12, 24.96 ppm. ¹¹B NMR (128 MHz, CDCl₃): δ 33.74 ppm. MS (GCMS, EI): m/z=224 (3%), 209 (38%), 195 (22%), 166 (100%), 137 (68%), 125 (80%). TLC: R_{f}=0.30 (5:1 hexanes:ethyl acetate).

### 55. Compound 59

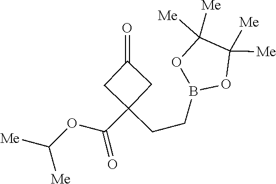 [SMILES: CC(C)OC(=O)C1(CCB2OC(C)(C)C(C)(C)O2)CC(=O)C1]

isopropyl-3-oxo-1-(2-(4,4,5,5-tetramethyl-1,3,2-dioxaborolan-2-yl)ethyl)cyclobutane-1-carbo-xylate (59) (Yamamoto et al., 2004). A dry round-bottom flask was charged with [Ir(cod)Cl]₂ (13 mg, 0.02 mmol) and 1,2-bis(diphenylphosphino)ethane (16 mg, 0.04 mmol). The flask was evacuated and backfilled with argon for three cycles and methylene chloride (2 mL) was added. After all solids dissolved, pinacolborane HBpin (179.0 mg, 1.4 mmol) and the SI-17 (228 mg, 1.0 mmol) were added sequentially via syringe. The reaction was stirred at room temperature and monitored by thin layer chromatography. The reaction was then open to air and methanol (1 mL MeOH/mmol HBPin) was added slowly. The mixture was stirred until gas evolution ceased, then concentrated in vacuo. The residue was dissolved in acetonitrile (5 mL), and 2M H₂SO₄ (2 mL) was added. The mixture was stirred at room temperature for 3 hours. Diethyl ether was added, the layers were separated, and the aqueous phase was extracted with diethyl ether. The combined organic layers were washed with water and brine, dried (MgSO₄), concentrated and purified by chromatography (hexanes:ethyl acetate, 5:1) on silica gel to afford 186 mg (60%) of the product 59. Physical State: colorless oil. ¹H NMR (600 MHz, CDCl₃): δ 5.05 (hept, J=6.3 Hz, ¹H), 3.47-3.37 (m, 2H), 2.97-2.86 (m, 2H), 2.03-1.95 (m, 2H), 1.26 (d, J=6.2 Hz, 6H), 1.24 (s, 12H), 0.79-0.73 (m, 2H) ppm. ¹³C NMR (151 MHz, CDCl₃): δ 205.30, 174.47, 83.44, 68.82, 55.58, 39.78, 31.85, 24.96, 21.88 ppm. ¹¹B NMR (128 MHz, CDCl₃): δ 33.61 ppm. MS (GCMS, EI): m/z=310 (1%), 295 (6%), 251 (32%), 210 (68%), 140 (100%), 124 (36%). TLC: R_{f}=0.47 (3:1 hexanes:ethyl acetate).

### 56. Compound 60

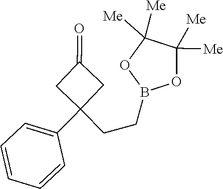 [SMILES: CC1(C)OB(CCC2(c3ccccc3)CC(=O)C2)OC1(C)C]

3-phenyl-3-(2-(4,4,5,5-tetramethyl-1,3,2-dioxaborolan-2-yl)ethyl)cyclobutan-1-one (60). A dry round-bottom flask charged with BrCH₂Cl (130 mg, 1.0 mmol) and SI-27 (166 mg, 0.50 mmol) was evacuated and filled with argon for three cycles. THE (1.5 mL) was added and the mixture was cooled to −78° C. n-BuLi (1.6 M in Hexanes, 0.63 mL, 1.0 mmol, 2.0 equiv.) was added dropwise to the mixture via syringe and the resulting solution was stirred at −78° C. for 0.5 h. The cooling bath was removed, and the mixture was stirred at room temperature for 12 h. To the mixture was added 2 M H₂SO₄ (2.0 mL). The suspension was stirred at room temperature for 2 h. Diethyl ether was added, the layers were separated, and the aqueous phase was extracted with diethyl ether. The combined organic layers were washed with water and brine, dried (MgSO₄), concentrated and purified by column chromatography (hexanes:ethyl acetate, 10:1) on silica gel to give 125 mg (83%) of the boronic esters 60. Physical State: colorless oil. ¹H NMR (600 MHz, CDCl₃): δ 7.36-7.30 (m, 2H), 7.26-7.18 (m, 3H), 3.40-3.31 (m, 2H), 3.18-3.10 (m, 2H), 1.95-1.88 (m, 2H), 1.18 (s, 12H), 0.64-0.54 (m, 2H) ppm. ¹³C NMR (151 MHz, CDCl₃): δ 207.04, 145.95, 128.35, 127.10, 126.33, 83.27, 57.27, 39.04, 37.56, 24.93 ppm. ¹¹B NMR (128 MHz, CDCl₃): δ 33.76 ppm. MS (GCMS, EI): m/z=300 (1%), 285 (4%), 258 (68%), 158 (100%), 117 (58%). TLC: R_{f}=0.36 (5:1 hexanes ethyl acetate).

### 57. Compound 64

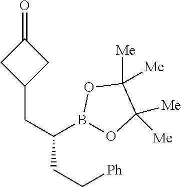 [SMILES: CC1(C)OB([C@H](CCc2ccccc2)CC2CC(=O)C2)OC1(C)C]

(R)-3-(4-phenyl-2-(4,4,5,5-tetramethyl-1,3,2-dioxaborolan-2-yl)butyl)cyclobutan-1-one (64) (Larouche-Gauthier et al., 2011). To a solution of SI-28 (343 mg, 1.3 mmol) and (−)-sparteine (352 mg, 1.5 mmol) in Et₂O (5 mL) at −78° C. was added sBuLi (1.4 M in cyclohexane, 1.07 mL, 1.5 mmol) dropwise. The resulting mixture was stirred for 5 hours at −78° C. before SI-26 (256 mg, 1.0 mmol, 1 M in diethyl ether) was added. The reaction mixture was further stirred at −78° C. for 1 hour, allowed to warm to room temperature. The reaction mixture was refluxed for 16 hours, then was allowed to cool down to room temperature and was carefully quenched with water. Diethyl ether was added, the layers were separated, and the aqueous phase was extracted with diethyl ether. The combined organic layers were concentrated, and the residue was dissolved in THE (5 mL). To the mixture was added 2 M H₂SO₄ (2 mL). The suspension was stirred at room temperature for 2 h. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 20:1) on silica gel to obtain 125 mg (29%) of the boronic esters 64. Physical State: colorless oil. ¹H NMR (600 MHz, CDCl₃): δ 7.22-7.17 (m, 2H), 7.12-7.07 (m, 3H), 3.05-2.97 (m, 2H), 2.66-2.44 (m, 4H), 2.37-2.28 (m, ¹H), 1.81-1.66 (m, 2H), 1.66-1.51 (m, 2H), 1.19 (s, 12H), 0.98 (tt, J=8.9, 5.9 Hz, ¹H) ppm. ¹³C NMR (151 MHz, CDCl₃): δ 208.70, 142.69, 128.43, 128.39, 125.80, 83.30, 52.94, 52.75, 37.97, 35.50, 33.45, 25.00, 24.95, 23.60 ppm. ¹¹B NMR (128 MHz, CDCl₃): δ 34.13 ppm. [α]_{D}²⁰=+1.4 (c=0.43, CHCl₃). MS (GCMS, EI): m/z=328 (2%), 313 (8%), 224 (36%), 158 (36%), 101 (100%). TLC: R_{f}=0.35 (5:1 hexanes:ethyl acetate). Chiral HPLC: The product was oxidized, and the corresponding alcohol 64-ol was used for HPLC analysis.

To a solution of 64 (32.8 mg, 0.1 mmol) and NaOAc (16.4 mg, 0.2 mmol) in THE (1.0 mL) at 0° C. was added H₂O₂ (35 wt. % in water, 0.1 mL) dropwise. The resulting mixture was stirred at 0° C. for 1.5 h. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 3:1) on silica gel to obtain 10.0 mg (46%) of the alcohol 64-ol. Physical State: colorless oil. ¹H NMR (600 MHz, CDCl₃): δ 7.32-7.28 (m, 2H), 7.23-7.18 (m, 3H), 3.67 (tt, J=8.3, 4.1 Hz, ¹H), 3.25-3.08 (m, 2H), 2.85-2.66 (m, 4H), 2.65-2.52 (m, ¹H), 1.88-1.77 (m, 3H), 1.73 (ddd, J=14.0, 8.5, 3.9 Hz, ¹H) ppm. ¹³C NMR (151 MHz, CDCl₃): δ 208.30, 141.76, 128.67, 128.49, 126.17, 70.73, 53.13, 52.80, 43.83, 39.53, 32.13, 21.03 ppm. TLC: R_{f}=0.40 (1:1 hexanes:ethyl acetate). LC-MS (ESI, m/z): calcd [M+Na]⁺: 241.3, found: 241.3. [α]_{D}²⁰=−6.7 (c=0.14, CHCl₃). Chiral HPLC: Chiralcel-OD-H column (25 cm) with guard, 10.0% isopropanol in hexane, 0.8 mL/min, ambient temperature, 220 nm: t_{R}=27.340 min (minor, (R)), t_{R}=32.352 min (major, (S)), 97.5: 2.5 e.r.

### 58. Compound 66

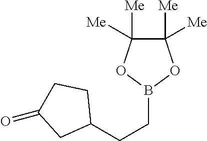 [SMILES: CC1(C)OB(CCC2CCC(=O)C2)OC1(C)C]

3-(2-(4,4,5,5-tetramethyl-1,3,2-dioxaborolan-2-yl)ethyl)cyclopentan-1-one (66) (Yamamoto et al., 2004). A dry round-bottom flask was charged with [Ir(cod)Cl]₂ (13 mg, 0.02 mmol) and 1,2-bis(diphenylphosphino)ethane (16 mg, 0.04 mmol). The flask was evacuated and backfilled with nitrogen 3 times and methylene chloride (2 mL) was added. After all solids had dissolved, pinacolborane HBpin (179.0 mg, 1.4 mmol) and the SI-29 (110 mg, 1.0 mmol) were added sequentially via syringe. The reaction was stirred at room temperature and monitored by thin layer chromatography. The reaction was then open to air and methanol (1 mL MeOH/mmol HBPin) was added slowly. The mixture was stirred until gas evolution ceased, then concentrated in vacuo and the product purified by chromatography (hexanes:ethyl acetate, 10:1) on silica gel to afford 162 mg (68%) of the product 66. Physical State: colorless oil. ¹H NMR (600 MHz, CDCl₃): δ 2.34-2.25 (m, ¹H), 2.23-2.16 (m, ¹H), 2.12-1.96 (m, 3H), 1.71 (ddd, J=18.1, 9.8, 1.5 Hz, ¹H), 1.47 (td, J=8.1, 6.8 Hz, 2H), 1.44-1.36 (m, ¹H), 1.16 (s, 12H), 0.80-0.67 (m, 2H) ppm. ¹³C NMR (151 MHz, CDCl₃): δ 219.87, 83.02, 45.02, 39.39, 38.53, 29.66, 29.08, 24.79 ppm. ¹¹B NMR (128 MHz, CDCl₃): δ 33.80 ppm. MS (GCMS, EI): m/z=238 (14%), 223 (8%), 180 (100%), 165 (80%), 139 (68%). TLC: R_{f}=0.29 (5:1 hexanes:ethyl acetate).

### 59. Compound 67

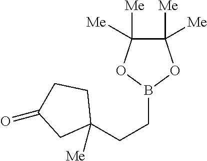 [SMILES: CC1(CCB2OC(C)(C)C(C)(C)O2)CCC(=O)C1]

3-(2-(4,4,5,5-tetramethyl-1,3,2-dioxaborolan-2-yl)ethyl)cyclopentan-1-one (67) (Yamamoto et al., 2004). A dry round-bottom flask was charged with [Ir(cod)Cl]₂ (13 mg, 0.02 mmol) and 1,2-bis(diphenylphosphino)ethane (16 mg, 0.04 mmol). The flask was evacuated and backfilled with nitrogen 3 times and methylene chloride (2 mL) was added. After all solids had dissolved, pinacolborane HBpin (179.0 mg, 1.4 mmol) and the SI-30 (124 mg, 1.0 mmol) were added sequentially via syringe. The reaction was stirred at room temperature and monitored by thin layer chromatography. The reaction was then open to air and methanol (1 mL MeOH/1 mmol HBPin) was added slowly. The mixture was stirred until gas evolution ceased, then concentrated in vacuo and the product purified by chromatography (hexanes:ethyl acetate=10:1) on silica gel to afford 156 mg (62%) of the product 67. Physical State: colorless oil. ¹H NMR (600 MHz, CDCl₃): δ 2.28 (dd, J=8.6, 7.1 Hz, 2H), 2.08 (d, J=17.9 Hz, ¹H), 1.99 (dd, J=17.8, 1.4 Hz, ¹H), 1.80 (dt, J=13.0, 8.7 Hz, ¹H), 1.72 (dt, J=12.9, 7.2, 1.4 Hz, ¹H), 1.57-1.46 (m, 2H), 1.24 (s, 12H), 1.02 (s, 3H), 0.81-0.65 (m, 2H) ppm. ¹³C NMR (151 MHz, CDCl₃): δ 220.48, 83.27, 52.03, 40.41, 37.06, 35.49, 34.74, 24.96, 24.67 ppm. ¹¹B NMR (128 MHz, CDCl₃): δ 34.20 ppm. MS (GCMS, EI): m/z=252 (1%), 237 (10%), 194 (99%), 179 (60%), 137 (30%), 109 (100%). TLC: R_{f}=0.29 (5:1 hexanes:ethyl acetate).

### 60. Compound 70

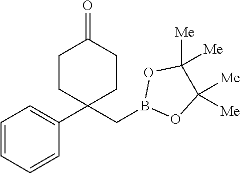 [SMILES: CC1(C)OB(CC2(c3ccccc3)CCC(=O)CC2)OC1(C)C]

4-phenyl-4-((4,4,5,5-tetramethyl-1,3,2-dioxaborolan-2-yl)methyl)cyclohexan-1-one (70) (Yang et al. 2012). To a solution of SI-31 (246 mg, 1.0 mmol) in methanol (2 mL) was added p-toluenesulfonyl hydrazide (223 g, 1.2 mmol), and the resultant mixture was stirred at room temperature for 2 h. The resulted white suspension was filtered and washed with cold methanol. The white solid was dried under high vacuum to afford the tosylsulfonyl hydrazone as a white solid (353 mg, 85%) without further purification.

A dry round-bottom flask charged with crude tosylsulfonyl hydrazone (208 mg, 0.5 mmol), 60% NaH (1.2 mmol, 24 mg) was degassed and filled with argon for three times. Toluene (4 mL) was added, and the reaction mixture was stirred at room temperature for 1 h. A solution of HBpin (192 mg, 1.5 mmol) in toluene (2 mL) was added via syringe. Then the tube was sealed and heated at 100° C. for 12 h. After cooling to room temperature, the suspension was filtered by Celite, and washed by acetonitrile (5 mL). The filtrate was transferred to a round-bottom flask, and 2 M H₂SO₄ (2 mL) was added. The mixture was stirred at room temperature for 3 h, then diethyl ether (5 mL) was added. The organic layer was separated, and the aqueous layer was extracted with diethyl ether (3 mL) twice. The combined organic solution was washed with saturated brine (5 mL) and dried over anhydrous Na₂SO₄. The mixture was filtered and concentrated, and the residue was purified by chromatography (hexanes:ethyl acetate, 20:1) on silica gel to afford 86 mg (55%) of the borated product 70. Physical State: colorless oil. ¹H NMR (600 MHz, CDCl₃): δ 7.48-7.44 (m, 2H), 7.37-7.32 (m, 2H), 7.23-7.18 (m, ¹H), 2.66-2.58 (m, 2H), 2.45-2.26 (m, 4H), 2.15-2.04 (m, 2H), 1.22 (s, 2H), 1.06 (s, 12H) ppm. ¹³C NMR (151 MHz, CDCl₃): δ 212.41, 145.45, 128.70, 126.34, 126.21, 83.08, 39.34, 38.68, 37.57, 24.87 ppm. ¹¹B NMR (128 MHz, CDCl₃): δ 32.48 ppm. MS (GCMS, EI): m/z=314 (8%), 285 (16%), 256 (8%), 170 (100%), 157 (28%), 129 (30%). TLC: R_{f}=0.29 (5:1 hexanes:ethyl acetate).

### 61. Compound 72

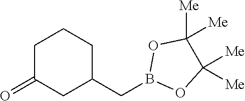 [SMILES: CC1(C)OB(CC2CCCC(=O)C2)OC1(C)C]

3-((4,4,5,5-tetramethyl-1,3,2-dioxaborolan-2-yl)methyl)cyclohexan-1-one (K-32) (Kisan et al., 2017). A screw-capped culture tube charged with SI-32 (154 mg, 1.0 mmol) and [Ru(p-cymene)Cl₂]₂ (0.0005 mmol, 0.05 mol %) was evacuated and backfill with argon for three times. Pinacolborane HBpin (128 mg, 1.0 mmol) was added to the tube by syringe, and the mixture was stirred at room temperature for 1 hour. The resulted mixture was diluted with acetonitrile (5 mL), followed by addition of 2M H₂SO₄ (2 mL). The suspended solution was stirred at room temperature for 3 h, then diethyl ether was added. The solution was separated and the aqueous layer was extracted with diethyl ether. The combined organic solution was washed with saturated brine and dried over anhydrous Na₂SO₄. The solution was filtered and concentrated, and the residue was purified by chromatography (hexanes:ethyl acetate, 10:1) on silica gel to afford 162 mg (68%) of the boronate product 72. Physical State: colorless oil. ¹H NMR (600 MHz, CDCl₃): δ 2.34-2.26 (m, ¹H), 2.23-2.16 (m, ¹H), 2.10 (dddd, J=14.0, 12.6, 6.2, 1.1 Hz, ¹H), 1.97-1.84 (m, 3H), 1.81-1.74 (m, ¹H), 1.53 (dddd, J=17.6, 13.4, 8.8, 4.8 Hz, ¹H), 1.30-1.20 (m, ¹H), 1.12 (s, 12H), 0.74 (qd, J=15.7, 6.6 Hz, 2H) ppm. ¹³C NMR (151 MHz, CDCl₃): δ 211.61, 83.02, 50.13, 41.00, 35.29, 33.64, 25.19, 24.73 ppm. ¹¹B NMR (128 MHz, CDCl₃): δ 33.12 ppm. MS (GCMS, EI): m/z=238 (14%), 223 (6%), 195 (8%), 180 (100%), 165 (20%). TLC: R_{f}=0.29 (5:1 hexanes:ethyl acetate).

### 62. Compound 74

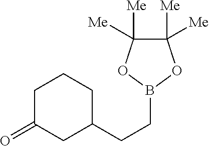 [SMILES: CC1(C)OB(CCC2CCCC(=O)C2)OC1(C)C]

3-(2-(4,4,5,5-tetramethyl-1,3,2-dioxaborolan-2-yl)ethyl)cyclohexan-1-one (74) (Yamamoto et al., 2004). A dry round-bottom flask was charged with [Ir(cod)Cl]₂ (13 mg, 0.02 mmol) and 1,2-bis(diphenylphosphino)ethane (16 mg, 0.04 mmol). The flask was evacuated and backfilled with nitrogen (3×) and dichloromethane (2 mL) was added. After all solids had dissolved, pinacolborane HBpin (179.0 mg, 1.4 mmol) and the SI-33 (124.0 mg, 1.0 mmol) were added sequentially via syringe. The reaction was stirred at room temperature and monitored by thin layer chromatography. The reaction was then open to air and methanol (1 mL MeOH/mmol HBPin) was added slowly. The mixture was stirred until gas evolution ceased, then concentrated in vacuo and the product purified by chromatography (hexanes:ethyl acetate, 10:1) on silica gel to afford 171 mg (68%) of the product 74. Physical State: colorless oil. ¹H NMR (600 MHz, CDCl₃): δ 2.36-2.30 (m, ¹H), 2.26-2.21 (m, ¹H), 2.15 (dddd, J=14.0, 12.5, 6.1, 1.3 Hz, ¹H), 1.98-1.92 (m, ¹H), 1.89 (ddd, J=13.6, 11.9, 1.3 Hz, ¹H), 1.86-1.79 (m, ¹H), 1.66-1.47 (m, 2H), 1.41-1.29 (m, 2H), 1.26-1.17 (m, ¹H), 1.15 (s, 12H), 0.68 (t, J=8.3 Hz, 2H) ppm. ¹³C NMR (151 MHz, CDCl₃): δ 212.01, 82.99, 47.89, 41.47, 41.16, 30.79, 30.68, 25.25, 24.77 ppm. ¹¹B NMR (128 MHz, CDCl₃): δ 33.52 ppm. MS (GCMS, EI): m/z=252 (14%), 237 (8%), 194 (100%), 153 (38%), 136 (60%). TLC: R_{f}=0.29 (5:1 hexanes:ethyl acetate).

### 63. Compound 76

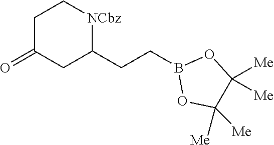 [SMILES: CC1(C)OB(CCC2CC(=O)CCN2C(=O)OCc2ccccc2)OC1(C)C]

benzyl 4-oxo-2-(2-(4,4,5,5-tetramethyl-1,3,2-dioxaborolan-2-yl)ethyl)piperidine-1-carboxylate (76) (Yamamoto et al., 2004). A dry round-bottom flask was charged with [Ir(cod)Cl]₂ (13 mg, 0.02 mmol) and 1,2-bis(diphenylphosphino)ethane (16 mg, 0.04 mmol). The flask was evacuated and backfilled with nitrogen (3 times) and dichloromethane (2 mL) was added. After all solids had dissolved, pinacolborane HBpin (179.0 mg, 1.4 mmol) and the SI-34 (259.0 mg, 1.0 mmol) were added sequentially via syringe. The reaction was stirred at room temperature and monitored by thin layer chromatography. The reaction was then open to air and methanol (1 mL MeOH/mmol HBPin) was added slowly. The mixture was stirred until gas evolution ceased, then concentrated in vacuo and the product purified by chromatography (hexanes:ethyl acetate, 10:1) on silica gel to afford 242 mg (63%) of the product 76. Physical State: colorless oil. ¹H NMR (600 MHz, CDCl₃): δ 7.37-7.29 (m, 5H), 5.22-5.08 (m, 2H), 4.58 (d, J=64.1 Hz, ¹H), 4.36 (d, J=68.4 Hz, ¹H), 3.33-3.16 (m, ¹H), 2.68-2.55 (m, ¹H), 2.44 (s, ¹H), 2.31 (s, 2H), 1.69-1.48 (m, 2H), 1.20 (s, 12H), 0.71 (t, J=8.0 Hz, 2H) ppm. ¹³C NMR (151 MHz, CDCl₃): δ 207.79, 136.51, 128.64, 128.22, 128.02, 83.28, 67.63, 54.17 (br.), 45.54 (br.), 40.70 (br.), 38.39, 26.77, 24.92, 24.89 ppm. ¹¹B NMR (128 MHz, CDCl₃): δ 33.65 ppm. MS (GCMS, EI): m/z=387 (0.5%), 252 (66%), 188 (78%), 136 (100%), 110 (12%). TLC: R_{f}=0.50 (2:1 hexanes:acetone).

### F. Experimental Procedures and Characterization Data of Substrates Compound 16

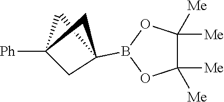 [SMILES: CC1(C)OB([C@]23C[C@](c4ccccc4)(C2)C3)OC1(C)C]

4,4,5,5-tetramethyl-2-(3-phenylbicyclo[1.1.1]pentan-1-yl)-1,3,2-dioxaborolane (16). Following General Procedure B on 0.10 mmol scale with K-1. Purification by chromatography (hexanes:methylene chloride, 2:1) on silica gel afforded 18.6 mg (69%) of the title compound 16. Physical State: colorless oil. ¹H NMR (400 MHz, CDCl₃): δ 7.32-7.18 (m, 5H), 2.18 (s, 6H), 1.28 (s, 12H) ppm. ¹³C NMR (151 MHz, CDCl₃): δ 142.25, 128.21, 126.48, 125.83, 83.53, 53.15, 47.50, 24.92 ppm. ¹¹B NMR (128 MHz, CDCl₃): δ 30.66 ppm. MS (GCMS, EI): m/z=270 (2%), 255 (3%), 169 (24%), 142 (100%), 129 (34%), 103 (24%). TLC: R_{f}=0.50 (10:1 hexanes:ethyl acetate).

### Compound 17

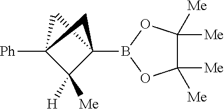 [SMILES: C[C@@H]1[C@]2(B3OC(C)(C)C(C)(C)O3)C[C@@]1(c1ccccc1)C2]

4,4,5,5-tetramethyl-2-(2-methyl-3-phenylbicyclo[1.1.1]pentan-1-yl)-1,3,2-dioxa-borolane (17). Following General Procedure B on 0.10 mmol scale with K-2. Purification by chromatography (hexanes:methylene chloride, 2:1) on silica gel afforded 22.2 mg (78%) of the title compound 17. Physical State: colorless crystal. m.p.: 61-63° C. ¹H NMR (600 MHz, CDCl₃): δ 7.29 (t, J=7.5 Hz, 2H), 7.20 (t, J=7.4 Hz, ¹H), 7.17-7.12 (m, 2H), 2.69 (dd, J=9.8, 2.9 Hz, ¹H), 2.58 (p, J=6.4 Hz, ¹H), 2.11 (d, J=1.6 Hz, ¹H), 2.08 (dd, J=6.4, 2.9 Hz, ¹H), 2.01 (dd, J=9.8, 1.5 Hz, ¹H), 1.26 (s, 12H), 1.22 (d, J=6.3 Hz, 3H) ppm. ¹³C NMR (151 MHz, CDCl₃): δ 141.22, 128.20, 126.38, 126.11, 83.36, 59.31, 53.01, 49.87, 46.54, 24.93, 24.90, 10.93 ppm. ¹¹B NMR (128 MHz, CDCl₃): δ 30.36 ppm. MS (GCMS, EI): m/z=284 (5%), 269 (4%), 184 (26%), 156 (100%), 141 (22%), 128 (22%). TLC: R_{f}=0.51 (10:1 hexanes:ethyl acetate).

### Compound 18

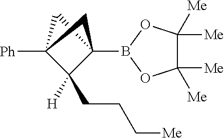 [SMILES: CCCC[C@@H]1[C@]2(B3OC(C)(C)C(C)(C)O3)C[C@@]1(c1ccccc1)C2]

2-(2-butyl-3-phenylbicyclo[1.1.1]pentan-1-yl)-4,4,5,5-tetramethyl-1,3,2-dioxaborolane (18). Following General Procedure B on 0.10 mmol scale with K-3. Purification by chromatography (hexanes:methylene chloride, 2:1) on silica gel afforded 29.0 mg (89%) of the title compound 18. Physical State: colorless oil. ¹H NMR (600 MHz, CDCl₃): δ 7.28 (t, J=7.5 Hz, 2H), 7.22-7.16 (m, ¹H), 7.16-7.12 (m, 2H), 2.69 (dd, J=9.7, 2.8 Hz, ¹H), 2.50 (dt, J=8.7, 5.8 Hz, ¹H), 2.06-2.03 (m, 2H), 2.01 (dd, J=9.7, 1.5 Hz, ¹H), 1.71 (ddt, J=18.3, 9.1, 4.8 Hz, ¹H), 1.54 (ddt, J=14.4, 9.4, 5.1 Hz, ¹H), 1.26 (s, 12H), 1.35-1.22 (m, 4H), 0.85 (t, J=7.0 Hz, 3H) ppm. ¹³C NMR (151 MHz, CDCl₃): δ 141.36, 128.14, 126.33, 126.15, 83.40, 66.24, 52.76, 49.88, 46.18, 31.17, 25.82, 24.93, 24.89, 23.12, 14.24 ppm. ¹¹B NMR (128 MHz, CDCl₃): δ 30.50 ppm. MS (GCMS, EI): m/z=326 (34%), 269 (64%), 198 (90%), 169 (76%), 118 (80%), 101 (100%). TLC: R_{f}=0.57 (10:1 hexanes:ethyl acetate).

### Compound 19

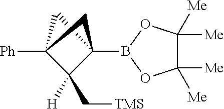 [SMILES: CC1(C)OB([C@]23C[C@](c4ccccc4)(C2)[C@@H]3C[Si](C)(C)C)OC1(C)C]

trimethyl((1-phenyl-3-(4,4,5,5-tetramethyl-1,3,2-dioxaborolan-2-yl)bicyclo[1.1.1]pentan-2-yl)methyl)silane (19). Following General Procedure B on 0.10 mmol scale with K-4. Purification by chromatography (hexanes:methylene chloride, 2:1) on silica gel afforded 29.2 mg (89%) of the title compound 19. Physical State: colorless crystal. m.p.: 35-37° C. ¹H NMR (600 MHz, CDCl₃): δ 7.28 (t, J=7.5 Hz, 2H), 7.20-7.17 (m, ¹H), 7.14-7.09 (m, 2H), 2.73 (dd, J=10.2, 2.7 Hz, ¹H), 2.57 (q, J=6.3 Hz, ¹H), 2.08-2.01 (m, 3H), 1.26 (s, 12H), 0.95-0.83 (m, 2H), -0.11 (s, 9H) ppm. ¹³C NMR (151 MHz, CDCl₃): δ 141.13, 128.10, 126.36, 126.29, 83.37, 61.73, 52.51, 50.74, 45.45, 25.07, 25.05, 13.48, -1.02 ppm. ¹¹B NMR (128 MHz, CDCl₃): δ 30.59 ppm. MS (GCMS, EI): m/z=356 (4%), 299 (12%), 282 (26%), 214 (46%), 156 (42%), 101 (100%). TLC: R_{f}=0.58 (10:1 hexanes:ethyl acetate).

### Compound 14

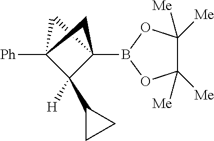 [SMILES: CC1(C)OB([C@]23C[C@](c4ccccc4)(C2)[C@@H]3C2CC2)OC1(C)C]

2-(2-cyclopropyl-3-phenylbicyclo[1.1.1]pentan-1-yl)-4,4,5,5-tetramethyl-1,3,2-dioxaborolane (14). Following General Procedure B on 0.10 mmol scale with K-5. Purification by chromatography (hexanes:methylene chloride, 2:1) on silica gel afforded 25.7 mg (89%) of the title compound 19. Physical State: colorless oil. ¹H NMR (400 MHz, CDCl₃): δ 7.35-7.17 (m, 5H), 2.85 (dd, J=9.8, 2.7 Hz, ¹H), 2.13 (dd, J=6.6, 2.7 Hz, ¹H), 2.07 (d, J=1.6 Hz, ¹H), 1.93 (dd, J=9.7, 1.7 Hz, ¹H), 1.85 (dd, J=8.4, 6.7 Hz, ¹H), 1.29 (s, 12H), 1.24-1.09 (m, ¹H), 0.57-0.43 (m, 2H), 0.27-0.16 (m, 2H) ppm. ¹³C NMR (101 MHz, CDCl₃): δ 141.40, 128.11, 126.33, 126.27, 83.37, 70.77, 52.25, 50.95, 47.79, 24.86, 24.84, 7.58, 4.94, 3.87 ppm. ¹¹B NMR (128 MHz, CDCl₃): δ 30.46 ppm. MS (GCMS, EI): m/z=310 (54%), 268 (18%), 225 (18%), 182 (100%), 167 (66%), 118 (39%). TLC: R_{f}=0.50 (10:1 hexanes:ethyl acetate).

### Compound 20

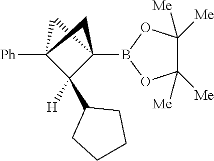 [SMILES: CC1(C)OB([C@]23C[C@](c4ccccc4)(C2)[C@@H]3C2CCCC2)OC1(C)C]

2-(-2-cyclopentyl-3-phenylbicyclo[1.1.1]pentan-1-yl)-4,4,5,5-tetramethyl-1,3,2-dioxaborolane (20). Following General Procedure B on 3.7 mmol scale with K-6. Purification by chromatography (hexanes:methylene chloride, 2:1) on silica gel afforded 1.1 g (89%) of the title compound 20. Physical State: colorless crystal. m.p.: 41-43° C. ¹H NMR (600 MHz, CDCl₃): δ 7.28-7.24 (m, 2H), 7.20-7.12 (m, 3H), 2.74 (dd, J=9.8, 2.8 Hz, ¹H), 2.33 (dd, J=9.9, 6.1 Hz, ¹H), 2.31-2.24 (m, ¹H), 2.03 (dd, J=10.9, 2.1 Hz, ¹H), 2.01 (d, J=2.8 Hz, ¹H), 1.97 (d, J=1.3 Hz, ¹H), 1.80 (ddt, J=14.5, 7.2, 3.9 Hz, ¹H), 1.62-1.36 (m, 5H), 1.263 (s, 6H), 1.260 (s, 6H), 1.22-1.15 (m, ¹H), 0.88 (tdd, J=11.0, 6.7, 3.1 Hz, ¹H) ppm. 13C NMR (151 MHz, CDCl₃): δ 141.72, 128.03, 126.20, 83.42, 73.38, 52.80, 50.10, 45.43, 37.04, 32.69, 32.21, 25.81, 25.21, 24.98, 24.88 ppm. ¹¹B NMR (128 MHz, CDCl₃): δ 30.03 ppm. MS (GCMS, EI): m/z=338 (16%), 323 (20%), 269 (18%), 210 (38%), 169 (40%), 105 (100%). TLC: R_{f}=0.62 (10:1 hexanes:ethyl acetate).

### Compound 21

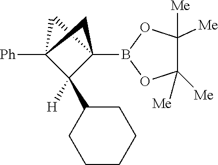 [SMILES: CC1(C)OB([C@]23C[C@](c4ccccc4)(C2)[C@@H]3C2CCCCC2)OC1(C)C]

2-(2-cyclohexyl-3-phenylbicyclo[1.1.1]pentan-1-yl)-4,4,5,5-tetramethyl-1,3,2-dioxaborolane (21). Following General Procedure B on 0.1 mmol scale with K-7. Purification by chromatography (hexanes:methylene chloride, 2:1) on silica gel afforded 29.2 mg (83%) of the title compound 21. Physical State: colorless oil. ¹H NMR (600 MHz, CDCl₃): δ 7.28-7.24 (m, 2H), 7.19-7.13 (m, 3H), 2.68 (dd, J=9.7, 2.8 Hz, ¹H), 2.28 (dd, J=9.4, 6.5 Hz, ¹H), 2.01 (dd, J=6.5, 2.8 Hz, ¹H), 1.99 (dd, J=9.7, 1.5 Hz, ¹H), 1.91 (d, J=1.5 Hz, ¹H), 1.84-1.74 (m, ¹H), 1.68 (d, J=10.7 Hz, 2H), 1.60-1.55 (m, ¹H), 1.52-1.47 (m, ¹H), 1.30-1.20 (m, 2H), 1.26 (s, 12H), 1.10-1.04 (m, 2H), 1.02-0.96 (m, ¹H), 0.80-0.70 (m, ¹H) ppm. 13C NMR (151 MHz, CDCl₃): δ 142.04, 128.05, 126.18, 126.12, 83.42, 73.10, 52.45, 49.97, 45.20, 34.98, 32.52, 32.41, 26.47, 26.27, 26.07, 24.93, 24.81 ppm. ¹¹B NMR (128 MHz, CDCl₃): δ 30.38 ppm. MS (GCMS, EI): m/z=352 (20%), 269 (100%), 224 (46%), 169 (52%), 118 (90%). TLC: R_{f}=0.62 (10:1 hexanes:ethyl acetate).

### Compound 22

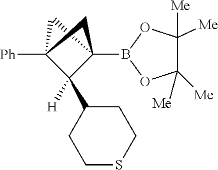 [SMILES: CC1(C)OB([C@]23C[C@](c4ccccc4)(C2)[C@@H]3C2CCSCC2)OC1(C)C]

4,4,5,5-tetramethyl-2-(3-phenyl-2-(tetrahydro-2H-thiopyran-4-yl)bicyclo[1.1.1]pentan-1-yl)-1,3,2-dioxaborolane (22). Following General Procedure B on 0.03 mmol scale with K-8. Purification by chromatography (hexanes:methylene chloride, 2:1) on silica gel afforded 9.7 mg (89%) of the title compound 22. Physical State: colorless oil. ¹H NMR (600 MHz, CDCl₃): δ 7.28-7.24 (m, 2H), 7.20-7.15 (m, ¹H), 7.14-7.11 (m, 2H), 2.69 (ddd, J=14.7, 12.3, 2.7 Hz, ¹H), 2.64 (dd, J=9.7, 3.0 Hz, ¹H), 2.57 (dtd, J=13.5, 3.8, 2.0 Hz, ¹H), 2.53-2.47 (m, ¹H), 2.37 (dtd, J=13.6, 3.8, 2.1 Hz, ¹H), 2.31 (dd, J=9.5, 6.3 Hz, ¹H), 2.03 (dd, J=6.4, 3.0 Hz, ¹H), 2.01-1.97 (m, 2H), 1.92 (d, J=1.8 Hz, ¹H), 1.88-1.80 (m, ¹H), 1.55-1.51 (m, ¹H), 1.42 (dtd, J=13.2, 11.8, 3.5 Hz, ¹H), 1.25 (s, 12H), 1.19-1.16 (m, ¹H) ppm. 13C NMR (151 MHz, CDCl₃): δ 141.57, 128.21, 126.43, 126.03, 83.57, 72.10, 52.31, 49.94, 45.17, 34.68, 33.08, 33.02, 28.52, 28.40, 24.94, 24.81 ppm. ¹¹B NMR (128 MHz, CDCl₃): δ 30.70 ppm. MS (GCMS, EI): m/z=370 (44%), 253 (58%), 225 (28%), 165 (48%), 105 (100%). TLC: R_{f}=0.44 (10:1 hexanes:ethyl acetate).

### Compound 23

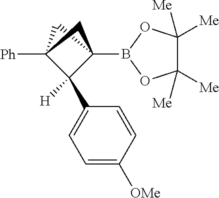 [SMILES: COc1ccc([C@@H]2[C@]3(B4OC(C)(C)C(C)(C)O4)C[C@@]2(c2ccccc2)C3)cc1]

2-(2-(4-methoxyphenyl)-3-phenylbicyclo[1.1.1]pentan-1-yl)-4,4,5,5-tetramethyl-1,3,2-dioxaborolane (23). Following General Procedure B on 0.1 mmol scale with K-12. Purification by chromatography (hexanes:methylene chloride, 2:1) on silica gel afforded 18.0 mg (48%) of the title compound 23. Physical State: colorless crystal. m.p.: 68-70° C. ¹H NMR (600 MHz, CDCl₃): δ 7.29 (t, J=7.4 Hz, 2H), 7.24-7.20 (m, ¹H), 7.17-7.12 (m, 2H), 7.02 (d, J=8.4 Hz, 2H), 6.78-6.72 (m, 2H), 3.76 (s, 3H), 3.74 (d, J=6.7 Hz, ¹H), 2.58 (dd, J=9.8, 2.7 Hz, ¹H), 2.24 (dd, J=9.7, 1.6 Hz, ¹H), 2.15 (dd, J=6.7, 2.6 Hz, ¹H), 2.11 (d, J=1.5 Hz, ¹H), 1.299 (s, 6H), 1.298 (s, 6H) ppm. ¹³C NMR (151 MHz, CDCl₃): δ 157.86, 140.91, 132.22, 129.89, 128.23, 126.54, 126.48, 113.29, 83.74, 66.59, 55.30, 52.27, 50.37, 46.95, 24.98, 24.95 ppm. ¹¹B NMR (128 MHz, CDCl₃): δ 31.05 ppm. MS (GCMS, EI): m/z=376 (42%), 258 (54%), 248 (100%), 173 (38%), 142 (46%), 115 (60%). TLC: R_{f}=0.47 (10:1 hexanes:ethyl acetate).

### Compound 24

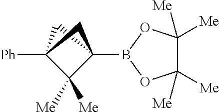

2-(2,2-dimethyl-3-phenylbicyclo[1.1.1]pentan-1-yl)-4,4,5,5-tetramethyl-1,3,2-dioxaborolane (24). Following General Procedure B on 0.05 mmol scale with K-21. Purification by chromatography (hexanes:methylene chloride, 2:1) on silica gel afforded 13.4 mg (90%) of the title compound 24. Physical State: yellow solid. m.p.: 46-48° C. ¹H NMR (600 MHz, CDCl₃): δ 7.31-7.27 (m, 2H), 7.20 (tt, J=6.7, 1.2 Hz, ¹H), 7.16-7.13 (m, 2H), 2.77 (s, 2H), 1.85 (s, 2H), 1.29 (s, 6H), 1.26 (s, 12H) ppm. ¹³C NMR (151 MHz, CDCl₃): δ 140.25, 128.15, 126.51, 126.43, 83.24, 61.61, 53.28, 47.76, 24.96, 19.45 ppm. ¹¹B NMR (128 MHz, CDCl₃): δ 30.92 ppm. MS (GCMS, EI): m/z=298 (12%), 197 (16%), 183 (36%), 170 (100%), 155 (24%). TLC: R_{f}=0.57 (10:1 hexanes:ethyl acetate).

### Compound 25

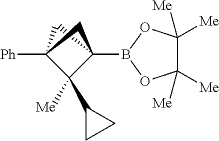 [SMILES: CC1(C)OB([C@]23C[C@](c4ccccc4)(C2)[C@]3(C)C2CC2)OC1(C)C]

2-((1R,2R,3S)-2-cyclopropyl-2-methyl-3-phenylbicyclo[1.1.1]pentan-1-yl)-4,4,5,5-tetramethyl-1,3,2-dioxaborolane (25). Following General Procedure B on 0.6 mmol scale with K-22. Purification by chromatography (hexanes:methylene chloride, 2:1) on silica gel afforded 138.2 mg (71%) of the title compound 25. Physical State: colorless oil. ¹H NMR (600 MHz, CDCl₃): δ 7.31-7.27 (m, 2H), 7.23-7.17 (m, 3H), 3.18 (dd, J=10.3, 2.3 Hz, ¹H), 2.68 (dd, J=10.4, 2.8 Hz, ¹H), 1.89 (d, J=2.3 Hz, ¹H), 1.80 (d, J=2.8 Hz, ¹H), 1.28 (s, 3H), 1.24 (s, 6H), 1.24 (s, 6H), 1.03 (tt, J=8.7, 5.7 Hz, ¹H), 0.67-0.60 (m, ¹H), 0.54-0.47 (m, ¹H), 0.42-0.35 (m, ¹H), 0.31-0.24 (m, ¹H) ppm. ¹³C^{NMR} (151 MHz, CDCl₃): δ 140.27, 128.13, 126.66, 126.42, 83.21, 64.27, 54.52, 47.56, 47.34, 24.92, 24.81, 16.38, 15.40, 6.97, 3.36 ppm. ¹¹B NMR (128 MHz, CDCl₃): δ 30.58 ppm. MS (GCMS, EI): m/z=324 (16%), 295 (8%), 196 (70%), 181 (52%), 101 (100%). TLC: R_{f}=0.60 (10:1 hexanes:ethyl acetate).

### Compound 25-ol

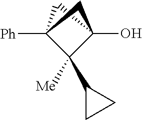 [SMILES: C[C@@]1(C2CC2)[C@]2(O)C[C@@]1(c1ccccc1)C2]

2-cyclopropyl-2-methyl-3-phenylbicyclo[1.1.1]pentan-1-ol (25-ol). To a solution of 25 (162 mg, 0.5 mmol) and NaOAc (82 mg, 1.0 mmol) in THE (5.0 mL) at 0° C. was added H₂O₂ (35 wt. % in water, 0.5 mL) dropwise. The resulting mixture was stirred at 0° C. for 1 h. Na₂S₂O₃ was added and the mixture was stirred at 0° C. for 10 min. Diethyl ether was added, the layers were separated and the aqueous phase was extracted with diethyl ether. The combined organic layers were washed with water and brine, dried over anhydrous MgSO₄, concentrated and purified by column chromatography (hexanes:ethyl acetate, 3:1) on silica gel to obtain 95.5 mg (89%) the alcohol 25-ol. Physical State: colorless crystal. m.p.: 49-51° C. ¹H NMR (600 MHz, CDCl₃): δ 7.33-7.19 (m, 5H), 3.30 (dd, J=10.4, 1.3 Hz, ¹H), 2.74 (dd, J=10.2, 2.1 Hz, ¹H), 2.65 (OH, br, ¹H), 2.05 (d, J=1.6 Hz, ¹H), 1.97 (d, J=2.3 Hz, ¹H), 1.21 (s, 3H), 1.14-1.05 (m, ¹H), 0.64-0.56 (m, 2H), 0.49-0.41 (m, ¹H), 0.34-0.27 (m, ¹H) ppm. ¹³C NMR (151 MHz, CDCl₃): δ 137.24, 128.21, 127.30, 126.54, 68.72, 64.13, 52.37, 51.29, 42.60, 13.36, 13.13, 4.96, 3.57 ppm. MS (GCMS, EI): m/z=214 (8%), 185 (4%), 145 (26%), 115 (100%). TLC: R_{f}=0.35 (4:1 hexanes:ethyl acetate).

### Compound 26

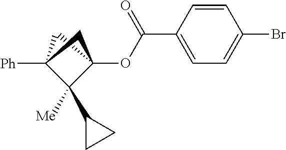 [SMILES: C[C@@]1(C2CC2)[C@]2(OC(=O)c3ccc(Br)cc3)C[C@@]1(c1ccccc1)C2]

2-cyclopropyl-2-methyl-3-phenylbicyclo[1.1.1]pentan-1-yl 4-bromobenzoate (26). To a solution of 25-ol (42.8 mg, 0.2 mmol) in methylene chloride (2.0 mL) was added 4-bromobenzoyl chloride (43.8 mg, 0.2 mmol), DMAP (4.8 mg, 0.04 mmol, 0.2 equiv.) and triethylamine (0.08 mL, 0.6 mmol, 3.0 equiv.) at room temperature. The resulting mixture was stirred at room temperature for 3 h, then concentrated and purified by column chromatography (hexanes:ethyl acetate, 20:1) on silica gel to obtain 80.0 mg (99%) the alcohol 26. Physical State: white solid. m.p.: 86-88° C. ¹H NMR (600 MHz, CDCl₃): δ 7.86 (d, J=8.2 Hz, 2H), 7.62-7.56 (m, 2H), 7.33 (t, J=7.4 Hz, 2H), 7.28-7.22 (m, 3H), 3.57-3.50 (m, ¹H), 3.11 (dd, J=10.1, 2.3 Hz, ¹H), 2.52 (s, ¹H), 2.48 (d, J=2.2 Hz, ¹H), 1.35 (s, 3H), 1.12 (tt, J=8.8, 5.8 Hz, ¹H), 0.71-0.59 (m, 2H), 0.53-0.45 (m, ¹H), 0.35-0.28 (m, ¹H) ppm. ¹³C NMR (151 MHz, CDCl₃): δ 165.31, 136.16, 131.88, 131.24, 129.45, 128.38, 128.28, 127.40, 126.94, 70.07, 66.34, 52.31, 51.12, 45.10, 14.52, 13.76, 6.00, 3.78 ppm. TLC: R_{f}=0.55 (20:1 hexanes:ethyl acetate).

### Compound 27

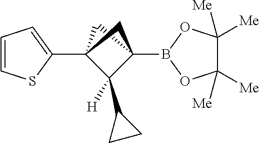 [SMILES: CC1(C)OB([C@]23C[C@](c4cccs4)(C2)[C@@H]3C2CC2)OC1(C)C]

2-(2-cyclopropyl-3-(thiophen-2-yl)bicyclo[1.1.1]pentan-1-yl)-4,4,5,5-tetramethyl-1,3,2-dioxaborolane (27). Following General Procedure B on 0.1 mmol scale with K-11. Purification by chromatography (hexanes:methylene chloride, 2:1) on silica gel afforded 16.4 mg (52%) of the title compound 27. Physical State: colorless crystal. m.p.: 48-50° C. ¹H NMR (600 MHz, CDCl₃): δ 7.22 (dd, J=4.8, 2.9 Hz, ¹H), 7.00 (d, J=2.8 Hz, ¹H), 6.98 (d, J=4.8 Hz, ¹H), 2.80 (dd, J=9.8, 2.7 Hz, ¹H), 2.09 (dd, J=6.6, 2.8 Hz, ¹H), 2.07 (d, J=1.5 Hz, ¹H), 1.87 (dd, J=9.8, 1.5 Hz, ¹H), 1.77 (dd, J=8.5, 6.7 Hz, ¹H), 1.26 (s, 12H), 1.21-1.13 (m, ¹H), 0.56-0.45 (m, 2H), 0.24-0.15 (m, 2H) ppm. ¹³C NMR (151 MHz, CDCl₃): δ 143.35, 126.76, 125.30, 120.45, 83.43, 71.19, 52.78, 49.26, 47.44, 24.88, 24.86, 7.57, 4.88, 3.88 ppm. ¹¹B NMR (128 MHz, CDCl₃): δ 30.80 ppm. MS (GCMS, EI): m/z=316 (88%), 287 (14%), 188 (66%), 124 (88%), 101 (100%). TLC: R_{f}=0.56 (10:1 hexanes:ethyl acetate).

### Compound 28

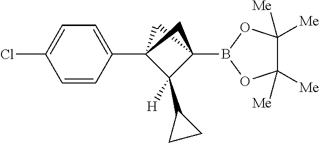 [SMILES: CC1(C)OB([C@]23C[C@](c4ccc(Cl)cc4)(C2)[C@@H]3C2CC2)OC1(C)C]

2-(3-(4-chlorophenyl)-2-cyclopropylbicyclo[1.1.1]pentan-1-yl)-4,4,5,5-tetramethyl-1,3,2-dioxaborolane (28). Following General Procedure B on 0.1 mmol scale with K-9. Purification by chromatography (hexanes:methylene chloride, 2:1) on silica gel afforded 9.7 mg (89%) of the title compound 28. Physical State: colorless oil. ¹H NMR (600 MHz, CDCl₃): δ 7.25-7.23 (m, 2H), 7.15-7.12 (m, 2H), 2.80 (dd, J=9.8, 2.7 Hz, ¹H), 2.07 (dd, J=6.7, 2.8 Hz, ¹H), 2.02 (d, J=1.6 Hz, ¹H), 1.88 (dd, J=9.8, 1.8 Hz, ¹H), 1.78 (dd, J=8.6, 6.7 Hz, ¹H), 1.26 (s, 12H), 1.17-1.08 (m, ¹H), 0.52-0.43 (m, 2H), 0.20 (ddd, J=9.1, 4.8, 1.5 Hz, ¹H), 0.12 (ddd, J=9.4, 4.8, 3.4 Hz, ¹H) ppm. ¹³C NMR (151 MHz, CDCl₃): δ 139.87, 132.17, 128.28, 127.77, 83.49, 70.95, 52.23, 50.37, 47.77, 24.89, 24.87, 7.46, 4.85, 3.82 ppm. ¹¹B NMR (128 MHz, CDCl₃): δ 30.76 ppm. MS (GCMS, EI): m/z=344 (8%), 309 (46%), 216 (28%), 181 (34%), 152 (34%), 101 (100%). TLC: R_{f}=0.53 (10:1 hexanes:ethyl acetate).

### Compound 29

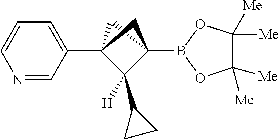 [SMILES: CC1(C)OB([C@]23C[C@](c4cccnc4)(C2)[C@@H]3C2CC2)OC1(C)C]

3-(2-cyclopropyl-3-(4,4,5,5-tetramethyl-1,3,2-dioxaborolan-2-yl)bicyclo[1.1.1]pentan-1-yl)pyridine (29). Following General Procedure B on 0.075 mmol scale with K-10. Purification by chromatography (hexanes:methylene chloride, 2:1) on silica gel afforded 12.6 mg (54%) of the title compound 29. Physical State: colorless crystal. m.p.: 128-130° C. ¹H NMR (600 MHz, CDCl₃): δ 8.49 (m, 2H), 7.69 (d, J=7.8 Hz, ¹H), 7.40-7.32 (m, ¹H), 2.87 (dd, J=9.8, 2.9 Hz, ¹H), 2.14 (dd, J=6.6, 2.9 Hz, ¹H), 2.10 (d, J=1.8 Hz, ¹H), 1.95 (dd, J=9.8, 1.8 Hz, ¹H), 1.82 (dd, J=8.7, 6.7 Hz, ¹H), 1.26 (s, 12H), 1.18-1.09 (m, ¹H), 0.55-0.46 (m, 2H), 0.25-0.18 (m, ¹H), 0.14-0.04 (m, ¹H) ppm. ¹³C NMR (151 MHz, CDCl₃): δ 145.77, 145.14, 136.47, 124.08, 83.65, 71.22, 52.02, 48.44, 47.95, 24.87, 24.85, 7.31, 4.81, 3.86 ppm. ¹¹B NMR (128 MHz, CDCl₃): δ 30.76 ppm. MS (GCMS, EI): m/z=311 (60%), 210 (50%), 170 (100%), 156 (82%), 104 (92%). TLC: R_{f}=0.33 (3:1 hexanes:acetone).

### Compound 30

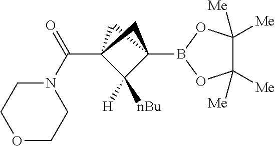

(2-butyl-3-(4,4,5,5-tetramethyl-1,3,2-dioxaborolan-2-yl)bicyclo[1.1.1]pentan-1-yl)(morpho-lino)methanone (30). Following General Procedure B on 0.1 mmol scale with K-19. Purification by chromatography (hexanes:methylene chloride, 2:1) on silica gel afforded 21.1 mg (58%) of the title compound 30. Physical State: colorless crystal. m.p.: 50-52° C. ¹H NMR (600 MHz, CDCl₃): δ 3.67-3.48 (m, 8H), 2.69 (dd, J=9.8, 3.2 Hz, ¹H), 2.58 (q, J=6.6 Hz, ¹H), 2.14 (d, J=1.9 Hz, ¹H), 2.10 (dd, J=6.4, 3.3 Hz, ¹H), 2.03 (dd, J=9.8, 1.9 Hz, ¹H), 1.66 (tt, J=14.4, 6.7 Hz, 2H), 1.34-1.27 (m, 4H), 1.21 (s, 12H), 0.88 (t, J=7.0 Hz, 3H) ppm. 13C NMR (151 MHz, CDCl₃): δ 168.17, 83.60, 67.06, 67.03, 66.83, 53.66, 47.71, 47.57, 45.84, 42.19, 31.00, 26.14, 24.97, 24.87, 24.85, 23.04, 14.23 ppm. ¹¹B NMR (128 MHz, CDCl₃): δ 30.12 ppm. LC-MS (ESI, m/z): calcd for [M+H]+ 364.3; found: 364.4 TLC: R_{f}=0.73 (10:1 hexanes:ethyl acetate).

### Compound 31

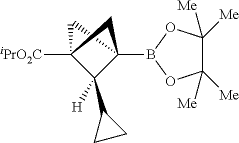

isopropyl-2-cyclopropyl-3-(4,4,5,5-tetramethyl-1,3,2-dioxaborolan-2-yl)bicyclo[1.1.1]pentane-1-carboxylate (31). Following General Procedure B on 1.0 mmol scale with K-17. Purification by chromatography (hexanes:methylene chloride, 2:1) on silica gel afforded 179.2 mg (56%) of the title compound 31. Physical State: colorless oil. ¹H NMR (600 MHz, CDCl₃): δ 4.96 (hept, J=6.2 Hz, ¹H), 2.75 (dd, J=9.6, 2.9 Hz, ¹H), 2.04 (dd, J=6.6, 2.9 Hz, ¹H), 2.00 (d, J=1.9 Hz, ¹H), 1.84 (dd, J=9.7, 1.9 Hz, ¹H), 1.80 (dd, J=8.1, 6.9 Hz, ¹H), 1.23 (s, 12H), 1.21 (d, J=1.5 Hz, 3H), 1.20 (d, J=1.6 Hz, 3H), 1.11 (dtd, J=11.7, 8.2, 4.2 Hz, ¹H), 0.54-0.43 (m, 2H), 0.26-0.14 (m, 2H) ppm. ¹³C NMR (151 MHz, CDCl₃): δ 169.27, 83.56, 70.39, 67.35, 51.14, 47.11, 46.88, 24.83, 24.81, 21.95, 21.93, 7.46, 4.34, 3.95 ppm. ¹¹B NMR (128 MHz, CDCl₃): δ 30.09 ppm. MS (GCMS, EI): m/z=320 (0.5%), 305 (1%), 278 (4%), 220 (8%), 178 (56%), 150 (100%), 134 (70%). TLC: R_{f}=0.48 (5:1 hexanes:ethyl acetate).

### Compound 32

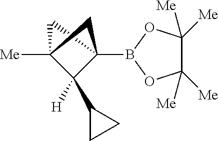 [SMILES: CC1(C)OB([C@]23C[C@](C)(C2)[C@@H]3C2CC2)OC1(C)C]

2-(2-cyclopropyl-3-methylbicyclo[1.1.1]pentan-1-yl)-4,4,5,5-tetramethyl-1,3,2-dioxaborolane (32). Following General Procedure B on 0.1 mmol scale with K-13. Purification by chromatography (hexanes:methylene chloride, 2:1) on silica gel afforded 16.1 mg (65%) of the title compound 32. Physical State: colorless oil. ¹H NMR (600 MHz, CDCl₃): δ 2.39 (dd, J=9.9, 2.6 Hz, ¹H), 1.67-1.65 (m, 2H), 1.47 (dd, J=9.7, 1.4 Hz, ¹H), 1.36-1.30 (m, ¹H), 1.22 (s, 12H), 1.01 (s, 3H), 1.00-0.95 (m, ¹H), 0.48-0.37 (m, 2H), 0.13-0.07 (m, 2H) ppm. ¹³C NMR (151 MHz, CDCl₃): δ 83.17, 69.92, 52.34, 48.28, 45.98, 24.84, 24.83, 17.60, 7.02, 4.03, 3.33 ppm. ¹¹B NMR (128 MHz, CDCl₃): δ 30.30 ppm. MS (GCMS, EI): m/z=248 (0.2%), 233 (2%), 191 (4%), 147 (22%), 120 (72%), 101 (100%). TLC: R_{f}=0.52 (10:1 hexanes:ethyl acetate).

### Compound 33

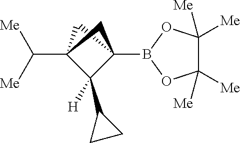 [SMILES: CC(C)[C@]12C[C@](B3OC(C)(C)C(C)(C)O3)(C1)[C@H]2C1CC1]

2-(2-cyclopropyl-3-isopropylbicyclo[1.1.1]pentan-1-yl)-4,4,5,5-tetramethyl-1,3,2-dioxaborolane (33). Following General Procedure B on 0.1 mmol scale with K-14. Purification by chromatography (hexanes:methylene chloride, 2:1) on silica gel afforded 20.4 mg (74%) of the title compound 33. Physical State: colorless oil. ¹H NMR (600 MHz, CDCl₃): δ 2.32 (dd, J=9.8, 2.8 Hz, ¹H), 1.63 (dd, J=6.6, 2.8 Hz, ¹H), 1.59 (dt, J=13.6, 6.8 Hz, ¹H), 1.53 (d, J=1.5 Hz, ¹H), 1.39 (dd, J=9.8, 1.5 Hz, ¹H), 1.31 (dd, J=9.1, 6.6 Hz, ¹H), 1.23 (s, 12H), 1.01 (ddt, J=12.8, 8.4, 4.3 Hz, ¹H), 0.80 (d, J=6.7 Hz, 3H), 0.79 (d, J=6.7 Hz, 3H), 0.44 (dddd, J=17.3, 8.7, 7.1, 3.2 Hz, 2H), 0.14-0.05 (m, 2H) ppm. ¹³C NMR (151 MHz, CDCl₃): δ 83.19, 67.95, 54.01, 47.62, 44.22, 28.84, 24.87, 24.83, 18.70, 18.51, 7.62, 5.02, 4.21 ppm. ¹¹B NMR (128 MHz, CDCl₃): δ 30.38 ppm. MS (GCMS, EI): m/z=276 (0.2%), 261 (2.5%), 233 (11%), 161 (22%), 133 (74%), 101 (100%). TLC: R_{f}=0.56 (10:1 hexanes:ethyl acetate).

### Compound 34

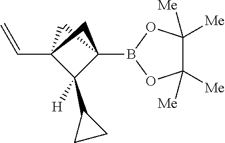 [SMILES: C=C[C@]12C[C@](B3OC(C)(C)C(C)(C)O3)(C1)[C@H]2C1CC1]

2-(2-cyclopropyl-3-vinylbicyclo[1.1.1]pentan-1-yl)-4,4,5,5-tetramethyl-1,3,2-dioxaborolane (34). Following General Procedure B on 0.1 mmol scale with K-15. Purification by chromatography (hexanes:methylene chloride, 2:1) on silica gel afforded 18.7 mg (72%) of the title compound 34. Physical State: colorless oil. ¹H NMR (600 MHz, CDCl₃): δ 5.81 (dd, J=17.4, 10.5 Hz, ¹H), 5.04-4.95 (m, 2H), 2.58 (dd, J=9.8, 2.7 Hz, ¹H), 1.83 (dd, J=6.7, 2.7 Hz, ¹H), 1.81 (d, J=1.5 Hz, ¹H), 1.65 (dd, J=9.8, 1.7 Hz, ¹H), 1.60-1.55 (m, ¹H), 1.23 (s, 12H), 1.04 (dq, J=11.6, 4.1, 3.4 Hz, ¹H), 0.52-0.42 (m, 2H), 0.17-0.13 (m, 2H) ppm. ¹³C NMR (151 MHz, CDCl₃): δ 137.84, 115.05, 83.34, 70.32, 51.70, 50.55, 47.34, 24.86, 24.85, 7.37, 4.78, 3.84 ppm. ¹¹B NMR (128 MHz, CDCl₃): δ 30.59 ppm. MS (GCMS, EI): m/z=260 (1%), 245 (1.4%), 203 (4%), 145 (24%), 132 (78%), 117 (100%). TLC: R_{f}=0.49 (10:1 hexanes:ethyl acetate).

### Compound 35

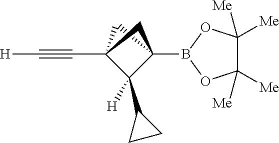 [SMILES: C#C[C@]12C[C@](B3OC(C)(C)C(C)(C)O3)(C1)[C@H]2C1CC1]

2-(2-cyclopropyl-3-ethynylbicyclo[1.1.1]pentan-1-yl)-4,4,5,5-tetramethyl-1,3,2-dioxaborolane (35). Following General Procedure B on 0.1 mmol scale with K-16. Purification by chromatography (hexanes:methylene chloride, 2:1) on silica gel afforded 9.0 mg (35%) of the title compound 35. Physical State: colorless oil. ¹H NMR (600 MHz, CDCl₃): δ 2.81 (dd, J=9.7, 2.8 Hz, ¹H), 2.10 (dd, J=6.7, 2.9 Hz, ¹H), 2.08 (d, J=1.8 Hz, ¹H), 2.02 (s, ¹H), 1.87 (dd, J=9.8, 1.9 Hz, ¹H), 1.81 (d, J=7.0 Hz, ¹H), 1.22 (s, 12H), 1.17-1.09 (m, ¹H), 0.61-0.53 (m, ¹H), 0.52-0.45 (m, ¹H), 0.39-0.32 (m, ¹H), 0.22-0.15 (m, ¹H) ppm. ¹³C NMR (151 MHz, CDCl₃): δ 83.57, 72.04, 66.69, 53.89, 50.89, 36.84, 24.83, 7.55, 4.09, 3.66 ppm. ¹¹B NMR (128 MHz, CDCl₃): δ 30.10 ppm. MS (GCMS, EI): m/z=258 (1%), 243 (1.4%), 173 (10%), 143 (58%), 129 (100%), 117 (78%). TLC: R_{f}=0.43 (10:1 hexanes ethyl acetate).

### Compound 36

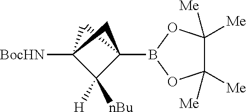

tert-butyl-2-butyl-3-(4,4,5,5-tetramethyl-1,3,2-dioxaborolan-2-yl)bicyclo[1.1.1]pentan-1-yl)carbamate (36). Following General Procedure B on 0.1 mmol scale with K-20. Purification by chromatography (hexanes:methylene chloride, 2:1) on silica gel afforded 18.3 mg (50%) of the title compound 36. Physical State: white solid. m.p.: 75-77° C. ¹H NMR (600 MHz, CDCl₃): δ 4.76 (br., ¹H), 2.54-2.49 (m, ¹H), 2.43-2.38 (m, ¹H), 2.04-1.96 (m, 2H), 1.89 (d, J=9.6 Hz, ¹H), 1.60-1.54 (m, 2H), 1.43 (s, 9H), 1.35-1.27 (m, 4H), 1.22 (s, 12H), 0.88 (t, J=6.9 Hz, 3H) ppm. ¹³C NMR (151 MHz, CDCl₃): δ 155.00 (br.), 83.38, 79.35 (br.), 66.01, 53.38, 50.49, 48.30, 31.02, 28.49, 25.04, 24.81, 24.78, 23.09, 14.21 ppm. ¹¹B NMR (128 MHz, CDCl₃): δ 30.99 ppm. MS (GCMS, EI): m/z=365 (0.4%), 308 (4%), 264 (12%), 222 (48%), 208 (62%), 122 (100%), 109 (40%). TLC: R_{f}=0.35 (5:1 hexanes:ethyl acetate).

### Compound 37

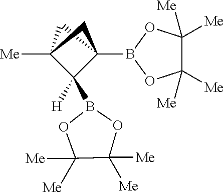 [SMILES: CC1(C)OB([C@H]2[C@]3(C)C[C@@]2(B2OC(C)(C)C(C)(C)O2)C3)OC1(C)C]

2,2′-(-3-methylbicyclo[1.1.1]pentane-1,2-diyl)bis(4,4,5,5-tetramethyl-1,3,2-dioxaborolane) (37). Following General Procedure B on 0.1 mmol scale with K-18. Purification by chromatography (hexanes:methylene chloride, 2:1) on silica gel afforded 15.7 mg (47%) of the title compound 37. Physical State: colorless crystal. m.p.: 35-37° C. ¹H NMR (600 MHz, CDCl₃): δ 2.22 (dd, J=9.7, 2.2 Hz, ¹H), 1.86-1.81 (m, ¹H), 1.76 (s, ¹H), 1.69 (dd, J=8.4, 2.2 Hz, ¹H), 1.57 (d, J=8.4 Hz, ¹H), 1.230 (s, 6H), 1.228 (s, 6H), 1.22 (s, 12H), 1.10 (s, 3H) ppm. ¹³C NMR (151 MHz, CDCl₃): δ 83.22, 82.81, 57.14, 51.38, 44.81, 25.07, 24.95, 24.85, 24.83, 20.37 ppm. ¹¹B NMR (128 MHz, CDCl₃): δ 31.89, 30.77 ppm. MS (GCMS, EI): m/z=334 (0.25%), 319 (4.5%), 277 (6%), 234 (18%), 219 (28%), 177(100%). TLC: R_{f}=0.33 (10:1 hexanes:ethyl acetate).

### Compound 38

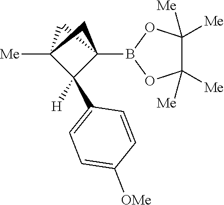 [SMILES: COc1ccc([C@H]2[C@]3(C)C[C@@]2(B2OC(C)(C)C(C)(C)O2)C3)cc1]

2-(2-(4-methoxyphenyl)-3-methylbicyclo[1.1.1]pentan-1-yl)-4,4,5,5-tetramethyl-1,3,2-dioxaborolane (38). Following General Procedure B on 0.4 mmol scale with K-23. Purification by chromatography (hexanes:methylene chloride, 2:1) on silica gel afforded 80.0 mg (64%) of the title compound 38. Physical State: colorless crystal. m.p.: 48-50° C. ¹H NMR (600 MHz, CDCl₃): δ 7.21-7.16 (m, 2H), 6.88-6.84 (m, 2H), 3.80 (s, 3H), 3.27 (d, J=6.7 Hz, ¹H), 2.21 (dd, J=9.8, 2.7 Hz, ¹H), 1.82 (d, J=1.7 Hz, ¹H), 1.77 (dd, J=9.8, 1.7 Hz, ¹H), 1.74 (dd, J=6.8, 2.7 Hz, ¹H), 1.27 (s, 6H), 1.26 (s, 6H), 1.13 (s, 3H) ppm. ¹³C NMR (151 MHz, CDCl₃): δ 157.74, 132.99, 129.67, 113.42, 83.49, 65.58, 55.33, 51.77, 48.77, 45.68, 24.91, 24.90, 18.18. ppm. ¹¹B NMR (128 MHz, CDCl₃): δ 30.46 ppm. [α]_{D}²⁰=+58.7 (c=1.27, CHCl₃). MS (GCMS, EI): m/z=314 (62%), 299 (12%), 258 (16%), 199 (34%), 186 (100%), 121 (82%). TLC: R_{f}=0.46 (10:1 hexanes:ethyl acetate). Chiral HPLC: The product was oxidized, and the corresponding alcohol 38-ol was used for HPLC analysis.

To a solution of 38 (40 mg, 0.13 mmol) and NaOAc (16.4 mg, 0.2 mmol) in THE (2.0 mL) at 0° C. was added H₂O₂ (35 wt. % in water, 0.2 mL) dropwise. The resulting mixture was stirred at 0° C. for 1.5 hours. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 3:1) on silica gel to obtain the 19 mg (72%) of the alcohol 38-ol. Physical State: colorless oil. ¹H NMR (600 MHz, CDCl₃): δ 7.26 (d, J=8.1 Hz, 2H), 6.87 (d, J=8.6 Hz, 2H), 3.80 (s, 3H), 3.19 (d, J=6.7 Hz, ¹H), 2.52 (s, ¹H), 2.26 (dd, J=9.6, 2.1 Hz, ¹H), 1.90 (d, J=1.2 Hz, ¹H), 1.82 (dd, J=9.5, 1.2 Hz, ¹H), 1.78 (dd, J=6.8, 2.1 Hz, ¹H), 1.33 (s, 3H) ppm. ¹³C NMR (151 MHz, CDCl₃): δ 158.00, 131.21, 129.65, 113.67, 65.65, 64.86, 55.84, 55.36, 51.34, 31.31, 14.20 ppm. TLC: R_{f}=0.33 (4:1 hexanes:ethyl acetate). [α]_{D}²⁰=+12.5 (c=0.75, CHCl₃). MS (GCMS, EI): m/z=204 (12%), 148 (10%), 121 (100%). Chiral HPLC: Chiralcel-AD-H column (25 cm) with guard, 10.0% isopropanol in hexane, 0.8 mL/min, ambient temperature, 210 nm: t_{R}=12.54 min (minor, (R)), t_{R}=10.36 min (major, (S)), 95.5:4.5 e.r.

### Compound 42

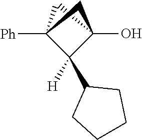 [SMILES: O[C@]12C[C@](c3ccccc3)(C1)[C@@H]2C1CCCC1]

2-cyclopentyl-3-phenylbicyclo[1.1.1]pentan-1-ol (42). To a solution of 20 (33.8 mg, 0.1 mmol) and NaOAc (16.4 mg, 0.2 mmol) in THE (2.0 mL) at 0° C. was added H₂O₂ (35 wt. % in water, 0.1 mL) dropwise. The resulting mixture was stirred at 0° C. for 1.5 hours. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 3:1) on silica gel to obtain the 19 mg (72%) of the alcohol 42. Physical State: colorless crystal m.p.: 66-68° C. ¹H NMR (600 MHz, CDCl₃): δ 7.35 (t, J=7.5 Hz, 2H), 7.28 (d, J=6.9 Hz, ¹H), 7.24 (t, J=7.8 Hz, 2H), 2.84 (dd, J=9.6, 1.7 Hz, ¹H), 2.39-2.27 (m, 2H), 2.22 (d, J=4.0 Hz, ¹H), 2.17-2.15 (m, 2H), 2.04-1.94 (m, ¹H), 1.75-1.64 (m, ¹H), 1.62-1.44 (m, 4H), 1.43-1.33 (m, ¹H), 0.97 (dq, J=10.9, 7.6, 7.0 Hz, ¹H) ppm. ¹³C NMR (151 MHz, CDCl₃): δ 138.29, 128.14, 126.98, 126.36, 73.36, 65.01, 56.39, 49.39, 37.08, 35.60, 32.18, 32.15, 25.27, 25.12 ppm. MS (GCMS, EI): m/z=228 (16%), 213 (6%), 170 (8%), 147 (14%), 115 (70%), 111(100%). TLC: R_{f}=0.33 (5:1 hexanes:ethyl acetate).

### Compound 43

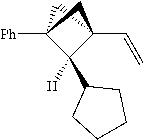 [SMILES: C=C[C@]12C[C@](c3ccccc3)(C1)[C@@H]2C1CCCC1]

(1R,2R,3R)-2-cyclopentyl-1-phenyl-3-vinylbicyclo[1.1.1]pentane (43) (Fawcett and Aggarwal, 2019). Vinyl magnesium chloride (0.4 mL, 1.0 M in THF, 0.4 mmol, 4.0 equiv.) was added dropwise to a solution of boronic ester 20 (33.8 mg, 0.1 mmol, 1.0 equiv.) in anhydrous THE (0.5 mL) at 0° C. and the resulting solution was stirred at ambient temperature for 30 min. The solution was cooled to −78° C. and then a solution of iodine (106.6 mg, 0.4 mmol, 4.0 equiv.) in anhydrous THE (0.8 mL) was added dropwise before stirring for 20 min. Sodium methoxide solution (0.8 mL, 1 M in Methanol, 0.8 mmol, 8.0 equiv.) was added in a single portion before warming to 0° C. and stirring for a further 30 min. Na₂S₂O₃ solution (3 mL) was added, followed by methylene chloride. The phases were separated, and the aqueous phase was extracted with methylene chloride. The combined organic phases were dried over anhydrous MgSO₄ and concentrated under reduced pressure. The crude residue was purified by flash column chromatography (SiO₂; pentane) on silica gel to yield 23 mg (96%) of the desired alkene 43. Note: MeONa solution was prepared through dissolving sodium (23 mg, 1.0 mmol) in MeOH (1 mL) at room temperature. Physical State: colorless oil. ¹H NMR (600 MHz, CDCl₃): δ 7.38-7.10 (m, 5H), 5.97 (dd, J=17.2, 10.4 Hz, ¹H), 5.07 (dd, J=14.3, 2.1 Hz, ¹H), 5.05-5.03 (m, ¹H), 2.69 (dd, J=9.6, 2.4 Hz, ¹H), 2.24-2.15 (m, 2H), 2.00 (dd, J=9.7, 1.2 Hz, ¹H), 1.96 (dd, J=6.0, 2.5 Hz, ¹H), 1.90-1.87 (m, ¹H), 1.79 (dtd, J=11.4, 7.1, 4.0 Hz, ¹H), 1.63-1.53 (m, ¹H), 1.52-1.35 (m, 4H), 1.12 (dq, J=12.5, 8.4 Hz, ¹H), 0.88 (ddt, J=12.3, 8.4, 3.7 Hz, ¹H) ppm. ¹³C NMR (151 MHz, CDCl₃): δ 140.81, 137.48, 128.07, 126.53, 126.23, 115.14, 73.01, 53.61, 45.40, 44.65, 43.42, 36.48, 32.51, 32.22, 25.38, 25.24 ppm. MS (GCMS, EI): m/z=238 (2%), 223 (5%), 195 (8%), 169 (66%), 155 (86%), 141 (100%). TLC: R_{f}=0.63 (hexane).

### Compound 44

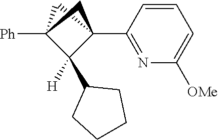 [SMILES: COc1cccc([C@]23C[C@](c4ccccc4)(C2)[C@@H]3C2CCCC2)n1]

2-(2-cyclopentyl-3-phenylbicyclo[1.1.1]pentan-1-yl)-6-methoxypyridine (44) (Odachowski et al., 2016). A solution of 2-bromo-6-methoxypyridine (17 ptL, 0.14 mmol, 1.4 equiv.) in THF:Et₂O:pentane (4:1:1, 0.3 M) was cooled to −78° C. and treated with n-BuLi (0.06 mL, 0.14 mmol, 1.3 eq., 2.32 M in hexanes) and the mixture was stirred at this temperature for 30 min. Boronic ester 20 (33.8 mg, 0.1 mmol, 1.0 eq.) was added dropwise as a solution in THE (0.5 mL). The mixture was stirred at −78° C. for 30 min. The mixture was warmed to room temperature. and the solvents were removed under high vacuum at room temperature. The crude was redissolved in MeOH (2 mL) and the mixture was cooled to 0° C. A solution of 1,3-dibromo-5,5-dimethylhydantoin (56 mg, 0.2 mmol, 2.0 eq.) in MeOH (3.0 mL) was added dropwise. After 1 hour at 0° C. saturated aqueous solution of Na₂S₂O₃ was added and the reaction mixture was allowed to warm to room temperature. The reaction mixture was diluted with ethyl acetate (15 mL) and water (15 mL). The layers were separated, and the aqueous layer was extracted with ethyl acetate twice. The combined organic layers were dried over anhydrous MgSO₄, filtered and concentrated under vacuum. The crude material was adsorbed on silica and purified by flash column chromatography (hexanes:ethyl acetate, 30:1) on silica gel to give 20.9 mg (66%) of the desired product 44. Physical State: colorless oil. ¹H NMR (600 MHz, CDCl₃): δ 7.52-7.46 (m, ¹H), 7.30 (t, J=7.5 Hz, 2H), 7.27-7.24 (m, 2H), 7.21 (t, J=7.2 Hz, ¹H), 6.77 (d, J=7.2 Hz, ¹H), 6.56 (d, J=8.2 Hz, ¹H), 3.94 (s, 3H), 2.99 (dd, J=9.6, 2.3 Hz, ¹H), 2.55 (dd, J=9.9, 6.2 Hz, ¹H), 2.35 (d, J=9.8 Hz, ¹H), 2.30 (dt, J=16.9, 8.4 Hz, ¹H), 2.21 (dd, J=6.2, 2.3 Hz, ¹H), 2.08 (s, ¹H), 1.51-1.30 (m, 6H), 0.98-0.83 (m, 2H) ppm. ¹³C NMR (151 MHz, CDCl₃): δ 163.66, 157.64, 140.70, 138.57, 128.12, 126.61, 126.33, 113.64, 107.78, 73.79, 54.36, 53.35, 44.87, 44.60, 44.26, 36.67, 32.32, 32.13, 25.30, 25.13 ppm. MS (GCMS, EI): m/z=319 (38%), 304 (40%), 250 (100%), 214 (18%), 123 (20%). TLC: R_{f}=0.50 (20:1 hexanes:ethyl acetate).

### Compound 45

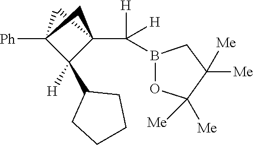 [SMILES: CC1(C)CB(C[C@]23C[C@](c4ccccc4)(C2)[C@@H]3C2CCCC2)OC1(C)C]

2-(((1R,2R,3R)-2-cyclopentyl-3-phenylbicyclo[1.1.1]pentan-1-yl)methyl)-4,4,5,5-tetramethyl-1,3,2-dioxaborolane (45) (Kondo et al., 2019). Boronic ester 20 (16.9 mg, 0.05 mmol, 1.0 equiv.) and dibromomethane (10 μL, 0.125 mmol, 2.5 eq.) were dissolved in anhydrous THE (0.5 mL) and cooled to −78° C. n-BuLi (2.32M in nhexane, 30 μL, 0.069 mmol, 1.4 equiv.) was added dropwise and the solution was stirred 10 minutes at −78° C., and then warmed up to room temperature and stir overnight. The reaction mixture was quenched with saturated NH₄Cl solution and dissolved in ethyl acetate. The aqueous phase was extracted with ethyl acetate twice. The combined organic phase was washed with brine, dried over Na₂SO₄ and evaporated to afford the crude residue, which was purified by flash chromatography (hexane:ethyl acetate, 20:1) on silica gel to give 17.8 mg (97%) of the desired product 45. Physical State: colorless oil. ¹H NMR (600 MHz, CDCl₃): δ 7.36-7.32 (m, 2H), 7.24 (d, J=7.8 Hz, 3H), 2.61 (dd, J=9.8, 2.3 Hz, ¹H), 2.27 (h, J=8.6 Hz, ¹H), 2.11 (dd, J=10.0, 6.3 Hz, ¹H), 1.99-1.89 (m, 4H), 1.66 (tdt, J=11.6, 7.3, 3.8 Hz, ¹H), 1.54 (ddtt, J=11.9, 9.1, 5.9, 3.4 Hz, 2H), 1.45 (ddtd, J=13.8, 10.7, 7.6, 3.4 Hz, 2H), 1.36 (s, 12H), 1.28 (dq, J=12.8, 9.0 Hz, ¹H), 1.21 (d, J=15.3 Hz, ¹H), 1.16 (d, J=15.4 Hz, ¹H), 0.92 (dtt, J=13.5, 8.7, 3.7 Hz, ¹H) ppm. ¹³C NMR (151 MHz, CDCl₃): δ 141.30, 127.94, 126.52, 125.88, 83.10, 72.25, 54.24, 47.31, 45.06, 38.79, 36.40, 32.34, 32.00, 25.37, 25.26, 25.10, 25.08 ppm. ¹¹B NMR (128 MHz, CDCl₃): δ 33.05 ppm. MS (GCMS, EI): m/z=352 (20%), 337 (24%), 283 (60%), 211 (82%), 183 (78%), 101 (100%). TLC: R_{f}=0.46 (20:1 hexanes:ethyl acetate).

### Compound 46

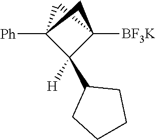

(2-cyclopentyl-3-phenylbicyclo[1.1.1]pentan-1-yl)trifluoro-l4-borane, potassium salt (46). Compound 20 (1.1 g, 3.3 mmol) was suspended in methanol (6.6 mL), and a saturated aqueous solution of KHF₂ (5 mL, 25 mmol) was added dropwise. The suspended solution was stirred at room temperature for 2 hours and then concentrated to dryness. The residue was extracted with hot acetone (3×30 mL), and the combined filtered extracts were concentrated to approximately 5 mL. Diethyl ether was added and the resultant precipitate was collected and dried to afford the 750 mg (73%) of the potassium trifluoroborate 46. Physical State: white solid. m.p.: >200° C. ¹H NMR (600 MHz, d⁶-Acetone): δ 7.21-7.18 (m, 2H), 7.13-7.09 (m, 2H), 7.10-7.05 (m, ¹H), 2.41 (dd, J=9.7, 2.4 Hz, ¹H), 2.30-2.17 (m, ¹H), 2.00-1.90 (m, 2H), 1.68-1.60 (m, 2H), 1.57 (s, ¹H), 1.53-1.23 (m, 6H), 0.81-0.73 (m, ¹H) ppm. ¹³C NMR (151 MHz, d⁶-Acetone): δ 144.98, 128.39, 126.78, 125.89, 71.41, 52.23, 48.12, 44.46, 38.20, 33.19, 33.03, 26.17, 25.71 ppm. ¹⁹F NMR (376 MHz, d⁶-Acetone): 6-144.92 ppm. ¹¹B NMR (128 MHz, d⁶-Acetone): δ 2.84 ppm. LC-MS (ESI, m/z): calcd for [M−K]⁻: 279.2, found: 279.2.

### Compound 47

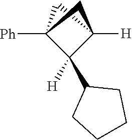 [SMILES: c1ccc([C@]23C[C@H](C2)[C@H]3C2CCCC2)cc1]

2-cyclopentyl-1-phenylbicyclo[1.1.1]pentane (47). In a flame-dried tube was charged with 46 (15.9 mg, 0.05 mmol, 1.0 equiv.), t-butylcatechol (50 mg, 0.3 mmol, 6.0 equiv.). The reaction tube was evacuated and backfilled with argon three times and then toluene (0.5 mL) was added. After stirring at 80° C. for 5 hours, the reaction mixture was cooled down to room temperature, filtered through Celite washed with hexanes, and concentrated in vacuo. The crude product was purified by column chromatography (hexanes) on silica gel to obtain 8.3 mg (78%) of the desired coupling product 47. Physical State: colorless oil. ¹H NMR (600 MHz, CDCl₃): δ 7.28-7.24 (m, 2H), 7.19-7.14 (m, 3H), 2.66 (dd, J=9.7, 2.6 Hz, ¹H), 2.40 (s, ¹H), 2.23 (dq, J=16.1, 7.9, 7.5 Hz, ¹H), 2.17 (dd, J=9.8, 6.1 Hz, ¹H), 1.98 (dd, J=6.1, 2.6 Hz, ¹H), 1.94-1.88 (m, 2H), 1.76 (dtd, J=11.8, 7.6, 4.0 Hz, ¹H), 1.64-1.38 (m, 5H), 1.17 (dq, J=12.6, 8.3 Hz, ¹H), 1.00-0.85 (m, ¹H) ppm. ¹³C NMR (151 MHz, CDCl₃): δ 141.29, 128.05, 126.36, 126.15, 70.99, 51.56, 49.92, 45.69, 36.43, 32.36, 32.17, 29.65, 25.75, 25.09 ppm. MS (GCMS, EI): m/z=212 (2%), 197 (4%), 183 (4%), 169 (8%), 143 (100%), 129 (86%). TLC: R_{f}=0.53 (hexanes).

### Compound 48

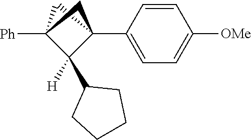 [SMILES: COc1ccc([C@]23C[C@](c4ccccc4)(C2)[C@@H]3C2CCCC2)cc1]

2-cyclopentyl-1-(4-methoxyphenyl)-3-phenylbicyclo[1.1.1]pentane (48) (Li et al., 2014). On the benchtop, 46 (15.9 mg, 0.05 mmol, 1.0 equiv.), K₂CO₃ (20.7 mg, 0.15 mmol, 3.0 equiv.), and methanesulfonato(tri-t-butylphosphino)(2″-methylamino-1,1″-biphenyl-2-yl)palladium(II), [P(t-Bu)₃ Palladacycle Gen. 4](5.8 mg, 0.01 mmol, 0.2 equiv.) were added to an oven-dried 10 mL screw-top test tube equipped with a stirbar. The test tube was sealed with a screw-top septum and electrical tape. The reaction vessel was evacuated and backfilled with argon four times. 4-bromoanisole (12 mL, 0.1 mmol, 2.0 equiv.) was added to the reaction vessel via syringe at this point. Degassed toluene (0.2 mL) and degassed water (0.1 mL) were then added via syringe. The septum was covered with electrical tape, and the reaction vessel was heated to 100° C. for 12 h. The cooled reaction mixture was diluted with methylene chloride (5 mL), filtered through Celite, concentrated under reduced pressure, and purified by column chromatography (hexanes:ethyl acetate, 20:1) on silica gel to obtain 4.0 mg (24%) of the desired coupling product 48. Physical State: colorless oil. ¹H NMR (600 MHz, CDCl₃): δ 7.30 (t, J=7.5 Hz, 2H), 7.25-7.20 (m, 3H), 7.18-7.14 (m, 2H), 6.87-6.83 (m, 2H), 3.80 (s, 3H), 2.92 (dd, J=9.7, 2.3 Hz, ¹H), 2.40 (dd, J=9.9, 6.2 Hz, ¹H), 2.28-2.22 (m, 2H), 2.16 (dd, J=6.3, 2.3 Hz, ¹H), 2.02 (s, ¹H), 1.47-1.37 (m, 4H), 1.37-1.29 (m, 2H), 0.91-0.83 (m, 2H) ppm. ¹³C NMR (151 MHz, CDCl₃): δ 158.26, 140.78, 132.99, 128.11, 127.65, 126.57, 126.26, 113.57, 73.93, 55.39, 54.87, 44.90, 43.92, 43.54, 36.67, 32.26, 25.16, 25.15 ppm. MS (GCMS, EI): m/z=318 (14%), 249 (48%), 135 (100%), 121 (46%). TLC: R_{f}=0.54 (20:1 hexanes:ethyl acetate).

### Compound 50

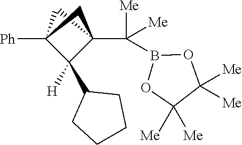 [SMILES: CC1(C)OB(C(C)(C)[C@]23C[C@](c4ccccc4)(C2)[C@@H]3C2CCCC2)OC1(C)C]

2-(2-(2-cyclopentyl-3-phenylbicyclo[1.1.1]pentan-1-yl)propan-2-yl)-4,4,5,5-tetramethyl-1,3,2-dioxaborolane (50) (Comins et al., 2001). A screw-capped culture tube was charged with 46 (63.6 mg, 0.2 mmol, 2.0 equiv.) and degassed water (2.0 mL), followed by addition of silica gel (150 mg) under argon atmosphere. The mixture was stirred at room temperature for 1 hour. Ethyl acetate (10 mL) was added and the suspended solution was filtered by Celite. The organic phase was separated, and the water phase was extracted with ethyl acetate (3×5 mL). The combined organic solvent was washed with brine and dried by anhydrous MgSO₄. The solvent was removed under vacuum and the crude residue was used in the subsequent step without further purification. Note: Due to the sensitivity to the air of tertiary alkylboronic acids, hydrolysis was running under argon atmosphere, and the water was degassed by bubbling with argon gas for 20 minutes.

Another screw-capped culture tube was charged with crude boronic acid in the last step and sulfonyl hydrazone 49 (25.4 mg, 0.1 mmol, 1.0 equiv.), and cesium carbonate (97.5 mg, 0.3 mmol, 3.0 equiv.) Then the tube was evacuated and backfilled with argon for three times, followed by addition of chlorobenzene (1.0 mL) via a syringe. After stirring for at 100° C. for 5 hours, the reaction mixture was cooled to room temperature. Next, pinacol (118 mg, 1.0 mmol, 5.0 equiv.) was added, and the reaction was stirred at 100° C. for another 1 hour. The suspended solution was then filtered over Celite and washed with diethyl ether. The solvent was removed under high vacuum, and the crude residue was purified by chromatography (hexanes:ethyl acetate, 15:1) on silica gel to afford 35.0 mg (92%) of the desired product 50. Physical State: colorless crystal. m.p.: 41-43° C. ¹H NMR (600 MHz, CDCl₃): δ 7.30-7.23 (m, 2H), 7.20-7.14 (m, 3H), 2.52 (dd, J=9.6, 2.3 Hz, ¹H), 2.16 (h, J=9.0 Hz, ¹H), 2.09 (dd, J=9.7, 6.2 Hz, ¹H), 1.95-1.87 (m, ¹H), 1.83 (dd, J=6.1, 2.3 Hz, ¹H), 1.78 (d, J=9.5 Hz, ¹H), 1.65 (s, ¹H), 1.57-1.49 (m, ¹H), 1.49-1.39 (m, 2H), 1.32-1.20 (m, 3H), 1.26 (s, 6H), 1.25 (s, 6H), 0.951 (s, 3H), 0.947 (s, 3H), 0.74-0.64 (m, ¹H) ppm. ¹³C NMR (151 MHz, CDCl₃): δ 142.04, 127.90, 126.62, 125.81, 82.97, 70.37, 49.97, 47.79, 43.44, 42.01, 36.90, 34.28, 32.03, 25.33, 25.09, 25.05, 25.00, 21.93, 21.54 ppm. ¹¹B NMR (128 MHz, CDCl₃): δ 34.08 ppm. HRMS (ESI-TOF): calc'd for C₂₅H₃₇BO₂ [M+H]⁺: 381.2959, not found. TLC: R_{f}=0.58 (20:1 hexanes:ethyl acetate).

### Compound 31-ol

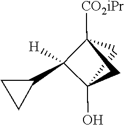

isopropyl-2-cyclopropyl-3-hydroxybicyclo[1.1.1]pentane-1-carboxylate (31-01). To a solution of 31 (154 mg, 0.48 mmol) and NaOAc (82 mg, 1.0 mmol) in THE (5.0 mL) at 0° C. was added H₂O₂ (35 wt. % in water, 0.6 mL) dropwise. The resulting mixture was stirred at 0° C. for 1 hour. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 3:1) on silica gel to obtain 81.7 mg (82%) of the alcohol 31-ol. Physical State: colorless oil. ¹H NMR (600 MHz, CDCl₃): δ 4.99 (hept, J=6.2 Hz, ¹H), 2.85-2.70 (m, 2H), 2.14 (dd, J=6.5, 2.4 Hz, ¹H), 2.09 (d, J=1.4 Hz, ¹H), 1.91 (dd, J=9.5, 1.4 Hz, ¹H), 1.83 (dd, J=8.4, 6.6 Hz, ¹H), 1.22 (d, J=1.9 Hz, 3H), 1.21 (d, J=1.9 Hz, 3H), 1.03 (qt, J=8.2, 4.9 Hz, ¹H), 0.54 (dddd, J=9.6, 8.3, 5.6, 4.1 Hz, ¹H), 0.48 (dddd, J=9.3, 8.2, 5.5, 4.1 Hz, ¹H), 0.26 (dtd, J=9.1, 5.2, 4.1 Hz, ¹H), 0.17 (dtd, J=9.3, 5.4, 4.3 Hz, ¹H) ppm. ¹³C NMR (151 MHz, CDCl₃): δ 169.73, 72.15, 68.05, 65.66, 54.87, 50.60, 34.79, 21.88, 21.87, 5.14, 3.71, 3.16 ppm. MS (GCMS, EI): m/z=210 (2%), 168 (8%), 151 (20%), 113 (100%). TLC: R_{f}=0.17 (4:1 hexanes:ethyl acetate).

### Compound 54

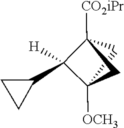

isopropyl (1R,2S,3R)-2-cyclopropyl-3-methoxybicyclo[1.1.1]pentane-1-carboxylate (54). To a solution of 31-ol (10.5 mg, 0.05 mmol) and proton sponge (54 mg, 0.25 mmol, 5.0 equiv.) in methylene chloride (0.5 mL) at 0° C. was added trimethyloxonium tetrafluoroborate (37.5 mg, 0.25 mmol, 5.0 equiv.). The resulting mixture was stirred at 0° C. for 1 h. 1M HCl (2 mL) was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated and purified by column chromatography (hexanes:ethyl acetate, 20:1) on silica gel to obtain 6.4 mg (57%) of the methyl ether 54. Physical State: colorless oil. ¹H NMR (600 MHz, CDCl₃): δ 5.01 (hept, J=6.3 Hz, ¹H), 3.32 (s, 3H), 2.78 (dd, J=9.5, 2.4 Hz, ¹H), 2.15 (dd, J=6.5, 2.4 Hz, ¹H), 2.03 (d, J=1.4 Hz, ¹H), 1.94-1.83 (m, 2H), 1.23 (d, J=2.3 Hz, 3H), 1.22 (d, J=2.3 Hz, 3H), 1.05 (qt, J=8.3, 4.9 Hz, ¹H), 0.59-0.46 (m, 2H), 0.27-0.16 (m, 2H) ppm. ¹³C NMR (151 MHz, CDCl₃): δ 169.69, 70.67, 70.17, 67.97, 54.26, 51.91, 47.98, 35.17, 21.93, 21.92, 5.59, 4.25, 3.85 ppm. MS (GCMS, EI): m/z=224 (0.2%), 209 (1%), 181 (8%), 154 (18%), 137 (100%). TLC: R_{f}=0.17 (20:1 hexanes:ethyl acetate).

### Compound 61

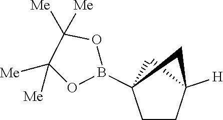 [SMILES: CC1(C)OB([C@]23CC[C@H](C2)C3)OC1(C)C]

2-(bicyclo[2.1.1]hexan-1-yl)-4,4,5,5-tetramethyl-1,3,2-dioxaborolane (61). Following General Procedure B on 0.1 mmol scale with 58. Purification by chromatography (hexanes:methylene chloride, 2:1) on silica gel afforded 12.1 mg (58%) of the title compound 61. Physical State: colorless crystal. m.p.: 39-41° C. ¹H NMR (600 MHz, CDCl₃): δ 2.54 (s, ¹H), 1.70-1.59 (m, 6H), 1.24 (s, 12H), 1.00-0.89 (m, 2H) ppm. ¹³C NMR (151 MHz, CDCl₃): δ 83.00, 41.22, 41.05, 29.25, 27.14, 24.88 ppm. ¹¹B NMR (128 MHz, CDCl₃): δ 32.77 ppm. MS (GCMS, EI): m/z=208 (0.4%), 193 (28%), 151 (32%), 122 (42%), 107 (100%). TLC: R_{f}=0.43 (15:1 hexanes:ethyl acetate).

### Compound 62

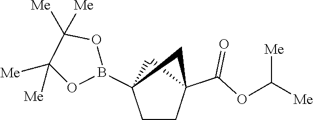 [SMILES: CC(C)OC(=O)[C@]12CC[C@](B3OC(C)(C)C(C)(C)O3)(C1)C2]

isopropyl-4-(4,4,5,5-tetramethyl-1,3,2-dioxaborolan-2-yl)bicyclo[2.1.1]hexane-1-carboxylate (62). Following General Procedure B on 0.1 mmol scale with 59. Purification by chromatography (hexanes:methylene chloride, 2:1) on silica gel afforded 22.6 mg (77%) of the title compound 62. Physical State: colorless oil. ¹H NMR (600 MHz, CDCl₃): δ 4.98 (hept, J=6.2 Hz, ¹H), 1.91-1.86 (m, 4H), 1.83-1.77 (m, 2H), 1.36 (dd, J=4.2, 2.0 Hz, 2H), 1.23 (s, 12H), 1.20 (d, J=6.3 Hz, 6H) ppm. ¹³C NMR (151 MHz, CDCl₃): δ 173.53, 83.30, 67.14, 55.56, 53.83, 43.62, 30.11, 29.96, 24.85, 21.95 ppm. ¹¹B NMR (128 MHz, CDCl₃): δ 32.50 ppm. MS (GCMS, EI): m/z=294 (1%), 279 (12%), 252 (22%), 207 (26%), 152 (70%), 101 (100%). TLC: R_{f}=0.46 (5:1 hexanes:ethyl acetate).

### Compound 63

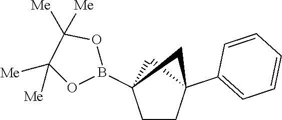 [SMILES: CC1(C)OB([C@]23CC[C@](c4ccccc4)(C2)C3)OC1(C)C]

4,4,5,5-tetramethyl-2-(4-phenylbicyclo[2.1.1]hexan-1-yl)-1,3,2-dioxaborolane (63). Following General Procedure B on 0.1 mmol scale with 60. Purification by chromatography (hexanes:methylene chloride, 2:1) on silica gel afforded 27.0 mg (95%) of the title compound 63. Physical State: colorless oil. ¹H NMR (600 MHz, CDCl₃): δ 7.33-7.24 (m, 4H), 7.21-7.16 (m, ¹H), 1.92 (s, 4H), 1.89-1.86 (m, 2H), 1.54 (dd, J=4.1, 2.1 Hz, 2H), 1.27 (s, 12H) ppm. ¹³C NMR (151 MHz, CDCl₃): δ 144.59, 128.19, 126.05, 125.96, 83.20, 55.76, 45.33, 33.93, 31.19, 24.91 ppm. ¹¹B NMR (128 MHz, CDCl₃): δ 32.71 ppm. MS (GCMS, EI): m/z=284 (8%), 269 (4%), 200 (12%), 183 (12%), 156 (100%), 143 (90%), 128 (28%). TLC: R_{f}=0.34 (15:1 hexanes:ethyl acetate).

### Compound 65

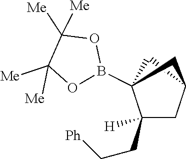 [SMILES: CC1(C)OB([C@]23C[C@H](C[C@H]2CCc2ccccc2)C3)OC1(C)C]

4,4,5,5-tetramethyl-2-((1R,2R,4S)-2-phenethylbicyclo[2.1.1]hexan-1-yl)-1,3,2-dioxaborolane (65). Following General Procedure B on 0.1 mmol scale with 64. Purification by chromatography (hexanes:methylene chloride, 2:1) on silica gel afforded 20.6 mg (66%) of the title compound 65. Physical State: colorless oil. ¹H NMR (600 MHz, CDCl₃): δ 7.38-7.12 (m, 5H), 2.72 (ddd, J=15.4, 10.6, 5.1 Hz, ¹H), 2.65 (ddd, J=13.6, 10.3, 6.5 Hz, ¹H), 2.50 (s, ¹H), 2.16 (tt, J=8.8, 4.0 Hz, ¹H), 1.88 (dtd, J=12.6, 7.5, 6.2, 4.2 Hz, 2H), 1.70 (dt, J=5.4, 2.6 Hz, ¹H), 1.64-1.60 (m, ¹H), 1.53 (dtd, J=13.2, 10.3, 5.1 Hz, ¹H), 1.24 (s, 12H), 1.22-1.17 (m, 2H), 1.08 (dd, J=9.8, 6.4 Hz, ¹H) ppm. ¹³C NMR (151 MHz, CDCl₃): δ 143.27, 128.50, 128.36, 125.63, 83.04, 43.98, 42.12, 41.01, 36.62, 36.55, 35.05, 34.55, 25.00, 24.83 ppm. ¹¹B NMR (128 MHz, CDCl₃): δ 32.47 ppm. [α]_{D}²⁰=−27.0 (c=0.23, CHCl₃). MS (GCMS, EI): m/z=312 (2%), 297 (3%), 255 (5%), 227 (19%), 207 (20%), 184 (100%), 121 (42%). TLC: R_{f}=0.43 (15:1 hexanes:ethyl acetate). Chiral HPLC: The product was oxidized, and the corresponding alcohol 65-ol was used for HPLC analysis.

To a solution of 65 (10 mg, 0.03 mmol) and NaOAc (8.2 mg, 0.1 mmol) in THE (1.0 mL) at 0° C. was added H₂O₂ (35 wt. % in water, 0.05 mL) dropwise. The resulting mixture was stirred at 0° C. for 1.5 h. Na₂S₂O₃ was added and the mixture was stirred at 0° C. for 10 min. Diethyl ether was added, the layers were separated and the aqueous phase was extracted with diethyl ether. The combined organic layers were washed with water and brine, dried over MgSO₄, concentrated and purified by column chromatography (hexanes:ethyl acetate, 3:1) on silica gel to obtain 5.0 mg (83%) of the alcohol. Physical State: colorless oil. ¹H NMR (600 MHz, CDCl₃): δ 7.30-7.27 (m, 2H), 7.23-7.16 (m, 3H), 2.72 (ddd, J=13.8, 10.1, 5.2 Hz, ¹H), 2.63 (ddd, J=13.7, 9.8, 6.8 Hz, ¹H), 2.19-2.13 (m, ¹H), 2.10-1.98 (m, 2H), 1.90 (ddt, J=10.8, 8.6, 2.1 Hz, ¹H), 1.86-1.80 (m, ¹H), 1.63 (dd, J=9.6, 6.4 Hz, ¹H), 1.54 (dt, J=6.0, 3.1 Hz, ¹H), 1.48 (dd, J=9.6, 5.9 Hz, ¹H), 1.44 (ddd, J=10.2, 5.2, 3.0 Hz, ¹H), 1.39 (ddt, J=6.1, 3.8, 1.8 Hz, ¹H), 1.28-1.23 (m, ¹H) ppm. ¹³C NMR (151 MHz, CDCl₃): δ 142.86, 128.56, 128.43, 125.80, 80.82, 46.98, 41.03, 39.88, 35.81, 34.38, 32.91, 28.40 ppm. MS (GCMS, EI): m/z=202 (2%), 128 (10%), 111 (100%). TLC: R_{f}=0.35 (4:1 hexanes:ethyl acetate). [α]_{D}²⁰=−30.7 (c=0.3, CHCl₃). Chiral HPLC: Chiralcel-OD-H column (25 cm) with guard, 10.0% isopropanol in hexane, 0.8 mL/min, ambient temperature, 220 nm: t_{R}=7.93 min (minor, (R)), t_{R}=10.09 min (major, (S)), 97:3 e.r.

### Compound 68

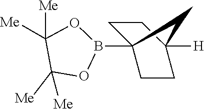 [SMILES: CC1(C)OB([C@]23CC[C@H](CC2)C3)OC1(C)C]

2-((1s,4s)-bicyclo[2.2.1]heptan-1-yl)-4,4,5,5-tetramethyl-1,3,2-dioxaborolane (68). Following General Procedure B on 0.1 mmol scale with 66. Purification by chromatography (hexanes:methylene chloride, 2:1) on silica gel afforded 16.0 mg (72%) of the title compound 68. Physical State: colorless crystal. m.p.: 48-52° C. ¹H NMR (600 MHz, CDCl₃): δ 2.27 (t, J=4.0 Hz, ¹H), 1.57 (ddd, J=14.4, 9.3, 3.6 Hz, 2H), 1.52-1.43 (m, 2H), 1.30-1.20 (m, 4H), 1.24 (s, 12H), 1.18-1.11 (m, 2H) ppm. ¹³C NMR (151 MHz, CDCl₃): δ 82.91, 41.68, 38.68, 32.58, 30.43, 24.85 ppm. ¹¹B NMR (128 MHz, CDCl₃): δ 34.89 ppm. MS (GCMS, EI): m/z=222 (2%), 207 (38%), 136 (100%), 122 (42%). TLC: R_{f}=0.48 (15:1 hexanes:ethyl acetate).

### Compound 69

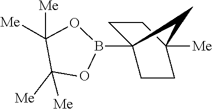 [SMILES: CC1(C)OB([C@]23CC[C@](C)(CC2)C3)OC1(C)C]

4,4,5,5-tetramethyl-2-(4-methylbicyclo[2.2.1]heptan-1-yl)-1,3,2-dioxaborolane (69). Following General Procedure B on 0.1 mmol scale with 67. Purification by chromatography (hexanes:methylene chloride, 2:1) on silica gel afforded 18.4 mg (78%) of the title compound 69. Physical State: colorless oil. ¹H NMR (600 MHz, CDCl₃): δ 1.76-1.67 (m, 2H), 1.36-1.29 (m, 4H), 1.25-1.17 (m, 4H), 1.21 (s, 12H), 1.12 (s, 3H) ppm. ¹³C NMR (151 MHz, CDCl₃): δ 82.86, 48.38, 46.23, 37.45, 33.90, 24.84, 20.60 ppm. ¹¹B NMR (128 MHz, CDCl₃): δ 34.89 ppm. MS (GCMS, EI): m/z=236 (6%), 221 (28%), 207 (30%), 150 (48%), 108 (100%). TLC: R_{f}=0.52 (15:1 hexanes:ethyl acetate).

### Compound 71

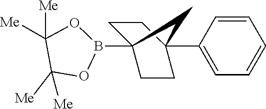 [SMILES: CC1(C)OB([C@]23CC[C@](c4ccccc4)(CC2)C3)OC1(C)C]

4,4,5,5-tetramethyl-2-((1r,4r)-4-phenylbicyclo[2.2.1]heptan-1-yl)-1,3,2-dioxaborolane (71). Following General Procedure B on 0.1 mmol scale with 70. Purification by chromatography (hexanes:methylene chloride, 2:1) on silica gel afforded 26.8 mg (90%) of the title compound 71. Physical State: colorless crystal. m.p.: 106-108° C. ¹H NMR (600 MHz, CDCl₃): δ 7.35-7.27 (m, 4H), 7.18 (t, J=7.2 Hz, ¹H), 1.89 (tt, J=10.0, 4.9 Hz, 2H), 1.79-1.67 (m, 6H), 1.56-1.48 (m, 2H), 1.28 (s, 12H) ppm. ¹³C NMR (151 MHz, CDCl₃): δ 146.47, 128.15, 126.67, 125.68, 83.10, 53.87, 45.91, 38.00, 33.66, 24.88 ppm. ¹¹B NMR (128 MHz, CDCl₃): δ 34.60 ppm. MS (GCMS, EI): m/z=298 (20%), 269 (38%), 225 (10%), 170 (100%), 128 (32%). TLC: R_{f}=0.42 (15:1 hexanes:ethyl acetate).

### Compound 73

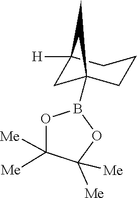 [SMILES: CC1(C)OB([C@]23CCC[C@H](C2)C3)OC1(C)C]

2-(bicyclo[3.1.1]heptan-1-yl)-4,4,5,5-tetramethyl-1,3,2-dioxaborolane (73). Following General Procedure B on 0.1 mmol scale with 72. Purification by chromatography (hexanes:methylene chloride, 2:1) on silica gel afforded 13.5 mg (61%) of the title compound 73. Physical State: colorless oil. ¹H NMR (600 MHz, CDCl₃): δ 2.30 (tt, J=5.9, 3.1 Hz, ¹H), 2.05 (tt, J=7.9, 3.9 Hz, 2H), 1.86-1.73 (m, 6H), 1.40-1.34 (m, 2H), 1.21 (s, 12H) ppm. 13C NMR (151 MHz, CDCl₃): δ 82.92, 34.29, 33.93, 30.18, 29.31, 24.81, 15.89 ppm. ¹¹B NMR (128 MHz, CDCl₃): δ 34.50 ppm. MS (GCMS, EI): m/z=222 (3%), 207 (32%), 181 (12%), 165 (100%), 136 (40%), 121 (76%). TLC: R_{f}=0.49 (15:1 hexanes:ethyl acetate).

### Compound 75

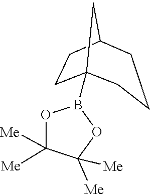 [SMILES: CC1(C)OB(C23CCCC(CC2)C3)OC1(C)C]

2-(bicyclo[3.2.1]octan-1-yl)-4,4,5,5-tetramethyl-1,3,2-dioxaborolane (75). Following General Procedure B on 0.1 mmol scale with 74. Purification by chromatography (hexanes:methylene chloride, 2:1) on silica gel afforded 17.0 mg (72%) of the title compound 75. Physical State: colorless oil. ¹H NMR (600 MHz, CDCl₃): δ 2.17 (s, ¹H), 1.72-1.62 (m, 2H), 1.55-1.37 (m, 10H), 1.21 (s, 12H) ppm. ¹³C NMR (151 MHz, CDCl₃): δ 82.82, 41.89, 36.21, 33.67, 32.67, 31.64, 30.00, 24.78, 19.34 ppm. ¹¹B NMR (128 MHz, CDCl₃): δ 34.50 ppm. MS (GCMS, EI): m/z=236 (8%), 221 (78%), 150 (100%), 136 (38%), 107 (26%). TLC: R_{f}=0.55 (15:1 hexanes:ethyl acetate).

### Compound 77

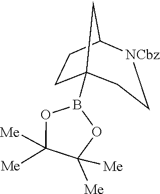 [SMILES: CC1(C)OB(C23CCC(C2)N(C(=O)OCc2ccccc2)CC3)OC1(C)C]

benzyl-5-(4,4,5,5-tetramethyl-1,3,2-dioxaborolan-2-yl)-2-azabicyclo[3.2.1]octane-2-carboxy-late (77). Following General Procedure B on 0.1 mmol scale with 76. Purification by chromatography (hexanes:methylene chloride, 2:1) on silica gel afforded 28.9 mg (78%) of the title compound 77. Physical State: colorless crystal. m.p.: 60-62° C. ¹H NMR (600 MHz, CDCl₃): δ 7.31-7.13 (m, 5H), 5.02 (s, 2H), 4.70-4.49 (m, ¹H), 3.83 (s, ¹H), 3.02-2.82 (m, ¹H), 1.82-1.73 (m, ¹H), 1.73-1.66 (m, ¹H), 1.66-1.59 (m, ¹H), 1.59-1.49 (m, 2H), 1.49-1.45 (m, ¹H), 1.45-1.38 (m, ¹H), 1.35-1.28 (m, ¹H), 1.14 (s, 12H) ppm. 13C NMR (151 MHz, CDCl₃): δ 154.72, 137.27, 128.56, 127.93, 127.86, 83.31, 66.82, 55.03, 41.01, 38.33, 31.96, 30.94, 30.32, 24.80, 24.76 ppm. ¹¹B NMR (128 MHz, CDCl₃): δ 30.19 ppm. MS (GCMS, EI): m/z=371 (8%), 356 (6%), 298 (14%), 280 (100%), 236 (24%), 154 (20%). TLC: R_{f}=0.25 (5:1 hexanes:ethyl acetate).

### G. X-ray Crystallographic Data for Compounds 16, 20, & 26

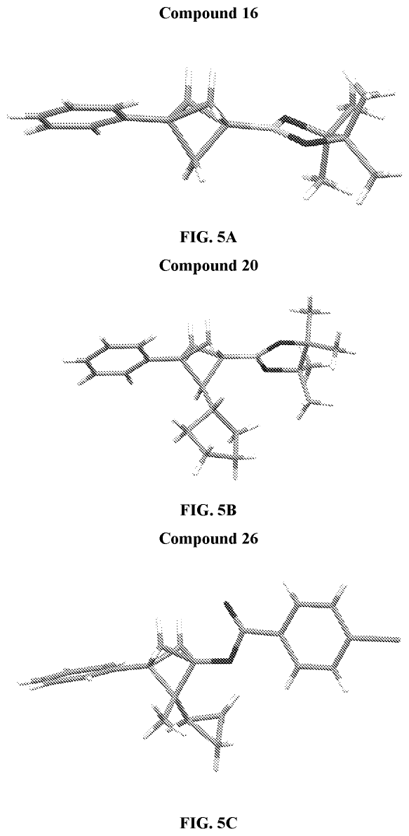

TABLE 1
Crystal data and structure refinement for
16. See crystal structure shown in FIG. 5A.

| Empirical formula | C17 H23 B O2 | |
|---|---|---|
| Formula weight | 270.16 | |
| Temperature | 100.15 | K |
| Wavelength | 1.54184 | Å |

| Crystal system | monoclinic | | |
|---|---|---|---|
| Space group | P 1 21/c 1 | | |
| Unit cell dimensions | a = 11.18795(14) | Å | α = 90°. |
| | b = 15.01936(19) | Å | β = 98.8863(13)°. |
| | c = 18.8670(3) | Å | γ = 90°. |

| Volume | 3132.27(7) | Å³ |
|---|---|---|
| Z | 8 | |
| Density (calculated) | 1.146 | Mg/m³ |
| Absorption coefficient | 0.560 | mm⁻¹ |
| F(000) | 1168 | |
| Crystal size | 0.25 × 0.2 × 0.1 | mm³ |

| Theta range for data | 3.779 to 73.195°. |
|---|---|
| collection | |
| Index ranges | −13 <= h <= 13, −17 <= k <= 18, |
| | −23 <= 1 <= 14 |
| Reflections collected | 17150 |
| Independent reflections | 6129 [R(int) = 0.0149] |
| Completeness to theta = | 99.4% |
| 67.684° | |
| Absorption correction | Semi-empirical from equivalents |
| Max. and min. | 1.00 and 0.886 |
| transmission | |
| Refinement method | Full-matrix least-squares on F² |
| Data/restraints/ | 6129/48/425 |
| parameters | |
| Goodness-of-fit on F² | 1.028 |
| Final R indices | R1 = 0.0406, wR2 = 0.1055 |
| [I > 2sigma(I)] | |
| R indices (all data) | R1 = 0.0430, wR2 = 0.1076 |
| Extinction coefficient | n/a |
| Largest diff. peak and | 0.416 and −0.236 e · Å⁻³ |
| hole | |

TABLE 2
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| O1 | 8257(1) | 2008(1) | −4346(1) | 27(1) |
| O2 | 6409(1) | 2615(1) | −4258(1) | 25(1) |
| C1 | 8081(1) | 2736(1) | −4869(1) | 24(1) |
| C2 | 6689(1) | 2886(1) | −4961(1) | 23(1) |
| C3 | 8806(1) | 3525(1) | −4525(1) | 38(1) |
| C4 | 8544(1) | 2443(1) | −5549(1) | 31(1) |
| C5 | 6284(1) | 3843(1) | −5107(1) | 33(1) |
| C6 | 5988(1) | 2260(1) | −5509(1) | 31(1) |
| C7 | 7199(1) | 1440(1) | −3314(1) | 21(1) |
| C11 | 7065(1) | 685(1) | −2516(1) | 18(1) |
| C12 | 6945(1) | 90(1) | −1902(1) | 18(1) |
| C13 | 7945(1) | −172(1) | −1410(1) | 23(1) |
| C14 | 7797(1) | −754(1) | −855(1) | 28(1) |
| C15 | 6664(1) | −1082(1) | −786(1) | 26(1) |
| C16 | 5663(1) | −823(1) | −1275(1) | 23(1) |
| C17 | 5808(1) | −236(1) | −1822(1) | 19(1) |
| B1 | 7294(1) | 2035(1) | −3980(1) | 21(1) |
| C8 | 8145(1) | 1283(1) | −2633(1) | 25(1) |
| C9 | 6976(2) | 415(1) | −3316(1) | 24(1) |
| C10 | 6227(1) | 1494(1) | −2790(1) | 25(1) |
| C8A | 8154(5) | 651(4) | −2977(3) | 22(1) |
| C9A | 6215(5) | 730(4) | −3241(3) | 24(1) |
| C10A | 7185(6) | 1690(4) | −2532(3) | 27(1) |
| O3 | 7310(1) | −2143(1) | 759(1) | 23(1) |
| O4 | 8162(1) | −3248(1) | 1504(1) | 23(1) |
| C18 | 7688(1) | −1719(1) | 1455(1) | 19(1) |
| C19 | 7856(1) | −2534(1) | 1973(1) | 20(1) |
| C20 | 8860(1) | −1226(1) | 1402(1) | 27(1) |
| C21 | 6719(1) | −1065(1) | 1595(1) | 26(1) |
| C22 | 8876(1) | −2444(1) | 2602(1) | 26(1) |
| C23 | 6696(1) | −2813(1) | 2240(1) | 29(1) |
| C24 | 7733(1) | −3617(1) | 149(1) | 23(1) |
| C28 | 7782(1) | −4350(1) | −671(1) | 21(1) |
| C29 | 7860(1) | −4942(1) | −1297(1) | 21(1) |
| C30 | 8964(1) | −5053(1) | −1544(1) | 25(1) |
| C31 | 9074(1) | −5639(1) | −2101(1) | 30(1) |
| C32 | 8072(1) | −6117(1) | −2421(1) | 30(1) |
| C33 | 6966(1) | −6005(1) | −2189(1) | 28(1) |
| C34 | 6860(1) | −5420(1) | −1628(1) | 24(1) |
| B2 | 7726(1) | −3001(1) | 815(1) | 22(1) |
| C25 | 8079(2) | −3334(1) | −600(1) | 30(1) |
| C26 | 6702(2) | −4163(2) | −277(1) | 33(1) |
| C27 | 8568(2) | −4442(1) | 90(1) | 28(1) |
| C25A | 8721(5) | −3705(4) | −313(3) | 40(2) |
| C26A | 6783(5) | −3640(4) | −587(3) | 42(2) |
| C27A | 7638(5) | −4681(3) | 94(2) | 36(1) |

TABLE 3
Crystal data and structure refinement for
20. See crystal structure shown in FIG. 5B.

| Empirical formula | C22 H31 B O2 | |
|---|---|---|
| Formula weight | 338.28 | |
| Temperature | 100.03(11) | K |
| Wavelength | 1.54184 | Å |

| Crystal system | monoclinic | | |
|---|---|---|---|
| Space group | P 1 21/c 1 | | |
| Unit cell dimensions | a = 6.43554(4) | Å | α = 90°. |
| | b = 16.86422(10) | Å | β = 91.1191(7)°. |
| | c = 18.13096(14) | Å | γ = 90°. |

| Volume | 1967.39(2) | Å³ |
|---|---|---|
| Z | 4 | |
| Density (calculated) | 1.142 | Mg/m³ |
| Absorption coefficient | 0.538 | mm⁻¹ |
| F(000) | 736 | |
| Crystal size | 0.381 × 0.292 × 0.261 | mm³ |

| Theta range for data | 3.580 to 73.301°. |
|---|---|
| collection | |
| Index ranges | −7 <= h <= 7, −20 <= k <= 20, |
| | −21 <= 1 <= 22 |
| Reflections collected | 33374 |
| Independent reflections | 3916 [R(int) = 0.0250] |
| Completeness to theta = | 100.0% |
| 67.684° | |
| Absorption correction | Gaussian and multi-scan |
| Max. and min. | 1.000 and 0.416 |
| transmission | |
| Refinement method | Full-matrix least-squares on F² |
| Data/restraints/ | 3916/116/326 |
| parameters | |
| Goodness-of-fit on F² | 1.036 |
| Final R indices | R1 = 0.0390, wR2 = 0.1006 |
| [I > 2sigma(I)] | |
| R indices (all data) | R1 = 0.0408, wR2 = 0.1022 |
| Extinction coefficient | n/a |
| Largest diff. peak and hole | 0.248 and −0.205 e · Å⁻³ |

TABLE 4
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| C7 | 3203(2) | 3793(1) | 6364(1) | 25(1) |
| C11 | 4624(2) | 4066(1) | 7262(1) | 22(1) |
| C12 | 5673(2) | 4291(1) | 7972(1) | 22(1) |
| C13 | 7479(2) | 4743(1) | 7991(1) | 28(1) |
| C14 | 8412(2) | 4957(1) | 8660(1) | 32(1) |
| C15 | 7535(2) | 4726(1) | 9318(1) | 29(1) |
| C16 | 5736(2) | 4276(1) | 9306(1) | 28(1) |
| C17 | 4814(2) | 4060(1) | 8638(1) | 26(1) |
| B1 | 2041(2) | 3557(1) | 5632(1) | 25(1) |
| O1 | 2708(1) | 3771(1) | 4947(1) | 27(1) |
| O2 | 296(1) | 3098(1) | 5613(1) | 28(1) |
| C1 | 1109(2) | 3520(1) | 4412(1) | 25(1) |
| C2 | −80(2) | 2867(1) | 4844(1) | 26(1) |
| C3 | 2179(3) | 3225(1) | 3721(1) | 33(1) |
| C4 | −229(3) | 4240(1) | 4236(1) | 41(1) |
| C5 | 852(3) | 2043(1) | 4758(1) | 32(1) |
| C6 | −2408(2) | 2827(1) | 4701(1) | 36(1) |
| C8 | 4136(3) | 3196(1) | 6967(1) | 19(1) |
| C9 | 2247(6) | 4228(2) | 7063(2) | 24(1) |
| C10 | 5098(4) | 4312(2) | 6478(2) | 23(1) |
| C18 | 5847(3) | 2634(1) | 6759(1) | 20(1) |
| C19 | 4956(13) | 1849(4) | 6417(3) | 26(1) |
| C20 | 6707(11) | 1308(4) | 6494(4) | 31(1) |
| C21 | 8312(3) | 1642(1) | 7054(1) | 35(1) |
| C22 | 7134(17) | 2306(7) | 7421(5) | 32(1) |
| O1A | 2880(20) | 3254(11) | 5092(9) | 30 |
| O2A | −240(20) | 3567(11) | 5584(7) | 30 |
| C1A | 1280(20) | 2983(10) | 4566(9) | 30 |
| C2A | −630(20) | 3477(10) | 4796(8) | 30 |
| C3A | 1920(70) | 3320(30) | 3826(14) | 35 |
| C4A | 1210(70) | 2089(11) | 4630(20) | 35 |
| C5A | −790(50) | 4310(12) | 4467(16) | 35 |
| C6A | −2760(30) | 3184(16) | 4598(15) | 35 |
| C8A | 5217(6) | 3350(2) | 6734(2) | 20(1) |
| C9A | 2447(14) | 3953(4) | 7088(5) | 29(2) |
| C10A | 4760(12) | 4589(4) | 6490(4) | 26(1) |
| C18A | 4916(8) | 2525(2) | 7035(3) | 26(1) |
| C19A | 4920(30) | 1944(12) | 6386(10) | 31(2) |
| C20A | 6900(30) | 1257(12) | 6429(9) | 24(2) |
| C21A | 7463(12) | 1435(3) | 7257(3) | 42(1) |
| C22A | 7040(40) | 2312(17) | 7430(14) | 32(1) |

TABLE 5
Crystal data and structure refinement for
26. See crystal structure shown in FIG. 5C.

| Empirical formula | C22 H21 Br O2 | |
|---|---|---|
| Formula weight | 397.30 | |
| Temperature | 100.02(13) | K |
| Wavelength | 1.54184 | Å |

| Crystal system | triclinic | | |
|---|---|---|---|
| Space group | P-1 | | |
| Unit cell dimensions | a = 10.0725(5) | Å | α = 71.172(5)°. |
| | b = 10.0782(6) | Å | β = 78.694(4)°. |
| | c = 10.7457(5) | Å | γ = 64.096(5)°. |

| Volume | 926.78(9) | Å³ |
|---|---|---|
| Z | 2 | |
| Density (calculated) | 1.424 | Mg/m³ |
| Absorption coefficient | 3.107 | mm⁻¹ |
| F(000) | 408 | |
| Crystal size | 0.238 × 0.131 × 0.059 | mm³ |

| Theta range for data | 4.356 to 73.648°. |
|---|---|
| collection | |
| Index ranges | −12 <= h <= 12, −12 <= k <= 11, |
| | −13 <= 1 <= 13 |
| Reflections collected | 20626 |
| Independent reflections | 3682 [R(int) = 0.0339] |
| Completeness to theta = | 99.9% |
| 67.684° | |
| Absorption correction | Gaussian and multi-scan |
| Max. and min. | 1.000 and 0.593 |
| transmission | |
| Refinement method | Full-matrix least-squares on F² |
| Data/restraints/ | 3682/167/292 |
| parameters | |
| Goodness-of-fit on F² | 1.086 |
| Final R indices | R1 = 0.0302, wR2 = 0.0717 |
| [I > 2sigma(I)] | |
| R indices (all data) | R1 = 0.0317, wR2 = 0.0724 |
| Extinction coefficient | n/a |
| Largest diff. peak and | 0.708 and −0.776 e · Å⁻³ |
| hole | |

TABLE 6
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| Br1 | 10653(1) | 1668(1) | −849(1) | 36(1) |
| O1 | 7791(2) | 4783(2) | 4327(1) | 33(1) |
| O2 | 8838(2) | 2320(2) | 5493(2) | 38(1) |
| C1 | 9039(2) | 2937(2) | 3144(2) | 28(1) |
| C2 | 8643(2) | 4070(2) | 1961(2) | 30(1) |
| C3 | 9105(2) | 3689(2) | 773(2) | 30(1) |
| C4 | 9969(2) | 2179(2) | 780(2) | 30(1) |
| C5 | 10375(2) | 1032(2) | 1941(2) | 33(1) |
| C6 | 9902(2) | 1422(2) | 3123(2) | 32(1) |
| C7 | 8566(2) | 3272(2) | 4451(2) | 29(1) |
| C8 | 7278(2) | 5275(2) | 5507(2) | 31(1) |
| C12 | 6556(2) | 6051(2) | 6951(2) | 30(1) |
| C13 | 5941(2) | 6714(2) | 8093(2) | 30(1) |
| C14 | 6698(2) | 7303(3) | 8565(2) | 35(1) |
| C15 | 6093(3) | 7956(3) | 9610(2) | 39(1) |
| C16 | 4720(3) | 8041(3) | 10194(2) | 38(1) |
| C17 | 3950(3) | 7467(3) | 9729(2) | 42(1) |
| C18 | 4559(3) | 6801(3) | 8690(2) | 39(1) |
| C9 | 6110(3) | 6912(3) | 5483(3) | 29(1) |
| C10 | 8202(4) | 5412(4) | 6414(4) | 32(1) |
| C11 | 6475(5) | 4605(4) | 6775(4) | 40(1) |
| C19 | 6533(3) | 8250(3) | 4786(3) | 30(1) |
| C20 | 7900(3) | 8165(3) | 3897(3) | 35(1) |
| C21 | 6437(3) | 8900(3) | 3316(3) | 40(1) |
| C22 | 4506(3) | 7372(4) | 5228(3) | 40(1) |
| C9A | 6720(10) | 7036(11) | 5392(11) | 32(2) |
| C10A | 8112(16) | 4866(17) | 6716(16) | 40(3) |
| C11A | 5964(15) | 5179(15) | 6391(13) | 36(2) |
| C19A | 5321(10) | 8125(10) | 4723(8) | 36(2) |
| C20A | 4694(12) | 7803(12) | 3752(10) | 41(2) |
| C21A | 5406(13) | 8909(11) | 3274(8) | 41(2) |
| C22A | 7811(12) | 7787(13) | 5103(12) | 44(3) |

### H. Results

The retrosynthetic analysis to multi-substituted BCPs (strain energy ˜71 kcal/mol) relies on cyclization from cyclobutanones 9 (strain energy for cyclobutane ˜26 kcal/mol) (Wiberg, 2009). However, previous studies indicated that base-initiated intramolecular substitution proved unsuccessful in BCP formation (Wiberg and Connor, 1966), presumably due to the unusual strain energy present in the desired target. Taking inspiration from our (Yang et al., 2021) and other's prior studies (Barluenga et al., 2009; Préz-Aguilar and Valdés, 2012; Plaza and Valdés, 2016; Plaza et al., 2018; Plaza et al., 2019; Merchant and Lopez, 2020; Arunprasath et al., 2019; Li et al., 2012) on base-promoted cross-coupling between alkyl sulfonylhydrazones and boronic acids, we surmised that base-mediated intramolecular coupling of cyclobutane-tethered sulfonyl hydrazones and boronates might enable the formation of a high energy bicyclic [2.1.1] zwitterionic intermediate 10.

Furthermore, it was hypothesized that this high-energy intermediate might undergo subsequent 1,2-metallate rearrangement to form BCP 11 via extrusion of N₂. While the C-B bond in 10 is not perfectly aligned with the leaving group, the loss of N₂ could help drive the subsequent 1,2-metallate rearrangement and contraction to the desired BCP scaffold 11 (Tani and Stoltz, 2006; Davenport et al., 2020). An alternative mechanism for the proposed transformation would proceed via formation of a bridgehead cation followed by 1,2-alkyl migration. Aryl and alkyl boron pinacol esters (Bpin) have a priori been reported as recalcitrant coupling partners in Barluenga-Valdés coupling (Barluenga et al., 2009; Préz-Aguilar and Valdés, 2012; Plaza and Valdés, 2016; Plaza et al., 2018; Plaza et al., 2019; Merchant and Lopez, 2020; Arunprasath et al., 2019; Li et al., 2012) and its modifications (Yang et al., 2021) However, from a both practicality and ease of access perspective, alkyl Bpins were identified as ideal starting materials. Additionally, it was envisioned that the short spatial distance between the tethered coupling partners might help overcome the poor reactivity of the Bpin, thereby enabling the intramolecular cyclization to occur. To test this theory, the key intermediate 13 was prepared in one-step using boron-preserving cross-coupling conditions from cyclobutane aldehyde 12 (Table 2) (Yang et al., 2021). Subjecting 13 to in situ hydrazone formation followed by our previously reported conditions for intermolecular cross-coupling, gratifyingly afforded the desired bridgehead Bpin substituted BCP product 14 in 78% yield (Entry 6). Subsequent optimization of sulfonylhydrazide, base, solvent and temperature (summarized in Table 2) resulted in the identification of optimal conditions, employing mesitylsulfonyl hydrazide, cesium carbonate and dioxane to afford the coupling product 14 in 83% isolated yield (88% GC yield) (Entry 1). The use of mesitylsulfonyl hydrazide as the activation reagent was found to be the key for effecting efficient hydrazone condensation and in situ generation of the diazo intermediate (Entries 2 and 3, starting material 13 is left for these two cases). The selection of base (Entries 4 and 5) and solvent (Entries 6 and 7) were also important for obtaining high yield for this cyclization. Varying the temperatures also afforded the desired product 14 (Entries 8 and 9), albeit in lower yields. It is noteworthy that the reaction does not require inert atmosphere and proceeds smoothly under air, presumably due to the improved stability of the Bpin motif in comparison to its B(OH)₂ counterpart (Entry 10).

TABLE 2
Cyclization Optimization to Access BCPs

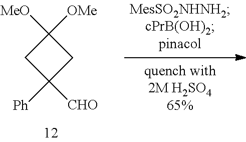 [SMILES: COC1(OC)CC(C=O)(c2ccccc2)C1]

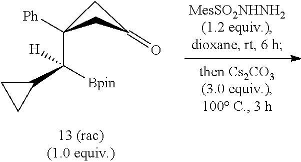

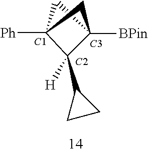

| entry | deviation from above (13 to 14) | yield (%)^{a,b} |
|---|---|---|
| 1 | none | 88 (83) |
| 2 | TsNHNH₂ in place of MesSO₂NHNH₂ | 63 |
| 3 | TrisylNHNH₂ in place of MesSO₂NHNH₂ | 67 |
| 4 | K₂CO₃ in place of Cs₂CO₃ | 26 |
| 5 | KOtBu in place of Cs₂CO₃ | 18 |
| 6 | PhCl in place of dioxane | 78 |
| 7 | DMF in place of dioxane | 52 |
| 8 | reaction performed at 80° C. | 78 |
| 9 | reaction performed at 110° C. | 75 |
| 10 | stirred open to air | 77 |

^{a}Yield determined by GC analysis with trimethoxybenzene as an internal standard;
^{b}Yield in parenthesis is isolated yield;
Mes = mesityl;
cPr = cyclopropyl;
Ts = tosyl;
Trisyl = triisopropylbenzenesulfonyl.

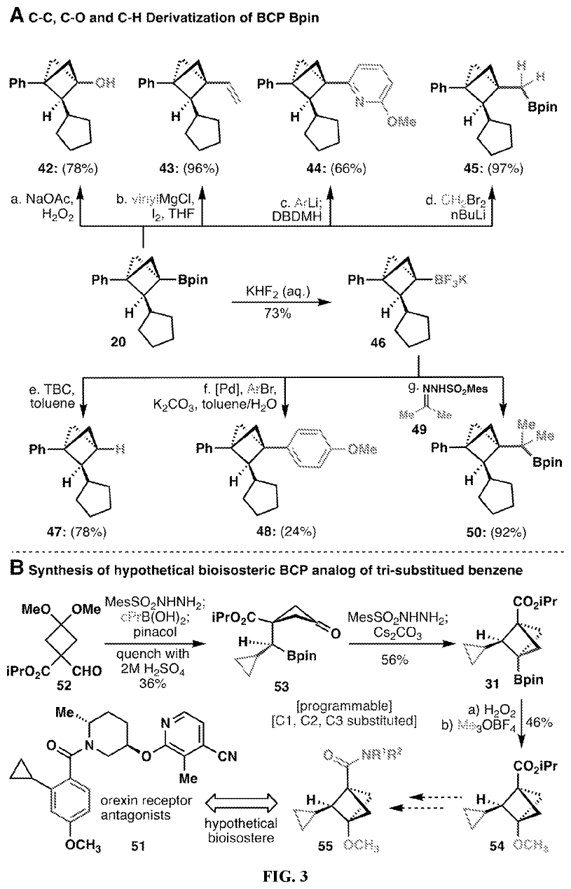

With the optimal conditions in hand, the substrate scope of this intramolecular cyclization to access di-, tri-, and tetra-substituted BCPs was systematically investigated (FIG. 2). With the hypothesis that this cyclization would be influenced by the conformation of cyclobutane 9, exploration commenced with a sterically large phenyl group (A value=3.0) on cyclobutane ring.²³ The cyclobutanone Bpins 9 were prepared from the corresponding aldehydes, ketones, esters and halides (Tani and Stoltz, 2006; Davenport et al., 2020; Yang et al., 2012; Stymiest et al., 2007; Li et al., 2014; Li et al., 2012; Bonet et al., 2011; Kisan et al., 2017; Yamamoto et al., 2004). A primary alkyl Bpin (R₂═H, R₃═H) underwent smooth cyclization to the C1, C3 disubstituted BCP Bpin 16. Starting from secondary alkyl Bpins, a variety of C1, C2 and C3 trisubstituted BCPs, including C2-alkyl (17-22, 11) and C2-aryl substituted (23) BCP Bpins were prepared. Lastly, subjecting tertiary alkyl Bpin starting materials to cyclization condensations afforded BCPs with di-substituted C₂ side chains (24, 25). The structures of BCPs 16, 20 and 26 were unambiguously assigned by single crystal X-ray analysis. From this structural data, it is clear to observe that the substitution on the C2 of BCP reduces the C1-C₂-C₃ angle due to Thorpe-Ingold effect (75.7° in 16, 73.6° in 20, 72.1° in 26). In addition to Ph at C1, other medicinal chemistry relevant motifs such as, halogenated aryls (4-chlorophenyl, 28), electron-rich heterocycles (2-thiophene, 27), and Lewis-basic heterocycles (3-pyridyl, 29) were all compatible in this cyclization. Smaller alkyl substitutions, including methyl (A value=1.7, 32) or isopropyl (33) could also be incorporated at R₁ to promote smooth cyclization to the corresponding products. It is noteworthy that the cyclization could also be performed with a variety of functional groups that allow for further downstream functionalizations, including amide (30), isopropyl ester (A value=1.2, 31), vinyl (A value=1.35, 34), terminal alkyne (A value=0.41, 35) and amine (36). In addition to the aryl- and alkyl substitutions at C2, productive cyclization of gem-diborylated (Li et al., 2014) precursors provides the 37 di-Bpin substituted BCP. This substrate opens avenues for further diversification. The asymmetric BCP 38 was cyclized from its chiral Bpin precursor in a 69% yield with slightly ee erosion. Besides the above-mentioned substitutions on the cyclobutanone side chain (R² and/or R³) to C2-substitued BCPs, the cyclobutane ring itself can be prefunctionalized (FIG. 2B). To that end, the methyl substituted cyclobutanone 39 (single diastereomer, stereochemistry unassigned) was cyclized to 17 in 42% yield. This compound exemplifies the possibility of accessing more complicated BCPs via cyclobutanone prefunctionalization.

The robustness of this reaction was highlighted by accessing 20 on gram scale (3.7 mmol, 89%) in a similar yield to that on 0.1 mmol scale and under identical conditions. Consistent with the initial hypothesis that an axial conformation of the Bpin-containing side chain is crucial for the success of this cyclization, lower yields were observed when a smaller R₁ group was incorporated on the cyclobutanone starting material (as observed by A value trends, vide supra). Currently, the only limitation for this methodology (FIG. 2C) was found when attempting the cyclization of substrates with a small R₁ group (e.g. R₁═H, 40) and when R₁=Bpin (41) (Fasano et al., 2020).

As illustrated in FIG. 3, the strategic impact of this methodology shines in its ability to combine the modularity of preparing C2-substituted BCP Bpins (via cross-coupling) and leveraging the plethora of existing transformations for Bpin functionalization for downstream diversification of the BCP bridgehead position. (FIG. 3). For example, the oxidation of boronic ester 20 led to the alcohol (42) in high yield. Additionally, 20 was subjected to Zweifel olefination (Zweifel et al., 1967; Armstrong and Aggwaral, 2017), Aggwaral's arylation protocol (Odachowski et al., 2016), and Matteson homologation (Sadhu et al., 1985) to afford C—C bond-forming products 43, 44 and 45, respectively. The Bpin group can also be transformed to the more stable trifluoroborate salt (46), which opens further functionalization opportunities. Radical proto-deborylation (Pozzi et al., 2005; André-Joyaux et al., 2020) results in C1, C2-disubstituted BCPs (47), and C(sp³)-C(sp²) Pd catalyzed Suzuki cross-coupling conditions (Li et al., 2014; Dreher et al., 2008) enables arylation at the bridge head (48). Lastly, cross-coupling of the in situ-generated boronic acid with sulfonylhydrazone 49 (Tani and Stoltz, 2006; Davenport et al., 2020) affords the Bpin 50 in 92% yield. Therefore, this strategy allows for systematic introduction of substitutions at any position of the BCP, including the bridgeheads (C1 and/or C3) as well as the backbone (C2, mono- and di-). Importantly, this enables the practitioner to access a wide range of substituted BCPs that can serve as bioisosteres for ortho-, meta- or para-substituted benzene rings.

As illustrated in FIG. 3B, compound 51 was developed by Merck and Co. as an orexin receptor antagonists to treat insomnia (WO 2014/066196). While this drug possesses a 1,3,4-trisubstituted benzene ring within its structure, previous methods to access functionalized BCPs were not conducive to the preparation of a saturated trisubstituted analogue. In contrast, this methodology provides straightforward and modular access to its higher fraction sp³ (Fsp³) BCP analog 55, via a sequence of 1) cPr installation (53), 2) cyclization (31), 3) Bpin oxidation to alcohol, 4) alkylation (54), and subsequent hydrolysis/amide coupling (55).

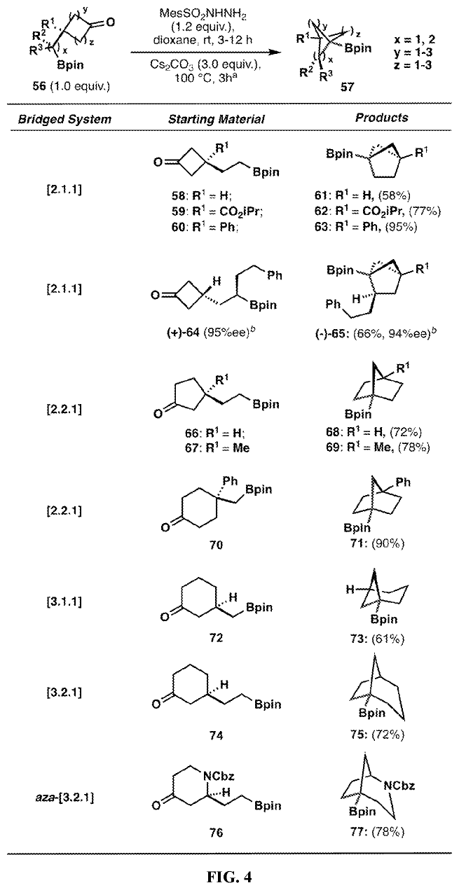

Besides BCPs, other bicyclic scaffolds have also been showcased or proposed as potential saturated bioisosteres. Often the bottleneck in performing SAR (Structure-Activity Relationship) studies on these ring systems, at the bridgehead positions in particular, is the lack of unified synthetic strategies to access suitable diversifiable building blocks. As delineated in FIG. 4, this cyclization enables the construction of a wide range of bicyclic rings systems with the versatile Bpin preserved at the bridgehead position. Starting from a range of cyclobutanones (58-60, 64), cyclopentanones (66, 67) and cyclohexanones (70, 72, 74), in combination with pendant boronic ester side chains of varying length, bicyclo[2.1.1](61-63, 65), [2.2.1](68, 69, 71), [3.1.1](73) and [3.2.1](75) systems were successfully prepared using these coupling conditions. Depending on the ease of accessibility of the starting material, [2.2.1] bicycles could be accessed from either cyclopentanones (66, 67) or cyclohexanones (70). Saturated ring systems with a heteroatom embedded in them could also be prepared using this protocol, as demonstrated by the aza-[3.2.1]bicycle (77). Notably, starting from a chiral alkyl Bpin, this protocol allows for complete transfer of chiral information into the bicyclic products and enables the asymmetric synthesis of these valuable bioisosteres. For example, the chiral cyclobutanone Bpin 64 (Stymiest et al., 2007) provided chiral [2.1.1] bicycle 65 with no erosion of ee.

In conclusion, a novel intramolecular cyclization has been developed to access C1-, C2- and C3-substituted BCPs. As showcased in FIG. 2 and FIG. 3, this operationally simple and chemoselective method enables rapid and modular preparation of a variety of synthetically challenging boronate-substituted BCPs. Synergistic application with existing Bpin functionalization strategies allows for rapid diversification and synthesis of complex bioisosteres that are highly desired in drug discovery. In addition, this method was successfully implemented to prepare a range of other pharmaceutically relevant bicyclic bioisosteres (FIG. 4) that have yet to be fully explored. As a result, this method is expected to have a substantial impact within drug discovery, specifically in how benzene replacements are designed and incorporated into targets of interest.

### Example 2: Bis-boronate Compounds and Methods of Use

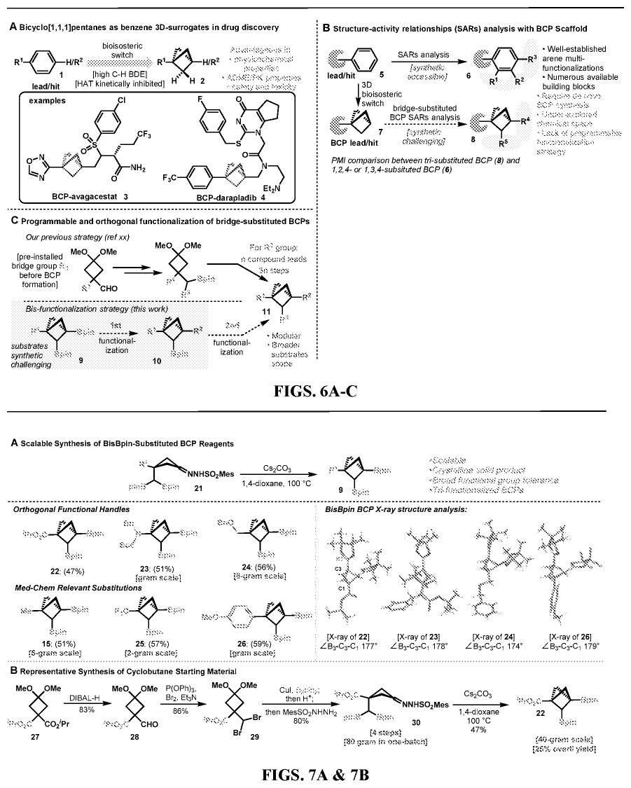

Chemical space is infinite which provides boundless opportunities for medicinal chemists, within which three-dimensional scaffolds with drug-like properties are particularly sought after. In the past decade, owing to their unique physical and chemical properties, bicyclo[1.1.1]pentane (BCP) motif has increasingly gained attention in the medicinal chemistry community as a bioisosteric replacement of aromatic moieties. This consideration was driven by its potential to alter physicochemical, pharmacological, ADME and safety properties of drug candidates (FIG. 6A). Bridgehead (C1 and C3) substituted BCPs are now widely recognized as saturated bioisosteres for mono- and para-substituted benzenes and analogously, it has been hypothesized that C2-substituted BCPs represent bioisosteres of ortho- and meta-substituted benzenes. However, despite the recent reports from Baran, Ma, and our groups to prepare bridge-substituted BCPs, the practical applications of such BCPs in medicinal chemistry have been heavily restricted owing to synthetic challenges in accessing them.

The advances in cross-coupling chemistry have led to rapid and programmable SAR studies of substituted aromatics in drug development (FIG. 6B). In contrast, on switching out the sp² system for its sp³-rich bioisostere, such as C2-substituted BCPs, each analog requires multi-step de novo synthesis, making synthetic challenge the biggest bottleneck to access and evaluate these compounds. Moreover, the PMI metric, a theoretical method used to evaluate and estimate overall library shape, indicates the multi-substituted BCPs populated a 3D shape in comparison with tri-substituted benzenes (FIG. 6B). Therefore, to enable the SAR campaigns with BCPs, it is imperative to develop a modular and programmable strategy to access C1 and C2-substituted and C1, C2 and C3-substituted BCPs.

The strain-induced stable C-H bonds in BCPs provide advantageous metabolic stability, but also create the synthetic hurdles to access their derivatives. To construct multi-substituted BCPs (C1, C2 and C3), our group reported the intramolecular coupling of cyclobutane-tethered sulfonylhydrazones and boronic esters. Despite the successful functionalization of C2 BCP position, the installation of bridge-substitution group prior to the cyclization substantially increased the synthetic steps (FIG. 6C). Strain-release strategy from propellane offers an alternative approach to C2-substituted BCP. However, specific propellane preparation is often required. To address the aforementioned issues, the goal was to identify a late-stage BCP intermediate with two functional handles that could be selectively modified to pursue divergent SAR. To that end, the group reported two cases with C1 alkyl substitutions to introduce boronate at C2 position, where an intramolecular cyclization of geminal bisBpin pendant cyclobutyl hydrazone afforded the BCPs bearing Bpin substituents at both C2 and C3. Inspired by breakthrough works reported by Morken and others, these bis-boronate BCPs could be used selectively and provide for sequentially functionalization (FIG. 6C) and this synthetic strategy would provide an efficient method to access C1, C2-di- and tri-substituted BCPs.

### A. Results and Discussion

The advantages of this strategy for accessing bridge-substituted BCPs not only rest onto its modularity, but also were illustrated by the synthetic efficacy and practicality of various bisBpin BCPs preparation, in particularly for the ones bearing important medicinal relevant substituents and orthogonal functional handles such as carboxylate ester, trifluoromethyl group and amine. In a previous study, the alkyl substituted bisBpin BCPs (25) were synthesized from readily accessible starting materials in a gram scale and moderate yield (FIG. 7A). But during the attempts to synthesize the carboxylic ester, CF₃ and aryl substituted bisBpin BCPs, this synthetic pathway was found to be incompetent, which is plagued by the hardly access of germinal bisBpin precursors (yield <5%) and the diminished yield in intramolecular cyclization. Gratifyingly, these BCPs were successfully accessed (22, 23, 27) by crucial modifications including diborylation of germinal dibromo compounds instead of diborylation of sulfonylhydrazone, and a “dry” cyclization condition (pre-preparation of sulfonylhydrazone, dry solvent and base). Taken the ester C1-substituted BCP 22 as an example, the detailed synthetic route was listed in FIG. 7A. Starting from affordable cyclobutene 28, the cyclobutyl sulfonylhydrazone 31 was generated in high yields through a sequence of DIBAL-H reduction, debromination and diborylation. The cesium carbonate-mediate cyclization robustly afforded carboxylate bisBin BCP 22 in 40-gram scale at one-pass without contamination of yield. Notably, all the synthesized bisBpin BCPs are stable crystalline solids for several months at -20° C.

### B. General Experimental

Tetrahydrofuran (THF), diethyl ether (Et₂O), toluene and dichloromethane (CH₂Cl₂) were obtained by passing the previously degassed solvents through an activated alumina column. Dioxane and reagents were purchased at the highest commercial quality and used after it was distilled under argon atmosphere from sodium benzophenone ketyl. Pinacol was purchased from TCI and used without further purification. Cesium carbonate (Cs₂CO₃), boronic acid, boronic acid pinacol ester and ketones were purchased from BLD Pharmatech Co., Sigma-Aldrich, Synthonix and Combi-Blocks, which were used without further purification. Yields refer to chromatographically and spectroscopically (¹H NMR) homogeneous material. Reactions were monitored by GC-MS (Rtx-5MS, 30 m, 0.25 mm ID, 0.25 μm), GC-FID (SH-Rxi-5Sil MS, 30 m, 0.25 mm ID, 0.25 μm), LC/MS, and thin layer chromatography (TLC). TLC was performed using 0.25 mm E. Merck silica plates (60F-254), using short-wave UV light as the visualizing agent, and phosphomolybdic acid and CAM (H₂SO₄, ammonium molybdate and ceric ammonium sulfate), or KMnO₄ and heat as developing agents. NMR spectra were recorded on Bruker Ascend-600 spectrometers, Varian Inova-400 spectrometers and Bruker Ascend-400 spectrometers instruments and are calibrated using residual undeuterated solvent (CHCl₃ at 7.26 ppm ¹H NMR, 77.16 ppm ¹³C NMR; acetone at 2.05 ppm ¹H NMR, 29.84, 206.26 ppm ¹³C NMR; DMSO at 2.50 ppm ¹H NMR, 39.52 ppm ¹³C NMR; methanol at 3.31 ppm ¹H NMR, 49.00 ppm ¹³C NMR). The following abbreviations were used to explain multiplicities: s=singlet, d=doublet, t=triplet, q=quartet, m=multiplet, br=broad. ¹³C signals adjacent to boron are generally not observed due to quadrupolar relaxation. Column chromatography was performed using E. Merck silica (60, particle size 0.043-0.063 mm), and preparative TLC was performed on Merck silica plates (60F-254). Melting points were recorded on a Fisher Scientific™ melting point apparatus (12-144) and are uncorrected. Optical rotation data was recorded on a JAS DIP-360 digital polarimeter. Chiral HPLC analyses were performed on an Agilent 1200 Series system.

### C. BCP Bisboronates

### V. Decagram-Scale Synthesis of BCP BisBoronates xxCO₂ⁱPr (R¹═CO₂ⁱPr)

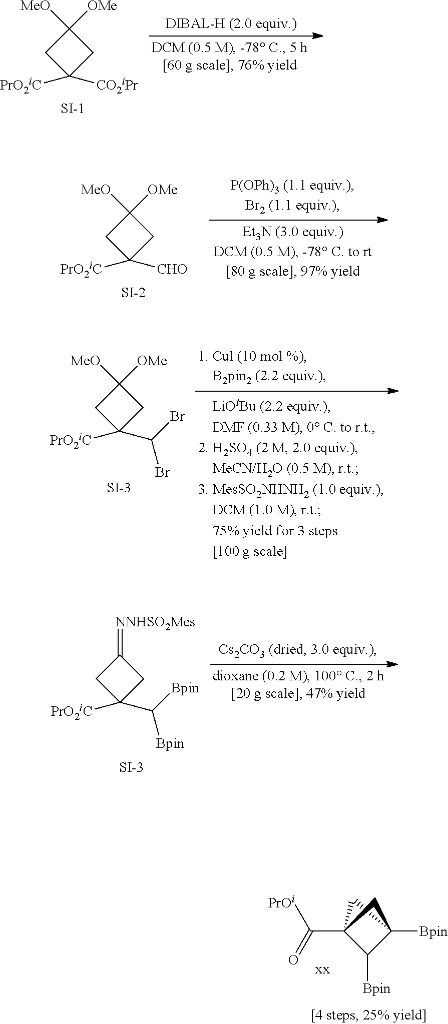

### 64. Step 1: Synthesis of SI-2

A 2-L three-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with diisopropyl 3,3-dimethoxycyclobutane-1,1-dicarboxylate, SI-1, (103.8 g, 360 mmol, 1.0 equiv.). Methylene chloride (720 mL) was added into the flask and the mixture was cooled in a dried ice-acetone bath (−78° C.) and stirred for 15 minutes. Next a solution of DIBAL-H (720 mL, 1 M in hexanes, 2.0 equiv., pre-cooled at −78° C.) was added dropwise into the flask through a dropping funnel at −78° C. in 2 hours and the mixture was allowed to stir at −78° C. for another 3 hours. After it was confirmed that the starting material, SI-1, was consumed through TLC analysis, the reaction was quenched at −78° C. with methanol (24 mL, 720 mmol, 2.0 equiv.). After the reaction was slowly warmed to room temperature, water (29 mL), 20% NaOH (29 mL) and water (72 mL) was slowly added into the reaction mixture in sequence and the mixture was allowed to stir for another 30 minutes. Next, excess Na₂SO₄ was added to dry the reaction mixture and the suspension was filtered through Celite. Solvents was removed under vacuum and the crude product was purified through flash chromatography (hexanes:ethyl acetate, 5:1) on silica gel to afford 63 g (76%) of the title compound SI-2. Spectroscopic data of the product SI-2 matches that reported in the literature (Yang et al., 2021).

### 65. Step 2: Synthesis of SI-3

A 2-L three-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with triphenyl phosphite (78 mL, 300 mmol, 1.1 equiv.). Methylene chloride (340 mL) was added into the flask and the mixture was cooled to −78° C. Then bromine (15 mL, 300 mmol, 1.1 equiv.) was added slowly into the flask, followed by addition of triethyl amine (140 mL, 1.0 mol, 3.3 equiv.). Next, the solution of SI-2 (63 g, 270 mmol, 1.0 equiv.) in 160 mL methylene chloride was added into the mixture and the reaction was warmed up to room temperature. After it was confirmed that the starting material, SI-2, was consumed through TLC analysis, solvent was removed by rotary evaporator and the crude product was purified through flash chromatography (hexanes:ethyl acetate, 20:1) on silica gel to afford 87 g (97%) of the title compound SI-3.

### 66. Compound SI-3

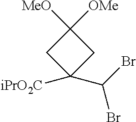

isopropyl 1-(dibromomethyl)-3,3-dimethoxycyclobutane-1-carboxylate (16) Physical State: colorless oil. ¹H NMR (600 MHz, CDCl₃): δ 6.03 (s, 1H), 5.10 (hept, J=6.3 Hz, 1H), 3.15 (d, J=1.3 Hz, 6H), 2.72-2.66 (m, 2H), 2.48-2.42 (m, 2H), 1.28 (d, J=6.3 Hz, 6H) ppm. ¹³C NMR (151 MHz, CDCl₃) δ 170.41, 96.85, 69.77, 49.87, 48.79, 48.75, 48.57, 40.13, 21.74. ppm. MS (GCMS, EI): m/z=345 (1.5%), 343 (3%), 341 (1.5%), 255 (8%), 201 (29%), 88 (100%). TLC: R_{f}=0.32 (10:1 hexanes:ethyl acetate).

### 67. Step 3: Synthesis of SI-4

A 2-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with copper(I) iodide (4.88 g, 25.6 mmol, 0.1 equiv.), B₂pin₂ (140 g, 550 mmol, 2.2 equiv.), and lithium tert-butoxide (44.0 g, 550 mmol, 2.2 equiv.). After being evacuated and backfilled with argon from a balloon 3 times, DMF (500 mL) was added into the flask at 0° C. Then a solution of SI-3 (256 mmol, 95.6 g, 1.0 equiv.) in DMF (250 mL) was added slowly into the mixture at 0° C. in 15 minutes and the reaction mixture was allowed to slowly warm to room temperature and stir for another 1 hour. After it was confirmed that the starting material, SI-3, was consumed through TLC analysis, the reaction was filtered through Celite, washed with diethyl ether (200 mL) and quenched at 0° C. with water (500 mL) (Caution: the quenching process is exothermic). The mixture was transferred into a 6-L flask and diluted with water (1.5 L) and diethyl ether (300 mL). After the mixture was stirred for 30 minutes at room temperature, the two-phase solution was transferred into a 3-L separation funnel. The aqueous phase is separated and extracted with two 200-mL portions of diethyl ether. The combined organic layers are washed with the mixture of 200 mL water and 200 mL saturated NaCl solution twice, dried over Na₂SO₄, and filtered through Celite.

After solvent was removed by rotary evaporator, the crude product was redissolved in 250 mL acetonitrile in a 1-L flask. 2M H₂SO₄ (256 mL, 2.0 equiv.) was added into the mixture at room temperature and the reaction was allowed to stir for another 1.5 hours. After it was confirmed that the ketal intermediate was consumed through TLC analysis, the crude reaction is concentrated to remove excess acetonitrile. Then diethyl ether (400 mL) and saturated brine (150 mL) is added to the reaction mixture and the mixture is transferred to a 1-L separatory funnel. The aqueous layer is separated and further extracted with diethyl ether (3×150 mL). The combined organic layers are dried over Na₂SO₄, filtered through Celite. Excess solvent was removed by rotary evaporator.

The crude product was redissolved in 250 mL methylene chloride in a 500 mL-flask and mesitylene sulfonyl hydrazide (54.9 g, 256 mmol, 1.0 equiv.) was added. The mixture was allowed to stir at room temperature for another 2 hours. After it was confirmed that the ketone intermediate was consumed through TLC analysis, the crude reaction is concentrated to remove excess solvent. The crude product was purified through flash chromatography (hexanes:ethyl acetate, 4:1 to 2:1) on silica gel to afford 116 g (73%) of the title compound SI-4.

### 68. Compound SI-4

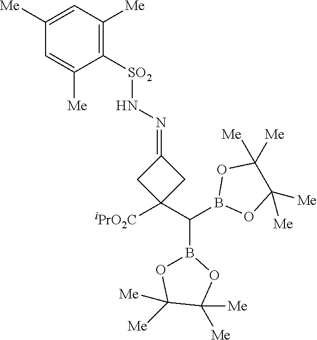

Isopropyl 1-(bis(4,4,5,5-tetramethyl-1,3,2-dioxaborolan-2-yl)methyl)-3-(2-(mesitylsulfonyl)-hydrazineylidene)cyclobutane-1-carboxylate (16) Physical State: white solid. m.p.: 85-87° C. ¹H NMR (600 MHz, Acetone-d₆) δ 9.17 (s, 1H), 7.02 (s, 2H), 4.90 (hept, J=6.2 Hz, 1H), 3.23 (ddd, J=17.6, 3.3, 1.7 Hz, 1H), 3.12 (dt, J=17.0, 2.5 Hz, 1H), 3.05-2.98 (m, 1H), 2.94 (ddd, J=17.1, 3.4, 1.5 Hz, 1H), 2.65 (s, 6H), 2.28 (s, 3H), 1.22 (s, 1H), 1.19 (d, J=6.3 Hz, 3H), 1.18 (d, J=6.6 Hz, 3H), 1.17 (s, 6H), 1.16 (s, 6H), 1.13 (s, 12H) ppm. ¹³C NMR (151 MHz, Acetone-d₆) δ 176.43, 154.40, 143.07, 140.75, 134.85, 132.46, 83.83, 83.78, 68.79, 45.17, 43.93, 40.62, 25.18, 25.06, 24.74, 23.44, 21.80, 21.76, 20.85 ppm. ¹¹B NMR (128 MHz, CDCl₃): δ 32.98 ppm. HRMS (ESI-TOF): calc'd for C₃₀H₄₈B₂N₂O₈S [M+H]⁺: 619.3390, found: 619.3402. TLC: R_{f}=0.30 (3:1 hexanes:ethyl acetate).

### 69. Step 4: Synthesis of xxCO₂ⁱPr

A 1-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with SI-4 (61.8 g, 100 mmol, 1.0 equiv.) and dried cesium carbonate (100 g, 300 mmol, 3.0 equiv.). (Note: Cesium carbonate was dried at 120° C. under vacuum for 18 hours.) After being evacuated and backfilled with argon from a balloon 3 times, dioxane (500 mL) was added into the flask and the reaction mixture was allowed to stir at 100° C. for 40 minutes. After it was confirmed that the starting material, SI-4, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 10:1) on silica gel to afford the title compound xxCO₂ⁱPr, which was further purified through trituration in hexanes at −40° C. affording 19.0 g product (47% yield) with >99% purity as white solids. Trituration procedure: The product (around 25 g) after chromatography was dissolved in hexanes (10 mL) at room temperature and then cooled to −40° C. After the solution of the product was slowly stirred at −40° C. for 1 h, the suspension was filtered and the white solid was washed with cooled hexanes (5 mL) quickly and dried under vacuum for 1 hour.

### 70. Compound xxCO₂ⁱPr

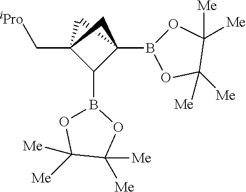

isopropyl 2,3-bis(4,4,5,5-tetramethyl-1,3,2-dioxaborolan-2-yl)bicyclo[1.1.1]pentane-1-carboxylate (xx) Physical State: white solid. m.p.: 41-43° C. ¹H NMR (600 MHz, CDCl₃): δ 4.93 (hept, J=6.3 Hz, 1H), 2.71 (dd, J=9.4, 2.3 Hz, 1H), 2.14-2.08 (m, 2H), 2.03 (dd, J=8.1, 2.2 Hz, 1H), 1.88 (dd, J=8.2, 0.9 Hz, 1H), 1.22 (s, 12H), 1.21 (s, 6H), 1.20 (s, 6H), 1.19 (d, J=2.9 Hz, 3H), 1.18 (d, J=3.0 Hz, 3H) ppm. ¹³C NMR (151 MHz, CDCl₃) δ 169.49, 83.55, 83.10, 67.44, 55.81, 50.75, 44.87, 24.89, 24.87, 24.84, 24.79, 21.93 ppm. ¹¹B NMR (128 MHz, CDCl₃): δ 31.18 ppm. MS (GCMS, EI): m/z=391 (0.2%), 363 (0.3%), 348 (1%), 305 (1%), 164 (30%), 83 (100%). TLC: R_{f}=0.32 (5:1 hexanes:ethyl acetate).

### VI. Gram-Scale Synthesis of BCP BisBoronates xxMeOPh (R¹=4-MeOPh)

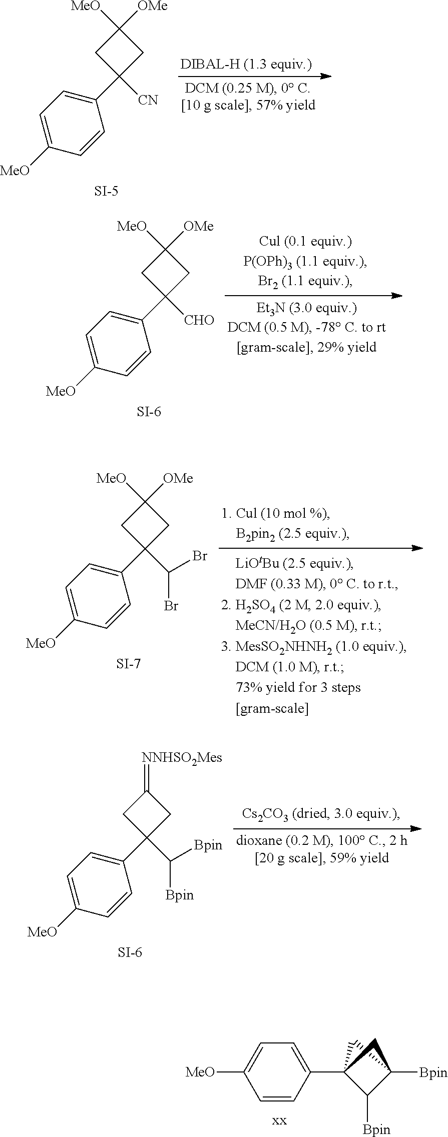

Compound SI-5 was prepared according to previous literature (Yang, 2021; Pinchman et al., 2018)

### 71. Step 1: Synthesis of SI-6

A 500-mL round-bottomed flask, equipped with a Teflon-coated magnetic stir bar, was flame-dried under vacuum, and then cooled to 23° C. under an atmosphere of argon. Then the flask was charged with compound SI-5 (12.5 g, 50 mmol, 1.0 equiv.). Then methylene chloride (200 mL) was added and the reaction mixture was cooled to 0° C. Next, DIBAL-H (65 mL, 1.0 M, 1.3 equiv.) was added at 0° C. and the mixture was stirred at 0° C. for 3 hours. The cool mixture was added under vigorous stirring to saturated Rochelle salt solution at 0° C. and stirred overnight. The organic phase was separated, washed with brine, dried over Na₂SO₄ and evaporated. The crude product was purified through flash chromatography (hexanes:ethyl acetate, 4:1) on silica gel to afford 7.1 g (57%) of the title compound SI-6.

### 72. Compound SI-6

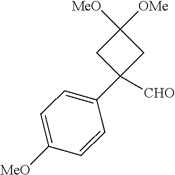 [SMILES: COc1ccc(C2(C=O)CC(OC)(OC)C2)cc1]

3,3-dimethoxy-1-(4-methoxyphenyl)cyclobutane-1-carbaldehyde (SI-6) Physical State: white solid. m.p.: 56-58° C. ¹H NMR (600 MHz, CDCl₃): δ 9.49 (s, 1H), 7.11-7.06 (m, 2H), 6.94-6.87 (m, 2H), 3.80 (s, 3H), 3.17 (s, 3H), 3.14 (s, 3H), 3.02-2.96 (m, 2H), 2.48-2.42 (m, 2H) ppm. ¹³C NMR (151 MHz, CDCl₃) δ 198.24, 158.95, 131.30, 128.25, 114.49, 98.60, 55.45, 48.77, 48.68, 48.21, 38.95 ppm. HRMS (ESI-TOF): calc'd for C₁₄H₁₈O₄ [M+H]⁺: 251.1278, found: 251.1278. TLC: R_{f}=0.17 (10:1 hexanes:ethyl acetate).

### 73. Step 2: Synthesis of SI-7

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with triphenyl phosphite (5.8 mL, 22 mmol, 1.1 equiv.). Methylene chloride (25 mL) was added into the flask and the mixture was cooled to −78° C. Then bromine (1.1 mL, 22 mmol, 1.1 equiv.) was added slowly into the flask, followed by addition of triethyl amine (8.4 mL, 60 mmol, 3.0 equiv.). Next, the solution of SI-6 (5.0 g, 20 mmol, 1.0 equiv.) in 25 mL methylene chloride was added into the mixture and the reaction was warmed up to room temperature. After it was confirmed that the starting material, SI-6, was consumed through TLC analysis, solvent was removed by rotary evaporator and the crude product was purified through flash chromatography (hexanes:ethyl acetate, 20:1) on silica gel to afford 2.31 g (29%) of the title compound SI-7.

### 74. Compound SI-7

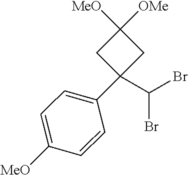 [SMILES: COc1ccc(C2(C(Br)Br)CC(OC)(OC)C2)cc1]

1-(1-(dibromomethyl)-3,3-dimethoxycyclobutyl)-4-methoxybenzene (SI-7) Physical State: white solid. m.p.: 59-61° C. ¹H NMR (600 MHz, CDCl₃): δ 7.33-7.26 (m, 2H), 6.92-6.86 (m, 2H), 6.22 (s, 1H), 3.82 (s, 3H), 3.22 (s, 3H), 3.10 (s, 3H), 2.71-2.60 (m, 4H) ppm. ¹³C NMR (151 MHz, CDCl₃) δ 158.79, 133.80, 130.48, 112.67, 97.64, 58.64, 55.36, 48.81, 48.65, 45.40, 43.67 ppm. HRMS (ESI-TOF): calc'd for C₁₄H₁₈Br₂O₃[M+Na]⁺: 414.9515, found: 414.9508. TLC: R_{f}=0.45 (10:1 hexanes:ethyl acetate).

### 75. Step 3: Synthesis of SI-8

A 100-mL one-necked (24/40 joint) round-bottomed flask, equipped with a Teflon-coated magnetic stir bar, was flame-dried under vacuum, and then cooled to 23° C. under an atmosphere of argon. Then the flask was charged with copper(I) iodide (114 mg, 0.6 mmol, 0.1 equiv.), B₂pin₂ (3.7 g, 14.5 mmol, 2.5 equiv.), and lithium tert-butoxide (1.16 g, 14.5 mmol, 2.5 equiv.). After being evacuated and backfilled with argon from a balloon 3 times, DMF (5 mL) was added into the flask at 0° C. Then a solution of SI-7 (5.8 mmol, 2.3 g, 1.0 equiv.) in DMF (10 mL) was added slowly into the mixture at 0° C. and the reaction mixture was allowed to slowly warm to room temperature and stir for another 1 hour. After it was confirmed that the starting material, SI-7, was consumed through TLC analysis, the reaction was filtered through Celite, washed with diethyl ether (50 mL) and quenched at 0° C. with water (100 mL) (Caution: the quenching process is exothermic). The mixture was then transferred into a 3-L separation funnel. The aqueous phase is separated and extracted with two 50-mL portions of diethyl ether. The combined organic layers are washed with the mixture of 50 mL water and 50 mL saturated NaCl solution twice, dried over Na₂SO₄, and filtered through Celite.

After solvent was removed by rotary evaporator, the crude product was redissolved in 10 mL acetonitrile in a 50-mL flask. 2M H₂SO₄ (6 mL, 2.0 equiv.) was added into the mixture at room temperature and the reaction was allowed to stir for another 1.5 hours. After it was confirmed that the ketal intermediate was consumed through TLC analysis, the crude reaction is concentrated to remove excess acetonitrile. Then diethyl ether (40 mL) and saturated brine (15 mL) is added to the reaction mixture and the mixture is transferred to a 125-mL separatory funnel. The aqueous layer is separated and further extracted with diethyl ether (3×30 mL). The combined organic layers are dried over Na₂SO₄, filtered through Celite. Excess solvent was removed by rotary evaporator.

The crude product was redissolved in 20 mL methylene chloride in a 50 mL-flask and mesitylene sulfonyl hydrazide (1.24 g, 5.8 mmol, 1.0 equiv.) was added. The mixture was allowed to stir at room temperature for another 2 hours. After it was confirmed that the ketone intermediate was consumed through TLC analysis, the crude reaction is concentrated to remove excess solvent. The crude product was purified through flash chromatography (hexanes:ethyl acetate, 4:1 to 2:1) on silica gel to afford 2.72 g (73%) of the title compound SI-8.

### 76. Compound SI-8

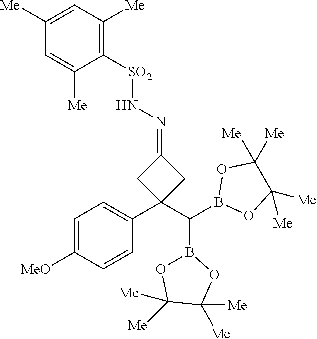 [SMILES: COc1ccc(C2(C(B3OC(C)(C)C(C)(C)O3)B3OC(C)(C)C(C)(C)O3)CC(=NNS(=O)(=O)c3c(C)cc(C)cc3C)C2)cc1]

N′-(3-(bis(4,4,5,5-tetramethyl-1,3,2-dioxaborolan-2-yl)methyl)-3-(4-methoxyphenyl)cyclo-butylidene)-2,4,6-trimethylbenzenesulfonohydrazide (SI-8) Physical State: white solid. m.p.: 155-157° C. ¹H NMR (600 MHz, Acetone-d₆) δ 9.04 (s, 1H), 7.24 (d, J=8.8 Hz, 2H), 6.98 (s, 2H), 6.89-6.64 (m, 2H), 3.74 (s, 3H), 3.40 (ddd, J=17.8, 3.4, 1.9 Hz, 1H), 3.32 (ddd, J=17.1, 3.4, 1.9 Hz, 1H), 3.16 (ddd, J=17.7, 3.5, 1.6 Hz, 1H), 3.09 (ddd, J=17.0, 3.5, 1.6 Hz, 1H), 2.63 (s, 6H), 2.26 (s, 3H), 1.31 (s, 1H), 1.11 (s, 12H), 1.10 (s, 12H) ppm. ¹³C NMR (151 MHz, Acetone-d₆) δ 158.50, 156.01, 143.72, 142.96, 140.73, 140.72, 134.91, 132.40, 128.11, 113.93, 83.78, 83.71, 55.41, 47.78, 46.24, 46.21, 39.47, 25.21, 25.03, 24.88, 24.84, 23.44, 20.84 ppm. ¹¹B NMR (128 MHz, Acetone-d₆): δ 32.77 ppm. HRMS (ESI-TOF): calc'd for C₃₃H₄₈B₂N₂O₇S [M+H]⁺: 639.3441, found: 639.3447. TLC: R_{f}=0.30 (3:1 hexanes:ethyl acetate).

### 77. Step 4: Synthesis of xxMeOPh

A 100-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-8 (2.7 g, 4.2 mmol, 1.0 equiv.) and dried cesium carbonate (4.1 g, 12.6 mmol, 3.0 equiv.). (Note: Cesium carbonate was dried at 120° C. under vaccum for 18 hours.) After being evacuated and backfilled with argon from a balloon 3 times, dioxane (40 mL) was added into the flask and the reaction mixture was allowed to stir at 100° C. for 40 minutes. After it was confirmed that the starting material, SI-8, was consumed through TLC analysis, the reaction was cooled to room temperature, filtered through Celite, washed with hexanes (200 mL), and concentrated to remove excess solvents. The crude reaction was purified through flash chromatography (hexanes:ethyl acetate, 20:1) on silica gel to afford the title compound xxMeOPh, which was further purified through trituration in hexanes at −20° C. affording 1.05 g product (59% yield) with >99% purity as white solids.

### 78. Compound xxMeOPh

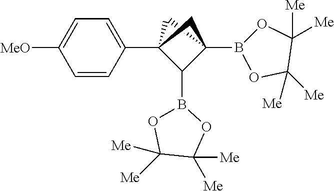 [SMILES: COc1ccc([C@]23C[C@](B4OC(C)(C)C(C)(C)O4)(C2)C3B2OC(C)(C)C(C)(C)O2)cc1]

2,2′-(3-(4-methoxyphenyl)bicyclo[1.1.1]pentane-1,2-diyl)bis(4,4,5,5-tetramethyl-1,3,2-dioxaborolane) (xxMeOPh) Physical State: white solid. m.p.: 89-91° C. ¹H NMR (600 MHz, CDCl₃): δ 7.22-7.17 (m, 2H), 6.85-6.78 (m, 2H), 3.77 (s, 3H), 2.73 (dd, J=9.7, 2.2 Hz, 1H), 2.17 (dd, J=9.7, 1.5 Hz, 1H), 2.15-2.12 (m, 1H), 2.04 (dd, J=8.2, 2.2 Hz, 1H), 1.93 (dd, J=8.2, 0.9 Hz, 1H), 1.25 (d, J=1.3 Hz, 12H), 1.24 (s, 6H), 1.23 (s, 6H) ppm. 13C NMR (151 MHz, CDCl₃) δ 158.23, 135.32, 127.21, 113.47, 83.41, 83.05, 56.34, 55.40, 51.87, 49.01, 25.02, 24.92, 24.91, 24.87 ppm. ¹¹B NMR (128 MHz, CDCl₃): δ 32.00 ppm. HRMS (ESI-TOF): calc'd for C₂₄H₃₆B₂O₅ [M+H]⁺: 427.2822, found: 427.2819. TLC: R_{f}=0.43 (5:1 hexanes:ethyl acetate).

### VII. Gram-Scale Synthesis of BCP BisBoronates xxCF₃ (R¹═CF₃)

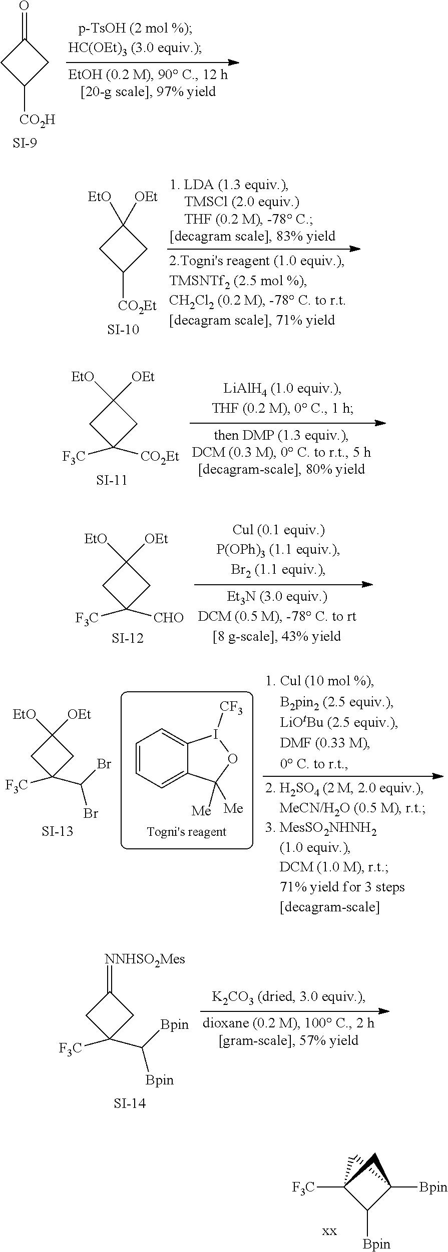

### 79. Step 1: Synthesis of SI-10

A 500-mL round-bottomed flask, equipped with a Teflon-coated magnetic stir bar, was added SI-9 (22.8 g, 200 mmol, 1.0 equiv.) and TsOH·H₂O (760 mg, 4.0 mmol, 0.02 equiv.). Then EtOH (600 mL) and HC(OEt)₃ (100 mL, 600 mmol, 3.0 equiv.) were added, and the reaction mixture was refluxed at 90° C. for 12 h. The reaction was cooled to room temperature and concentrated under vacuum. The residue was purified through flash chromatography (hexanes:ethyl acetate, 10:1) on silica gel to afford 41.9 g (97%) of the title compound SI-10.

### 80. Compound SI-10

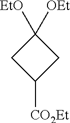 [SMILES: CCOC(=O)C1CC(OCC)(OCC)C1]

ethyl 3,3-diethoxycyclobutane-1-carboxylate (SI-10) Physical State: colorless oil. ¹H NMR (600 MHz, CDCl₃): δ 4.14 (q, J=7.2 Hz, 2H), 3.46-3.37 (m, 4H), 2.88 (p, J=8.6 Hz, 1H), 2.48-2.35 (m, 4H), 1.24 (d, J=7.3 Hz, 3H), 1.20-1.16 (m, 6H) ppm. ¹³C NMR (151 MHz, CDCl₃) δ 175.06, 99.29, 60.75, 56.87, 56.59, 36.49, 29.40, 15.48, 15.30, 14.35 ppm. MS (GCMS, EI): m/z=205 (6%), 176 (8%), 131 (8%), 91 (100%), 65 (14%). TLC: R_{f}=0.28 (10:1 hexanes:ethyl acetate).

### 81. Step 2: Synthesis of SI-11

A flame-dried 1-L flask equipped with rubber septum and magnetic stirring bar was charged under Ar atmosphere subsequently with diisopropylamine (27.7 mL; 198 mmol; 1.1 equiv.) and anhydrous THE (500 mL). To this well-stirred solution held at dry ice-acetone bath (−78° C.) was added within 20 minutes via a dropping funnel a solution of n-BuLi (2.5M in hexanes, 86.4 mL; 1.2 equiv.). The resulting solution was stirred at this temperature for 30 minutes. A solution of the SI-10 (180 mmol; 1 equiv.) in anhydrous THE (100 mL) was slowly introduced dropwise via a dropping funnel within 20 minutes. After stirring at −78° C. for 2 h, neat trimethylchlorosilane (39 mL; 306 mmol; 1.7 equiv.) was introduced at once. The resultant reaction mixture was stirred overnight allowing to gradually reach room temperature. The turbid solution was concentrated in vacuo in the reaction flask. To the remaining white slurry hexane (200 mL) was introduced and the mixture was cooled to 0° C. The resulting suspension was poured into ice water and hexanes, and extracted with hexanes. The combined organic solution was dried with Na₂SO₄, filtered and concentrated. The residue was purified by distillation to afford the desired trimethylsilylketene acetal 43 g (83%) as colorless oil.

In a flame-dried 2-L flask equipped with rubber septum and magnetic stirring bar, trimethylsilyl ketene acetal (1.2 mmol) was added under Ar. Then anhydrous DCM (1.3 L) was added and the reaction mixture was cooled to −78° C. (dry ice/acetone bath). TMSNTf₂ (424 mg; 1.2 mmol; 0.01 equiv) was added via a syringe at once. To the resulting well-stirred solution was added solid 1-trifluoromethyl-1,3-dihydro-3,3-dimethyl-1,2-benziodoxole (39.6 g; 120 mmol; 1 equiv). The mixture was allowed to reach room temperature with stirring for 4 h. NaHCO₃ (50 mL) aqueous solution was added. The organic phase was separated and dried by Na₂SO₄. The solvent was concentrated and the residue was purified through flash chromatography (hexanes:ethyl acetate, 10:1) on silica gel to afford 24.2 g (71%) of the title compound SI-11.

### 82. Compound SI-11

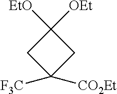 [SMILES: CCOC(=O)C1(C(F)(F)F)CC(OCC)(OCC)C1]

ethyl 3,3-diethoxy-1-(trifluoromethyl)cyclobutane-1-carboxylate (SI-11) Physical State: colorless oil. ¹H NMR (600 MHz, CDCl₃): δ 4.26 (q, J=7.1 Hz, 2H), 3.40 (q, J=7.1 Hz, 2H), 3.40 (q, J=7.1 Hz, 2H), 2.83-2.72 (m, 2H), 2.61-2.52 (m, 2H), 1.30 (t, J=7.1 Hz, 3H), 1.19 (t, J=7.1 Hz, 3H), 1.15 (t, J=7.1 Hz, 3H) ppm. ¹³C NMR (151 MHz, CDCl₃) δ 168.86, 125.22 (q, J=279.5 Hz), 97.02, 62.26, 56.91, 56.82, 44.13 (q, J=30.1 Hz), 38.07, 15.11, 15.06, 13.96 ppm. ¹⁹F NMR (565 MHz, CDCl₃): δ −73.10 ppm. MS (GCMS, EI): m/z=239 (30%), 211 (30%), 183 (48%), 116 (65%), 89 (100%). TLC: R_{f}=0.59 (10:1 hexanes:ethyl acetate).

### 83. Step 3: Synthesis of SI-12

A 1-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with SI-11 (20.2 g, 71 mmol, 1.0 equiv.). Dried THE (400 mL) was added into the flask and the mixture was cooled to 0° C. Then LiAlH₄ (2.7 g, 71 mmol, 1.0 equiv.) was added into the flask slowly at 0° C. and the reaction mixture was allowed to stir at 0° C. for 1 hour. After it was confirmed that the start material, SI-11, was totally consumed, water (2.7 mL) was slowly added at 0° C., followed by 20% w.t. NaOH (2.7 mL) and water (8.0 mL), and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

To a solution of the crude alcohol in methylene chloride (280 mL) was added Dess-Martin periodinane (42.4 g, 100 mmol, 1.4 equiv.) at 0° C. and the reaction mixture was allowed to warm to room temperature and stir for 2 hours. Then the reaction was quenched by excess saturated NaHCO₃ solution and Na₂S₂O₃ solution and extracted with methylene chloride (100 mL) three times. The organic phase was separated, washed with brine, dried over Na₂SO₄ and evaporated. The crude product was purified through flash chromatography (hexanes:ethyl acetate, 10:1) on silica gel to afford 13.0 g (80%) of the title compound SI-12.

### 84. Compound SI-12

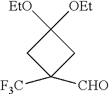 [SMILES: CCOC1(OCC)CC(C=O)(C(F)(F)F)C1]

3,3-diethoxy-1-(trifluoromethyl)cyclobutane-1-carbaldehyde (SI-12) Physical State: colorless oil. ¹H NMR (600 MHz, CDCl₃): δ 9.73 (s, 1H), 3.44-3.39 (m, 2H), 3.40-3.36 (m, 2H), 2.67-2.62 (m, 2H), 2.50 (dt, J=11.5, 1.6 Hz, 2H), 1.19 (tt, J=7.1, 1.1 Hz, 3H), 1.15 (tt, J=7.1, 1.2 Hz, 3H) ppm. ¹³C NMR (151 MHz, CDCl₃) δ 193.87, 125.64 (q, J=279.3 Hz), 96.55, 56.95, 56.86, 47.30 (q, J=27.8 Hz), 34.98, 15.13 ppm. ¹⁹F NMR (565 MHz, CDCl₃): δ −72.10 ppm. MS (GCMS, EI): m/z=211 (48%), 195 (51%), 167 (40%), 135 (80%), 115 (100%). TLC: R_{f}=0.53 (10:1 hexanes:ethyl acetate).

### 85. Step 4: Synthesis of SI-13

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with triphenyl phosphite (21 mL, 80 mmol, 1.5 equiv.). Methylene chloride (50 mL) was added into the flask and the mixture was cooled to −78° C. Then bromine (4 mL, 78 mmol, 1.4 equiv.) was added slowly into the flask, followed by addition of triethyl amine (23 mL, 162 mmol, 3.0 equiv.). Next, the solution of SI-12 (13.0 g, 54 mmol, 1.0 equiv.) in 40 mL methylene chloride was added into the mixture and the reaction was warmed up to room temperature. After it was confirmed that the starting material, SI-12, was consumed through TLC analysis, solvent was removed by rotary evaporator and the crude product was purified through flash chromatography (hexanes:ethyl acetate, 20:1) on silica gel to afford 8.6 g (43%) of the title compound SI-13.

### 86. Compound SI-13

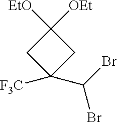 [SMILES: CCOC1(OCC)CC(C(Br)Br)(C(F)(F)F)C1]

1-(dibromomethyl)-3,3-diethoxy-1-(trifluoromethyl)cyclobutane (SI-13) Physical State: colorless oil. ¹H NMR (600 MHz, CDCl₃): δ 5.96 (s, 1H), 3.43 (q, J=7.1 Hz, 2H), 3.40 (q, J=7.1 Hz, 2H), 2.66-2.59 (m, 2H), 2.42-2.36 (m, 2H), 1.22 (t, J=7.1 Hz, 3H), 1.19 (t, J=7.1 Hz, 3H) ppm. ¹³C NMR (151 MHz, CDCl₃) δ 126.09 (q, J=281.8 Hz), 95.57, 57.10, 56.88, 45.76, 45.48 (q, J=27.8 Hz), 39.60 (q, J=2.3 Hz), 15.40, 15.17 ppm. ¹⁹F NMR (565 MHz, CDCl₃): δ −68.99 ppm. MS (GCMS, EI): m/z=341 (5%), 339 (10%), 337 (5%), 311 (9%), 211 (30%), 116 (100%). TLC: R_{f}=0.69 (10:1 hexanes:ethyl acetate).

### 87. Step 5: Synthesis of SI-14

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with copper(I) iodide (437 mg, 2.3 mmol, 0.1 equiv.), B₂pin₂ (12.9 g, 51 mmol, 2.2 equiv.), and lithium tert-butoxide (4.4 g, 55 mmol, 2.4 equiv.). After being evacuated and backfilled with argon from a balloon 3 times, DMF (23 mL) was added into the flask at 0° C. Then a solution of SI-13 (23 mmol, 8.6 g, 1.0 equiv.) in DMF (46 mL) was added slowly into the mixture at 0° C. and the reaction mixture was allowed to slowly warm to room temperature and stir for another 1 hour. After it was confirmed that the starting material, SI-13, was consumed through TLC analysis, the reaction was filtered through Celite, washed with diethyl ether (100 mL) and quenched at 0° C. with water (300 mL) (Caution: the quenching process is exothermic). The mixture was then transferred into a 1-L separation funnel. The aqueous phase is separated and extracted with two 100-mL portions of diethyl ether. The combined organic layers are washed with the mixture of 100 mL water and 100 mL saturated NaCl solution twice, dried over Na₂SO₄, and filtered through Celite.

After solvent was removed by rotary evaporator, the crude product was redissolved in 23 mL acetonitrile in a 100-mL flask. 2M H₂SO₄ (23 mL, 2.0 equiv.) was added into the mixture at room temperature and the reaction was allowed to stir for another 1.5 hours. After it was confirmed that the ketal intermediate was consumed through TLC analysis, the crude reaction is concentrated to remove excess acetonitrile. Then diethyl ether (100 mL) and saturated brine (50 mL) is added to the reaction mixture and the mixture is transferred to a 125-mL separatory funnel. The aqueous layer is separated and further extracted with diethyl ether (3×50 mL). The combined organic layers are dried over Na₂SO₄, filtered through Celite. Excess solvent was removed by rotary evaporator.

The crude product was redissolved in 20 mL methylene chloride in a 100 mL-flask and mesitylene sulfonyl hydrazide (4.93 g, 23 mmol, 1.0 equiv.) was added. The mixture was allowed to stir at room temperature for another 2 hours. After it was confirmed that the ketone intermediate was consumed through TLC analysis, the crude reaction is concentrated to remove excess solvent. The crude product was purified through flash chromatography (hexanes:ethyl acetate, 4:1) on silica gel to afford 9.8 g (71%) of the title compound SI-14.

### 88. Compound SI-14

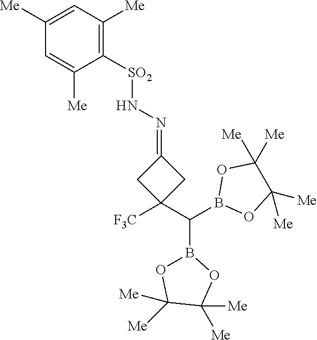 [SMILES: Cc1cc(C)c(S(=O)(=O)NN=C2CC(C(B3OC(C)(C)C(C)(C)O3)B3OC(C)(C)C(C)(C)O3)(C(F)(F)F)C2)c(C)c1]

N′-(3-(bis(4,4,5,5-tetramethyl-1,3,2-dioxaborolan-2-yl)methyl)-3-(trifluoromethyl)cyclobutyl idene)-2,4,6-trimethylbenzenesulfonohydrazide (SI-14) Physical State: white solid. m.p.: 186-188° C. ¹H NMR (600 MHz, Acetone-d₆): δ 9.34 (s, 1H), 7.03 (s, 2H), 3.22 (dd, J=18.1, 3.3 Hz, 1H), 3.11 (dd, J=17.6, 3.2 Hz, 1H), 3.06 (ddd, J=18.2, 3.3, 1.9 Hz, 1H), 3.00 (ddd, J=17.7, 3.3, 1.9 Hz, 1H), 2.64 (s, 6H), 2.29 (s, 3H), 1.28 (s, 1H), 1.19 (s, 6H), 1.18 (s, 6H), 1.17 (s, 6H), 1.14 (s, 6H) ppm. ¹³C NMR (151 MHz, Acetone-d₆) δ 151.49, 143.20, 140.78, 134.71, 132.49, 130.17 (q, J=279.7 Hz), 84.32, 84.28, 41.54 (q, J=2.8 Hz), 40.49 (q, J=2.7 Hz), 39.96 (q, J=27.4 Hz), 25.17, 24.98, 24.66, 24.64, 23.40, 20.85 ppm. ¹⁹F NMR (565 MHz, Acetone-d₆): δ −78.92 ppm. ¹¹B NMR (128 MHz, Acetone-d₆): δ 32.51 ppm. HRMS (ESI-TOF): calc'd for C₂₇H₄₁B₂F₃N₂O₆S [M+H]⁺: 601.2896, found: 601.2903. TLC: R_{f}=0.47 (10:1 hexanes:ethyl acetate).

### 89. Step 6: Synthesis of xxCF₃

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-14 (6.0 g, 10 mmol, 1.0 equiv.) and dried potassium carbonate (4.14 g, 30 mmol, 3.0 equiv.). (Note: Potassium carbonate was dried at 120° C. under vacuum for 18 hours.) After being evacuated and backfilled with argon from a balloon 3 times, dioxane (60 mL) was added into the flask and the reaction mixture was allowed to stir at 105° C. for 2 hours. After it was confirmed that the starting material, SI-14, was consumed through TLC analysis, the reaction was cooled to room temperature, filtered through Celite, washed with hexanes (200 mL), and concentrated to remove excess solvents. The crude reaction was purified through flash chromatography (hexanes:ethyl acetate, 20:1) on silica gel to afford the title compound xxCF₃, which was further purified through trituration in hexanes at −40° C. affording 2.2 g product (57% yield) with >99% purity as white solids. Trituration procedure: The product (around 3 g) after chromatography was dissolved in hexanes (3.0 mL) at room temperature and then cooled to −40° C. After the solution of the product was slowly stirred at −40° C., the suspension was filtered and the white solid was washed with cooled hexanes (3.0 mL) quickly and dried under vacuum for 1 hour.

### 90. Compound xxCF₃

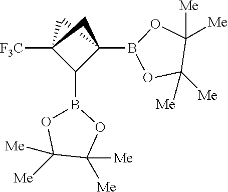 [SMILES: CC1(C)OB(C2[C@]3(B4OC(C)(C)C(C)(C)O4)C[C@@]2(C(F)(F)F)C3)OC1(C)C]

2,2′-(3-(trifluoromethyl)bicyclo[1.1.1]pentane-1,2-diyl)bis(4,4,5,5-tetramethyl-1,3,2-dioxa-borolane) (xxCF₃) Physical State: white solid. m.p.: 49-51° C. ¹H NMR (600 MHz, CDCl₃): δ 2.68 (dd, J=9.6, 2.3 Hz, 1H), 2.07 (dd, J=9.6, 1.7 Hz, 1H), 2.02 (d, J=1.7 Hz, 1H), 1.96 (dd, J=8.2, 2.3 Hz, 1H), 1.84 (d, J=8.1 Hz, 1H), 1.25-1.18 (m, 24H) ppm. 13C NMR (151 MHz, CDCl₃) δ 121.70 (q, J=278.4 Hz), 83.82, 83.44, 53.05 (q, J=2.7 Hz), 47.47 (q, J=2.4 Hz), 43.37 (q, J=36.9 Hz), 24.88, 24.85, 24.81, 24.73 ppm. ¹⁹F NMR (376 MHz, CDCl₃): δ −74.97 ppm. ¹¹B NMR (128 MHz, CDCl₃): δ 30.96 ppm. MS (GCMS, EI): m/z=387 (0.1%), 373 (0.4%), 288 (1%), 231 (5%), 131 (15%), 83 (100%). TLC: R_{f}=0.28 (15:1 hexanes:ethyl acetate).

### VIII. Gram-Scale Synthesis of BCP BisBoronates xxMe (R¹=Me)

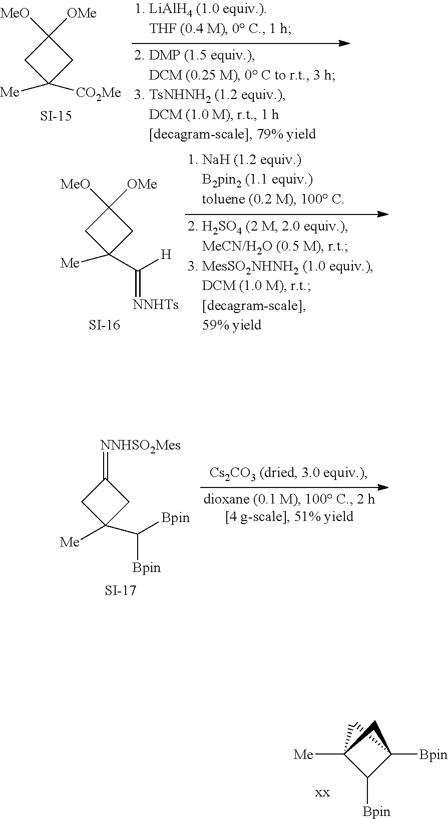

### 91. Step 1: Synthesis of SI-16

To a solution of methyl 3,3-dimethoxy-1-methyl-cyclobutanecarboxylate, SI-15, (10.8 g, 57 mmol, 1.0 equiv.) in diethyl ether (160 mL) was added LiAlH₄ (3.3 mg, 85.5 mmol, 1.5 equiv.) at 0° C. The mixture was allowed to warm up to room temperature. After it was confirmed that the start material, SI-15, was totally consumed, water (3.3 mL) was slowly added at 0° C., followed by 20% w.t. NaOH (3.3 mL) and water (10 mL), and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

To a solution of the crude alcohol in methylene chloride (250 mL) was added Dess-Martin periodinane (25 g, 60 mmol, 1.05 equiv.) at 0° C. and the reaction mixture was allowed to warm to room temperature and stir for 2 hours. Then the reaction was quenched by excess saturated NaHCO₃ solution and Na₂S₂O₃ solution and extracted with methylene chloride (100 mL) three times. The organic phase was separated, washed with brine, dried over Na₂SO₄ and evaporated. The crude aldehyde was used without further purification.

The aldehyde was dissolved in 60 mL methylene chloride and then p-toluenesulfonyl hydrazide (11.2 g, 60 mmol, 1.05 equiv.) was added. The mixture was allowed to stir at room temperature for another 1 hour. After it was confirmed that the aldehyde was consumed through TLC analysis, the crude reaction is concentrated to remove excess solvent. The crude product was purified through flash chromatography (hexanes:ethyl acetate, 3:1) on silica gel to afford 14.7 g (79%) of the title compound SI-16. Spectroscopic data of the product SI-16 matches that reported in the literature (Yang et al., 2021).

### 92. Step 2: Synthesis of SI-17

A dry round-bottom flask charged with SI-16 (14.7 g, 45 mmol, 1.0 equiv.), 60% NaH (2.2 g, 54 mmol, 1.2 equiv.) was degassed and filled with argon for three times. Toluene (200 mL) was added, and the mixture was stirred at room temperature for 1 h. A solution of B₂pin₂ (17.0 g, 67 mmol, 1.5 equiv.) in toluene (50 mL) was added via syringe. Then the tube was sealed and heated at 100° C. for 1 h. After cooling to room temperature, the suspension was filtered by Celite, and washed by diethyl ether (200 mL). After solvent was removed by rotary evaporator from the filtrate, the crude product was redissolved in 45 mL acetonitrile in a 100-mL flask. 2M H₂SO₄ (45 mL, 2.0 equiv.) was added into the mixture at room temperature and the reaction was allowed to stir for another 2 hours. After it was confirmed that the ketal intermediate was totally consumed, the crude reaction is concentrated to remove excess acetonitrile. Then diethyl ether (150 mL) and saturated brine (150 mL) is added to the reaction mixture and the mixture is transferred to a separatory funnel. The aqueous layer is separated and further extracted with diethyl ether (3×50 mL). The combined organic layers are dried over Na₂SO₄, filtered through Celite. Excess solvent was removed by rotary evaporator.

The crude ketone was redissolved in 50 mL methylene chloride in a 100 mL-flask and mesitylene sulfonyl hydrazide (10.7 g, 50 mmol, 1.1 equiv.) was added. The mixture was allowed to stir at room temperature for another 3-5 hours. After it was confirmed that the ketone intermediate was consumed through TLC analysis, the crude reaction is concentrated to remove excess solvent. The crude product was purified through flash chromatography (hexanes:ethyl acetate, 4:1) on silica gel to afford 14.5 g (59%) of the title compound SI-17.

### 93. Compound SI-17

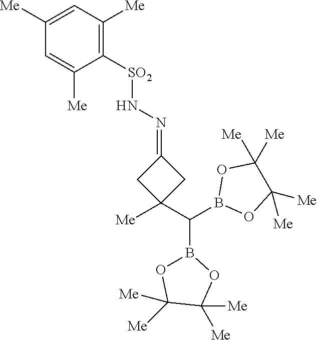 [SMILES: Cc1cc(C)c(S(=O)(=O)NN=C2CC(C)(C(B3OC(C)(C)C(C)(C)O3)B3OC(C)(C)C(C)(C)O3)C2)c(C)c1]

N′-(3-(bis(4,4,5,5-tetramethyl-1,3,2-dioxaborolan-2-yl)methyl)-3-methylcyclobutylidene)-2,4,6-trimethylbenzenesulfonohydrazide (SI-17) Physical State: white solid. m.p.: 111-113° C. ¹H NMR (600 MHz, Acetone-d⁶): δ 8.93 (s, 1H), 2.85 (dd, J=18.1, 3.3 Hz, 1H), 2.80 (dd, J=16.5, 2.2 Hz, 1H), 2.63 (s, 6H), 2.53 (dt, J=17.1, 2.9 Hz, 1H), 2.43 (dt, J=16.5, 3.0 Hz, 1H), 2.28 (s, 3H), 1.23 (s, 3H), 1.18 (s, 6H), 1.18 (s, 6H), 1.16 (s, 6H), 1.16 (s, 6H), 0.93 (s, 1H) ppm. ¹³C NMR (151 MHz, Acetone-d⁶): δ 156.80, 143.01, 140.69, 134.87, 132.42, 83.62, 83.61, 48.06, 46.69, 32.54, 30.04, 25.20, 25.12, 24.80, 24.79, 23.38, 20.86 ppm. ¹¹B NMR (128 MHz, Acetone-d⁶): δ 32.87 ppm. HRMS (ESI-TOF): calc'd for C₂₇H₄₄B₂N₂O₆S [M+H]⁺: 547.3179, found: 547.3177. TLC: R_{f}=0.40 (3:1 hexanes:ethyl acetate).

### 94. Step 3: Synthesis of xxMe

A 500-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-15 (14.5 g, 26.5 mmol, 1.0 equiv.) and dried cesium carbonate (25.4 g, 78 mmol, 3.0 equiv.). (Note: Cesium carbonate was dried at 120° C. under vacuum for 18 hours.) After being evacuated and backfilled with argon from a balloon 3 times, dioxane (250 mL) was added into the flask and the reaction mixture was allowed to stir at 100° C. for 2 hours. After it was confirmed that the starting material, SI-15, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 30:1) on silica gel to afford the title compound xxMe, which was further purified through trituration in hexanes at −40° C. affording 4.5 g product (51% yield) with >99% purity as white solids. Trituration procedure: The product (around 6 g) after chromatography was dissolved in hexanes (4.0 mL) at room temperature and then cooled to −40° C. After the solution of the product was slowly stirred at −40° C., the suspension was filtered and the white solid was washed with cooled hexanes (4.0 mL) quickly and dried under vacuum for 1 hour. Spectroscopic data of the product xxMe matches that reported in the literature (Yang et al., 2021).

### IX. Gram-Scale Synthesis of BCP BisBoronates xxCH₂OBn (R¹=CH₂OBn)

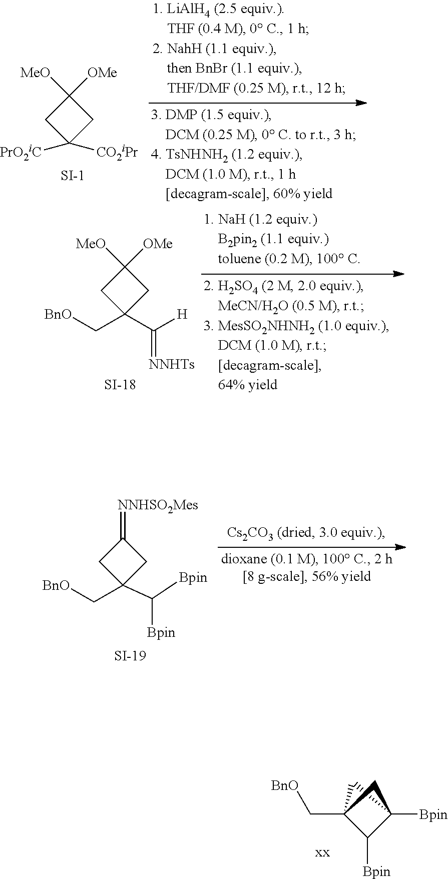

### 95. Step 1: Synthesis of SI-18

To a solution of diisopropyl 3,3-dimethoxycyclobutane-1,1-dicarboxylate, SI-1, (28.8 g, 100 mmol, 1.0 equiv.) in dried THE (250 mL) was added LiAlH₄ (9.5 g, 250 mmol, 2.5 equiv.) at 0° C. The mixture was allowed to warm up to room temperature and stirred for 3 hours. After it was confirmed that the start material, SI-1, was totally consumed, water (9.5 mL) was slowly added at 0° C., followed by 20% w.t. NaOH (9.5 mL) and water (25 mL), and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

To a solution of the crude alcohol in THF/DMF (400 mL, 1:1) was added NaH (4.2 g, 100 mmol, 1.05 equiv.) slowly at 0° C. (Caution: Hydrogen was released.) After the reaction was stirred for 1 hour at room temperature, benzyl bromide (13 mL, 110 mmol, 1.1 equiv.) was added and the mixture was allowed to stir for 12 hours at room temperature. After it was confirmed that the diol intermediate was totally consumed, the reaction was quenched with water (5 mL) at 0° C. Excess solvent was removed by rotary evaporator and the mixture was diluted with water (500 mL) and diethyl ether (200 mL) and then transferred into a 1-L separation funnel. The aqueous phase is separated and extracted with two 100-mL portions of diethyl ether. The combined organic layers are washed with the mixture of 100 mL water and 100 mL saturated NaCl solution twice, dried over Na₂SO₄, and filtered through Celite.

After solvent was removed by rotary evaporator, the crude product was redissolved in methylene chloride (300 mL) and Dess-Martin periodinane (25 g, 150 mmol, 1.05 equiv.) was added to mixture at 0° C. The reaction was allowed to warm to room temperature and stir for 2 hours. After it was confirmed that the alcohol intermediate was consumed totally, the reaction was quenched by excess saturated NaHCO₃ solution and Na₂S₂O₃ solution and extracted with methylene chloride (100 mL) three times. The organic phase was separated, washed with brine, dried over Na₂SO₄ and evaporated. The crude aldehyde was used without further purification.

The aldehyde was dissolved in 100 mL methylene chloride and then p-toluenesulfonyl hydrazide (20.4 g, 110 mmol, 1.1 equiv.) was added. The mixture was allowed to stir at room temperature for another 1 hours. After it was confirmed that the aldehyde was consumed through TLC analysis, the crude reaction is concentrated to remove excess solvent. The crude product was purified through flash chromatography (hexanes:ethyl acetate, 3:1) on silica gel to afford 21.6 g (50%) of the title compound SI-18. Cis/trans-isomerism (1/1.8) was observed. The 1H NMR characterization of main isomer was provided.

### 96. Compound SI-18

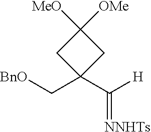

N′-((1-((benzyloxy)methyl)-3,3-dimethoxycyclobutyl)methylene)-4-methylbenzenesulfono-hydrazide (SI-18) Physical State: yellow oil. ¹H NMR (600 MHz, CDCl₃): δ 7.93 (s, 1H), 7.78 (d, J=8.3 Hz, 2H), 7.36-7.09 (m, 7H), 4.43 (s, 2H), 3.52 (s, 2H), 3.06 (s, 3H), 3.02 (s, 3H), 2.37 (s, 3H), 2.24 (d, J=9.0 Hz, 2H), 2.11 (d, J=13.3 Hz, 2H) ppm. HRMS (ESI-TOF): calc'd for C₂₂H₂₈N₂O₅S [M+H]⁺: 433.1792, found: 433.1786. TLC: R_{f}=0.23 (2:1 hexanes:ethyl acetate).

### 97. Step 2: Synthesis of SI-19

A dry round-bottom flask charged with SI-18 (21.6 g, 50 mmol, 1.0 equiv.), 60% NaH (2.4 g, 60 mmol, 1.2 equiv.) was degassed and filled with argon for three times. Toluene (250 mL) was added, and the mixture was stirred at room temperature for 1 h. A solution of B₂pin₂ (19.05 g, 75 mmol, 1.5 equiv.) in toluene (50 mL) was added via syringe. Then the tube was sealed and heated at 100° C. for 1 h. After cooling to room temperature, the suspension was filtered by Celite, and washed by diethyl ether (200 mL). After solvent was removed by rotary evaporator from the filtrate, the crude product was redissolved in 50 mL acetonitrile in a 250-mL flask. 2M H₂SO₄ (50 mL, 2.0 equiv.) was added into the mixture at room temperature and the reaction was allowed to stir for another 2 hours. After it was confirmed that the ketal intermediate was totally consumed, the crude reaction is concentrated to remove excess acetonitrile. Then diethyl ether (150 mL) and saturated brine (150 mL) is added to the reaction mixture and the mixture is transferred to a separatory funnel. The aqueous layer is separated and further extracted with diethyl ether (3×50 mL). The combined organic layers are dried over Na₂SO₄, filtered through Celite. Excess solvent was removed by rotary evaporator.

The crude ketone was redissolved in 50 mL methylene chloride in a 100 mL-flask and mesitylene sulfonyl hydrazide (10.7 g, 50 mmol, 1.0 equiv.) was added. The mixture was allowed to stir at room temperature for another 3-5 hours. After it was confirmed that the ketone intermediate was consumed through TLC analysis, the crude reaction is concentrated to remove excess solvent. The crude product was purified through flash chromatography (hexanes:ethyl acetate, 4:1) on silica gel to afford 22 g (66%) of the title compound SI-19.

### 98. Compound SI-19

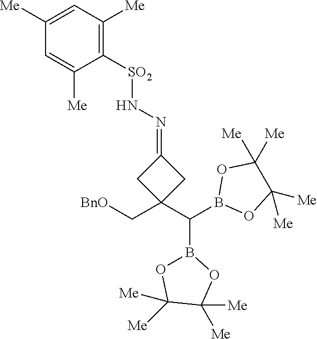 [SMILES: Cc1cc(C)c(S(=O)(=O)NN=C2CC(COCc3ccccc3)(C(B3OC(C)(C)C(C)(C)O3)B3OC(C)(C)C(C)(C)O3)C2)c(C)c1]

N′-(3-((benzyloxy)methyl)-3-(bis(4,4,5,5-tetramethyl-1,3,2-dioxaborolan-2-yl)methyl)cyclo-butylidene)-2,4,6-trimethylbenzenesulfonohydrazide (SI-19) Physical State: white solid. m.p.: 198-200° C. ¹H NMR (600 MHz, Acetone-d₆) δ 9.02 (s, 1H), 7.36-7.30 (m, 4H), 7.29-7.23 (m, 1H), 7.00 (s, 2H), 4.50 (s, 2H), 3.35 (d, J=8.9 Hz, 1H), 3.33 (d, J=8.9 Hz, 1H), 2.88-2.81 (m, 1H), 2.81-2.77 (m, 1H), 2.74 (ddd, J=17.3, 3.1, 2.1 Hz, 1H), 2.66 (ddd, J=17.3, 3.1, 2.1 Hz, 1H), 2.63 (s, 6H), 2.27 (s, 3H), 1.15 (s, 6H), 1.15 (s, 6H), 1.14 (s, 1H), 1.12 (s, 6H), 1.11 (s, 6H) ppm. ¹³C NMR (151 MHz, Acetone-d₆) δ 156.62, 142.96, 140.67, 139.71, 134.90, 132.41, 129.07, 128.36, 128.17, 83.67, 83.65, 78.27, 73.50, 43.34, 42.10, 36.28, 25.20, 25.08, 24.74, 23.39, 20.84 ppm. ¹¹B NMR (128 MHz, Acetone-d₆): δ 33.11 ppm. HRMS (ESI-TOF): calc'd for C₃₄H₅₀B₂N₂O₇S [M+H]⁺: 653.3598, found: 653.3602. TLC: R_{f}=0.37 (3:1 hexanes:ethyl acetate).

### 99. Step 3: Synthesis of xxCH₂OBn

A 500-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-19 (22 g, 33 mmol, 1.0 equiv.) and dried cesium carbonate (33 g, 100 mmol, 3.0 equiv.). (Note: Cesium carbonate was dried at 120° C. under vacuum for 18 hours.) After being evacuated and backfilled with argon from a balloon 3 times, dioxane (200 mL) was added into the flask and the reaction mixture was allowed to stir at 100° C. for 2 hours. After it was confirmed that the starting material, SI-19, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 10:1) on silica gel to afford the title compound xxCH₂OBn, which was further purified through trituration in hexanes at −40° C. affording 8.3 g product (56% yield) with >99% purity as white solids. Trituration procedure: The product (around 10 g) after chromatography was dissolved in hexanes (6.0 mL) at room temperature and then cooled to −40° C. After the solution of the product was slowly stirred at −40° C., the suspension was filtered and the white solid was washed with cooled hexanes (6.0 mL) quickly and dried under vacuum for 1 hour.

### 100. Compound xxCH₂OBn

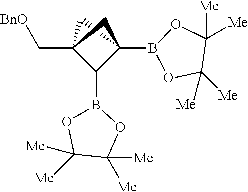 [SMILES: CC1(C)OB(C2[C@]3(COCc4ccccc4)C[C@@]2(B2OC(C)(C)C(C)(C)O2)C3)OC1(C)C]

2,2′-(3-((benzyloxy)methyl)bicyclo[1.1.1]pentane-1,2-diyl)bis(4,4,5,5-tetramethyl-1,3,2-dioxa-borolane) (xxCH₂OBn) Physical State: colorless crystal. m.p.: 65-67° C. ¹H NMR (600 MHz, CDCl₃): δ 7.36-7.28 (m, 4H), 7.24 (dd, J=8.2, 5.9 Hz, 1H), 4.52 (s, 2H), 3.38 (d, J=11.0, 1H), 3.36 (d, J=11.0, 1H), 2.38 (dd, J=9.7, 2.3 Hz, 1H), 1.93 (dd, J=9.7, 1.5 Hz, 1H), 1.88 (s, 1H), 1.82 (dd, J=8.3, 2.3 Hz, 1H), 1.67 (d, J=8.2 Hz, 1H), 1.23 (s, 12H), 1.20 (s, 6H), 1.19 (s, 6H) ppm. ¹³C NMR (151 MHz, CDCl₃) δ 139.14, 128.32, 127.55, 127.37, 83.35, 82.91, 77.37, 77.16, 76.95, 72.88, 71.28, 54.69, 49.02, 46.50, 24.99, 24.90, 24.87, 24.84 ppm. ¹¹B NMR (128 MHz, CDCl₃): δ 31.92 ppm. MS (GCMS, EI): m/z=425 (0.1%), 349 (0.2%), 325 (0.2%), 249 (5%), 91 (100%). TLC: R_{f}=0.54 (5:1 hexanes:ethyl acetate).

### X. Gram-Scale Synthesis of BCP BisBoronates xxNBnBoc

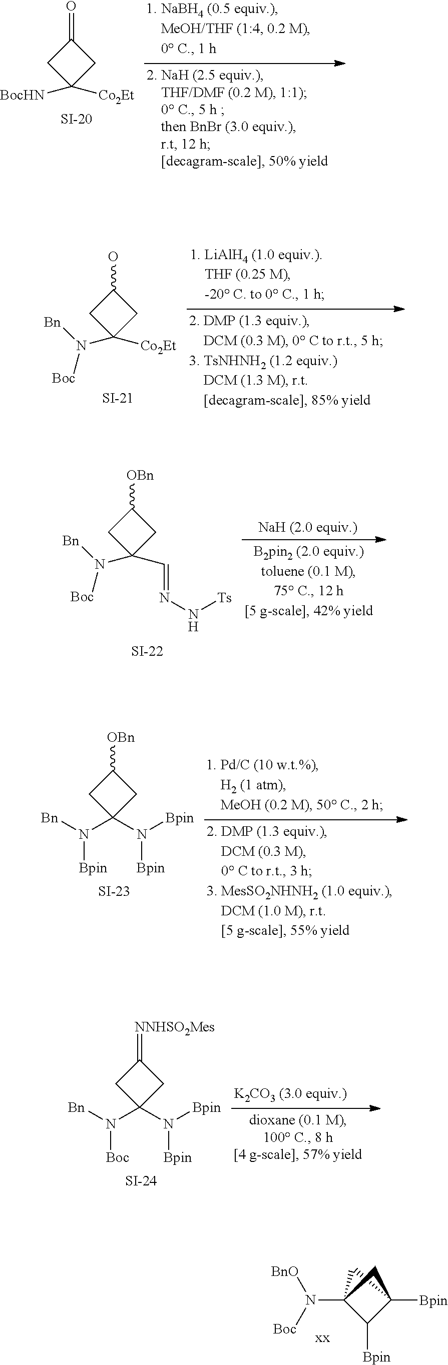

### 101. Step 1: Synthesis of SI-21

A flame-dried round-bottom flask charged with ethyl 1-([(tert-butoxy)carbonyl]amino)-3-oxocyclobutane-1-carboxylate, SI-20 (25 g, 100 mmol, 1.0 equiv.) dissolved in THF/methanol (500 mL, 4:1) was cooled to 0° C. Then NaBH₄ (1.9 g, 50 mmol, 0.5 equiv.) was added slowly to the mixture at 0° C. and the reaction was allowed to stir at the same temperature for 1 h. After it was confirmed that the starting material, SI-20, was consumed totally, the reaction was quenched by water (1.0 mL). After excess solvent was removed, the mixture was diluted with ethyl acetate (200 mL) and water (200 mL) and transferred into a 1-L separatory funnel. The aqueous layer is separated and further extracted with ethyl acetate (3×100 mL). The combined organic layers are dried over Na₂SO₄, filtered through Celite. Excess solvent was removed by rotary evaporator. The crude alcohol was used without further purification.

The crude alcohol was dissolved in THF/DMF (500 mL, 1:1) and the mixture was cooled to 0° C. NaH (10.0 g, 250 mmol, 2.5 equiv.) was added slowly to the reaction at 0° C. and the mixture was warmed to room temperature and stirred for 3 hours. After there is no bubble released, benzyl bromide (36 mL, 300 mmol, 3.0 equiv.) was added to the reaction at 0° C. and the mixture was allowed to stir at room temperature for around 12 hours. After it was confirmed that the alcohol intermediate was consumed totally, water (5.4 mL) was added to quench the reaction. Excess solvent was removed by rotary evaporator and the mixture was diluted with water (500 mL) and diethyl ether (200 mL) and then transferred into a 1-L separation funnel. The aqueous phase is separated and extracted with two 100-mL portions of diethyl ether. The combined organic layers are washed with the mixture of 100 mL water and 100 mL saturated NaCl solution twice, dried over Na₂SO₄, and filtered through Celite. The crude product was purified through flash chromatography (hexanes:ethyl acetate, 4:1) on silica gel to afford 21.9 g (50%) of the title compound SI-21.

### 102. Compound SI-21

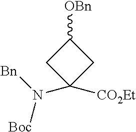 [SMILES: CCOC(=O)C1(N(Cc2ccccc2)C(=O)OC(C)(C)C)CC(OCc2ccccc2)C1]

ethyl 1-(benzyl(tert-butoxycarbonyl)amino)-3-(benzyloxy)cyclobutane-1-carboxylate (xx) Note: 1H NMR showed the presence of diastereoisomers and rotamers. Physical State: yellow oil. ¹H NMR (600 MHz, CDCl₃): δ 7.31-7.14 (m, 10H), 4.49 (brs, 2H), 4.17 (brs, 2H), 4.12-4.06 (m, 2H), 3.65 (brs, 1H), 2.52 (brs, 4H), 1.35 (s, 9H), 1.24-1.13 (m, 3H) ppm. Note: The complexity of the 1H NMR is attributed to the diastereomerism and rotating isomerism. HRMS (ESI-TOF): calc'd for C₂₆H₃₃NO₅ [M+H]⁺: 440.2432, found: 440.2428. TLC: R_{f}=0.68 (3:1 hexanes:ethyl acetate).

### 103. Step 2: Synthesis of SI-22

A flame-dried round-bottom flask charged with SI-21 (11.5 g, 25 mmol, 1.0 equiv.) dissolved in THE (100 mL) was cooled to −20° C. LiAlH₄ (1.0 g, 26 mmol, 1.05 equiv.) was added slowly to the solution at −20° C. and the reaction was allowed to warm to r.t. and stir at 0° C. for 1 hour. After it was confirmed that SI-21 was consumed totally, the reaction was quenched at 0° C. with water (1.0 mL), followed by 20% NaOH (1.0 mL) and water (3.0 mL) and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

The crude alcohol was redissolved in methylene chloride (75 mL) and Dess-Martin periodinane (13.8 g, 32.5 mmol, 1.3 equiv.) was added to mixture at 0° C. The reaction was allowed to warm to room temperature and stir for 2 hours. After it was confirmed that the alcohol intermediate was consumed totally, the reaction was quenched by excess saturated NaHCO₃ solution and Na₂S₂O₃ solution and extracted with methylene chloride (100 mL) three times. The organic phase was separated, washed with brine, dried over Na₂SO₄ and evaporated. The crude aldehyde was used without further purification.

The aldehyde was dissolved in 25 mL methylene chloride and then p-toluenesulfonyl hydrazide (5.2 g, 27.5 mmol, 1.1 equiv.) was added. The mixture was allowed to stir at room temperature for another 1 hours. After it was confirmed that the aldehyde was consumed through TLC analysis, the crude reaction is concentrated to remove excess solvent. The crude product was purified through flash chromatography (hexanes:ethyl acetate, 3:1) on silica gel to afford 12.0 g (85%) of the title compound SI-22.

### 104. Compound SI-22

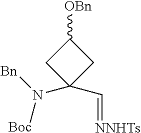

tert-butyl benzyl(3-(benzyloxy)-1-((2-tosylhydrazineylidene)methyl)cyclobutyl)carbamate (SI-22) Note: 1H NMR showed the presence of diastereoisomers (1/0.4) and trans/cis isomers. The 1H NMR of the main isomer is given. Physical State: yellow oil. ¹H NMR (600 MHz, Acetone) δ 9.81 (s, 1H), 7.76 (d, J=8.3 Hz, 2H), 7.58 (s, 1H), 7.38-7.14 (m, 12H), 4.25 (s, 2H), 4.15 (s, 2H), 3.87 (tt, J=7.0, 4.2 Hz, 1H), 2.58 (dd, J=13.7, 6.9 Hz, 2H), 2.34 (s, 3H), 2.29 (dd, J=13.8, 4.1 Hz, 2H), 1.31 (s, 9H) ppm. HRMS (ESI-TOF): calc'd for C₃₁H₃₇N₃O₅S [M+Na]⁺: 586.2346, found: 586.2344. TLC: R_{f}=0.32 (3:1 hexanes:ethyl acetate).

### 105. Step 3: Synthesis of SI-23

A dry round-bottom flask charged with SI-22 (12 g, 21 mmol, 1.0 equiv.), 60% NaH (1.68 g, 42 mmol, 2.0 equiv.) and B₂pin₂ (10.6 g, 42 mmol, 2.0 equiv.) was degassed and filled with argon for three times. Toluene (210 mL) was added, and the mixture was heated at 75° C. for 5 h. After it was confirmed that the starting material SI-22 was consumed totally, the reaction was cooled to room temperature and the suspension was filtered by Celite and washed by diethyl ether (200 mL). After solvent was removed by rotary evaporator from the filtrate, the crude product was flash chromatography (hexanes:ethyl acetate, 4:1) on silica gel to afford 5.3 g (42%) of the title compound SI-23.

### 106. Compound SI-23

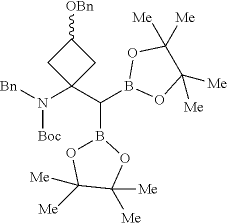 [SMILES: CC(C)(C)OC(=O)N(Cc1ccccc1)C1(C(B2OC(C)(C)C(C)(C)O2)B2OC(C)(C)C(C)(C)O2)CC(OCc2ccccc2)C1]

tert-butyl benzyl(3-(benzyloxy)-1-(bis(4,4,5,5-tetramethyl-1,3,2-dioxaborolan-2-yl)methyl)cyclo butyl)carbamate (SI-23) Note: the main isomer was isolated and characterized. Physical State: white solid. m.p.: 99-101° C. ¹H NMR (600 MHz, CDCl₃): δ 7.25-7.04 (m, 10H), 4.59 (s, 2H), 4.07 (s, 2H), 3.48-3.33 (m, 1H), 2.69-2.63 (m, 2H), 2.36-2.28 (m, 2H), 2.09 (s, 1H), 1.38 (s, 9H), 1.17 (s, 12H), 1.17 (s, 12H) ppm. ¹³C NMR (151 MHz, CDCl₃) δ 140.90, 138.80, 128.37, 128.22, 127.92, 127.81, 127.29, 126.44, 126.40, 83.18, 69.66, 68.77, 49.84, 28.64, 25.05, 24.88 ppm. Note: NC, NCH2 and Me3C were not observed. ¹¹B NMR (128 MHz, CDCl₃): δ 30.66 ppm. HRMS (ESI-TOF): calc'd for C₃₆H₅₃B₂NO₇ [M+H]⁺: 634.4081, found: 634.4096. TLC: R_{f}=0.68 (3:1 hexanes:ethyl acetate).

### 107. Step 4: Synthesis of SI-24

A dry round-bottom flask was charged with SI-23 (7 g, 11 mmol, 1.0 equiv.) and Pd/C (10 w.t.%, 350 mg) and methanol (70 mL) was added then. After the flask was degassed and refilled with hydrogen for three times. The reaction mixture was heated at 50° C. for 2 h. After it was confirmed that the starting material, SI-23, was consumed totally, the mixture was cooled to room temperature, filtered through Celite and concentrated. The crude alcohol was used without further purification.

The crude alcohol was redissolved in methylene chloride (40 mL) and Dess-Martin periodinane (6.4 g, 15 mmol, 1.3 equiv.) was added to mixture at 0° C. The reaction was allowed to warm to room temperature and stir for 2 hours. After it was confirmed that the alcohol intermediate was consumed totally, the reaction was quenched by excess saturated NaHCO₃ solution and Na₂S₂O₃ solution and extracted with methylene chloride (50 mL) three times. The organic phase was separated, washed with brine, dried over Na₂SO₄ and evaporated. The crude ketone was used without further purification.

The ketone was dissolved in 25 mL methylene chloride and then mesitylsulfonyl hydrazide (2.6 g, 12 mmol, 1.1 equiv.) was added. The mixture was allowed to stir at room temperature for another 3-5 hours. After it was confirmed that the aldehyde was consumed through TLC analysis, the crude reaction is concentrated to remove excess solvent. The crude product was purified through flash chromatography (hexanes:ethyl acetate, 3:1) on silica gel to afford 4.48 g (55%) of the title compound SI-24.

### 108. Compound SI-24

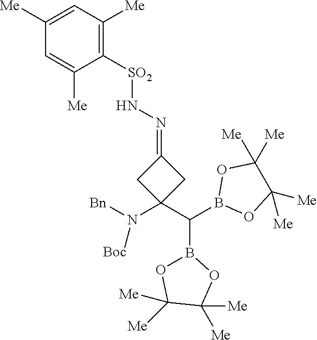 [SMILES: Cc1cc(C)c(S(=O)(=O)NN=C2CC(C(B3OC(C)(C)C(C)(C)O3)B3OC(C)(C)C(C)(C)O3)(N(Cc3ccccc3)C(=O)OC(C)(C)C)C2)c(C)c1]

tert-butyl benzyl(1-(bis(4,4,5,5-tetramethyl-1,3,2-dioxaborolan-2-yl)methyl)-3-(2-(mesityl sulfonyl)hydrazineylidene)cyclobutyl)carbamate (SI-24) Physical State: white solid. m.p.: 161-163° C. ¹H NMR (600 MHz, Acetone-d₆): δ 9.08 (s, 1H), 7.27 (t, J=7.6 Hz, 2H), 7.22-7.15 (m, 3H), 6.98 (s, 2H), 4.71-4.52 (m, 2H), 3.28-3.01 (m, 4H), 2.57 (s, 6H), 2.28 (s, 3H), 2.10 (s, 1H), 1.55-1.29 (m, 9H), 1.25-1.12 (m, 24H) ppm. ¹³C NMR (151 MHz, Acetone-d₆): δ 142.98, 141.79, 140.73, 140.71, 135.00, 134.96, 132.44, 129.24, 127.21, 126.32, 84.09, 84.03, 50.70, 28.53, 25.21, 25.04, 25.01, 24.96, 23.43, 20.85 ppm. Note: NC, NCH2 and Me3C were not observed. ¹¹B NMR (128 MHz, CDCl₃): δ 37.71 ppm. HRMS (ESI-TOF): calc'd for C₃₈H₅₇B₂N₃O₈S [M+H]⁺: 738.4125, found: 738.4148. TLC: R_{f}=0.40 (3:1 hexanes:ethyl acetate).

### 109. Step 5: Synthesis of xxNBnBoc

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-24 (4.48 g, 6 mmol, 1.0 equiv.) and dried potassium carbonate (2.76 g, 20 mmol, 3.3 equiv.). (Note: Potassium carbonate was dried at 120° C. under vacuum for 18 hours.) After being evacuated and backfilled with argon from a balloon 3 times, dioxane (60 mL) was added into the flask and the reaction mixture was allowed to stir at 105° C. for 8 hours. After it was confirmed that the starting material, SI-24, was consumed through TLC analysis, the reaction was cooled to room temperature, filtered through Celite, washed with diethyl ether (200 mL), and concentrated to remove excess solvents. The crude reaction was purified through flash chromatography (hexanes:ethyl acetate, 10:1) on silica gel to afford the title compound xxNBnBoc, which was further purified through trituration in hexanes at −40° C. affording 1.8 g product (57% yield) with >99% purity as white solids. Trituration procedure: The product (around 2.3 g) after chromatography was dissolved in hexanes (2.0 mL) at room temperature and then cooled to −40° C. After the solution of the product was slowly stirred at −40° C., the suspension was filtered and the white solid was washed with cooled hexanes (2.0 mL) quickly and dried under vacuum for 1 hour.

### 110. Compound xxNBnBoc

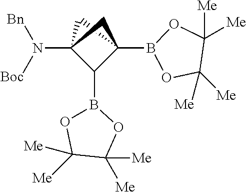 [SMILES: CC(C)(C)OC(=O)N(Cc1ccccc1)[C@]12C[C@](B3OC(C)(C)C(C)(C)O3)(C1)C2B1OC(C)(C)C(C)(C)O1]

tert-butyl benzyl(2,3-bis(4,4,5,5-tetramethyl-1,3,2-dioxaborolan-2-yl)bicyclo[1.1.1]pentan-1-yl)carbamate (xxNBnBoc) Physical State: white solid. m.p.: 89-91° C. ¹H NMR (600 MHz, CDCl₃): δ 7.29-7.12 (m, 5H), 4.47 (brs, 2H), 2.56 (s, 1H), 2.12 (dd, J=9.5, 1.4 Hz, 1H), 2.06-1.97 (m, 3H), 1.47 (s, 9H), 1.21 (s, 12H), 1.20 (s, 12H) ppm. ¹³C NMR (151 MHz, CDCl₃) δ 140.12, 128.26, 126.92, 126.51, 83.48, 83.07, 52.68, 48.28, 28.69, 25.00, 24.95, 24.84, 24.81 ppm. Note: NC, NCH2, Me3C and BC were not observed. ¹¹B NMR (128 MHz, CDCl₃): δ 30.94 ppm. HRMS (ESI-TOF): calc'd for C₂₉H₄₆B₂NO₆ [M+H]⁺: 526.3506, found: 526.3518. TLC: R_{f}=0.68 (3:1 hexanes:ethyl acetate).

All the compounds, formulations, and methods disclosed and claimed herein can be made and executed without undue experimentation in light of the present disclosure. While the compounds, formulations, and methods of this disclosure have been described in terms of preferred embodiments, it will be apparent to those of skill in the art that variations may be applied to the compounds, formulations, and methods, as well as in the steps or in the sequence of steps of the method described herein without departing from the concept, spirit, and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

### REFERENCES

The following references to the extent that they provide exemplary procedural or other details supplementary to those set forth herein, are specifically incorporated herein by reference.
WO 2004/082682
WO 2014/066196
Anderson, Practical Process Research & Development—A Guide for Organic Chemists, 2^{nd} ed., Academic Press, New York, 2012.
André-Joyaux et al., Angew. Chem. Int. Ed. 2020, 59, 13859-13864.
Applequist et al., J. Org. Chem. 1982, 47, 4985-4995.
Armstrong and Aggarwal, Synthesis 2017, 49, 3323-3336.
Arunprasath et al., Adv. Synth. Catal. 2019, 361, 1172-1207.
Auberson et al., ChemMedChem 2017, 12, 590-598.
Barluenga et al., Nat. Chem. 2009, 1, 494-499.
Bauer et al., RSC Med. Chem. 2021, doi.org/10.1039/DOMD00370K.
Bonet et al., Angew. Chem. Int. Ed. 2011, 50, 7158-7161.
Caputo et al., Chem. Sci. 2018, 9, 5295-5300.
Clausen et al., Chem. Sci. 2019, 10, 6210.
Comins et al., J. Org. Chem. 2001, 66, 2181.
Costantino et al., Bioorg. Med. Chem. 2001, 9, 221-227.
Davenport et al., Angew. Chem., Int. Ed. 2020, 59, 6525-6528.
de Miguel et al., Adv. Synth. Catal. 2012, 354, 1731.
Della and Pigou, J. Am. Chem. Soc. 1984, 106, 1085-1092.
Della et al., J. Am. Chem. Soc. 1981, 103, 4131-4135.
Denisenko et al., Angew. Chem. Int. Ed. 2020, 59, 20515-20521.
Dilmag et al., Angew. Chem. Int. Ed. 2017, 56, 5684-5718.
Dreher et al., J. Am. Chem. Soc. 2008, 130, 9257-9259.
Eliel and Wilen, Stereochemistry of Organic Compounds, Wiley, 1993, p. 696.
Eliel et al., Basic Organic Stereochemistry, Wiley, 2001, p. 443.
Farre et al., Chem. Eur. J. 2016, 22, 17552.
Fasano et al., Angew. Chem. Int. Ed. 2020, 59, 22403-22407.
Fawcett et al., Nat. Chem. 2019, 11, 117.
Feller and Davidson, J. Am. Chem. Soc. 1987, 109, 4133-4139.
Garlets et al., Nat. Catal 2020, 3, 351-357.
Gianatassio et al., Science, 2016, 351, 241-246.
Handbook of Pharmaceutical Salts: Properties, and Use, Stahl and Wermuth Eds., Verlag Helvetica Chimica Acta, 2002.
Hirsch, Topics in Stereochemistry, 1967, 3, 199-222.
Hughes et al., Org. Lett. 2019, 21, 6800-6804.
Jackson and Allen, J. Am. Chem. Soc. 1984, 106, 591-599.
Kanazawa and Uchiyama, Synlett 2019, 30, 1-11.
Kanazawa et al., J. Am. Chem. Soc. 2017, 139, 17791-17794.
Kaszynki and Michl, J. Org. Chem. 1988, 53, 4593-4594.
Kim et al., Angew. Chem. Int. Ed. 2020, 59, 8225-8231.
Kisan et al., ACS Catal. 2017, 7, 5950-5954.
Kondo et al., Angew. Chem. Int. Ed. 2020, 59, 1970-1974.
Kondo et al., Angew. Chem., Int. Ed. 2019, 59, 1980.
Lambert et al., J. Am. Chem. Soc. 1986, 108, 7575.
Larouche-Gauthier et al., Chem. Commun., 2011, 47, 12592.
Levin et al., Chem. Rev. 2000, 100, 169-234.
Li et al., Angew. Chem. Int. Ed. 2012, 51, 2943-2946.
Li et al., Angew. Chem. Int. Ed. 2012, 51, 2943-2946.
Li et al., J. Am. Chem. Soc. 2014, 136, 14027-14030.
Li et al., Org. Lett. 2014, 16, 448-451.
Lopchuk et al., J. Am. Chem. Soc. 2017, 139, 3209-3226.
Lovering et al., J. Med. Chem. 2009, 52, 6752-6756.
Ma and Nhat Pham, Asian J. Org. Chem. 2020, 9, 8-22.
Ma et al., Org. Lett. 2019, 21, 7199-7203.
Ma et al., Org. Lett. 2020, 22, 9133-9138.
Makarov et al., Angew. Chem., Int. Ed., 2017, 56, 12774-12777.
Measom et al., ACS Med. Chem. Lett. 2017, 8, 43-48.
Meinwald et al., Tetrahedron Lett. 1967, 8, 731-733.
Merchant and Lopez, Org. Lett. 2020, 22, 2271-2275.
Mikhailiuk et al., Angew. Chem. Int. Ed. 2006, 45, 5659-5661.
Mykhailiuk, Org. Biomol. Chem. 2019, 17, 2839-2849.
Nicolaou et al., ChemMedChem 2016, 11, 31-37.
Nugent et al., ACS Catal. 2019, 9, 9568-9574.
Odachowski et al., J. Am. Chem. Soc. 2016, 138, 9521-9532.
Padwa and Alexander, J. Am. Chem. Soc. 1967, 89, 6376.
Padwa et al., J. Am. Chem. Soc. 1969, 91, 456-462.
Pellicciari et al., J. Med. Chem. 1996, 39, 2874-2876.
Plaza and Valdés, J. Am. Chem. Soc. 2016, 138, 12061-12064.
Plaza et al., Chem. Eur J. 2018, 24, 14836-14843.
Plaza et al., Org. Lett. 2019, 21, 632-635.
Pozzi et al., J. Am. Chem. Soc. 2005, 127, 14204-14205.
Préz-Aguilar and Valdés, Angew. Chem. Int. Ed. 2012, 51, 5953-5957.
Reagan-Shaw et al., FASEB J., 22(3):659-661, 2008.
Rifi, Tetrahedron Lett. 1969, 10, 1043-1046.
Sadhu and Matteson, Organometallics 1985, 4, 1687-1689.
Shelp et al., Angew. Chem. Int. Ed. 2018, 57, 15857-15861.
Shin et al., Angew. Chem. Int. Ed. 2021, doi:10.1002/ange.202016156.
Srinivasan and Carlough, J. Am. Chem. Soc. 1967, 89, 4932-4936.
Stepan et al., J. Med. Chem. 2012, 55, 3414-3424.
Stymiest et al., Angew. Chem. Int. Ed. 2007, 46, 7491-7494.
Talele, J. Med. Chem. 2020, 63, 13291-13315.
Tani and Stoltz, Nature 2006, 441, 731-734.
Toriyama et al., J. Am. Chem. Soc. 2016, 138, 11132-11135.
Trongsiriwat et al., Angew. Chem. Int. Ed. 2019, 58, 13416-13420.
VanHeyst et al., Org. Lett. 2020, 22, 1648-1654.
Westphal et al., ChemMedChem 2015, 10, 461-469.
Wiberg and Connor, J. Am. Chem. Soc. 1966, 88, 4437-4441.
Wiberg and Walker, J. Am. Chem. Soc. 1982, 104, 5239-5240.
Wiberg et al., Tetrahedron Lett. 1964, 5, 531-534.
Wiberg et al., Tetrahedron Lett. 1986, 27, 1553-1556.
Wiberg, K. B., Angew. Chem. Int. Ed. Engl. 1986, 25, 312-322.
Wiberg, PATAI'S Chemistry of Functional Groups, 2009.
Wolleb et al., Org. Lett. 2018, 20, 3014.
Wu et al., Angew. Chem. Int. Ed. 2009, 48, 1407-1410.
Wu et al., Bioorg. Med. Chem. 2013, 21(8), 2217.
Yamamoto et al., Tetrahedron 2004, 60, 10695-10700.
Yang et al., Angew. Chem. Int. Ed. 2012, 51, 528-532.
Yang et al., J. Am. Soc. Chem. 2021, 143, 471-480.
Yu et al., Angew. Chem., Int. Ed. 2020, 59, 3917-3921.
Zarate et al., Org. Process Res. Dev., 2021, doi.org/10.1021/acs.oprd.0c00446.
Zhang et al., Nature, 2020, 580, 220-226.
Zhao et al., Chemrxiv, 2020.
Zweifel et al., J. Am. Chem. Soc. 1967, 89, 3652-3653.

1. A method of synthesizing a product, wherein the product is an organic compound having a substructure of the formula: 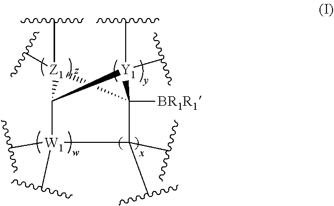
wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, are B-heterocycloalkyl_{(C≤12)} or substituted B-heterocycloalkyl_{(C≤12)};
or a salt thereof;
the method comprising:
(a) obtaining a precursor, wherein the precursor is an organic compound having a substructure of the formula: 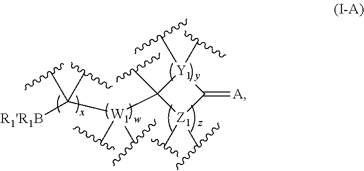
wherein w, x, y, z, W₁, Y₁, Z₁, R₁, and R₁′ are as defined above; and
A is O, S, or NRₑ, wherein:
Rₑ is hydrogen, alkyl_{(C≤12)}, alkoxy_{(C≤12)}, alkylamino_{(C≤12)}, dialkylamino(cc₁₂), alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
or a salt thereof; and
(b) contacting the precursor with a reagent, wherein the reagent is an organic compound comprising a hydrazide moiety, to afford a first reaction mixture; and
(c) contacting the first reaction mixture with a base to afford the product.

2. The method of claim 1, wherein the product is further defined as: 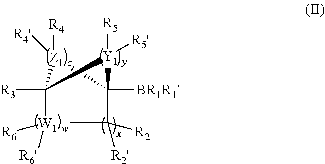
wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
R₂, R₂′, R₃, R₄, R₄′, R₅, R₅′, R₆, and R₆′ are each independently, in each instance, absent, hydrogen, hydroxy, halo, amino, cyano, nitro, or a monovalent amino protecting group; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group; or
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof; and
the substructure of the precursor is further defined as: 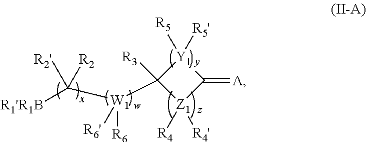
wherein w, x, y, z, W₁, Y₁, Z₁, R₁, R₁′, R₂, R₂′, R₃, R₄, R₄′, R₅, R₅′, R₆, and R₆′ are as defined above;
A is O, S, or NRₑ, wherein:
Rₑ is hydrogen, alkyl_{(C≤12)}, alkoxy_{(C≤12)}, alkylamino_{(C≤12)}, dialkylamino_{(C≤12)}, alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
or a salt thereof.

3. The method of claim 1, wherein the product is further defined as: 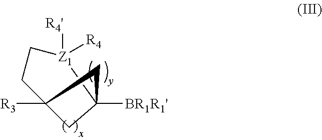
wherein:
x and y are each independently 1, 2, or 3;
Z₁ is C, N, O, or S; and
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
R₃ is hydrogen, hydroxy, halo, amino, cyano, nitro, or a monovalent amino protecting group; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
R₄, and R₄′ are each independently absent, hydrogen, hydroxy, halo, amino, cyano, nitro, or a monovalent amino protecting group; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
or a salt thereof.

4. The method of claim 1, wherein the product is an organic compound having a substructure of the formula: 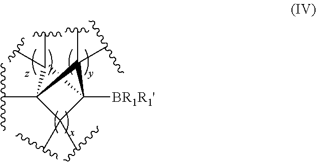
wherein:
x is 1 or 2;
y and z are each independently 1, 2, or 3; and
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
or a salt thereof;
the method comprising:
(a) obtaining a precursor, wherein the precursor is an organic compound having a substructure of the formula: 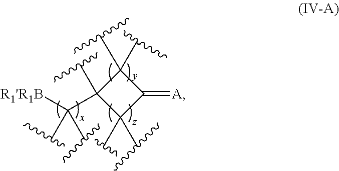
wherein x, y, z, R₁, and R₁′ are as defined above;
A is O, S, or NRₑ, wherein:
Rₑ is hydrogen, alkyl_{(C≤12)}, alkoxy_{(C≤12)}, alkylamino_{(C≤12)}, dialkylamino_{(C≤12)}, alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
or a salt thereof; and
(b) contacting the precursor with a reagent, wherein the reagent is an organic compound comprising a hydrazide moiety to afford a first reaction mixture; and
(c) contacting the first reaction mixture with a base to afford the product.

5. The method of claim 4, wherein the product is further defined as: 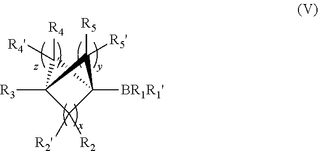
wherein:
x is 1 or 2;
y and z are each independently 1, 2, or 3;
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)}; and
R₂, R₂′, R₃, R₄, R₄′, R₅, and R₅′ are each independently, in each instance, hydrogen, hydroxy, halo, amino, cyano, or nitro; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof; and
the precursor is further defined as: 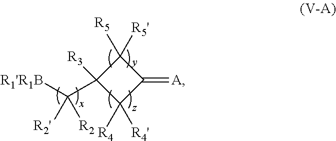
wherein:
x, y, z, R₁, R₁′, R₂, R₂′, R₃, R₄, R₄′, R₅, and R₅′ are as defined above;
A is O, S, or NRₑ, wherein:
Rₑ is hydrogen, alkyl_{(C≤12)}, alkoxy_{(C≤12)}, alkylamino_{(C≤12)}, dialkylamino(cc₁₂), alkylsulfonyl_{(C≤12)}, arylsulfonyl_{(C≤12)}, alkylsulfonylamino_{(C≤12)}, arylsulfonylamino_{(C≤12)}, or a substituted version of any of these groups; or
A is a protected carbonyl;
or a salt thereof.

6. The method of claim 4, wherein the product is further defined as: 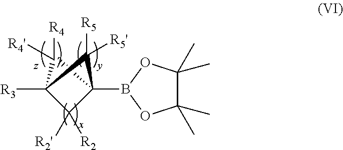
wherein:
x is 1 or 2;
y and z are each independently 1, 2, or 3; and
R₂, R₂′, R₃, R₄, R₄′, R₅, and R₅′ are each independently, in each instance, hydrogen, hydroxy, halo, amino, cyano, or nitro; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino(cc₁₂), or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof.

7.-113. (canceled)

114. The method of claim 4, wherein the product is further defined as: 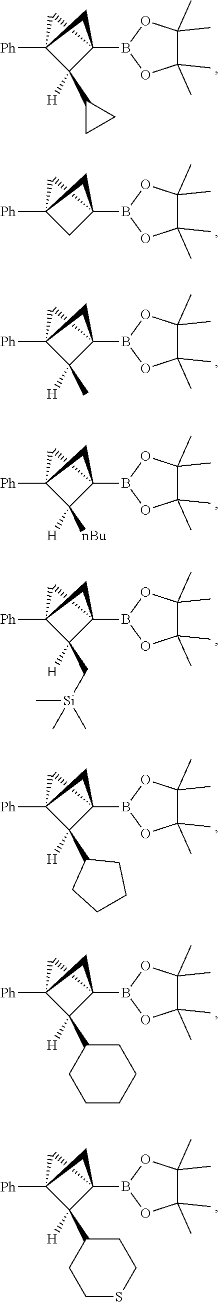 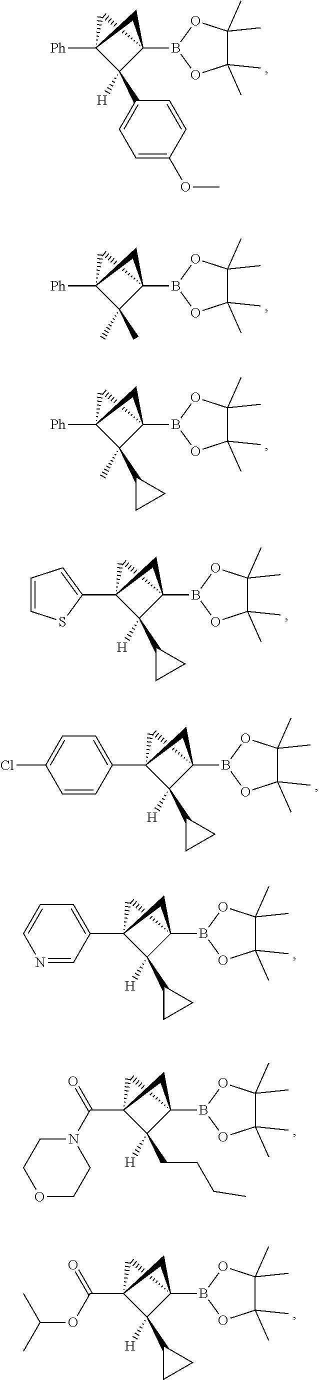 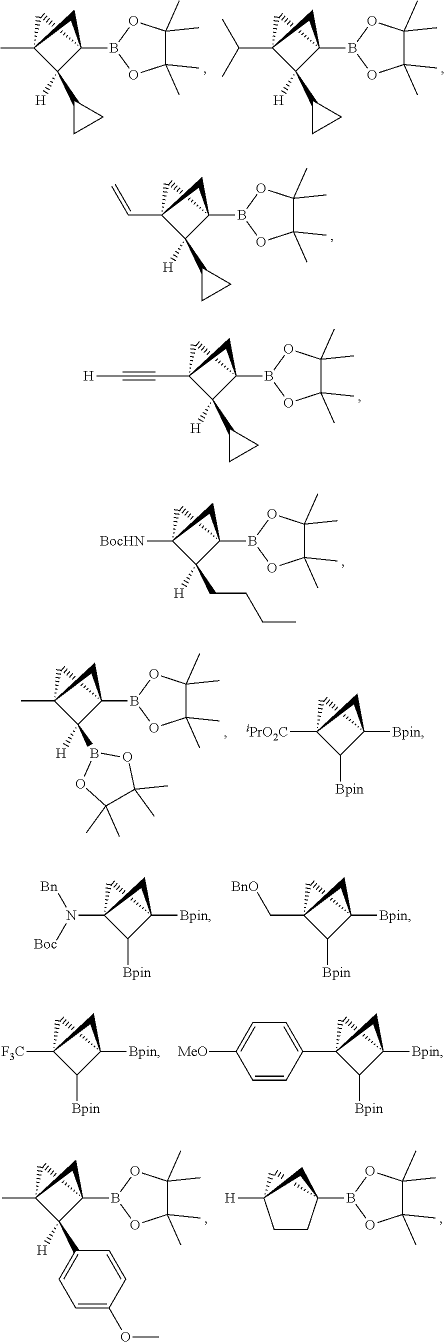 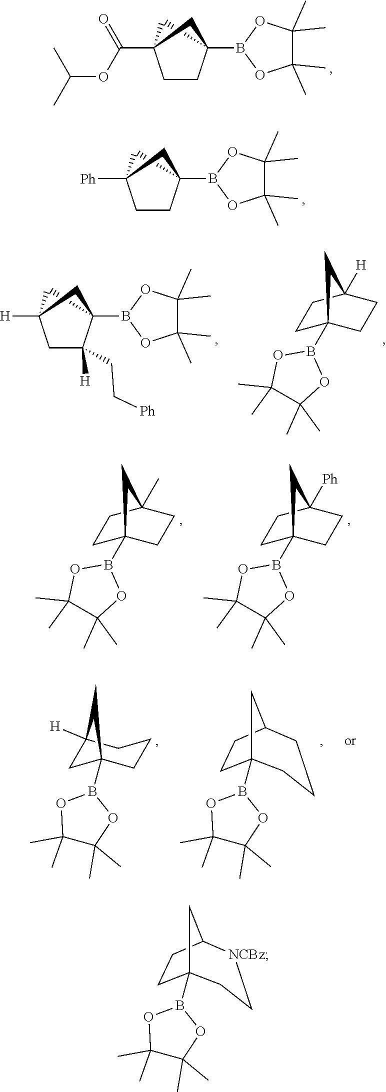
or a salt thereof.

115. The method of claim 4, wherein the reagent is of the formula: 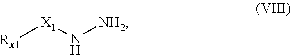
wherein:
X₁ is —C(O)— or —SO₂—; and
Rₓ₁ is alkyl_{(C≤12)}, substituted alkyl_{(C≤12)}, aryl_{(C≤12)}, or substituted aryl_{(C≤12)}.

116. The method of claim 115, wherein X₁—SO₂—.

117. The method of claim 115, wherein Rₓ₁ is aryl_{(C≤12)} or substituted aryl_{(C≤12)}.

118.-120. (canceled)

121. The method of claim 4, wherein the base is an inorganic base.

122. The method of claim 4, wherein the base is a salt.

123.-126. (canceled)

127. The method of claim 4, wherein the method is conducted in a solvent.

128. (canceled)

129. The method according to of claim 4, wherein the method further comprises heating the first reaction mixture to a first temperature.

130.-145. (canceled)

146. A compound of the formula: 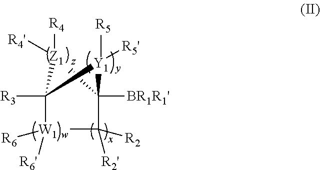
wherein:
w is 0 or 1;
x, y, and z are each independently 1, 2, or 3;
W₁, Y₁, and Z₁ are each independently, in each instance, C, N, O, or S; and
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
R₂, R₂′, R₃, R₄, R₄′, R₅, R₅′, R₆, and R₆′ are each independently, in each instance, absent, hydrogen, hydroxy, halo, amino, cyano, nitro, or a monovalent amino protecting group; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino(cc₁₂), or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof.

147. The compound of 146, wherein the product is further defined as: 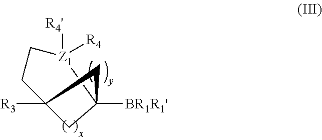
wherein:
x and y are each independently 1, 2, or 3;
Z₁ is C, N, O, or S; and
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)};
R₃ is hydrogen, hydroxy, halo, amino, cyano, nitro, or a monovalent amino protecting group; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
R₄, and R₄′ are each independently absent, hydrogen, hydroxy, halo, amino, cyano, nitro, or a monovalent amino protecting group; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
or a salt thereof.

148. The compound of claim 146, wherein the product is further defined as: 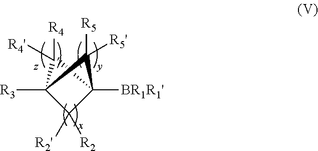
wherein:
x is 1 or 2;
y and z are each independently 1, 2, or 3;
R₁ and R₁′ are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or
R₁ and R₁′ are taken together as defined below;
R₁ and R₁′, when taken together with the boron atom of the —BR₁R₁′ group, and is B-heterocycloalkyl_{(C≤12)} or substituted B-heterocycloalkyl_{(C≤12)}; and
R₂, R₂′, R₃, R₄, R₄′, R₅, and R₅′ are each independently, in each instance, hydrogen, hydroxy, halo, amino, cyano, or nitro; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof.

149. The compound of claim 146, wherein the product is further defined as: 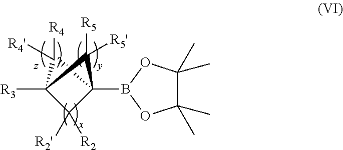
wherein:
x is 1 or 2;
y and z are each independently 1, 2, or 3; and
R₂, R₂′, R₃, R₄, R₄′, R₅, and R₅′ are each independently, in each instance, hydrogen, hydroxy, halo, amino, cyano, or nitro; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof.

150. The compound of claim 146, wherein the product is further defined as: 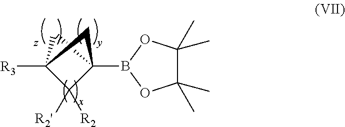
wherein:
x is 1 or 2;
y and z are each independently 1, 2, or 3; and
R₂, R₂′, and R₃ are each independently, in each instance, hydrogen, hydroxy, halo, amino, cyano, or nitro; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, heteroaryl_{(C≤12)}, aralkyl_{(C≤12)}, heteroaralkyl_{(C≤12)}, alkoxy_{(C≤12)}, alkylamino_{(C≤12)}, dialkylamino_{(C≤12)}, acyl_{(C≤12)}, acyloxy_{(C≤12)}, amido_{(C≤12)}, -alkanediyl_{(C≤12)}-alkylsilyl_{(C≤12)}, or a substituted version of any of these groups; or
—(CH₂)ₐC(O)Rₐ, —(CH₂)ₐOR_{b}, or —(CH₂)ₐNR_{c}R_{c}′, wherein:
a is 0, 1, 2, 3, or 4;
Rₐ is hydrogen, hydroxy, halo, or amino; or
alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, alkoxy_{(C≤12)}, alkylamino_{(C≤12)}, dialkylamino_{(C≤12)}, or a substituted version of any of these groups;
R_{b} is a monovalent hydroxy protecting group; or alkyl_{(C≤12)}, alkenyl_{(C≤12)}, alkynyl_{(C≤12)}, cycloalkyl_{(C≤12)}, heterocycloalkyl_{(C≤12)}, aryl_{(C≤12)}, aralkyl_{(C≤12)}, heteroaryl_{(C≤12)}, or a substituted version of any of these groups;
R_{c} and R_{c}′ are each independently hydrogen or a monovalent amino protecting group; or
R_{c} and R_{c}′ are taken together and is a divalent amino protecting group;
—BR_{d}R_{d}′, wherein:
R_{d} and R_{d}′ are each independently are each independently hydrogen, hydroxy, or amino; or
alkoxy_{(C≤12)}, alkylamino_{(C≤12)}, dialkylamino_{(C≤12)}, acyloxy_{(C≤12)}, amido_{(C≤12)}, or a substituted version of any of these groups; or R_{d} and R_{d}′ are taken together as defined below;
R_{d} and R_{d}′, when taken together with the boron atom of the —BR_{d}R_{d}′ group, and is B-heterocycloalkyl_{(C≤12)} or substituted B-heterocycloalkyl_{(C≤12)};
or a salt thereof.

151.-251. (canceled)

252. The compound of claim 146, wherein the product is further defined as: 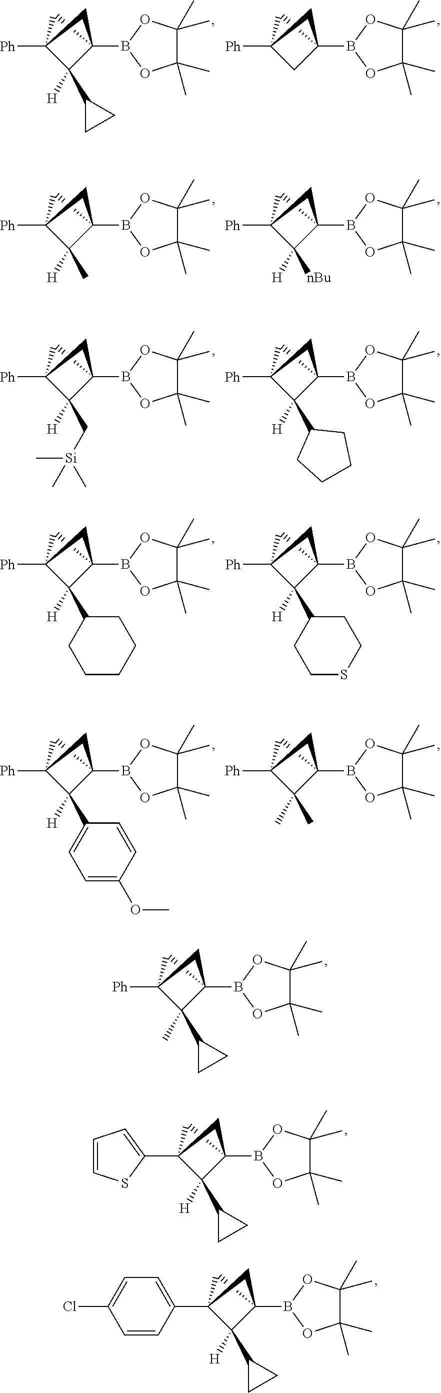 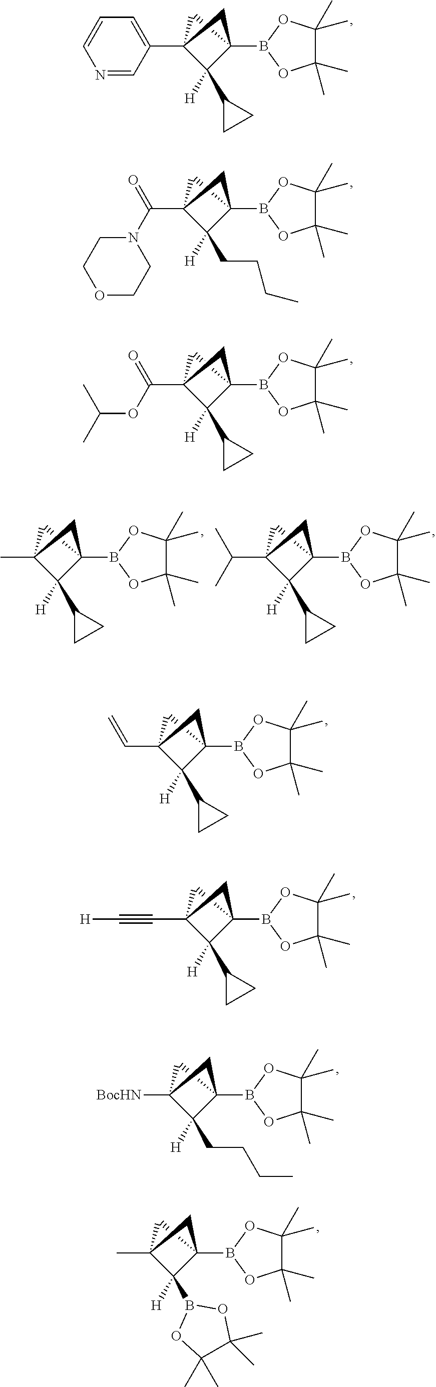 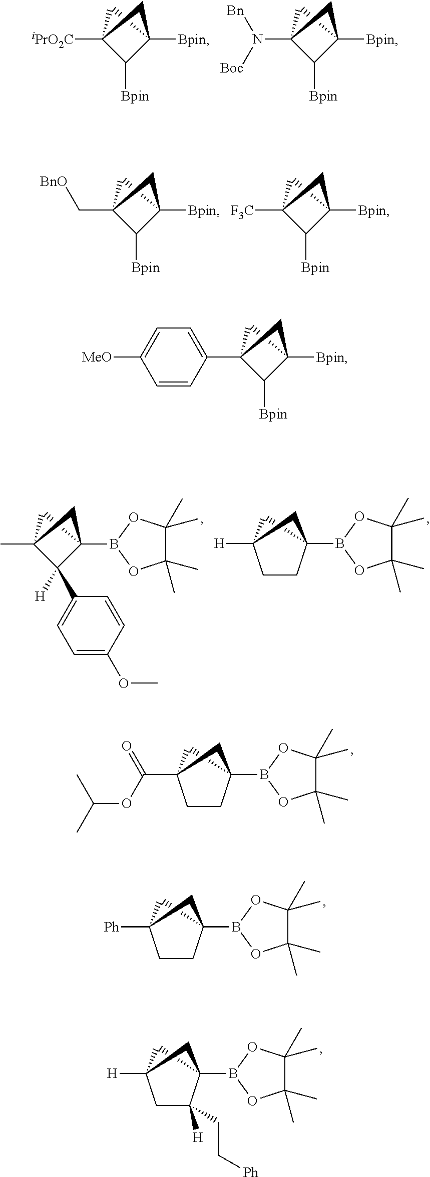 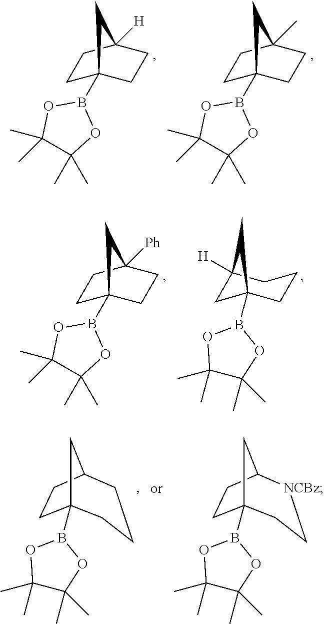
or a salt thereof.
